(19) United States
(12) Patent Application Publication
(10) Pub. No.: US 2025/0221336 A1
(43) Pub. Date: Jul. 10, 2025

(54) MOWER

(71) Applicant: Greenworks (Jiangsu) Co., Ltd, Changzhou (CN)

(72) Inventors: Qunli Wei, Changzhou (CN); Dongdong Shi, Changzhou (CN); Qinghua Shi, Changzhou (CN); Chris Eichel, Mooresville, NC (US); Chenghai Ning, Changzhou (CN); Yansheng Sun, Changzhou (CN); Min Ding, Changzhou (CN); Qin Ji, Changzhou (CN); Nick Suchoza, Mooresville, NC (US); Hui Chen, Changzhou (CN); Jing Wang, Changzhou (CN); Jiafu Xue, Changzhou (CN); Paulius Bulovas, Jönköping (SE); Jaquline Hultman, Huskvarna (SE); Tao Yu, Changzhou (CN); Xiazi Li, Changzhou (CN); Tao Wang, Changzhou (CN); Naixin Gao, Changzhou (CN); Zhiyuan Li, Changzhou (CN); Yu Mei, Changzhou (CN); Fei Zhu, Changzhou (CN); Shiyuan Ding, Changzhou (CN); Yueyue Xu, Changzhou (CN)

(21) Appl. No.: 19/080,937

(22) Filed: Mar. 17, 2025

Related U.S. Application Data
(63) Continuation of application No. PCT/CN2023/119063, filed on Sep. 15, 2023.

(30) Foreign Application Priority Data
Sep. 16, 2022 (CN) 202211131936.9
Sep. 16, 2022 (CN) 202211131983.3
Sep. 16, 2022 (CN) 202211131985.2
Sep. 16, 2022 (CN) 202211132261.X
Sep. 16, 2022 (CN) 202222463616.5
Sep. 16, 2022 (CN) 202222464012.2
Sep. 16, 2022 (CN) 202222464517.9
Sep. 16, 2022 (CN) 202222465126.9
Sep. 16, 2022 (CN) 202222465614.X
Sep. 16, 2022 (CN) 202222467150.6
Sep. 16, 2022 (CN) 202222471370.6
Dec. 19, 2022 (CN) 202211639732.6
Dec. 19, 2022 (CN) 202223422873.0
Jun. 29, 2023 (CN) 202321711252.6
Sep. 7, 2023 (CN) 202311155252.7
Sep. 7, 2023 (CN) 202322437426.0

(51) Int. Cl. A01D 34/82; A01D 34/64; A01D 69/02; A01D 101/00; B60K 1/02; B60L 53/16

(52) U.S. Cl. CPC A01D 34/824; A01D 34/64; A01D 69/02; B60K 1/02; B60L 53/16; A01D 2101/00; B60L 2200/40

(57) ABSTRACT

A mower includes a frame, a walking assembly, a cutting deck assembly and an operating mechanism. The walking assembly, the cutting deck assembly and the operating mechanism are all installed on the frame, and the operating mechanism is configured to control a walking of the walking assembly. The operating mechanism includes an operating lever mounting base, an operating lever, a limiting assembly and a reset assembly. The operating lever mounting base is rotatably installed on the frame along a first direction. The operating lever is rotatably installed on the operating lever mounting base along a second direction. The reset assembly drives the operating lever to reset to an initial position in the first direction, and the limiting assembly locks the operating lever in the initial position.

### CROSS REFERENCE TO RELATED APPLICATION

The present application is a continuation application of PCT application No. PCT/CN2023/119063 filed on Sep. 15, 2023, which claims the benefit of CN202211132261.X filed on Sep. 16, 2022, CN202222471370.6 filed on Sep. 16, 2022, CN202222467150.6 filed on Sep. 16, 2022, CN202222464012.2 filed on Sep. 16, 2022, CN202222465614.X filed on Sep. 16, 2022, CN202222463616.5 filed on Sep. 16, 2022, CN202211131983.3 filed on Sep. 16, 2022, CN202211131985.2 filed on Sep. 16, 2022, CN202211131936.9 filed on Sep. 16, 2022, CN202222465126.9 filed on Sep. 16, 2022, CN202211639732.6 filed on Dec. 19, 2022, CN202223422873.0 filed on Dec. 19, 2022, CN202222464517.9 filed on Sep. 16, 2022, CN202321711252.6 filed on Jun. 29, 2023, CN202311155252.7 filed on Sep. 7, 2023, CN202322437426.0 filed on Sep. 7, 2023. All the above are hereby incorporated by reference for all purposes.

### TECHNICAL FIELD

The disclosure relates a technical field of mowers, especially relates to a mower.

### BACKGROUND

As an automatic mechanical tool used for mowing lawn and vegetation, mowers can replace or reduce manpower, and they are easy to operate, which fully save manpower and time, and realize environmental beautification, so they are widely used.

In a process of using the mower, people need to constantly adjust the operation handle to maintain the driving of the mower, and the quality of the driving effect of the mower directly affects the aesthetics and effect of the mowing. The structure of the operating system of the general mower is relatively complex. There are many parts, most of the parts adopt sheet metal structure, the cumulative error of assembly is difficult to control, and the reset structure in the operating system is complex. It is difficult to adjust the center position of the operation handle later, which increases manufacturing and assembly costs.

### SUMMARY

One or more embodiments of the disclosure provide a mower, to improve technical problems of the traditional mower, such as a complicated structure of the operating mechanism, an inability to automatically reset, and an inconvenient operation.

One or more embodiments of the disclosure provide the mower. The mower includes a frame, a walking assembly, a cutting deck assembly and an operating mechanism. The walking assembly, the cutting deck assembly and the operating mechanism are all installed on the frame, and the operating mechanism is configured to control the walking assembly to walk. The operating mechanism includes an operating lever mounting base, an operating lever, a limiting assembly and a reset assembly. The operating lever mounting base is rotatably installed on the frame along a first direction. The operating lever is rotatably installed on the operating lever mounting base along a second direction. The reset assembly drives the operating lever to reset to an initial position in the first direction, and the limiting assembly locks the operating lever in the initial position.

In an embodiment of the disclosure, the operating lever includes an operating handle and a limiting plate, and the limiting plate is connected with a bottom of the operating handle.

In an embodiment of the disclosure, the operating lever further includes a sleeving tube, the sleeving tube is arranged between a connection of the limiting plate and the operating handle, the operating lever is arranged on the operating lever mounting base through a rotation shaft, the rotation shaft penetrates through the sleeving tube and is fixed together with the sleeving tube, and two ends of the rotation shaft are respectively rotatably installed on the operating lever mounting base.

In an embodiment of the disclosure, the operating mechanism further includes an elastic assembly, the elastic assembly is installed on the operating lever mounting base and is connected with the limiting plate.

In an embodiment of the disclosure, the elastic assembly includes a spring base and a compression spring arranged in the spring base, the spring base is fixedly installed at a bottom of the operating lever mounting base, a first end of the compression spring is connected with the spring base, a second end of the compression spring is connected with the limiting plate, and two sides of the limiting plate are respectively provided with a protrusion matched with the compression spring.

In an embodiment of the disclosure, the limiting assembly includes a fixing base, a limiting rod and an clastic body, a first end of the limiting rod is arranged on the fixing base, a second end of the limiting rod extends towards the operating lever, the limiting plate is provided with a limiting hole matched with the limiting rod, and the elastic body is arranged between the limiting rod and the fixing base.

In an embodiment of the disclosure, the limiting rod is obliquely arranged.

In an embodiment of the disclosure, an angle between the limiting rod and a horizontal plane is from 8 degrees to 10 degrees, and the limiting hole is a waist-shaped hole.

In an embodiment of the disclosure, the reset assembly includes a tension spring, and an end of the tension spring is connected with the operating lever mounting base to drive the operating lever mounting base to move along the first direction.

In an embodiment of the disclosure, the operating mechanism further includes an angle sensor, and a rotating shaft of the angle sensor is installed on the operating lever and rotates synchronously with the operating lever.

In an embodiment of the disclosure, the operating mechanism further includes a blocking plate and a limiting base, the blocking plate is fixedly installed on the frame, the limiting base is rotatably connected with the blocking plate, and the operating lever mounting base is fixedly installed on the limiting base.

In an embodiment of the disclosure, the operating mechanism is arranged on the frame through a fixing plate, the fixing plate is connected with the frame, the blocking plate is arranged on the fixing plate, and the fixing plate is configured to limit the operating lever mounting base in the first direction.

In an embodiment of the disclosure, the operating mechanism further includes a first operating handle and a second operating handle fixedly installed on the frame, and the first operating handle and the second operating handle are respectively arranged on a front side and rear side of the operating lever.

In an embodiment of the disclosure, the walking assembly includes a walking wheel and a driving motor to drive the walking wheel, and the operating mechanism further includes a switch to control the driving motor to be turned on and off, and when the operating lever returns to the initial position under an effect of the reset assembly, the switch is triggered, and the driving motor is powered off.

In an embodiment of the disclosure, an opening is arranged at a position of the frame corresponding to the operating lever for the operating lever to rotate.

One or more embodiments of the disclosure further provide an operating mechanism used for the mower. The operating mechanism includes an operating lever mounting base, an operating lever, a limiting assembly and a reset assembly. The operating lever mounting base is rotatably installed on the frame of the mower along the first direction. The operating lever is rotatably installed on the operating lever mounting base along the second direction. The reset assembly drives the operating lever to reset to an initial position in the first direction, and the limiting assembly locks the operating lever in the initial position.

In an embodiment of the mower of the disclosure, the mower includes a frame, a standing area, a walking mechanism, a cutting deck assembly, a battery and an operating device. The frame includes a front frame and a rear frame. The front frame is detachably connected with the rear frame. The standing area is arranged at a tail part of the frame. The walking mechanism is installed on the frame and includes a front wheel assembly, a rear wheel assembly and a driving motor. The front wheel assembly is installed at the front frame and includes a front wheel. The rear wheel assembly is installed at the rear frame and includes a rear wheel. The driving motor drives the front wheel and/or the rear wheel. The cutting deck assembly is installed on the frame and includes a cutting deck, a cutting motor and a cutting blade. The cutting motor drives the cutting blade to mow. The battery is installed on the frame. The operating device is configured to control the walking mechanism to walk and includes the operating lever mounting base and the operating lever. The operating lever is rotatably installed on the operating lever mounting base.

In an embodiment of the disclosure, the operating lever is rotatably installed on the frame, and when the operating lever mounting base rotates relative to the frame, the operating lever rotates synchronously with the operating lever mounting base.

In an embodiment of the disclosure, the operating lever includes the operating handle and the limiting plate, and the limiting plate is connected the bottom of the operating handle.

In an embodiment of the disclosure, the operating lever further includes the sleeving tube, the sleeving tube is arranged between the connection of the limiting plate and the operating handle, the operating lever is arranged on the operating lever mounting base through a first rotation shaft, the first rotation shaft penetrates through the sleeving tube and is fixed together with the sleeving tube, and two ends of the first rotation shaft are respectively rotatably installed on the operating lever mounting base.

In an embodiment of the disclosure, the operating assembly includes the limiting assembly, the reset assembly and the elastic assembly. The limiting assembly locks the operating lever at the initial position. The reset assembly drives the operating lever to reset to the initial position along the first direction. The clastic assembly is installed on the operating lever mounting base and is connected with the limiting plate.

In an embodiment of the disclosure, the limiting assembly includes the fixing base, the limiting rod and the elastic body, the first end of the limiting rod is arranged on the fixing base, the second end of the limiting rod extends to the direction of the operating lever, the limiting plate is provided with the limiting hole matched with the limiting rod, and the clastic body is arranged between the limiting rod and the fixing base.

In an embodiment of the disclosure, the angle between the limiting rod and the horizontal plane is from 8 degrees to 10 degrees, and the limiting hole is the waist-shaped hole.

In an embodiment of the disclosure, the reset assembly includes the tension spring, and the end of the tension spring is connected with the operating lever mounting base to drive the operating lever mounting base to move along the first direction.

In an embodiment of the disclosure, the elastic assembly includes the spring base and the compression spring arranged in the spring base, the spring base is installed at a bottom of the operating lever mounting base, the first end of the compression spring is connected with the spring base, and the second end of the compression spring is connected with the limiting plate.

In an embodiment of the disclosure, the front wheel assembly includes a front fork. The front fork is rotatably installed on the frame. The front wheel assembly is installed on the front fork. A front end of the front fork is provided with a wheel protective plate, and the front end of the wheel protective plate extends beyond the front wheel.

In an embodiment of the disclosure, a cushion is arranged on standing area, the cushion tilts forward from bottom to top, and the cushion forms an angle of 100 degrees to 110 degrees with a horizontal direction.

In an embodiment of the disclosure, an operating platform is arranged on standing area, the operating platform is provided with a display screen, and the display screen forms an angle of 150 degrees to 160 degrees with the horizontal direction.

In an embodiment of the disclosure, the frame is provided with a first placing area, batteries are installed on the first placing area, the first placing area is provided with a plurality of first installation holes, and the batteries of different specifications are matched with different first installation holes.

In an embodiment of the disclosure, a tail part of the mower is provided with a first charging port, and the first charging port forms an angle of 15 degrees to 30 degrees with a ground.

In an embodiment of the disclosure, the first charging port is provided with a reversible charging port cover.

In an embodiment of the disclosure, the mower is provided with a placing platform, and the placing platform is arranged above the battery.

In an embodiment of the disclosure, a reinforcing connecting plate is arranged between a front end of the placing platform and the frame.

In an embodiment of the disclosure, the mower is provided with a control assembly, and the control assembly is arranged above the battery.

In an embodiment of the disclosure, the mower includes an electromagnetic brake and a brake releasing mechanism. There are two electromagnetic brakes and they are respectively installed on the driving motors of the two rear wheels. The brake releasing mechanism includes a connecting base, a pulling rod and at least two pulling components. The connecting base is arranged on the frame. The pulling rod is rotatably connected on the connecting base. A first end of the pulling component is connected with the pulling rod, and a second end of the pulling component is connected with the electromagnetic brake. The pulling rod rotates to drive the pulling components to pull the two electromagnetic brakes to release and open, or the pulling rod rotates to drive the pulling components to pull the two electromagnetic brakes to reset and lock simultaneously.

In an embodiment of the mower of the disclosure, the mower includes the frame, the cutting deck and the walking mechanism. The cutting deck is installed on the frame. The walking mechanism is installed on the frame. The walking mechanism includes the front wheel assembly and the rear wheel assembly. The frame includes the front frame and the rear frame. The front frame is detachably connected with the rear frame. The front frame is installed with the front wheel, and the rear frame is installed with the rear wheel.

In an embodiment of the disclosure, the front frame includes a first cross beam and a first connecting part. The first connecting part extends forward from two ends of the first cross beam, and the two first connecting parts are respectively provided with the front wheel assemblies.

In an embodiment of the disclosure, a front end of the first connecting part is an assembling tube vertically downward. The front wheel assembly is assembled on the assembling tube so that the front wheel rotates around an axis of the assembling tube.

In an embodiment of the disclosure, a rear end of the front frame is provided with U-shaped grooves on both sides, and a front end of the rear frame includes two square tubes, and the square tubes are inserted into the grooves to fix the front frame and the rear frame.

In an embodiment of the disclosure, the rear end of the front frame is provided with two first clamping boards on both sides, bottom surfaces of the two first clamping boards on each side are provided with a second clamping board, and the first clamping boards and the second clamping board are enclosed to form the groove. Corresponding positions of side walls of the first clamping board and the square tube are provided with first through holes, and a connecting bolt penetrates through the first through holes to connect and fix the front frame and the rear frame.

In an embodiment of the disclosure, the cutting deck is installed at a bottom of the frame, and a minimum distance between the cutting deck and the front wheel is from 10 mm to 60 mm.

In an embodiment of the disclosure, the cutting deck is installed at the bottom of the frame, and a minimum distance between the cutting deck and the rear wheel is from 10 mm to 60 mm.

In an embodiment of the disclosure, the mower further includes the batteries. The frame is provided with the first placing area, and the batteries are fixed in the first placing area.

In an embodiment of the disclosure, the first placing area is provided with a plurality of first installation holes, and the batteries of different specifications are matched with different first installation holes.

One or more embodiments of the disclosure further provide a garden tool. The garden tool includes the frame, the walking mechanism, the battery and a working part. The walking mechanism is installed on the frame. The walking mechanism includes the front wheel assembly, the rear wheel assembly and a driving mechanism. The battery is installed on the frame and provides electrical energy for the mower. The working part is installed on the frame. The frame includes the front frame and the rear frame. The front frame is detachably and fixedly connected with the rear frame. The front frame is installed with the front wheel assembly, and the rear frame is installed with the rear wheel assembly.

In an embodiment of the mower of the disclosure, the mower includes the frame, the walking mechanism, the battery and the cutting deck assembly. The walking mechanism is installed on the frame. The battery provides the electrical energy for the mower. The cutting deck assembly is installed on the frame and includes the cutting deck, the cutting part and a cutting blocking plate. The cutting deck is mounted to the frame of the mower. The cutting part is arranged on the cutting deck and includes the cutting motor and the cutting blade driven by the cutting motor. The cutting blocking plate is detachably fixed at a bottom of the cutting deck. The cutting blocking plate encloses and forms a cutter accommodating cavity, and the cutting blade is arranged in the cutter accommodating cavity.

In an embodiment of the disclosure, the cutting blocking plate includes an edge blocking plate and a middle blocking plate. One side of an accommodating cavity formed by the edge baffle is provided with a lawn discharging port. The lawn discharging port is arranged on a side or a rear side of a forward direction of the cutting deck, and discharged lawn may be avoided from splashing on a staff through a way of side discharging, which may affect the staff.

In an embodiment of the disclosure, the middle blocking plate is arranged in an area enclosed by the edge blocking plate, the middle blocking plate and the edge blocking plate enclose to form a plurality of accommodating cavities, and the cutting blades are all arranged in the accommodating cavities.

In an embodiment of the disclosure, there are three cutting blades, and the three cutting blades are arranged in a triangular pattern.

In an embodiment of the disclosure, a lawn discharging cover is arranged at the lawn discharging port. An opening of the lawn discharging cover becomes larger from an inside of the cutting deck to an outside of the cutting deck, which is convenient for a discharging of crushed lawn and avoids an accumulation of the crushed lawn

In an embodiment of the disclosure, the cutting motor penetrates the cutting deck, and the cutting deck at a contact between the cutting motor and the cutting deck is provided with a plurality of ventilation holes. When air flow passes in the ventilation hole, heat around the cutting motor will be taken away, so as to avoid a problem of a heat accumulation caused by a sealed contact position between the cutting motor and the cutting deck, and improve a heat dissipation effect of the cutting motor.

In an embodiment of the disclosure, a front end of the cutting deck is provided with a roller.

In an embodiment of the disclosure, a height of the cutting blocking plate near the front wheel of the mower from the ground is greater than a height of the cutting blocking plate near the rear wheel of the mower.

In an embodiment of the disclosure, the cutting blade is provided with a lawn pushing part, and the lawn pushing part is arranged on a back side of the cutting blade in a cutting direction. A rear edge of the cutting blade in the cutting direction bents downward to form the lawn pushing part, thereby forming a front end of the cutting blade to cut the lawn, and the lawn pushing part at a rear side takes the cut lawn away, so as to realize a directional discharging of the lawn after mowing.

One or more embodiments of the disclosure further provide the cutting deck assembly for the mower. The cutting deck assembly includes the cutting deck, the cutting part and the cutting blocking plate. The cutting deck is installed on the frame of the mower. The cutting part is arranged on the cutting deck and includes the cutting motor and the cutting blade driven by the cutting motor. The cutting blocking plate is detachably fixed at a bottom of the cutting deck. The cutting blocking plate encloses to form a cutter accommodating cavity, and the cutting blade is arranged in the cutter accommodating cavity.

In an embodiment of the mower of the disclosure, the mower includes the frame, a power supply device, the cutting deck assembly, the brake releasing mechanism and at least two motors. The at least two motors are arranged on the frame. The cutting deck assembly is arranged on the frame. The power supply device is arranged on the frame and is electrically connected with the cutting deck assembly and the at least two motors. The brake releasing mechanism is arranged on the frame, and connected with the braking mechanisms on the at least two motors to operate the braking mechanisms located on the at least two motors simultaneously.

The brake releasing mechanism includes the connecting base, the pulling rod and at least two pulling components. The pulling rod includes the connecting sleeve, the pulling rod is sleeved and installed on the connecting base through the connecting sleeve, and the connecting sleeve is respectively connected with the braking mechanisms on the at least two motors through the at least two pulling components.

In an embodiment of the disclosure, the pulling rod is configured to rotate to drive the connecting sleeve to rotate, drive the pulling components connected with the connecting sleeve to move, and simultaneously pull the braking mechanism on the at least two motors to release and open or to reset and lock of the braking mechanism on the at least two motors.

In an embodiment of the disclosure, the pulling component is an elastic reset component.

In an embodiment of the disclosure, when the pulling rod rotates over a releasing position, the at least two clastic reset components stretch to drive the braking mechanism on the at least two motors to release and open, and enable the connecting sleeve to bear a force balance at the releasing position, and when the pulling rod rotates over the releasing position in an opposite direction, the at least two elastic reset components shrink and reset, so as to drive the connecting sleeve to move and reset, and enable the braking mechanism on the at least two motors to reset and lock at the same time.

In an embodiment of the disclosure, at least two motors are arranged in a central symmetry manner on a circumferential outward side of the connecting sleeve.

In an embodiment of the disclosure, one end of the pulling component close to the connecting sleeve is provided with a first limiting structure, and a shape of the first limiting structure is matched with the connecting sleeve.

In an embodiment of the disclosure, the first end of the pulling component is connected in a fixing hole on the connecting sleeve, and the second end of the pulling component is connected with the braking mechanism by threading.

In an embodiment of the disclosure, the connecting base is provided with a sleeving shaft, and the pulling rod is sleeved and installed on the sleeving shaft through the connecting sleeve.

In an embodiment of the disclosure, the connecting sleeve is sleeved on the sleeving shaft by a separating sleeve, and the separating sleeve is clamped on a second limiting structure of the sleeving shaft.

In an embodiment of the disclosure, the braking mechanism is an electromagnetic brake. The electromagnetic brake is provided with a brake releasing plate, and the brake releasing plate is connected with the pulling component.

One or more embodiments of the disclosure further provide a garden tool. The garden tool includes the frame, the working assembly, the power supply device, the brake releasing mechanism and the at least two motors. The at least two motors are arranged on the frame. The working assembly is arranged on the frame. The power supply device is arranged on the frame and is electrically connected with the working assembly and the at least two motors. The brake releasing mechanism is arranged on the frame, and connected with the braking mechanisms on the at least two motors to operate the braking mechanisms located on the at least two motors simultaneously.

The brake releasing mechanism includes the connecting base, the pulling rod and at least two pulling components. The pulling rod includes the connecting sleeve, the pulling rod is sleeved and installed on the connecting base through the connecting sleeve, and the connecting sleeve is respectively connected with the braking mechanisms on the at least two motors through the at least two pulling components.

In an embodiment of the motor of the disclosure, the mower includes the frame, the walking wheel, the cutting deck assembly, a mowing motor and a storage platform. The walking wheel is installed on the bottom of the frame. The cutting deck assembly is installed on the frame and provided with a blade. The mowing motor is connected with the blade to drive the blade to rotate to mow and the mowing motor is installed on the frame. The storage platform is arranged on the frame. The mower further includes a walking motor. The walking motor drives the walking wheel to move, so as to realize a walking of the mower.

The mower further includes the walking motor, a battery assembly and a controller. The walking motor drives the walking wheel to move, so as to realize the walking of the mower. The battery assembly is electrically connected with the mowing motor, the walking motor and the controller respectively. The controller is further electrically connected with the walking motor and the mowing motor respectively.

The mower in one or more embodiments of the disclosure is provided with the storage platform on the mower, which increases a load capacity of the mower in an operation process and is convenient for the staff to randomly configure auxiliary tools or other articles, so that the staff has reduced labor effort in the mowing process, and increased a convenience of the mower when using.

In an embodiment of the disclosure, an opening edge of the storage cavity is provided with a spacer block. A function of the spacer block is to separate a casing of the storage cavity from the storage platform of the storage cavity. The mower will cause a vibration of the storage platform in a mowing process, and the spacer block arranged between the storage platform and the storage cavity can effectively prevent the storage platform from causing wear to an edge of the storage cavity.

In an embodiment of the disclosure, a boss is arranged at a position of the storage platform corresponding to the spacer block, and the boss protrudes towards the spacer block. The Boss and the spacer block can effectively increase a height of the storage cavity, thereby increasing a storage space of the storage cavity.

In an embodiment of the disclosure, the tail part of the frame is provided with a supporting bracket. The storage platform is rotatably installed on the supporting bracket. A connecting component is arranged between the supporting bracket and the storage platform. A first end of the connecting component is installed on the supporting bracket, and a second end of the connecting component is installed on the storage platform. A pin hole is arranged on the supporting bracket. The storage platform is correspondingly provided with the first installation hole, and a pin bolt passes through the pin hole and the first installation hole, so that the storage platform are rotatably connected with the supporting bracket.

In an embodiment of the disclosure, the supporting bracket includes a supporting rod and an installation frame. The frame is provided with an inserting groove. The supporting rod is inserted into the inserting groove, and the installation frame is arranged at an end part of the supporting rod. The supporting rod is connected with the installation frame through a bolt. A first end of the installation frame is connected with the supporting rod, and a second end of the installation frame is connected with an anti-roll rod. The pin hole is arranged on the supporting rod.

In an embodiment of the disclosure, the supporting bracket is further provided with the connecting hole. The storage platform is provided with a second installation hole. A first end of the connecting component is installed on the connecting hole, and a second end of the connecting component is installed on the second installation hole. A main function of the connecting component is to enhance a load-bearing capacity of the storage platform, and in addition, the connecting component further has a limiting function.

In an embodiment of the disclosure, the connecting component is a rope, and the rope may be directly installed in the connecting hole and the second installation hole. But in order to avoid a wear and tear to the rope caused by the connecting hole or the second installation hole, the pin bolt or the bolt is installed in the connecting hole and the second installation hole respectively, and an end of the rope is provided with a ring buckle, and the ring buckle is installed on the pin bolt or the bolt, so that the wear to the rope can be effectively reduced.

In an embodiment of the disclosure, the storage platform is provided with a flange, the flange is located on a rear edge of the storage platform, and the flange can effectively increase a strength of the storage platform and the load-bearing capacity of the storage platform.

In an embodiment of the disclosure, a plurality of friction protrusions is arranged on the storage platform. A middle part of each friction protrusion is provided with a through hole, and the through hole is mainly set up for two purposes: firstly, it can effectively reduce a weight of a storage board, and secondly, the through hole can play a role of ventilation in order to maintain a dryness of the storage cavity.

In an embodiment of the disclosure, the casing is provided with an operating deck, the operating deck is provided with an operating key, and the operating key is configured to realize an operation of the mower, such as a speed or a light of the mower, etc. The operating deck is further provided with a display screen. The display screen is tilted and arranged.

In an embodiment of the disclosure, the walking wheel includes the front wheel assembly and the rear wheel assembly. The front wheel assembly is the universal wheel, and the rear wheel assembly is driven by the walking motor. A radius of the front wheel assembly is less than a radius of the rear wheel assembly. The large radius of the rear wheel assembly ensures that the mower has enough horsepower.

In an embodiment of the disclosure, a lawn outlet of the cutting deck assembly is provided with the lawn discharging cover, and two sides of the lawn discharging cover are provided with a flange that bends downward. A function of the lawn discharging cover is to drain crushed lawn clippings at the lawn outlet, and the flange on both sides of the lawn discharging cover can effectively prevent the crushed lawn clippings from flying during a discharging process.

In an embodiment of the disclosure, the lawn discharging cover is rotatably installed on the frame, and the torsion spring is arranged between the frame and the lawn discharging cover. The crushed lawn clippings carry moisture and may easily stick to an inside of the lawn discharging cover, so when it is necessary to clean the inside of the lawn discharging cover, the lawn discharging cover is turned over and cleaned. After cleaning, the lawn discharging cover is reset under an action of the torsion spring.

In an embodiment of the disclosure, the lawn discharging cover is installed on the frame by two installation plates. A plurality of bolts are arranged between the two installation plates, the lawn discharging cover is positioned between the two installation plates, and the two installation plates are rotatably installed on the frame.

In an embodiment of the disclosure, the mower is a standing mower, the storage platform is arranged in a middle part of the frame, the storage platform is provided with the connecting plate, and the connecting plate is connected with the frame. The connecting plate can effectively increase a firmness of the storage platform.

In an embodiment of the disclosure, three flanges are arranged on the storage platform. The three flanges enclose the storage platform to form a frame body with one side opening, which enables it to be easy to store things and increase the strength of the storage platform. The storage platform is provided with the friction protrusion, the friction protrusion protrudes upward, and a through hole is arranged in the friction protrusion. The through holes can reduce the weight of the entire storage platform and facilitate a heat dissipation for electrical equipment (e.g., motors, control boards, batteries, etc.) below the storage platform.

In an embodiment of the mower of the disclosure, the mower includes a machine body, a cutting system, a walking system, an operating system and a display system. The cutting system is installed on the machine body and includes at least one cutter and cutter driving device for mowing. The walking system is installed on the machine body and includes the walking wheel and a walking wheel driving device that are used for enable the mower to move. The operating system is installed on the machine body and includes the operation device for controlling the mower, and the operation device is provided with a speed regulation key. The display system is arranged on the machine body and includes identification information for displaying a walking speed and a cutting speed, and the identification information includes: a speed regulation identification. The walking speed or the cutting speed can be set by the speed regulation key or the speed regulating identification.

In an embodiment of the disclosure, the mower further includes a recording system, an energy supply system and a monitoring system. The recording system includes a memory that is used for recording fault information of the mower and corresponding fault handling measures, warning information and stage mowing information. The energy supply system includes at least one battery pack. The monitoring system is used for monitoring a state of the cutting system, the walking system, the operating system, the recording system and the energy supply system.

In an embodiment of the disclosure, the display system is further configured to display an external tool state. The external tool state includes whether the external tool is turned on or off. The mower further includes a port to connect the external tool, and the monitoring system is further configured to control whether to start the external tool when it is detected.

In an embodiment of the disclosure, the operating system further includes the operating lever for operating and controlling the walking system of mowing. The operating lever is rotatably installed on the machine body, and a rotation angle of the operating lever is positively correlated with the walking speed. The speed regulation key is located at an end part of the operating lever. The walking speed and the rotation angle of the mower can be operated and controlled by the operating lever.

In an embodiment of the disclosure, the operating system includes two operating levers, each operating lever is respectively provided with the speed regulation key, and the speed regulation key is installed at an end part of the corresponding operating lever.

In an embodiment of the disclosure, the operating system further includes a communication system. The monitoring system is electrically connected with the communication system and the display system respectively.

The display system includes the display screen. The display screen is arranged on the machine body. The display screen is configured to display identification information of the walking speed and a working speed, and the identification information includes the speed regulation identification, and the walking speed or the working speed of the machine body can be set through the speed regulation identification.

In an embodiment of the disclosure, the display screen includes a state display area and a working display area, the state display area is used for displaying state information, the working display area is used for displaying working information, and the working information includes the identification information.

In an embodiment of the disclosure, the state information includes at least one of an operator in-position state, a closing state and releasing state of an electromagnetic brake, time in a current time zone, a cellular signal state, a remote control state, a lighting device state, an alarm light state, and a project name. The project name may be a name of an item in working information. For example, the project name may be light, setting, stage working information, and so on.

In an embodiment of the disclosure, the working information includes a fault reminding, the fault reminding includes the fault information and the corresponding fault handling measures, and the fault information includes a fault code and corresponding fault details.

In an embodiment of the disclosure, the working information further includes the stage working information, which includes: an operating area, a working time, and an average speed.

In an embodiment of the disclosure, the working information further includes pause reminding information, and the pause reminding information includes a pause time period.

One or more embodiments of the disclosure further provide the garden tool. The garden tool includes the machine body, a working system, the walking system, the operating system and the display system. The working system is installed on the machine body and includes at least one tool for use in the work and a tool driving device. The walking system is installed on the machine body and includes the walking wheel and the walking wheel driving device that are used for enable the garden tool to move. The operating system is installed on the machine body and includes the operation device for controlling the garden tool, and the operation device is provided with the speed regulation key. The display system is arranged on the machine body and includes identification information for displaying the walking speed and the working speed, and the identification information includes the speed regulation identification. The walking speed or the working speed can be set by the speed regulation key or the speed regulating identification.

In an embodiment of the mower of the disclosure, the mower includes the machine body, the walking wheel, the cutting deck, the cutting motor, the controller and a light group. The machine body includes the frame. The walking wheel is rotatably installed on the frame. The cutting deck is arranged on the frame. The cutting deck is provided the blade. The cutting motor is arranged on the frame and is connected with the blade. The controller is arranged inside the machine body and is electrically connected with the cutting motor. The light group is arranged on the machine body, electrically connected with the controller, and lit according to a preset lighting method under a control of the controller. The light group has at least one lighting method, and the lighting method of the light group corresponds to a state of the mower. For example, the state of the mower corresponding to the different lighting method of the light group is different, and in a certain embodiment, the lighting method of the light group corresponds to the state of the mower one-to-one.

The mower further includes a functional assembly and the operating assembly. An energy supply assembly includes a battery pack to supply energy to the mower. The operating assembly includes an operating panel and the operating keys arranged on the operating panel to realize an operating and controlling of the mower. The mower further includes the walking motor. The walking motor drives the walking wheels to roll to enable the mower to move according to operations of the mower.

In an embodiment of the disclosure, the light group includes at least one of a headlight, a side light, a dome light and a tail light.

In an embodiment of the disclosure, the headlight, the side light or the dome light is a white light. The headlight, the side light or the dome light includes a light cover and a light bead arranged inside the light cover, and the light cover of the headlight, the side light or the dome light emits a white light with the light beads. For example, the light bead is white, and the light cover is transparent.

In an embodiment of the disclosure, the tail light is a red light, the tail light includes a tail light cover and a tail light bead arranged inside the tail light cover, and the tail light cover and the light bead of the tail light cooperate with each other to emit a red light externally. For example, the tail light cover is red, and the tail light bead is white or red.

In an embodiment of the disclosure, the mower is the standing mower, the headlight is arranged on a front side of the machine body, the side light is arranged on left and right directions of the front side of the machine body, the dome light is arranged on a top of the machine body, and the tail light is arranged on left and right directions of the tail part of the casing.

In an embodiment of the disclosure, the state of the mower includes a charging state, a charging completion state, a low power state, a light on state, or a light off state.

In an embodiment of the disclosure, the state of the mower further includes a plurality of fault states. The fault state includes a fault device and a number of faults. For example, a right driving controller has two faults, a left blade controller has two faults, etc.

One or more embodiments of the disclosure further provide a light indication system. The light indication system includes the controller and the light group. The light group is electrically connected with the controller, and lit according to the preset lighting method under the control of the controller. The light group has at least one lighting method, and the lighting method of the light group corresponds to the state of the mower. The light indication system is installed on the device.

One or more embodiments of the disclosure further provide the garden tool. The garden tool includes the machine body, the walking wheel, the working assembly, a working motor, the controller and the light group. The machine body includes the frame. The walking wheel is rotatably installed on the frame. The working assembly is arranged on the frame. The working motor is arranged on the frame and is connected with the working assembly. The controller is arranged inside the machine body and is electrically connected with the working motor. The light group is arranged on the machine body, electrically connected with the controller, and lit according to a preset lighting method under a control of the controller. The light group has at least one lighting method, and the lighting method of the light group corresponds to a state of the garden tool.

The garden tool further includes the functional assembly and the operating assembly. An energy supply assembly includes a battery pack to supply energy to the garden tool. The operating assembly includes an operating panel and the operating keys arranged on the operating panel to realize an operating and controlling of the garden tool. The garden tool further includes the walking motor. The walking motor drives the walking wheels to roll to enable the garden tool to move as it operates.

One or more embodiments of the disclosure further provide a working device system. The working device system includes a RTK base station and a working device.

The working device includes a positioning device, a control device and a storage device.

The positioning device communicates with the RTK base station, and collects positioning coordinates of the working device in real time.

The control device communicates with the RTK base station, and the control device generates a calibration map of a working area according to positioning coordinate data collected and corrected by the positioning device to the working area and base station coordinate data from the RTK base station.

The storage device is configured to store base station coordinates of the RTK base station and the calibration map sent by the control device.

When the working device works on the working area, the control device compares the coordinates of RTK base station in the calibration map and the RTK base station coordinates of current the RTK base station. If a deviation value obtained by the comparison is less than a preset value, then the calibration map is correspondingly offset, and a new map is generated for use. If the deviation value obtained by the comparison is greater than the preset value, then an abnormality in the position of the RTK base station is reported as an alarm.

In an embodiment of the disclosure, when the working device performs a map calibration on the working area, the positioning device applies the differential data from the RTK base station to correct the positioning coordinate data of the working device, and sends the corrected positioning coordinate data to control device. The control device applies the corrected positioning coordinate data and the base station coordinate data from the RTK base station to generate the calibration map of the working area, and sends the calibration map to the storage device for storage.

In an embodiment of the disclosure, the RTK base station is a portable RTK base station. In an embodiment of the disclosure, the working device is the mower.

In an embodiment of the disclosure, the control device and the positioning device communicate with the RTK base station through the communication device.

In an embodiment of the disclosure, the communication device receives the differential data and RTK base station coordinate data from the RTK base station, and sends the differential data to the positioning device and sends the RTK base station coordinate data to the control device.

In an embodiment of the disclosure, the communication device includes a radio station device installed on the mower.

In an embodiment of the disclosure, the positioning device is a mobile satellite positioning station.

In an embodiment of the disclosure, the mower further includes a terminal control device. The terminal control device may receive state information fed back by the mower and send a corresponding control command to the mower.

In an embodiment of the disclosure, the state information includes a positioning state information and alarm information of the mower.

In an embodiment of the disclosure, the positioning state information includes high-precision positioning state information and non-high-precision positioning state information. The high-precision positioning state information indicates that the mower is in a centimeter-level positioning state.

In an embodiment of the disclosure, the alarm information indicates that fault state information of the mower, which includes a blade current overcurrent, a walking motor overcurrent, a control temperature being too high, and other fault information.

In an embodiment of the disclosure, when the positioning state information received by the terminal control device is the high-precision positioning state information, the terminal control device sends a corresponding execution command to the mower. The execution command may include commands such as the command to continue a current state, the command to calibrate the map, the command to calibrate a non-working area, the command to increase the non-working area, the command that the map boundary calibration is completed, the command that the calibration of the non-working area is completed, etc.

In an embodiment of the disclosure, when the positioning state information received by the terminal control device is the non-high-precision positioning state information, the terminal control device sends a corresponding stop command to the mower.

In an embodiment of the disclosure, when the terminal control device receives the alarm information, the terminal control device displays the alarm information and notifies an operator, and the operator sends a corresponding processing command to the mower through the terminal control device.

In an embodiment of the disclosure, the terminal control device is a hand-held terminal device.

In an embodiment of the disclosure, the positioning device includes a satellite positioning receiving antenna installed on the mower.

In an embodiment of the disclosure, the communication device includes a wireless antenna installed on the mower.

In an embodiment of the disclosure, the communication device further includes a Bluetooth device for a wireless communication with the terminal control device.

In an embodiment of the disclosure, the communication device further includes a 4G-GPS module. The 4G-GPS module may upload information of the control device to a server, then the server may send the information of the control device to the terminal control device, and commands of the terminal control device may also be sent to the server through a mobile network, and then further sent to the control device.

In an embodiment of the disclosure, the control device includes a map generation and management module, a trajectory planning module and a mowing operation control module.

In an embodiment of the disclosure, when the mower is mapping the calibration map, the mower walks along a boundary of the working area, and the positioning device collects the positioning coordinates of the mower in real time. The control device monitors whether the mower is in the high-precision positioning state in real time. If it is not in the high-precision positioning state, then a feedback that the positioning system is abnormal is sent to the terminal control device. If it is in the high-precision positioning state all the time, then the positioning coordinates of the mower is continuously recorded until the terminal control device sends a map boundary calibration completion command. The control device generates and stores the calibration map of the working area according to the positioning coordinates of the mower received from a start calibration command to an end calibration command, and correspondingly stores the RTK base station coordinates sent by the RTK base station simultaneously.

In an embodiment of the disclosure, after completing the calibration map, the terminal control device may further send the command to calibrate the non-working area to the mower. The mower walks along a boundary of the non-working area, and the positioning device collects the positioning coordinates of the mower in real time. The control device monitors whether the mower is in the high-precision positioning state in real time. If it is not in the high-precision positioning state, then a feedback that the positioning system is abnormal is sent to the terminal control device. If it is in the high-precision positioning state all the time, then the positioning coordinates of the mower is continuously recorded until the terminal control device sends a non-working area calibration completion command. The control device then compares the calibration map of the non-working area with the calibration map of the working area to verify whether the non-working area is within a boundary of the working area. Then the control device generates and stores the calibration map of the non-working area according to the positioning coordinates of the mower received from a start calibration command to an end calibration command, and correspondingly stores the RTK base station coordinates sent by the RTK base station simultaneously.

In an embodiment of the disclosure, the calibration map of the working area and the calibration map of the non-working area may be stored on the control device, the terminal control device, or the server that may communicate with the mower and the terminal control device.

In an embodiment of the disclosure, when the calibration map of a mowing area is offset accordingly, the calibration map is first called by the storage device and sent to the map generation and management module of the control device. The map generation and management module calculates a difference between the RTK base station coordinates in the calibration map and the RTK base station coordinates of the current RTK base station, and then adds coordinates of all points in the calibration map to the calculated difference, thereby generating a new map after the offset. The mower may perform a mowing operation according to this new map.

In an embodiment of the disclosure, the preset value is 1.5 m.

The disclosure further provides a control method of the working device system. The working device system includes the RTK base station and the working device. The control method includes:
obtaining original RTK base station coordinates;
controlling the working device to collect positioning coordinate data along the boundary of the working area, and generating the calibration map of the working area according to the collected positioning coordinate data and the original RTK base station coordinate data;
storing the calibration map and the original RTK base station coordinates; and
when the working device works in the working area, calling the calibration map.

When calling the calibration map,
obtaining current RTK base station coordinates;
comparing the original coordinates of RTK base station and the current RTK base station coordinates, if a deviation value obtained by the comparison is less than a preset value, then correspondingly offsetting the calibration map, and generating the new map for working, if the deviation value obtained by the comparison is greater than the preset value, then reporting the abnormality in the position of the RTK base station as the alarm.

In an embodiment of the mower of the disclosure, the mower includes the driving motor. The driving motor includes a motor casing and a driving motor winding. The driving motor winding is arranged in the motor housing, and the motor housing is provided with at least one reinforcing connecting body. The motor housing and the reinforcing connecting body are made of different materials respectively, and a material strength of the reinforcing connecting body is greater than a material strength of the motor casing. The reinforcing connecting body is provided with a threaded hole for a threaded connection with a reducer.

In an embodiment of the mower of the disclosure, the reinforcing connecting body is detachably fixed on the motor casing.

In an embodiment of the mower of the disclosure, the reinforcing connecting body is embedded and cast inside the motor casing.

In an embodiment of the mower of the disclosure, the motor casing is provided with one reinforcing connecting body, and the reinforcing connecting body is provided with at least two threaded holes for the threaded connection with a reducer connecting component.

In an embodiment of the mower of the disclosure, the motor casing is provided with at least two reinforcing connecting bodies, and each reinforcing connecting body is provided with the threaded hole for the threaded connection with the reducer connecting component.

In an embodiment of the mower of the disclosure, a first circumferential stopping structure is arranged between the reinforcing connecting body and the motor casing.

In an embodiment of the driving motor of the disclosure, the first circumferential stopping structure includes a plurality of first protruding parts and a plurality of first concave parts corresponding to the plurality of first protruding parts. The first protruding parts are arranged on one of the reinforcing connecting body and/or the motor casing, and the plurality of first concave parts is correspondingly arranged on the other one of the reinforcing connecting body and/or the motor casing.

One or more embodiments of the disclosure further provide a driving device. The driving device is configured to drive the walking wheel to walk. The driving device includes the driving motor and the reducer. The driving motor includes the motor casing and the first torque output end. The reducer includes the fixing base, a torque input end and a second torque output end. At least one reinforcing connecting body for connection is fixedly arranged on the motor casing. The motor casing and the reinforcing connecting body are made of different materials respectively, and the material strength of the reinforcing connecting body is greater than that of the motor casing. The reinforcing connecting body is provided with the threaded hole. The fixing base of the reducer is in a threaded connection with the threaded hole on a same or different reinforcing connecting bodies through a plurality of connecting components. The first torque output end drives the second torque input end to rotate, and the second torque output end is coaxially connected with walking wheel.

In an embodiment of the driving device of the disclosure, the reinforcing connecting body is detachably fixed on the motor casing.

In an embodiment of the driving device of the disclosure, the reinforcing connecting body is embedded and cast inside the motor casing.

In an embodiment of the driving device of the disclosure, the motor casing is provided with one reinforcing connecting body. The fixing base is in the threaded connection with the reinforcing connecting body through at least two connecting components, and the connecting components are threaded with the reinforcing connecting body through a bolt hole on the fixing base.

In an embodiment of the driving device of the disclosure, the motor casing is provided with at least two reinforcing connecting bodies. The fixing base is in the respective threaded connection with the reinforcing connecting body through the at least two connecting components.

In an embodiment of the driving device of the disclosure, the first circumferential stopping structure is arranged between the reinforcing connecting body and the motor casing.

In an embodiment of the driving device of the disclosure, the first circumferential stopping structure includes the plurality of first protruding parts and the plurality of first concave parts corresponding to the plurality of first protruding parts. The first protruding parts are arranged on one of the reinforcing connecting body and/or the motor casing, and the plurality of first concave parts is correspondingly arranged on the other one of the reinforcing connecting body and/or the motor casing.

In an embodiment of the driving device of the disclosure, a second circumferential stopping structure is arranged between the fixing base and the reinforcing connecting body.

In an embodiment of the driving device of the disclosure, the second circumferential stopping structure includes a plurality of second protrusions and a plurality of second grooves matched with the plurality of second protrusions. The plurality of the second protrusions are arranged on one of the reinforcing connecting body and/or the fixing base, and the plurality of second grooves is correspondingly arranged on the other one of the reinforcing connecting body and/or the fixing base.

In an embodiment of the driving device of the disclosure, the reducer is a planetary gear reducer.

The disclosure further provides a garden walking device. The garden walking device includes the frame, the walking wheel configured to drive the frame to walk, the cutting deck assembly used for garden working and the driving device. The driving device includes the driving motor and the reducer. The driving motor includes the motor casing and the first torque output end. The reducer includes the fixing base, the torque input end and the second torque output end. At least one reinforcing connecting body for connection is fixedly arranged on the motor casing. The motor casing and the reinforcing connecting body are made of different materials respectively, and the material strength of the reinforcing connecting body is greater than that of the motor casing. The reinforcing connecting body is provided with the threaded hole. The fixing base of the reducer is in the threaded connection with the threaded hole on the same or different reinforcing connecting bodies through the plurality of connecting components. The first torque output end drives the second torque input end to rotate, and the second torque output end is coaxially connected with walking wheel.

In an embodiment of the mower of the disclosure, the mower includes the cutting deck assembly. The cutting deck assembly includes the cutting deck, a motor controller and a plurality of cutting motors. The motor controller and the cutting motor are both installed on the cutting deck, the plurality of the cutting motors is electrically connected with the motor controller, and the motor controller centrally controls a rotation of each cutting motor.

In an embodiment of the cutting deck assembly of the disclosure, the cutting deck is provided with a controller accommodating cavity for installing the motor controller, a bottom of the controller accommodating cavity is an opening hole structure, and at least part of a lower surface of the motor controller is exposed in the opening hole structure.

In an embodiment of the cutting deck assembly of the disclosure, the controller accommodating cavity is provided with a controller protective cover, and a connection between the controller protective cover and the controller accommodating cavity is provided with an air inlet.

In an embodiment of the cutting deck assembly of the disclosure, a bottom of the motor controller is provided with a plurality of heat sinks, and the plurality of heat sinks is arranged at intervals along the lower surface of the motor controller.

In an embodiment of the cutting deck assembly of the disclosure, the cutting deck is provided with the controller accommodating cavity for installing the motor controller, the motor controller is installed in the controller accommodating cavity, and an upper surface of the motor controller is not higher than an upper surface of the cutting deck.

In an embodiment of the cutting deck assembly of the disclosure, the cutting deck is provided with a motor installation hole penetrating the cutting deck, and the cutting motor is fixed on the cutting deck through the motor installation hole and passing through a flange part at an end part.

In an embodiment of the cutting deck assembly of the disclosure, the cutting motor includes a motor end cover, a motor housing, a motor rotor and a motor stator, the motor end cover is fastened with the motor housing to form a motor cavity, and the motor rotor and the motor stator are installed in the motor cavity.

In an embodiment of the cutting deck assembly of the disclosure, the motor housing includes a connecting flange, the first housing and the second housing that are communicated sequentially, an outer diameter of the connecting flange is greater than a diameter of the motor installation hole, and an outer diameter of the first housing and the second housing is less than or equal to the diameter of the motor installation hole.

In an embodiment of the cutting deck assembly of the disclosure, the motor end cover is provided with a first bearing installation base, and the first bearing installation base is matched with a first bearing of the motor rotor. A second bearing installation base is arranged in the second housing, and the second bearing installation base is matched with the second bearing of the motor rotor.

In an embodiment of the cutting deck assembly of the disclosure, a connection of the first housing and the second housing protrudes inward along a radial direction to form a stator supporting step, and the motor stator is arranged on the stator supporting step.

In an embodiment of the cutting deck assembly of the disclosure, the connecting flange includes a plurality of first connecting parts and a plurality of second connecting parts, and the first connecting part protrudes from the second connecting part along the radial direction. A plurality of first connecting parts and the plurality of second connecting parts are arranged at intervals and are connected sequentially along a circumferential direction of the first housing to form the connecting flange. The first connecting part is used for being connected with the motor end cover and the cutting deck.

In an embodiment of the cutting deck assembly of the disclosure, the motor end cover includes an end cover body and an end cover flange. The end cover flange is matched with the connecting flange, a position of the end cover flange corresponding to the second connecting part is concave downward and forms a step with the second connecting part, and a position of the corresponding step of the cutting deck is provided with a ventilation hole.

In an embodiment of the cutting deck assembly of the disclosure, a height of the step is from 10 mm to 12 mm.

In an embodiment of the cutting deck assembly of the disclosure, an outer surface of the motor housing is provided with a plurality of reinforcing ribs.

The disclosure provides the mower on another hand. The mower includes the frame, the walking assembly connected with the frame, the battery installed on the frame, the cutting deck assembly installed on the frame and powered by the battery and a cutting blade assembly installed on the cutting deck assembly. The cutting deck assembly includes the cutting deck, the motor controller and the plurality of cutting motors. The motor controller and the cutting motor are both installed on the cutting deck, the plurality of the cutting motors is electrically connected with the motor controller, and the motor controller centrally controls a rotation of each cutting motor. The cutting blade assembly includes a plurality of the cutting blades, and the plurality of the cutting blades is correspondingly installed on output shafts of the plurality of the cutting motors.

In an embodiment of the mower of the disclosure, the mower includes a walking driving mechanism. The walking driving mechanism includes the driving motor, the reducer and a scaling structure.

The reducer is coaxially connected with the driving motor. The sealing structure is arranged at a connection of the driving motor and the reducer, and a sealing fit is formed between the driving motor and the reducer.

In an embodiment of the disclosure, the scaling structure includes a first scaling component, and the first scaling component is coaxially sleeved on the driving motor and/or the reducer.

In an embodiment of the disclosure, the first sealing component is a first sealing ring, and the first scaling ring is provided with a first elastic structure. The first elastic structure is arranged on one surface of the sealing ring facing the reducer along the circumferential direction, and the first elastic structure is interference abutted on an end surface of the reducer, and forms a scaling with the end surface through a friction matching.

In an embodiment of the disclosure, the sealing structure further includes a second sealing component, the second scaling component is coaxially arranged on the reducer, and a radial plane of the second sealing component at the connection of the driving motor and the reducer is arranged relative to the first sealing component.

In an embodiment of the disclosure, the first sealing component is a second scaling ring, and the second sealing component is provided with a second clastic structure along a circumferential outer edge. The second seal is provided with a lip edge along the circumferential direction, the lip edge is located at the circumferential outward side of the second scaling ring, and the second clastic structure is interference abutted on an inner wall of the lip edge along the circumferential direction, and is matched with the lip edge to form the sealing through the friction matching.

In an embodiment of the disclosure, the first sealing component is provided with a first deck surface, and the second sealing component is provided with a second deck surface. The first deck surface and the second deck surface are arranged relative to each other at a radial plane, and a gap is left between the first deck surface and the second deck surface.

In an embodiment of the disclosure, a length of the gap is from 1 mm to 3 mm.

In an embodiment of the disclosure, the second sealing component is provided with a first flange along a circumferential outer edge of the first deck surface, and the circumferential outer edge of the first scaling component is relatively matched with the first flange to form the sealing.

In an embodiment of the disclosure, the first scaling component is provided with a second flange along an inner edge of the circumferential direction of the second deck surface. The second flange extends toward one side of the reducer, and the first deck surface is provided with a scaling groove matched with the second flange. The second flange is embedded in the sealing groove, and the second flange is matched with the scaling groove to form the seal.

One or more embodiments of the disclosure further provide the garden tool. The garden tool includes the machine body, the walking wheel, the driving motor, a power battery, the reducer and the scaling structure.

The walking wheels are arranged on two sides of the machine body. The driving motor is fixedly connected with the machine body. The power battery is electrically connected with the driving motor. A first end of the reducer is coaxially connected with the driving motor, and a second end of the reducer is coaxially connected with the walking wheel. The sealing structure is arranged at the connection of the driving motor and the reducer, and the scaling fit is formed between the driving motor and the reducer.

One or more embodiments of the disclosure provide a control method of the mower. The mower is provided with a first sensor. The first sensor is configured to detect whether the operator is standing on a pedal of the mower. The control method includes:
obtaining a control signal;
determining whether to meet a trigger condition of a walking mode or not according to the obtained control signal; and
if meeting the trigger condition of the walking mode, controlling the mower to run the corresponding walking mode of the mower.

In an embodiment of the disclosure, the walking mode includes a first walking mode, the control signal includes a first signal, and the first signal is configured to be generated when the operator arrives at a driving position and/or when the walking mode is selected. According to the obtained control signal, determining whether to meet the trigger condition of the walking mode or not includes: if obtaining the first signal, determining that the trigger condition the first walking mode is met.

In an embodiment of the disclosure, the walking mode includes a second walking mode, the control signal includes a second signal, and the second signal is configured to be generated when the operator arrives at a pushing position and/or when the walking mode is selected. According to the obtained control signal, determining whether to meet the trigger condition of the walking mode or not includes: if obtaining the second signal or not obtaining the first signal, determining that the trigger condition of the second walking mode is met.

In an embodiment of the disclosure, a maximum forward speed when the mower runs the first walking mode is greater than a maximum forward speed when the mower runs the second walking mode.

In an embodiment of the disclosure, a maximum backward speed when the mower runs the first walking mode is greater than a maximum backward speed when the mower runs the second walking mode.

In an embodiment of the disclosure, when the mower runs the first walking mode, the forward speed is provided with four gears. When in a first gear, the maximum forward speed is from 3 mph to 5 mph; when in a second gear, the maximum forward speed is from 5 mph to 8 mph; when in a third gear, the maximum forward speed is from 9 mph to 11 mph; and when in a fourth gear, the maximum forward speed is from 13 mph to 15 mph. The maximum backward speed when the mower runs the first walking mode is from 3 mph to 5 mph.

In an embodiment of the disclosure, when the mower runs the second walking mode, the forward speed is provided with three gears. When in a first gear, the maximum forward speed is from 1.75 mph to 2.75 mph, when in a second gear, the maximum forward speed is from 2.75 mph to 3.25 mph, and when in a third gear, the maximum forward speed is from 3.5 mph to 4.5 mph. The maximum backward speed when the mower runs the second walking mode is from 1.75 mph to 2.75 mph.

In an embodiment of the disclosure, the control signal includes a third signal. The third signal is configured to be sent out when the operating mechanism is in a non-parking state and/or performs a mode selection, and according to the obtained control signal, determining the trigger condition whether to meet the walking mode or not includes: if obtaining the third signal, determining that a triggering condition for entering or maintaining the walking mode is met.

In an embodiment of the disclosure, the control signal includes a fourth signal. The fourth signal is configured to be sent out when the operating mechanism is in a parking state and/or performs the mode selection, and according to the obtained control signal, determining the trigger condition whether to meet the walking mode or not includes: if obtaining the fourth signal, determining that the triggering condition for entering or maintaining the walking mode is not met.

In an embodiment of the disclosure, the method further includes:
obtaining an operating signal of the mowing motor;
determining whether to meet an operating condition of the mowing motor or not according to the control signal; and
if meeting the operating condition of the mowing motor, the mowing motor running.

In an embodiment of the disclosure, the control signal includes the first signal, the first signal is configured to be generated when the operator arrives at a driving position and/or when the walking mode is selected. According to the control signal, determining whether to meet the operating condition of the mowing motor or not includes: if receiving the first signal, determining that the operating condition of the mowing motor is met.

In an embodiment of the disclosure, the control signal includes a third signal. The third signal is configured to be sent out when the operating mechanism is in a non-parking state and/or performs a mode selection, and according to the control signal, determining the operating condition whether to meet the mowing motor or not includes: if receiving the third signal, determining that the operating condition of the mowing motor are met.

The disclosure further provides the control method of the mower. The mower is provided with the pedal, and the pedal is provided with at least the first position and the second position. The control method includes:
obtaining a position of the pedal;
determining the position of the pedal, if the pedal is in the first position, determining to meet the trigger condition of the first walking mode; if the pedal is in the second position, determining to meet the trigger condition of the second walking mode.

The disclosure provides a control method of the mower. The mower is provided with a first sensor. The first sensor is configured to detect whether the operator is on the pedal of the mower. The control method includes:
obtaining a signal from the first sensor;
determining the signal from the first sensor, if the first sensor is in the first signal, determining to meet the trigger condition of the first walking mode; if the first sensor is in the second signal, determining to meet the trigger condition of the second walking mode.

The disclosure provides the mower. The mower includes the frame, the cutting deck assembly, the walking mechanism and the first sensor.

The cutting deck assembly includes the mowing motor and the blade.

The walking mechanism includes the driving motor and the walking wheel.

The first sensor is configured to detect whether the operator is on the pedal of the mower. If the operator is on the mower, the first sensor is the first signal, and the mower runs the first walking mode. If the operator is not on the mower, the first sensor is the second signal, and the mower runs the second walking mode.

In an embodiment of the disclosure, when the mower runs the first walking mode, it is provided with four gears. When in the first gear, a maximum rotating speed of the driving motor when moving forward is from 1150 rpm to 1350 rpm; when in the second gear, the maximum rotating speed of the driving motor when moving forward is from 2050 rpm to 2250 rpm; when in the third gear, the maximum rotating speed of the driving motor when moving forward is from 2950 rpm to 3150 rpm; and when in the fourth gear, the maximum rotating speed of the driving motor is from 4150 rpm to 4350 rpm. When the mower runs the first walking mode, a maximum rotating speed of the driving motor when moving backward is from 1100 rpm to 1300 rpm.

In an embodiment of the disclosure, when the mower runs the second walking mode, it is provided with three gears. When in the first gear, a maximum rotating speed of the driving motor when moving forward is from 550 rpm to 750 rpm; when in the second gear, the maximum rotating speed of the driving motor when moving forward is from 800 rpm to 1000 rpm; and when in the third gear, the maximum rotating speed of the driving motor when moving forward is from 1150 rpm to 1350 rpm. When the mower runs the second walking mode, the maximum rotating speed of the driving motor when moving backward is from 550 rpm to 750 rpm.

In an embodiment of the disclosure, the mower includes the operating mechanism. The operating mechanism includes the operating lever and the second sensor. The operating lever operates a parking and walking of the mower. The second sensor is configured to detect whether the operating lever is in the parking state. If the operating lever is in the non-parking state, the second sensor is the third signal, and the mower enters or maintains the walking mode. If the operating lever is in the parking state, the third sensor is the fourth signal, and the mower enters or maintains the parking mode.

In an embodiment of the disclosure, after a switch of the mowing motor is turned on, when the second sensor sends the third signal and/or the first sensor sends the first signal, the mowing motor starts. If the second sensor sends the fourth signal and the first sensor sends the second signal, the mowing motor does not start.

In an embodiment of the disclosure, the mower includes the pedal, and the pedal is rotatably installed on the frame. When the pedal is in an initial state, the first sensor sends the second signal, —the pedal is subjected to an external force that exceeds a preset threshold so that the pedal rotates to the ground to a preset angle, and then the first sensor sends the first signal.

The disclosure provides a pedal device. The pedal device includes the pedal, a reset bracket, the first sensor and a reset mechanism. The reset bracket is rotatably installed on the pedal. The first sensor is arranged on the reset bracket and/or the pedal to send an in-position signal when the pedal rotates to a set position relative to the reset bracket. The reset mechanism is arranged between the reset bracket and the pedal to enable the pedal to rotate backward after the external force acting on the pedal is removed, thereby causing the first sensor to release the in-position signal.

In an embodiment of the disclosure, a shock absorbing pad is arranged between the reset bracket and the pedal, and the shock absorbing pad is arranged at an abutting position between the pedal and the reset bracket when the pedal rotates to the set position relative to the reset bracket.

In an embodiment of the disclosure, the reset bracket is provided with a first limiting part, and the pedal is provided with a second limiting part. The first limiting part is matched with the second limiting part, and a maximum angle between the pedal and the reset bracket is limited.

In an embodiment of the disclosure, a cushion pad is provided between the first limiting part and the second limiting part.

In an embodiment of the disclosure, an oil filling nozzle is arranged at a rotating connection between the reset bracket and the pedal, and the oil filling nozzle is communicated with a contact point between the reset bracket and the pedal.

In an embodiment of the disclosure, the reset mechanism includes the compression spring. A first end of the compression spring is arranged at a bottom of the pedal, and a second end of the compression spring is arranged at a top of the reset bracket.

In an embodiment of the disclosure, there are three compression springs, and the three compression springs are arranged in an isosceles triangle.

One or more embodiments of the disclosure further provide the garden tool. The garden tool includes the machine body, the working part, a control part, and the pedal device. The machine body is provided with a limiting component. The working part is arranged on the machine body. The control part controls the working part to work. The pedal device includes the pedal, the reset bracket, the first sensor and the reset mechanism. The reset bracket is rotatably installed on the pedal. The limiting component limits a rotation of the reset bracket away from the pedal. The first sensor is arranged on the reset bracket and/or the pedal to send the in-position signal when the pedal rotates to the set position relative to the reset bracket. The reset mechanism is arranged between the reset bracket and the pedal to enable the pedal to rotate backward after the external force acting on the pedal is removed, thereby causing the first sensor to release the in-position signal.

In an embodiment of the disclosure, the machine body is provided with the limiting hole, and a latch is arranged on the pedal device. When the pedal device is folded, the latch is inserted into the limiting hole to limit a rotation of the pedal device.

In an embodiment of the disclosure, when the latch is inserted into the limiting hole, the first sensor releases the in-position signal.

Beneficial effects of the disclosure are that:

The operating mechanism of the mower of one or more embodiments of the disclosure utilizes the reset assembly to enable the operating lever to rotate along the first direction, so that the operating lever is matched with the limiting assembly, and realizes the unlocking and locking between the operating lever and the limiting assembly. When the operating lever drives the operating lever mounting base to swing along the first direction, the operating lever and the limiting assembly are unlocked. At this time, the operating lever may rotate along the second direction (front and rear directions of the mower walks), realize a forward and backward walking of the mower. When the mower stops, under an effect of the reset assembly, the operating lever automatically resets to a middle position, the limiting assembly is inserted into the limiting hole at the bottom of the operating lever, and the operating lever and the limiting assembly are locked.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a schematic structural view of a mower according to at least one embodiment of the disclosure.

FIG. 2 is a schematic structural view of an operating mechanism according to at least one embodiment of the disclosure.

FIG. 3 is a partial schematic structural view of the operating mechanism according to at least one embodiment of the disclosure.

FIG. 4 is an exploded view of the operating mechanism according to at least one embodiment of the disclosure.

FIG. 5 is a schematic view of a matching and an installation of an operating lever, an clastic assembly and an angle sensor of the operating mechanism according to at least one embodiment of the disclosure.

FIG. 6 is a schematic structural view of the operating lever according to an embodiment of the operating mechanism of the disclosure.

FIG. 7 is a schematic view of a matching and an installation of the operating lever, a compression spring and a limiting assembly according to an embodiment of the operating mechanism of the disclosure.

FIG. 8 is a schematic structural view of the limiting assembly according to an embodiment of the operating mechanism of the disclosure.

FIG. 9 is a schematic exploded view of FIG. 8.

FIG. 10 is a schematic view of a matching and an installation of the operating lever and the limiting assembly according to an embodiment of the operating mechanism of the disclosure.

FIG. 11 is a schematic structural view of a first operating handle according to an embodiment of an automatic reset operating mechanism of the disclosure.

FIG. 12 is a schematic structural view of a second operating handle according to an embodiment of the automatic reset operating mechanism of the disclosure.

FIG. 13 is a schematic axial side view of the mower according to at least one embodiment of the disclosure.

FIG. 14 is a front view of the mower according to at least one embodiment of the disclosure.

FIG. 15 is a first schematic structural view of the mower according to at least one embodiment of the disclosure.

FIG. 16 is a schematic perspective view of the mower according to at least one embodiment of the disclosure.

FIG. 17 is a top view of the mower according to at least one embodiment of the disclosure.

FIG. 18 is a first schematic view of the mower according to at least one embodiment of the disclosure.

FIG. 19 is a partial schematic structural view of the mower according to at least one embodiment of the disclosure.

FIG. 20 is a partial schematic left view of the mower according to at least one embodiment of the disclosure.

FIG. 21 is a partial schematic view of a frame of the mower according to at least one embodiment of the disclosure.

FIG. 22 is a schematic view of a front frame of the mower according to at least one embodiment of the disclosure.

FIG. 23 is a schematic view of a rear frame of the mower according to at least one embodiment of the disclosure.

FIG. 24 is a first schematic view of a cutting deck assembly according to at least one embodiment of the disclosure.

FIG. 25 is a schematic view of the cutting deck assembly in a lawn discharging mode according to at least one embodiment of the disclosure.

FIG. 26 is a partial schematic structural view of the cutting deck assembly according to at least one embodiment of the disclosure.

FIG. 27 is an enlarged view of area A in FIG. 18 of the disclosure.

FIG. 28 is an enlarged view of area B in FIG. 20 of the disclosure.

FIG. 29 is a bottom view of the mower according to at least one embodiment of the disclosure.

FIG. 30 is a schematic view of a mower from an angle of a cushion according to at least one embodiment of the disclosure.

FIG. 31 is a schematic view of a mower from an angle of a first charging port according to at least one embodiment of the disclosure.

FIG. 32 is a schematic view of a mower from an angle of a display screen according to at least one embodiment of the disclosure.

FIG. 33 is a schematic size view of a covering component according to at least one embodiment of the disclosure.

FIG. 34 is a schematic height view of a main covering component according to at least one embodiment of the disclosure.

FIG. 35 is a schematic view of a distance of a battery to a ground according to at least one embodiment of the disclosure.

FIG. 36 is a schematic structural view of an operating device according to at least one embodiment of the disclosure.

FIG. 37 is a partial schematic structural view of the operating device according to at least one embodiment of the disclosure.

FIG. 38 is a schematic structural view of a storage bin according to at least one embodiment of the disclosure.

FIG. 39 is a partial schematic structural view of the storage bin according to at least one embodiment of the disclosure.

FIG. 40 is a schematic structural view of a fixing tube according to at least one embodiment of the disclosure.

FIG. 41 is a partial structural cross-sectional view of the fixing tube according to at least one embodiment of the disclosure.

FIG. 42 is a schematic structural view of a brake releasing mechanism according to at least one embodiment of the disclosure.

FIG. 43 is a schematic structural view of the frame according to at least one embodiment of the disclosure.

FIG. 44 is a schematic structural view of the front frame according to at least one embodiment of the disclosure.

FIG. 45 is a schematic structural view of the rear frame according to at least one embodiment of the disclosure.

FIG. 46 is a schematic view of the mower according to another embodiment of the disclosure.

FIG. 47 is a schematic structural view of the frame according to another embodiment of the disclosure.

FIG. 48 is a schematic structural view of the front frame according to another embodiment of the disclosure.

FIG. 49 is a first schematic view of a cutting deck assembly according to at least one embodiment of the disclosure.

FIG. 50 is a bottom view of the cutting deck assembly according to at least one embodiment of the disclosure.

FIG. 51 is a schematic structural view of the cutting deck assembly according to at least one embodiment of the disclosure.

FIG. 52 is a schematic structural view of the cutting deck assembly in the lawn crushing mode according to at least one embodiment of the disclosure.

FIG. 53 is a bottom view of the cutting deck assembly in the lawn discharging mode according to at least one embodiment of the disclosure.

FIG. 54 is a schematic structural view of the cutting deck assembly in the lawn discharging mode according to at least one embodiment of the disclosure.

FIG. 55 is a schematic structural view of a cutting deck according to at least one embodiment of the disclosure.

FIG. 56 is a perspective view of the mower according to at least one embodiment of the disclosure.

FIG. 57 is a schematic structural view of the brake releasing mechanism in the mower according to at least one embodiment of the disclosure.

FIG. 58 is a schematic structural view of the brake releasing mechanism in a pre-tightened position according to at least one embodiment of the disclosure.

FIG. 59 is a schematic structural view of the brake releasing mechanism in a middle position according to at least one embodiment of the disclosure.

FIG. 60 is a schematic structural view of the brake releasing mechanism in a releasing position according to at least one embodiment of the disclosure.

FIG. 61 is an exploded view of the brake releasing mechanism according to at least one embodiment of the disclosure.

FIG. 62 is a schematic structural connecting view when a traction component and a pulling rod are in the releasing position according to at least one embodiment of the disclosure.

FIG. 63 is a connecting top view when the traction component and the pulling rod are in the releasing position according to at least one embodiment of the disclosure.

FIG. 64 is a schematic structural view of a storage platform of the mower according to at least one embodiment of the disclosure.

FIG. 65 is a structural block view of the mower according to at least one embodiment of the disclosure.

FIG. 66 is a schematic display view of the display screen according to at least one embodiment of the disclosure.

FIG. 67 is a schematic view of an external tool state according to at least one embodiment of the disclosure.

FIG. 68 is a schematic view of a lighting device state and an alarm light state according to at least one embodiment of the disclosure.

FIG. 69 is a schematic view of device parameters according to at least one embodiment of the disclosure.

FIG. 70 is a schematic view of device use time according to at least one embodiment of the disclosure.

FIG. 71 is a schematic view of a screen brightness according to at least one embodiment of the disclosure.

FIG. 72 is a schematic view of a unit conversion according to at least one embodiment of the disclosure.

FIG. 73 is a schematic view of detailed fault codes and fault handling measures and advice according to at least one embodiment of the disclosure.

FIG. 74 is a schematic view of stage working information according to at least one embodiment of the disclosure.

FIG. 75 is a schematic view of a fault reminding according to at least one embodiment of the disclosure.

FIG. 76 is a schematic structural view of a standing mower according to at least one embodiment of the disclosure.

FIG. 77 is a partial enlarged view of area 7B in FIG. 76 of the disclosure.

FIG. 78 is a front view of the standing mower according to at least one embodiment of the disclosure.

FIG. 79 is a rear view of the standing mower according to at least one embodiment of the disclosure.

FIG. 80 is a schematic block view of the mower, a terminal control device and an RTK base station of the disclosure.

FIG. 81 is a schematic block view of a working principle framework of the mower of the disclosure.

FIG. 82 is a schematic view of the mower of the disclosure performing a lawn map calibration.

FIG. 83 is a flowchart of the mower of the disclosure generating a calibration map of a mowing area.

FIG. 84 is a flowchart of the mower of the disclosure calling the generated a calibration map for a mowing operation.

FIG. 85 is a schematic block view of the mower, a terminal control device and an RTK base station according to at least one embodiment of the disclosure.

FIG. 86 is a perspective view of a driving motor according to at least one embodiment of the disclosure.

FIG. 87 is an exploded connecting view of a motor casing and a reducer fixing base according to an embodiment of the driving motor of the disclosure.

FIG. 88 is a perspective view of the motor casing according to an embodiment of the driving motor of the disclosure.

FIG. 89 is a perspective view of a reinforcing connecting body according to an embodiment of the driving motor of the disclosure.

FIG. 90 is a perspective cross-sectional view of the motor casing according to another embodiment of the driving motor of the disclosure.

FIG. 91 is a perspective view of the reinforcing connecting body according to another embodiment of the driving motor of the disclosure.

FIG. 92 is a perspective view of the motor casing according to a third embodiment of the driving motor of the disclosure.

FIG. 93 is a cross-sectional view of the motor casing in FIG. 92.

FIG. 94 is a perspective view of the reinforcing connecting body embedded in the motor casing in FIG. 92.

FIG. 95 is an exploded view of the motor casing according to a fourth embodiment of the driving motor of the disclosure.

FIG. 96 is a left view of the motor casing with a pressing ring in FIG. 95.

FIG. 97 is a cross-sectional view along an 11C-11C direction in FIG. 96.

FIG. 98 is a perspective view of the reinforcing connecting body in FIG. 95.

FIG. 99 is an exploded connecting view of a driving device and a walking wheel according to at least one embodiment of the disclosure.

FIG. 100 is an exploded view of the driving device according to at least one embodiment of the disclosure.

FIG. 101 is a cross-sectional view of the driving device according to at least one embodiment of the disclosure.

FIG. 102 is a cross-sectional view along an 11B-11B direction in FIG. 101.

FIG. 103 is a cross-sectional view along an 11A-11A direction in FIG. 101.

FIG. 104 is a schematic structural view of the cutting deck assembly according to at least one embodiment of the disclosure.

FIG. 105 is a partial schematic structural view of the cutting deck assembly according to at least one embodiment of the disclosure.

FIG. 106 is a schematic structural view of a cutting motor according to an embodiment of the cutting deck assembly of the disclosure.

FIG. 107 is a schematic structural view of the cutting deck assembly from another angle according to at least one embodiment of the disclosure.

FIG. 108 is a schematic matching view of a controller protective cover and the cutting deck according to an embodiment of the cutting deck assembly of the disclosure.

FIG. 109 is a schematic structural view of a motor controller according to an embodiment of the cutting deck assembly of the disclosure.

FIG. 110 is a schematic structural cross-sectional view of the cutting motor according to an embodiment of the cutting deck assembly of the disclosure.

FIG. 111 is a schematic structural view of a motor end cover according to an embodiment of the cutting deck assembly of the disclosure.

FIG. 112 is a schematic structural view of a motor housing assembly according to an embodiment of the cutting deck assembly of the disclosure.

FIG. 113 is a schematic structural view of the motor housing from another angle according to an embodiment of the cutting deck assembly of the disclosure.

FIG. 114 is a schematic structural view of a motor rotor according to an embodiment of the cutting deck assembly of the disclosure.

FIG. 115 is a schematic structural view of a motor stator according to an embodiment of the cutting deck assembly of the disclosure.

FIG. 116 is a schematic structural view of an area 13II in FIG. 105.

FIG. 117 is a schematic structural view of an area 13I in FIG. 105.

FIG. 118 is a second schematic structural view of the mower according to at least one embodiment of the disclosure.

FIG. 119 is a schematic structural view of a walking driving mechanism according to at least one embodiment of the disclosure.

FIG. 120 is a schematic structural exploded view of the walking driving mechanism according to at least one embodiment of the disclosure.

FIG. 121 is a schematic structural view of a first sealing ring according to at least one embodiment of the disclosure;

FIG. 122 is a schematic cross-sectional structural view of a connection of a motor of the walking driving mechanism and a reducer according to at least one embodiment of the disclosure.

FIG. 123 is a schematic structural exploded view of the walking driving mechanism according to another embodiment of the disclosure.

FIG. 124 is a schematic matching view of an oil scaling and a second scaling ring according to another embodiment of the disclosure.

FIG. 125 is a schematic cross-sectional structural view of the second scaling ring according to another embodiment of the disclosure.

FIG. 126 is a schematic cross-sectional structural view of the connection of the motor of the walking driving mechanism and the reducer according to another embodiment of the disclosure.

FIG. 127 is a schematic structural exploded view of the walking driving mechanism according to a third embodiment of the disclosure.

FIG. 128 is a schematic cross-sectional structural view of the connection of the motor of the walking driving mechanism and the reducer according to a third embodiment of the disclosure.

FIG. 129 is a schematic structural exploded view of the walking driving mechanism according to a fourth embodiment of the disclosure.

FIG. 130 is a schematic cross-sectional structural view of the connection of the motor of the walking driving mechanism and the reducer according to a fourth embodiment of the disclosure.

FIG. 131 is a perspective view of a garden tool according to at least one embodiment of the disclosure.

FIG. 132 is a schematic structural connecting view of the walking driving mechanism on the garden tool and the walking wheel according to at least one embodiment of the disclosure.

FIG. 133 is a schematic view of a control method of the mower according to at least one embodiment of the disclosure.

FIG. 134 is a schematic view of determining a walking mode of the mower based on a first signal in a control method of the mower according to at least one embodiment of the disclosure.

FIG. 135 is a schematic view of determining whether the mower enters the walking mode based on a third signal in a control method of the mower according to at least one embodiment of the disclosure.

FIG. 136 is a schematic view of an operation of a mowing motor according to at least one embodiment of the disclosure.

FIG. 137 is a schematic view of the control method of the mower according to another embodiment of the disclosure.

FIG. 138 is a schematic view of the control method of the mower according to a third embodiment of the disclosure.

FIG. 139 is a third schematic structural view of the mower according to at least one embodiment of the disclosure.

FIG. 140 is a schematic structural view of the mower from another angle according to at least one embodiment of the disclosure.

FIG. 141 is a partial schematic structural view of a pedal device when it is not folded according to at least one embodiment of the disclosure.

FIG. 142 is a partial schematic structural view of the pedal device when it is folded according to at least one embodiment of the disclosure.

FIG. 143 is a schematic view of the pedal device according to at least one embodiment of the disclosure.

FIG. 144 is a first partial schematic structural view of the pedal device according to at least one embodiment of the disclosure.

FIG. 145 is a schematic view of a pedal signal switch in a connecting state according to at least one embodiment of the disclosure.

FIG. 146 is a schematic structural view of an operating signal switch in a separating state according to at least one embodiment of the disclosure.

FIG. 147 is a schematic view of the operating signal switch in the connecting state according to at least one embodiment of the disclosure.

FIG. 148 is a partial schematic view of an operating lever when the operating signal switch is in the separating state according to at least one embodiment of the disclosure.

FIG. 149 is a partial schematic view of an operating lever when the operating signal switch is in the connecting state according to at least one embodiment of the disclosure.

FIG. 150 is a schematic structural view of the pedal device according to at least one embodiment of the disclosure.

FIG. 151 is a schematic structural view of the pedal device from another angle according to at least one embodiment of the disclosure.

FIG. 152 is a bottom view of the pedal device according to at least one embodiment of the disclosure.

FIG. 153 is a front view of the pedal device according to at least one embodiment of the disclosure.

FIG. 154 is a second partial schematic structural view of the pedal device according to at least one embodiment of the disclosure.

FIG. 155 is a partial schematic structural view of the pedal device from another angle according to at least one embodiment of the disclosure.

FIG. 156 is a second schematic view of the mower according to at least one embodiment of the disclosure.

FIG. 157 is a schematic view of the mower from another angle according to at least one embodiment of the disclosure.

FIG. 158 is a rear view of the mower according to at least one embodiment of the disclosure.

### DETAILED DESCRIPTION

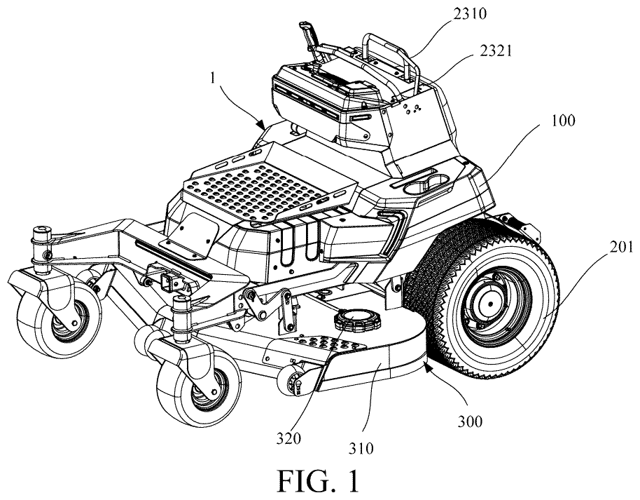

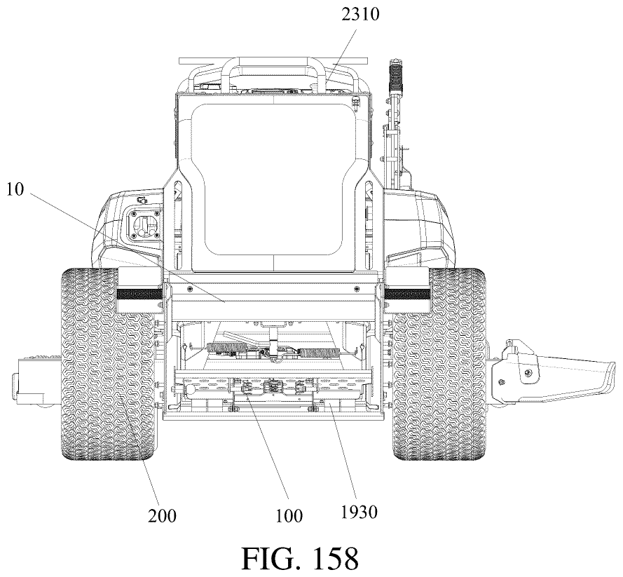

Please refer to FIG. 1 through FIG. 158. The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure. It should be noted that, the following embodiments and the features in the embodiments can be combined with each other without conflict. It should further be understood that the terms used in the examples of the disclosure are configured to describe specific embodiments, instead of limiting the protection scope of the disclosure. The test methods that do not indicate specific conditions in the following examples are usually in accordance with conventional conditions, or conditions recommended by each manufacturer.

When an embodiment gives a range of values, it should be understood that, unless otherwise specified in the disclosure, two endpoints of each range of values and any one of the values between the two endpoints may be selected. Unless otherwise defined, all technical and scientific terms used in the disclosure and the prior art mastered by a person skilled in the art and a description of the disclosure may also be realized by using any method, equipment and material similar to or equivalent to the prior art described in the embodiments of the disclosure.

It should be noted that terms “upper”, “lower”, “left”, “right”, “middle” and “one” quoted in this specification are only for a convenience of description, and are not configured to limit a scope of the disclosure. Changes or adjustments in their relative relationships shall also be regarded to be within the scope of the disclosure when there is no substantial change in the technical content.

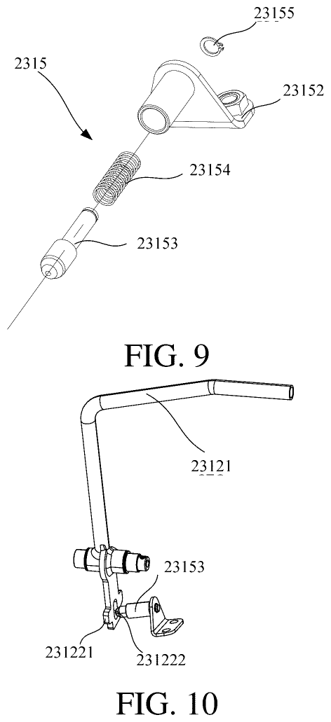

Embodiment 1. Please refer to FIG. 1 through FIG. 12. The disclosure provides a mower, to improve technical problems of a mower, such as a complicated structure of an operating mechanism, an inability to automatically reset, and an inconvenient operation.

Please refer to FIG. 1. The mower 1 of the disclosure includes an operating mechanism 2310, a frame 100, a walking assembly and a cutting deck assembly 300. In an embodiment, the frame 100 is a main part of the mower 1 and is configured to install other structures of the mower. The walking assembly is installed on the frame 100 and is configured to drive the mower 1 to walk. The walking assembly includes a walking wheel 201 installed on two sides of the frame 100 and a driving motor (not labeled) of the walking wheel 201. The cutting deck assembly 300 includes a cutting deck 310 and a cutting part 320, and the cutting deck 310 is installed on the frame 100. In this embodiment, the cutting deck 310 is arranged at a bottom of the frame 100, the cutting part 320 is arranged in the cutting deck 310, and a mowing work is performed through the cutting part 320. The operating mechanism 2310 is installed on the frame 100, used for controlling a rotating speed of the walking wheel, and then controlling a walking state such as forward, backward, steering and so on of the mower.

Please refer to FIG. 1 through FIG. 4. In an embodiment, the walking wheels 201 on both sides of the mower 1 are each controlled by the operating mechanism 2310 to control the rotating speed and/or steering. The operating mechanism 2310 is installed on the frame 100 on a side corresponding to the walking wheel 201. The operating mechanism 2310 includes an operating lever mounting base 2311, an operating lever 2312, a reset assembly 2314 and a limiting assembly 2315. In an embodiment, the operating lever mounting base 2311 is rotatably installed on the frame 100. The operating lever 2312 is rotatably installed on the operating lever mounting base 2311. Specifically, the operating lever mounting base 2311 is rotatably installed on the frame along a first direction (for example, left and right direction of the mower). The operating lever 2312 is rotatably installed on the operating lever mounting base 2311 along a second direction (for example, a walking direction of the mower). The reset assembly 2314 drives the operating lever mounting base 2311 to drive the operating lever 2312 to reset to an initial position (a neutral gear position) along the first direction, and the limiting assembly 2315 is configured to lock the operating lever 2312 in the initial position.

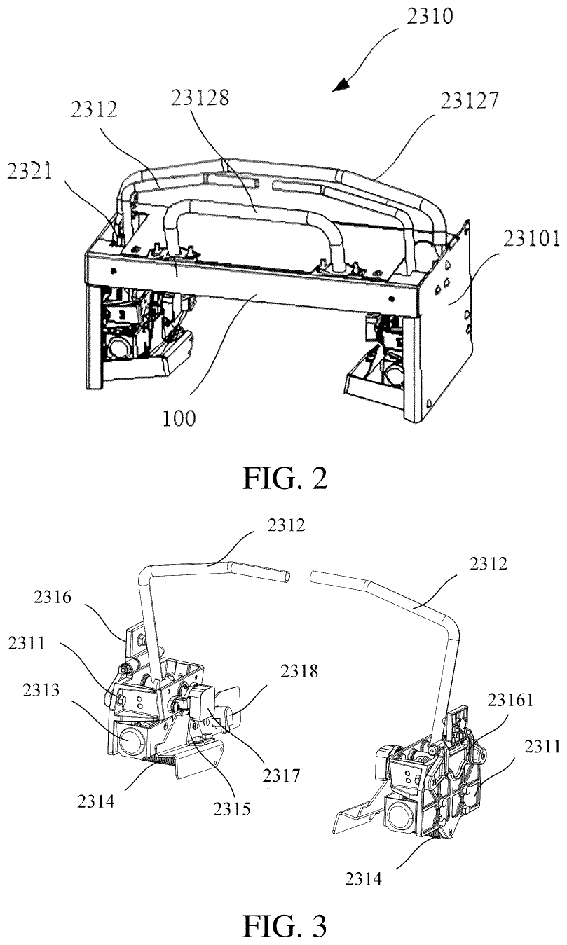

Please refer to FIG. 2 through FIG. 5. In an embodiment, the operating mechanism 2310 further includes an elastic assembly 2313. The elastic assembly 2313 is fixedly arranged on the operating lever mounting base 2311 and is connected with the operating lever 2312. The operating lever 2312 may rotate in the second direction in the operating lever mounting base 2311 under an action of the elastic assembly 2313. A first end of the limiting assembly 2315 is installed on the frame 100 through a limiting installation base 23151, and a second end of the limiting assembly 2315 extends in a direction of the operating lever 2312. A first end of the reset assembly 2314 is connected with the operating lever mounting base 2311, and a second end of the reset assembly 2314 is connected with the limiting installation base 23151. When the reset assembly 2314 drives the operating lever mounting base 2311 to rotate, so that when the operating lever 2312 returns to a neutral gear (an initial position, a position outside a middle), the limiting assembly 2315 automatically locks the operating lever 2312, the operating lever 2312 cannot rotate at this time, and the mower 1 stops walking. When the operating lever 2312 is pulled to enable it to return to a middle position (an intermediate position), the limiting assembly 2315 is separated from the operating lever 2312, and at this time, the operating lever 2312 may rotate along the second direction of the operating lever mounting base 2311. In some embodiments, the operating mechanism 2310 further includes a position detecting device, the position detecting device is used for detecting a position of the operating lever 2312, and a detection signal is fed back to a controller of the driving motor of the walking wheel 201. The controller outputs a corresponding rotating speed value to the driving motor of the walking wheel 201 according to the detection signal of the position detecting device, so as to control a walking of the walking wheel 201. In an embodiment, the position detecting device detects a rotation angle of the operating lever 2312, and adopts an angle sensor 2317. A rotating shaft of the angle sensor 2317 is installed on the operating lever 2312, and rotates synchronously with the operating lever, and the driving motor outputs the corresponding rotating speed according to information output by the angle sensor 2317, and then controls the walking of the walking wheel 201. The operating lever mounting base 2311 rotates relative to the frame 100, and the operating lever 2312 may be driven to switch between the middle position and the neutral gear, so as to realize an unlocking or locking of the operating lever 2312 and the limiting assembly 2315. The operating lever 2312 rotates relative to the operating lever mounting base 2311 to drive the rotating shaft of the angle sensor 2317 to rotate, thereby controlling the rotating speed and/or a steering of the driving motor. In other embodiments, the position detecting device may further be a magnetic component or a magnetic sensor, for example.

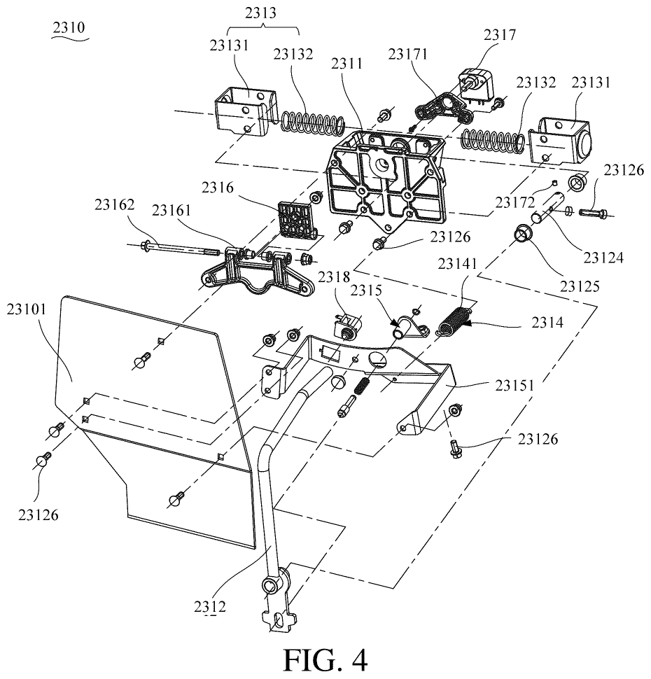

Please refer to FIG. 2, FIG. 4 through FIG. 6. In an embodiment, the operating mechanism 2310 is connected with the frame 100 through a fixing plate 23101. The fixing plate 23101 is fixed on one side of the frame 100 through a fastener, such as a bolt 23126. The operating lever mounting base 2311 may be rotatably installed on the fixing plate 23101, for example, it is connected with the fixing plate 23101 through a rotation shaft, and the operating lever mounting base 2311 may rotate along the first direction around the rotation shaft. Upper and lower ends of the operating lever mounting base 2311 are in an opening shape, and a surrounding side wall is a closed-like structure. The operating lever 2312 penetrates through the upper and lower ends of the operating lever mounting base 2311, and may swing along the second direction in an inside of the operating lever mounting base 2311. In an embodiment, the first direction corresponds to a conversion direction of the unlocking and locking of the operating lever 2312, and the second direction corresponds to forward and backward directions of the mower 1. The operating lever mounting base 2311 of the embodiment can rotate along the first direction around a shaft, which greatly simplifies a structure of the operating lever 2312, facilitates a production and installation of the operating lever 2312, eliminates an assembly error and clearance, and enables the operating lever 2312 to be in a more accurate middle position. In an embodiment, the operating lever 2312 includes an operating handle 23121, a limiting plate 23122 and a sleeving tube 23123. The operating handle 23121 is in an inverted L-shaped structure. A first end of the operating handle 23121 is held by an operator, and a second end of the operating handle 23121 extends to the inside of the operating lever mounting base 2311 and is connected with the limiting plate 23122 through the sleeving tube 23123. The sleeving tube 23123 is arranged along an extending direction perpendicular to the operating handle 23121 and the limiting plate 23122. The operating lever 2312 is connected with the operating lever mounting base 2311 through a rotation shaft, the rotation shaft here is recorded as a first rotation shaft 23124, and the first rotation shaft 23124 penetrates through the sleeving tube 23123 and is fixed together with the sleeving tube 23123 through the bolt 23126. Two ends of the first rotation shaft 23124 are respectively installed on a side wall of the operating lever mounting base 2311 through a shaft ring 23125. For example, the angle sensor 2317 may adopt a potentiometer. The potentiometer is installed on the operating lever mounting base 2311 through an angle sensor installation base 23171, and a rotation shaft of the potentiometer is connected together with the first rotation shaft 23124 through a fastener, such as a screw 23172, so that a synchronous rotation of the potentiometer and the operating lever 2312 is realized. When the operating lever 2312 rotates along the second direction, it drives the rotating shaft of the angle sensor 2317 to rotate, and the driving motor outputs the corresponding rotating speed according to the rotation angle of the angle sensor 2317.

Please refer to FIG. 3 through FIG. 7. In an embodiment, the elastic assembly 2313 includes a spring base 23131 and a compression spring 23132. The spring base 2313 is fixedly installed on a bottom of the operating lever mounting base 2311. For example, the operating lever mounting base 2311 extends downward toward a side wall of the fixing plate 23101 and exceeds a rest of the side wall of the operating lever mounting base 2311. The spring base 23131 is fixedly installed on the extra-long side wall of the operating lever mounting base 2311 through a fastener such as the bolt 23126. The compression spring 23132 is arranged inside the spring base 23131, a first end of the compression spring 23132 is connected with the spring base 23131, and a second end of the compression spring 23132 is connected with the limiting plate 23122 of the operating lever 2312. In some embodiments, the elastic assembly 2313 includes two compression springs 23132, the two compression springs 23132 are respectively arranged at two ends of the spring base 23131, and the operating lever 2312 penetrates through the operating lever mounting base 2311 from top to bottom, and is connected with two compression springs 23132 through the limiting plate 23122 at the bottom. In some embodiments, protrusions 231221 matched with the compression spring 23132 are respectively arranged on two sides of the limiting plate 23122 facing the compression spring 23132, and the operating lever 2312 is elastically connected with the clastic assembly 2313 through the protrusions 231221 on both sides of the limiting plate 23122. When the operating lever 2312 rotates around the first rotation shaft 23124, the operating lever 2312 squeezes the compression springs 23132 on both sides. Due to an elastic effect of the compression spring 23132, after releasing the operating lever 2312, the operating lever 2312 automatically returns to the middle position. The spring base 23131 in this embodiment may be an integral structure, and two compression springs are respectively arranged at the two ends of the spring base 23131. The spring base 23131 may also be a separating structure, and one compression spring 23132 corresponds to one spring base 23131.

Please refer to FIG. 4 through FIG. 10. In an embodiment, the limiting assembly 2315 includes a fixing base 23152, a limiting rod 23153 and an elastic body 23154. The limiting installation base 23151 is fixedly installed on the frame 100, and the fixing base 23152 is installed on the limiting installation base 23151 through a fastener such as the bolt 23126. The elastic body 23154 is arranged between the fixing base 23152 and the limiting rod 23153, and the elastic body 23154 may be a spring for example. The spring is sleeved on the limiting rod 23153, a first end of the limiting rod 23153 is installed on the fixing base 23152 through a circlip 23155, and a second end of the limiting rod 23153 extends in a direction of the operating lever 2312. The limiting plate 23122 of the operating lever 2312 is provided with a limiting hole 231222 matched with the limiting rod 23153. When the limiting rod 23153 is inserted into the limiting hole 231222, the operating lever 2312 is locked by the limiting rod 23153, the operating lever 2312 is in the neutral gear at this time and cannot rotate along the second direction around the first rotation shaft 23124, and the driving motor will not be driven. When the limiting rod 23153 is separated from the limiting hole 231222, the operating lever 2312 and the limiting assembly 2315 are unlocked at this time, and the operating lever 2312 may rotate along the second direction around the first rotation shaft 23124, and then control the mower to walk forward, backwards or steer. In some embodiments, when the limiting rod 23153 is installed, it is inclined downward at a certain angle, which means that an inclination direction of the limiting rod 23153 is at a certain angle α with a horizontal plane, and the angle of the a is from 8 degrees to 10 degrees, for example, it may be any value in the above-mentioned range such as 8 degrees, 9 degrees or 10 degrees. The limiting rod 23153 is installed obliquely, which is conducive to a connection of the limiting rod 23153 and the limiting plate 23122. In addition, an end part of the limiting rod 23153 is provided with an arc-shaped chamfer, and the limiting hole is 231222 a waist-shaped hole, so as to enable a process of the limiting rod 23153 separating from the limiting hole 231222 or clamped in the limiting hole 231222 to be more smoothly. In other embodiments, the elastic body 23154 may also be other elastomers with the same function. The clastic body 23154 is arranged between the limiting rod 23153 and the fixing base 23152, and two ends of the elastic body 23154 are respectively connected with the limiting rod 23153 and the fixing base 23152. In this embodiment, the limiting assembly 2315 is a circlip or an elastic mechanism. When pressing the operating handle, it may be automatically folded to prevent the limiting assembly 2315 from locking with the limiting plate 23122 below the operating handle 23121. In addition, in this embodiment, the limiting installation base 23151 is installed on the frame 100 through the fixing plate 23101, and the limiting installation base 23151 is connected with the fixing plate 23101.

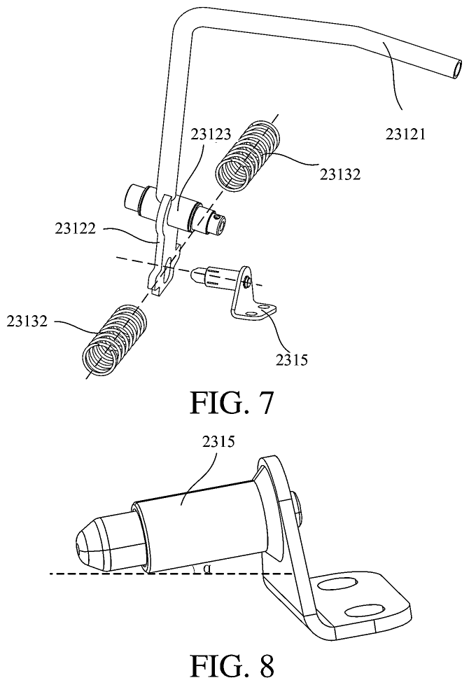

Please refer to FIG. 4 and FIG. 7. In an embodiment, the reset assembly 2314 includes a tension spring 23141. A first end of the tension spring 23141 is connected with the operating lever mounting base 2311, and a second end of the tension spring 23141 is connected with the limiting installation base 23151. Under an clastic action of the tension spring 23141, the operating lever mounting base 2311 has a tendency to rotate in a direction of the limiting installation base 23151, which means that the operating lever 2312 has a tendency to be locked by the limiting assembly 2315. Specifically, when the operating lever 2312 is pressed by an external force and the operating lever mounting base 2311 is driven to rotate in a direction deviating from the limiting installation base 23151, the lever 23153 is separated from the limiting hole 231222, the operating lever 2312 and the limiting assembly 2315 are unlocked, and the operating lever 2312 may rotate in the second direction at this time. Then the mower 1 is driven to move forward, backward or steer, and the mower changes from a stopping state to a walking state. When removing the external force, the operating lever 2312 returns to the middle position under an elastic action of the compression spring 23132, and under an clastic action of the tension spring 23141, it returns to the neutral gear outside the middle position. At this time, the limiting rod 23153 of the limiting assembly 2315 is inserted into the limiting hole 231222 at a bottom of the operating lever 2312, the operating lever 2312 is locked and cannot rotate, the driving motor stops rotating, and the mower is in the stopping state.

Please refer to FIG. 3 and FIG. 4. In some embodiments, the operating mechanism 2310 further includes a switch that is configured to control a power on and/or power off of the driving motor. In this embodiment, the switch is selected as a pressure switch 2318. The pressure switch 2318 is installed on the limiting installation base 23151. When the operating lever 2312 returns to the neutral gear under an effect of the reset assembly 2314, the spring base 23131 is in contact with the pressure switch 2318, and the pressure switch 2318 is triggered. At this time, the driving motor is in a power-off state, even if there is no electromagnetic brake, the motor will not rotate, which prevents an occurrence of an unexpected situation.

Please refer to FIG. 2 through FIG. 4. In an embodiment, the operating mechanism 2310 further includes a limiting device of the operating lever mounting base 2311, and the limiting device includes a blocking plate 2316 and a limiting base 23161. The blocking plate 2316 is installed on the fixing plate 23101 through a fastener such as the bolt 23126, the limiting base 23161 is rotatably connected with the blocking plate 2316 through a rotation shaft, and the rotation shaft herein is recorded as the second rotation shaft 23162. The operating lever mounting base 2311 is fixedly installed on the limiting base 23161 and operates the operating lever 2312. The operating lever mounting base 2311 may drive the limiting base 23161 to rotate around the second rotation shaft 23162, and an arrangement of the blocking plate 2316 and the limiting base 23161 is convenient for enabling the operating lever 2312 to rotate along the first direction. Due to a limitation of the fixing plate 23101, a rotation of the limiting base 23161 shall not exceed the fixed plate 23101, and a rotation range of the operating lever mounting base 2311 is limited between the fixed plate 23101 and the limiting assembly 2315. In order to facilitate an operation of the operating lever 2312, an opening 2321 is arranged at a position of the frame 100 corresponding to the operating mechanism 2310. The operating lever 2312 enters from the opening 2321 and is rotatably connected with the operating lever mounting base 2311. A size and a shape of the opening 2321 are not limited, so as to meet a rotating amplitude of the operating lever 2312 as a criterion.

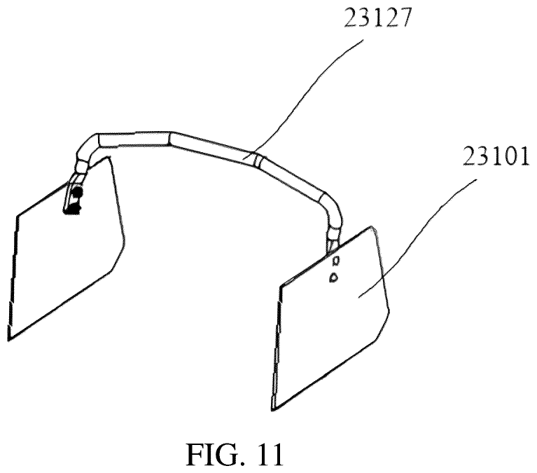

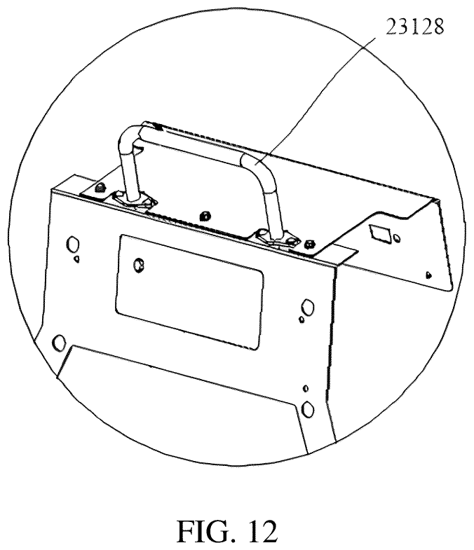

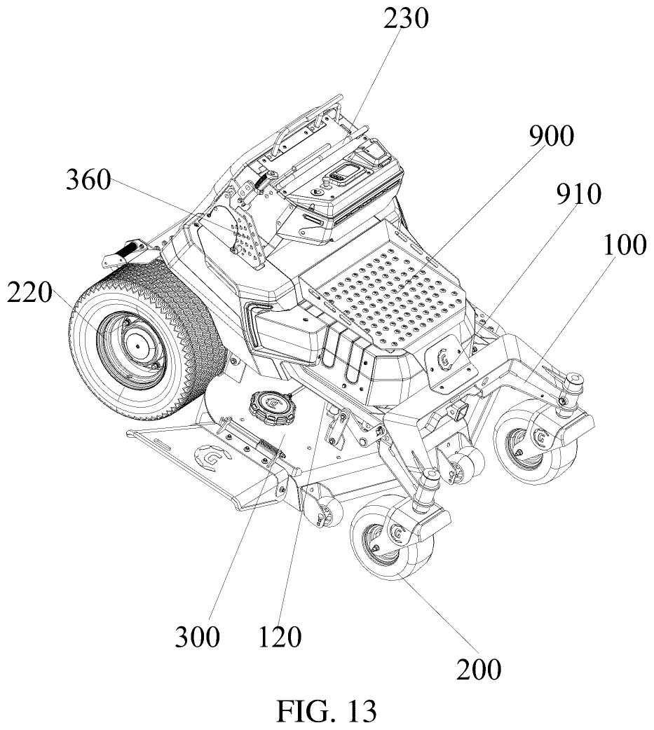

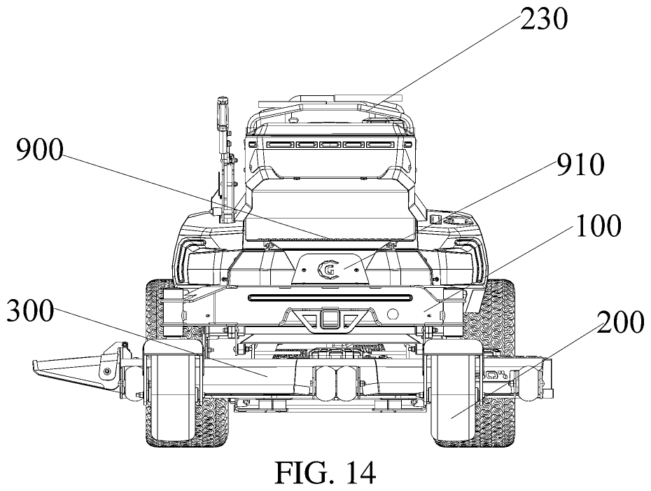

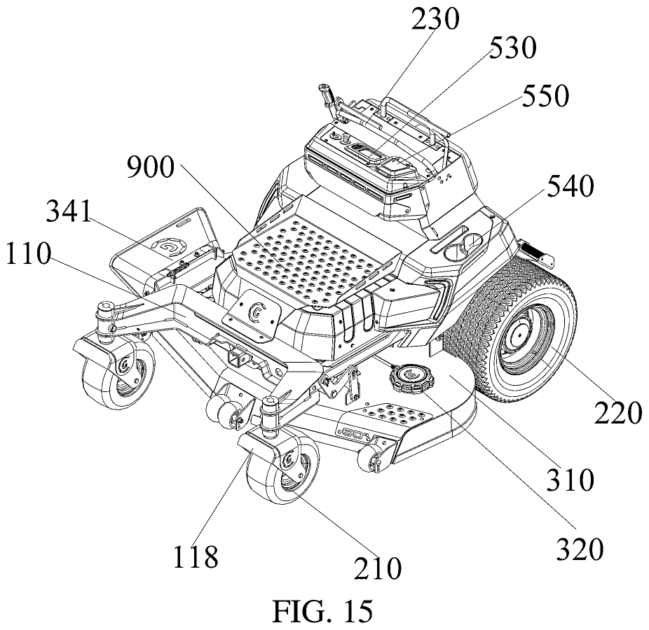

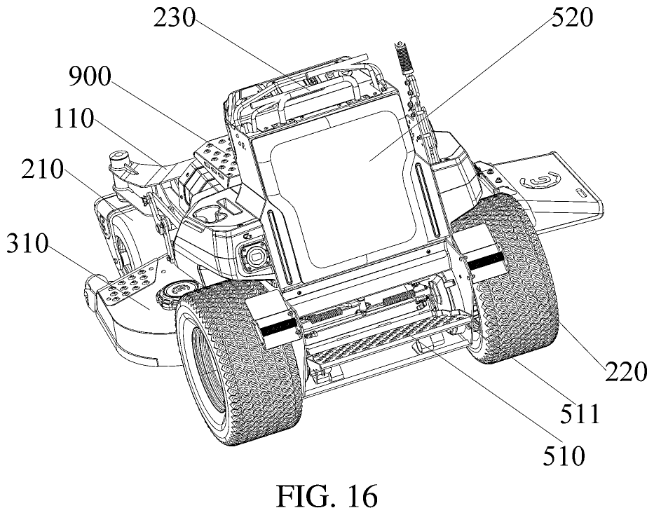

Please refer to FIG. 2, FIG. 11 and FIG. 12. In an embodiment, the operating mechanism 2310 further includes a first operating handle 32127 and a second operating handle 23128, and the first operating handle 32127 and the second operating handle 23128 are respectively arranged on a front side and rear side of the operating handle 23121, and are configured to stabilize the operating handle 23121 during a working state. Specifically, the first operating handle 32127 is fixedly installed on the fixing plate 23101 through the bolt and the nut. The first operating handle 32127 is located at a front side of the operating handle 23121. When the operating lever is pushed to enable the mower to drive forward, the operating handle 23121 is located at a front side of the middle position. Since there is a spring force effect, a hand is easy to be sore for a long time, and is easy to fall off. The first operating handle 32127 is held at this time, the hand is not easy to fatigue, and at a slope, the first operating handle 32127 may also play a stabilizing role and prevent people from falling. The second operating handle 23128 is fixedly installed on a control panel and the frame 100 through the bolt and the nut. When the operating lever is pushed to enable the mower to drive backward, the operating handle 23121 is located at a rear side of the middle position. Since there is a spring force effect, a hand is easy to be sore for a long time, and is easy to fall off. The second operating handle 23128 is held at this time, the hand is not easy to fatigue, and at a slope, the second operating handle 23128 may also play a stabilizing role and prevent people from falling.

When the mower 1 is working, a rotating speed and/or a steering of the walking wheels 20 on two sides are respectively controlled by the operating mechanism 2310, and then a forward, a backward or a steering of the mower 1 is controlled. When the mowing is completed and the mower needs to be stopped, the operating lever 2312 in the operating mechanism 2310 is loosened and may be automatically reset, and the mower is stopped.

The operating mechanism of the disclosure may be used not only for controlling the walking of mower, but also may be used for controlling other garden tools of a same type.

The operating mechanism in the mower of the disclosure utilizes an elastic assembly to realize an automatic reset when the operating lever rotates back and forth, utilizes a matching of the reset assembly and the limiting assembly with the limiting plate to realize the locking and unlocking of the operating lever and the limiting assembly. When the operating lever is locked with the limiting assembly, the operating lever cannot be pushed back and forth, which prevents a vehicle from stopping, and prevents a misoperation from producing danger. When starting the mower, the operating lever is pressed, the operating lever and the limiting assembly are unlocked, and the operating lever may rotate back and forth to control the mower to move forward and backward or steer. The operating mechanism of the disclosure is simple in structure, convenient in operation, may realize the automatic reset, and enhance user's experience.

In an embodiment, the mower includes a walking mechanism 200, the cutting deck assembly 300, a battery 800 and a control assembly 810.

Please refer to FIG. 21. In an embodiment, the frame 100 includes a front frame 110 and a rear frame 120. The front frame 110 is detachably connected with the rear frame 120. The walking mechanism 200 includes a front wheel assembly 210, a rear wheel assembly 220 and an operating device 230. The front wheel assembly 210 is installed on the front frame 110, and the rear wheel assembly 220 is installed on the rear frame 120. Different working environments need different cutting decks 310, and different specifications of cutting decks 310, such as 48 inches, 50 inches and so on need different assembly space. The front frame 110 is detachably connected with the rear frame 120, which may adjust a wheelbase of mower, thereby obtaining different bottom assembly spaces and meeting adaptation needs of different cutting deck assemblies 300. It should be noted that, the cutting deck assembly 300 is assembled on the frame 100. All the cutting deck assemblies 300 may be connected with the rear frame 120, and may also be partially connected with the rear frame 120, and partially connected with the front frame 110. A specific connection structure is not limited. When the cutting deck assembly 300 is partially connected with the front frame 110. In some embodiments, when disassembling and assembling, the cutting deck assembly 300 and the front frame 110 are always in a connecting state. On one hand, operations of disassembly and assembly are reduced, and on the other hand, the front frame 110 is convenient to be matched with the cutting deck assembly 300.

In an embodiment, the front frame 110 and the rear frame 120 are detachably and fixedly connected through fastening bolts, so that the front frame 110 may be easily replaced. In some embodiments, a rear end of the front frame 110 is provided with two first clamping boards 114 on both sides, and a front end of the rear frame 120 are two square tubes 121. The square tubes 121 are inserted between the two first clamping boards 114, corresponding positions of the square tubes 121 and the first clamping boards 114 are provided with a first through hole 116, and the front frame 110 and the rear frame 120 are fastened through a connecting bolts 122 penetrating through the first through hole 116. In order to improve a connecting firmness between the first clamping board 114 and the square tube 121, a bottom surface of the two first clamping boards 114 is further provided with a second clamping board 115. The two first clamping boards 114 and the second clamping board 115 are U-shaped. The second clamping board 115 supports a bottom surface of the square tube 121, reduces a shear force received by the connecting bolt 122, improves a duration life of the connecting bolt 122, and improves a connecting firmness between the front frame 110 and the rear frame 120.

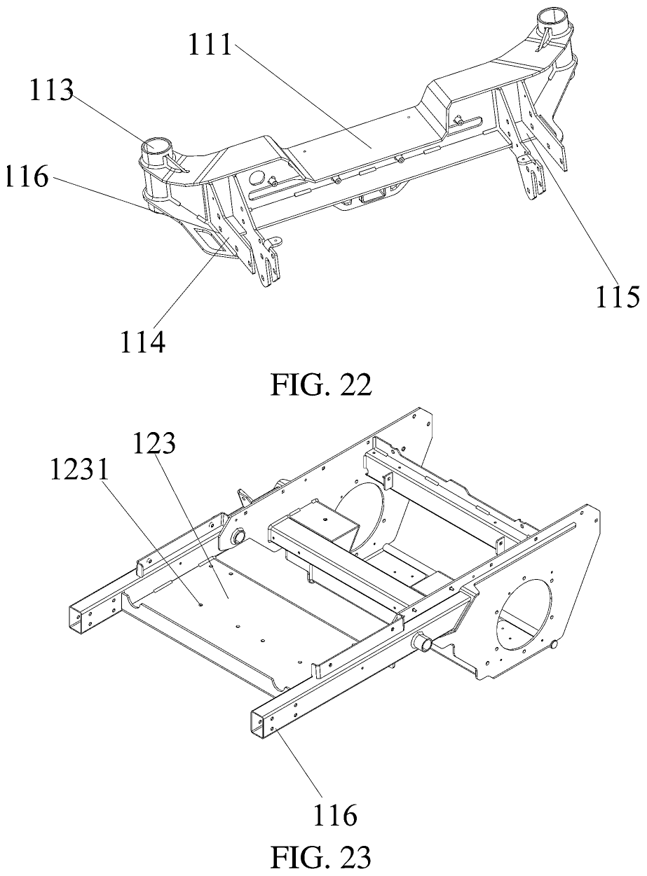

Please refer to FIG. 22. In an embodiment, the front frame 110 is U-shaped and includes a first cross beam 111. Two ends of the first cross beam 111 are provided with a first connecting part 112 extending forward, and two first connecting parts 112 are respectively provided with the front wheel assembly 210. The front wheel 211 preferably selects universal wheels as steering wheels. In an embodiment, a front end of the first connecting part 112 is provided with an assembling tube 113, and a first bearing arranged in the assembling pipe 113. The first bearing is provided with a first rotating shaft with an interference fit inside the first bearing. A lower end of the first rotating shaft extends out from the assembling pipe 113 and is connected with a front fork, and the front wheel 211 is rotatably connected with the front fork. A wheel protective plate 118 is arranged on the front fork. A front end of wheel protective plate 118 exceeds front wheel 211. When a collision occurs, the wheel protective plate 118 collides with an obstacle earlier than the front wheel 211, which may avoid a collision between a tire of the front wheel 211 and the obstacle. Especially when obstacle is hard, it may avoid the tire of the front wheel 211 from a damage, which improves a duration life of front wheel 211. In some embodiments, the wheel protective plate slopes from top to bottom toward a front of the mower. Compared with a vertical arrangement of the wheel protective plate 118, the wheel protective plate 118 is arranged obliquely, so that the wheel protective plate 118 and the front wheel assembly 210 are less damaged when a collision occurs, thereby improving an anti-collision capability.

In an embodiment, a front end of the frame 100 is provided with a front light, the front light is assembled on a rear side surface of the first cross beam 111 of the front frame 110, and part of the front light may extend and be embedded into a penetrating groove, or it may also be all arranged on a back of the front frame 110. A light emitted by the front light shines in front of the mower and acts as a light or signal. The front light is assembled on a back of the first cross beam 111, so that when the mower collides with the obstacle, a contact collision between the front light and the obstacle is avoided, which may cause a damage of the front light, and the front light is effectively protected. In other embodiments, the front light may be assembled in other positions at the front end of the frame 100, as long as the front light is effectively protected, and a specific installation position and installation structure are not limited. Please refer to FIG. 8. The bottom of the frame 100 is provided with the cutting deck assembly 300. In an embodiment, the cutting deck assembly 300 includes the cutting deck 310, the cutting part 320, a height adjustment device 350 and a locking device 360. The height adjustment device 350 is used for adjusting a distance between the cutting deck assembly 300 as a whole and the ground, and the locking device 360 is used for locking the distance between the cutting deck assembly 300 as a whole and the ground. In an embodiment, the cutting part 320 includes a cutting blade 322 and a cutting motor 321. One cutting motor 321 may drive one cutting blade 322 to rotate, or it may also drive multiple cutting blades 322 to rotate through a transmission mechanism, which is not limited in this disclosure.

In an embodiment, a bottom of the cutting deck 310 is detachably fixed with a cutting blocking plate 330, the cutting blocking plate 330 encloses a cutter accommodating cavity, and the cutting blade 322 is arranged in the cutter accommodating cavity. The cutting blocking plate 330 is detachably connected with the cutting deck 310, which is convenient to be replaced separately after the cutting blocking plate 330 is worn, and cost and time of maintenance are saved. In an embodiment, the cutting blocking plate 330 is detachably connected with the cutting deck 310 through the bolts, including but not limited to an installation plate with holes arranged on the cutting blocking plate 330, such as a cutting blocking plate 330 connected with a top plate of the cutting deck 310 and an installation plate perpendicular to a main body of the cutting blocking plate 330. The installation plate is parallel to the top plate of the cutting deck 310, which facilitates a detachable connection between the cutting blocking plate 330 and the top plate of the cutting deck 310 through the bolts. With different specifications of the cutting deck assemblies 300, the cutting blocking plates 330 that needs are also different. For the larger cutting deck assembly 300, the larger cutting blocking plate 330 is required. If the cutting blocking plate 330 is a whole, neither convenient for transportation, nor convenient for maintenance and replacement. In an embodiment, the cutting blocking plate 330 is made up of a plurality of single-section cutting blocking plates 330, and the cutting blocking plates 330 of different single sections are connected with each other by the bolts or directly fixed on the cutting deck 310. Compared with a whole integrated cutting blocking plate 330, a processing difficulty and a transportation difficulty of the single-section cutting blocking plate 330 are greatly reduced, an overall replacement is also not needed when replacing, and only the single-section cutting blocking plate 330 is needed to be replaced, so that the transportation and maintenance are convenient.

In an embodiment, there are three cutting blades 322, and the three cutting blades 322 are arranged in a triangular pattern. A middle blocking plate 332 and an edge blocking plate 331 are matched with each other to enclose and form three accommodating cavities. The cutting blade 322 is arranged in the accommodating cavity. In some embodiments, the middle blocking plate 332 may be disassembled according to needs to meet use requirements of a lawn crushing mode and a lawn discharging mode of the mower. When the mower crushes the lawn, working areas of the three cutting blades 322 are closed to each other, and the cut lawn is continuously cut and broken in the accommodating cavity until it fall to the ground. In an embodiment, the middle blocking plate 332 at a connection of the accommodating cavities is provided with a notch. In some embodiments, a height of the notch is set at half of a height of the middle blocking plate 332. In the lawn discharging mode, part of the middle blocking plate 332 is removed, and the accommodating cavities are communicated with each other. The cut lawn moves from one side away from a lawn discharging port 340 to the lawn discharging port 340 until it is discharged from the lawn discharging port 340.

In an embodiment, the cutting deck assembly 300 further includes a cutting deck controller 323. The cutting deck controller 323 is installed on the cutting deck 310. A plurality of the cutting motors 321 is electrically connected with a same cutting deck controller 323. In an embodiment, there are three cutting motors 321 and three cutting blades 322. Each cutting motor 321 drives one cutting blade 322 to rotate, the three cutting motors 321 are electrically connected with the same cutting controller 323, and the same cutting controller 323 controls rotations of three cutting motors 321 simultaneously. In an embodiment, the cutting deck 310 is provided with a controller accommodating cavity 324 of the motor controller 323, a bottom of the controller accommodating cavity 324 is an opening hole structure, and the motor controller 323 is arranged in the controller accommodating cavity 324. A bottom of the motor controller 323 is provided with a plurality of heat sinks 325, and the plurality of heat sinks 325 is arranged at intervals along the lower surface of the motor controller 323. The heat sink 325 may improve a heat dissipation capacity of the motor controller 323, avoid a heat accumulation of the motor controller 323 in the controller accommodating cavity 324, which may cause the motor controller 323 to malfunction.

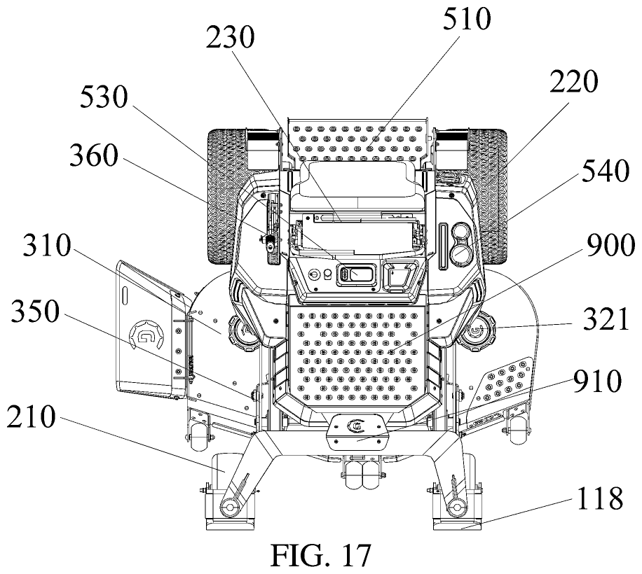

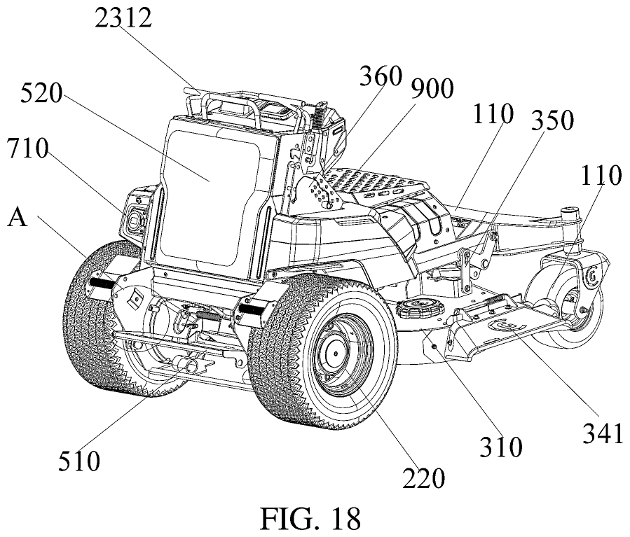

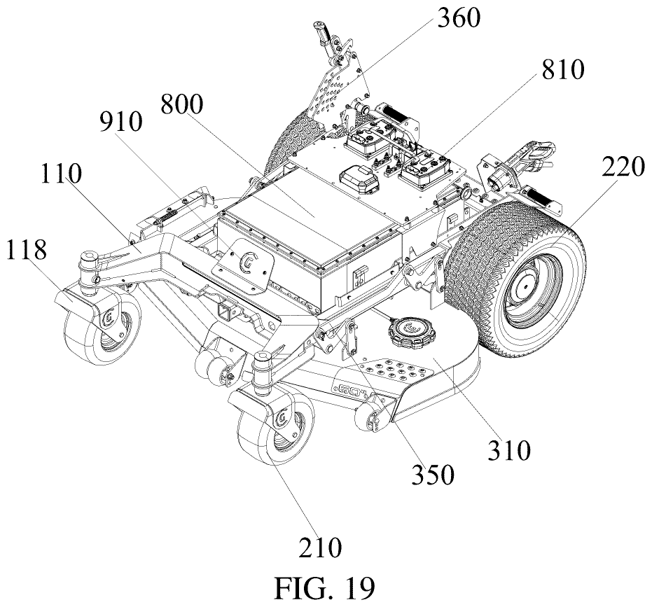

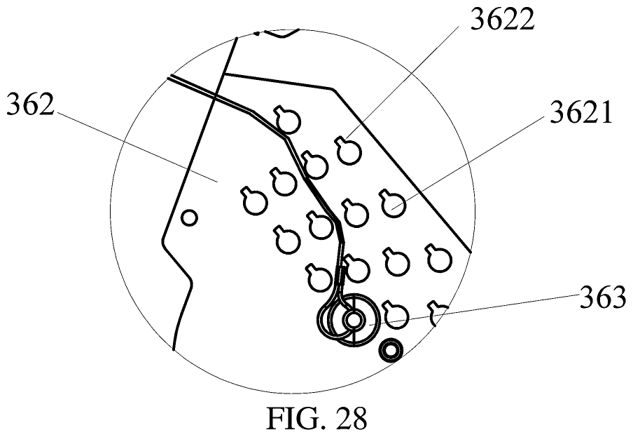

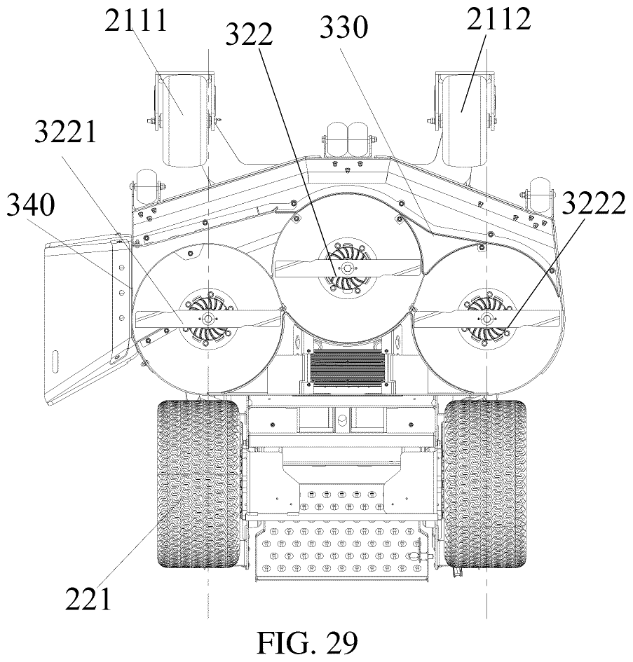

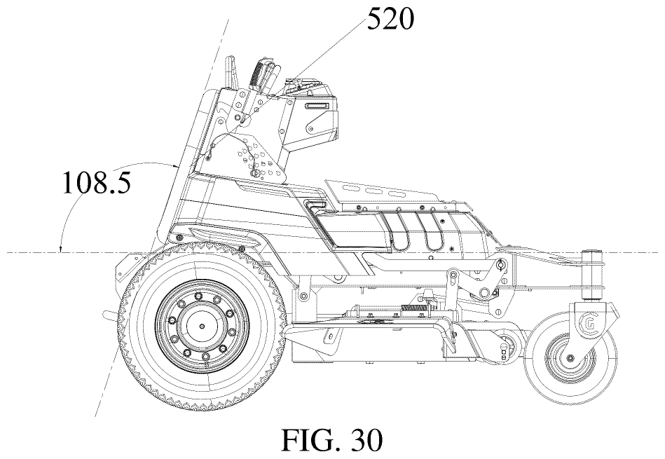

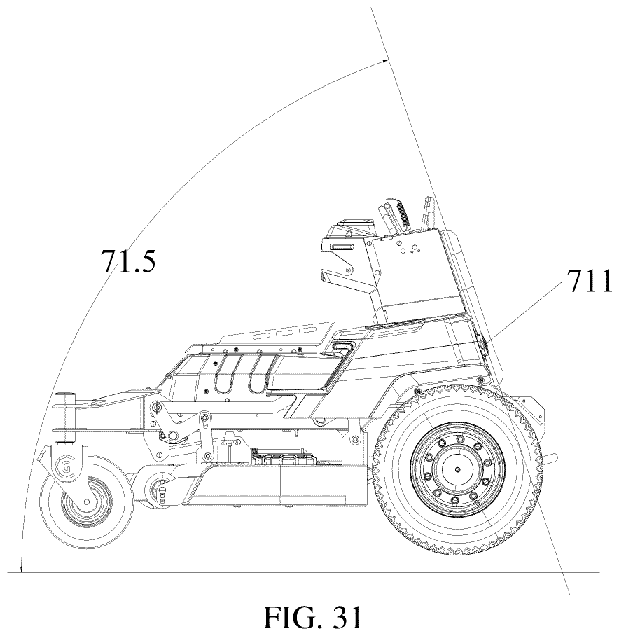

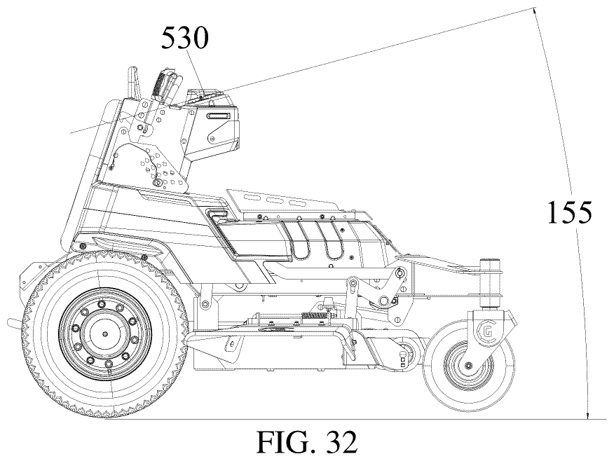

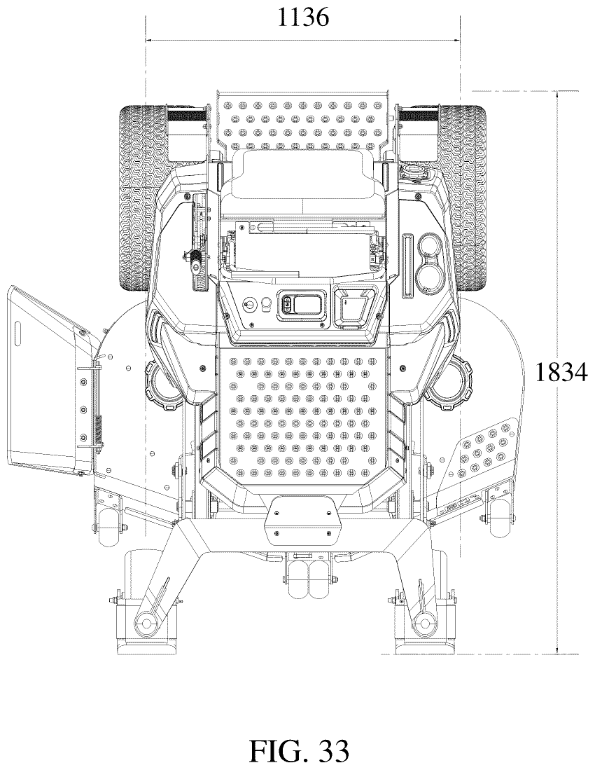

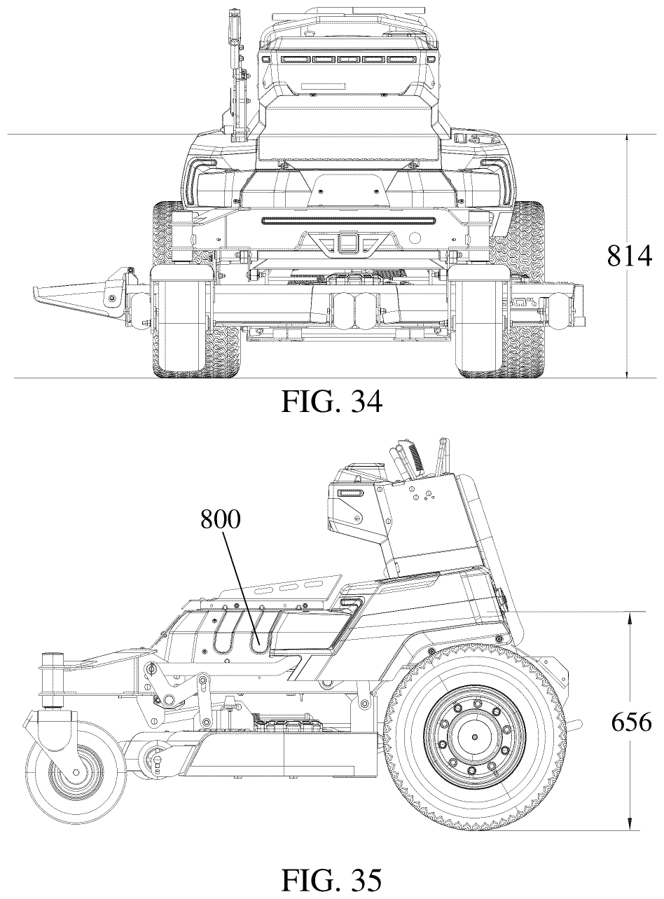

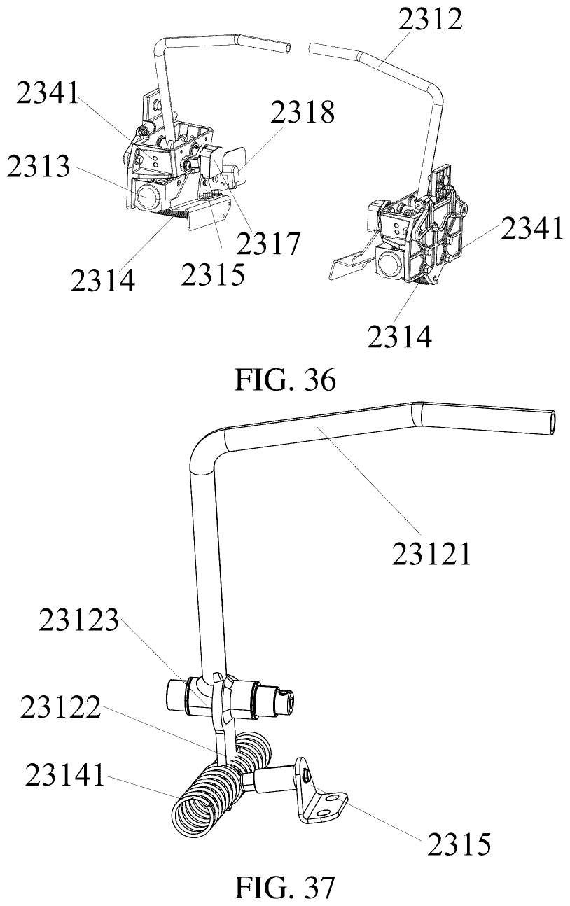

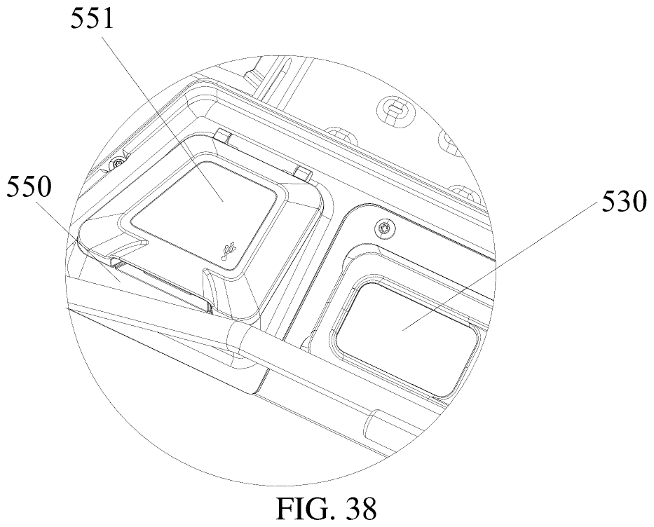

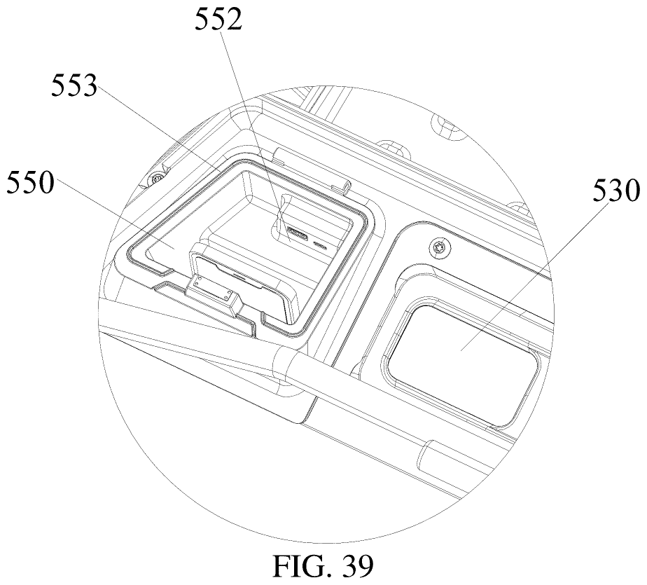

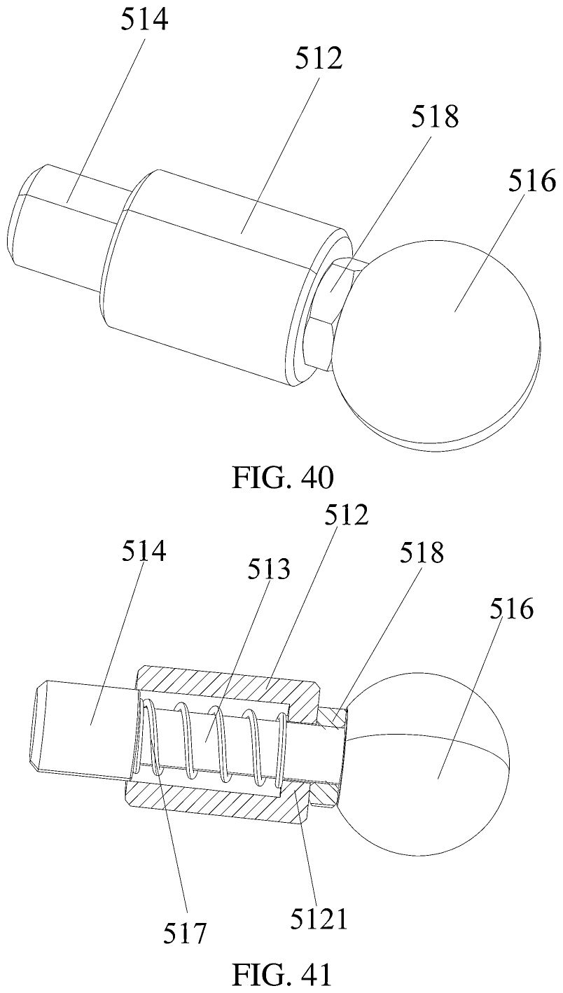

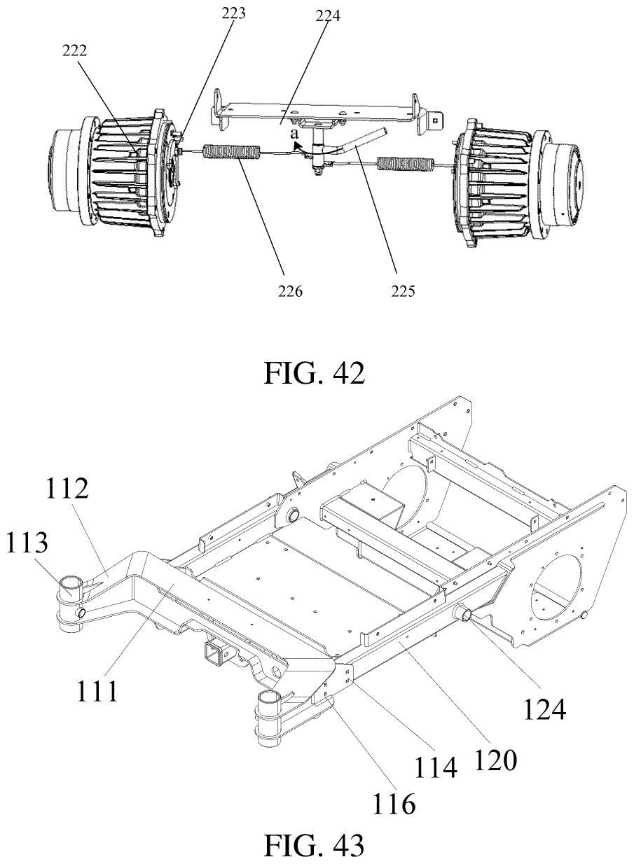

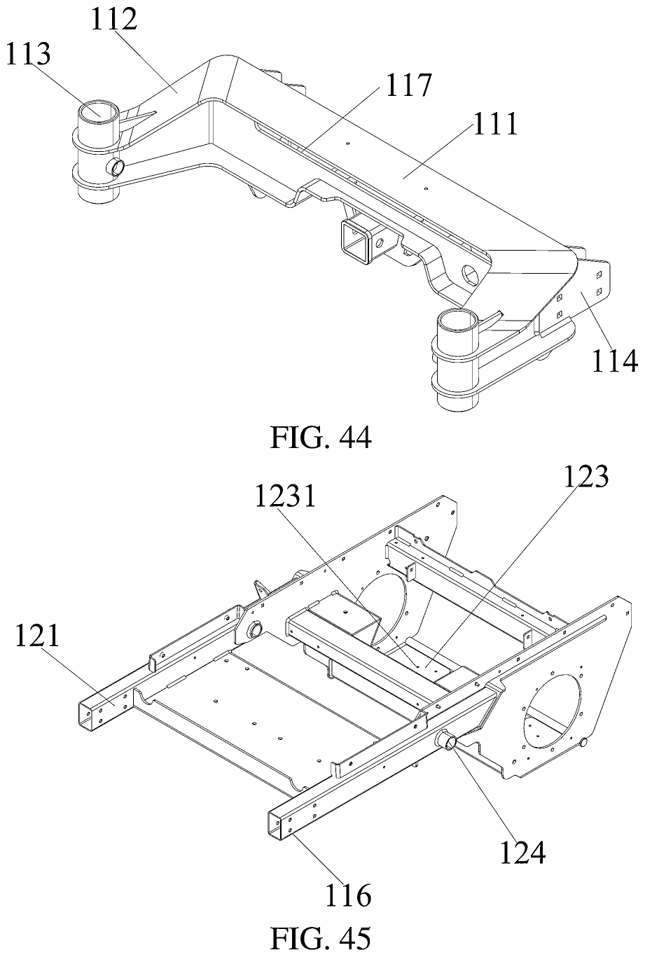

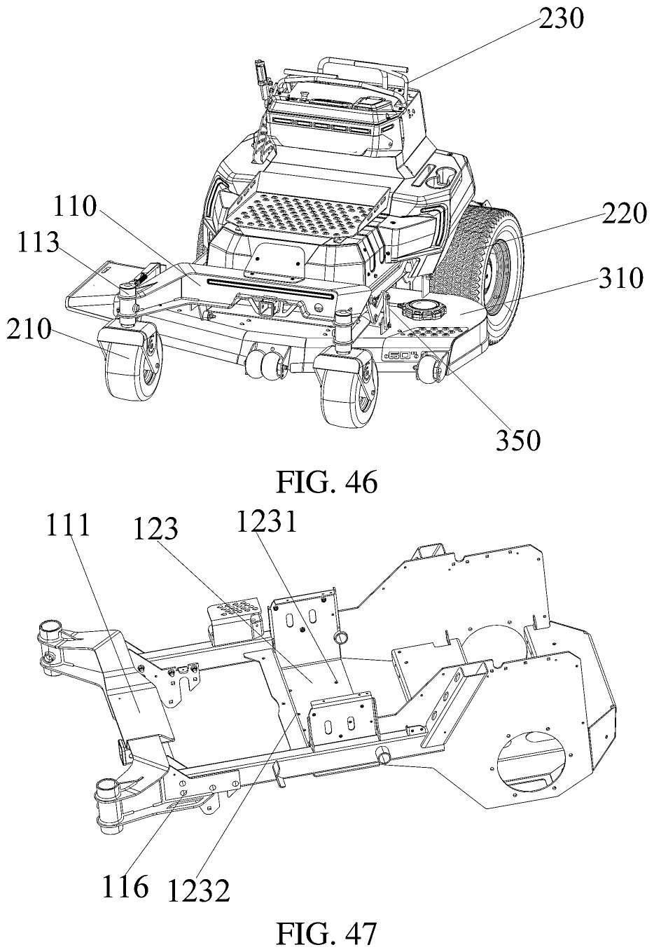

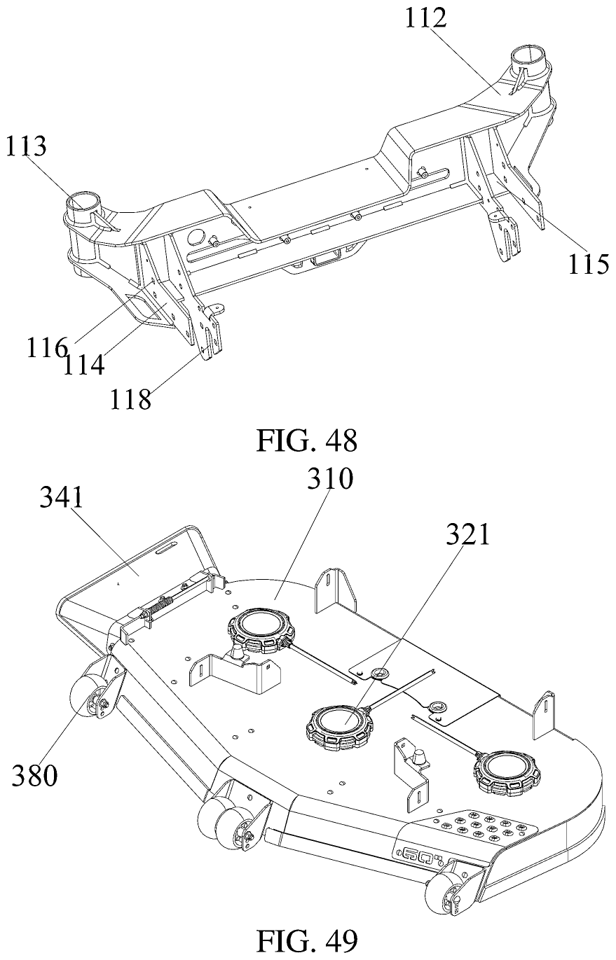

Please refer to FIG. 29. In an embodiment, in the projection along the longitudinal direction of the mower, a rotation axis of the cutting blade 322 with a front wheel projection falling into the rotation area of the cutting blade 322 is located at a side of the front wheel away from the lawn discharging port. It means that, in the longitudinal direction of the mower, the rotation area of the cutting blade 322 is divided into two by a rotating shaft of the cutting blade 322, and the front wheel is located in the rotation area of the cutting blade 322 close to the lawn discharging port 340. Specifically, the front wheel includes a first front wheel 2111 and a second front wheel 2112. The cutting blade 322 includes a first cutting blade 3221 and a second cutting blade 3222. In a forward or backward state, along a longitudinal projection of the mower, a projection of the first front wheel 2111 at least partially overlaps a rotation area of the first cutting blade 3221, and a projection of the second front wheel 2112 at least partially overlaps a rotation area of the second cutting blade 3222. With a longitudinal line that passes through an axis of the rotation shaft of the first cutting blade 3221 as boundary, a cutting rotation area of the first cutting blade 3221 is divided into two areas, which are close to the lawn discharging port 340 and away from the lawn discharging port 340. The projection of the first front wheel 2111 will fall into an area close to the lawn discharging port 340, which means that the axis of the rotation shaft of the first cutting blade 3221 is located on a side of the first front wheel 2111 that is away from the lawn discharging port 340. With a longitudinal line that passes through an axis of the rotation shaft of the second cutting blade 3222 as boundary, a cutting rotation area of the second cutting blade 3222 is divided into two areas, which are close to the lawn discharging port 340 and away from the lawn discharging port 340. The projection of the second front wheel 2112 will fall into the area close to the lawn discharging port 340, which means that the axis of the rotation shaft of the second cutting blade 3222 is located on a side of the second front wheel 2112 that is away from the lawn discharging port 340. In other words, defining a first plane parallel to a forward direction of the mower and passing through the axis of the rotation shaft of the first cutting blade 3221, the projection of the first front wheel 2111 is located on one side of the plane close to the lawn discharging port 340. In this embodiment, the projection of the first front wheel 2111 is completely located on one side of the plane close to the lawn discharging port 340. Defining a second plane parallel to a forward direction of the mower and passing through the axis of the rotation shaft of the second cutting blade 3222, the projection of the second front wheel 2112 is located on one side of the plane close to the lawn discharging port 340. In this embodiment, the projection of the second front wheel 2112 is completely located on one side of the plane close to the lawn discharging port 340. For example, please refer to FIG. 17. From a bottom of the mower, a left side of the cutting deck 310 is provided with the lawn discharging port 340, and the projection of the first front wheel 2111 falls into the area close to the lawn discharging port 340 (a left side of the axis of the rotation shaft of the first cutting blade 3221), which means that the first front 2111 wheel is located at a left side of the first plane. The projection of the second front wheel 2112 falls into the area close to the lawn discharging port 340 (a left side of the axis of the rotation shaft of the second cutting blade 3222), which means that the second front wheel 2112 is located at a left side of the second plane. When mowing, the lawn crushed by the front wheel is sucked up, and then cut off and discharged by the cutting blade 322. The front wheel may enable the lawn to be cut off directly on one side close to the lawn discharging port 340 on this side, and the lawn is directly discharged after cutting. In addition, a direction of airflow enables the airflow near the lawn discharging port to be relatively large, and the lawn crushed by the front wheels is more easily sucked up, and easier to be cut. An arrangement of the front wheels and the cutting blade 322 improves a lawn discharging effect. In an embodiment, the cutting blade 322 may further include a third cutting blade. The third cutting blade may be arranged between the first cutting blade 3221 and the second cutting blade 3222. In another embodiment, the mower may be further provided with a third front wheel and a fourth cutting blade, which is not limited in this disclosure.

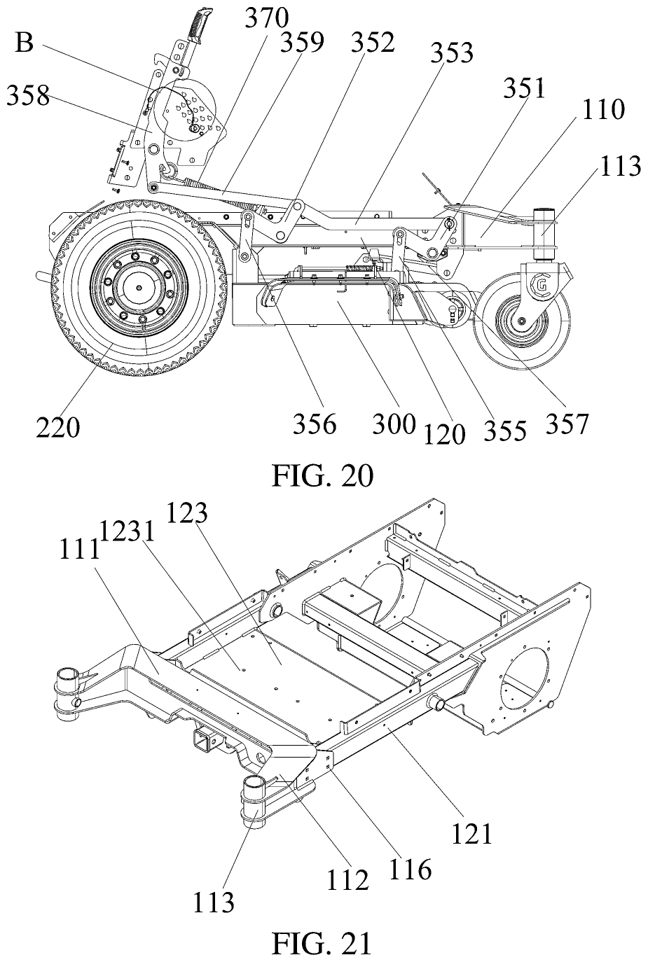

Please refer to FIG. 20. In an embodiment of the disclosure, the height adjustment device 350 includes a first connecting rod 351 rotatably connected with the frame 100 and a second connecting rod 352 rotatably connected with the frame 100. One end of the first connecting rod 351 and one end of the second connecting rod 352 are rotatably connected with the cutting deck 310, and the first connecting rod 351 and the second connecting rod 352 are further rotatably connected with a same third connecting rod 353. The third connecting rod 353, the first connecting rod 351, the second connecting rod 352, and the cutting deck 310 form a parallelogram structure, and the first connecting rod 351 or the second connecting rod 352 are rotated to realize a lifting or lowering of the cutting deck assembly 300 as a whole. In an embodiment, the height adjustment device 350 further includes a fourth connecting rod 355 and the fifth connecting rod 356. The first connecting rod 351 and the second connecting rod 352 are not directly connected with the cutting deck 310. The fourth connecting rod 355 is rotatably connected with the first connecting rod 351, and the fifth connecting rod 356 is rotatably connected with the second connecting rod 352. One end of the fourth connecting rod 355 away from the first connecting rod 351 is rotatably connected with the cutting deck 310, and one end of the fifth connecting rod 356 away from the second connecting rod 352 is rotatably connected with the cutting deck 310. The fourth connecting rod 355 and the fifth connecting rod 356 realize a rotation connection between the first connecting rod 351, the second connecting rod 352 and the cutting deck 310. Under a gravitational action of the cutting deck 310, the cutting deck 310 is always kept level during the lifting or lowering process, which ensures the cutting deck 310 to move smoothly.

In an embodiment of the disclosure, in order to facilitate the staff standing on the mower to adjust a height of the cutting deck assembly 300, a tail part of one side of the mower is provided with an adjusting rod 358. The adjusting rod 358 is rotatably connected with the frame 100, the other side of a hand-held end of the adjusting rod 358 is rotatably connected with a sixth connecting rod 359, and the sixth connecting rod 359 is rotatably connected with the second connecting rod 352 or the third connecting rod 353. When adjusting the height, the adjusting rod 358 is rotated, and the fifth connecting rod 356 or the third connecting rod 353 is driven by the sixth connecting rod 359, so that the height of the cutting deck 310 is adjusted. It should be noted that, in another embodiment, the sixth connecting rod 359 may also be connected with the first connecting rod 351, and may be selected according to an actual situation.

Please refer to FIG. 25. After adjusting a distance of the cutting deck assembly 300 as a whole to the ground, the locking device 360 is required to lock the height of the cutting deck assembly 300. The locking device 360 includes a limiting plate 362. A plurality of limiting holes 3621 is arranged on the limiting plate 362, and a limiting rod 363 is matched and arranged in the limiting hole 3621. In an embodiment, the limiting plate 362 is arranged at the adjusting rod 358, and the adjusting rod 358 is limited through the limiting rod 363. Under an effect of gravity of the cutting deck assembly 300, the adjusting rod 358 has a tendency to rotate in a first rotation direction, and the limiting rod 363 is arranged at a front end of the first rotation direction of the adjusting rod 358 to avoid the cutting deck assembly 300 moving downward. In some embodiments, a wall of the limiting hole 3621 protrudes with a clamping hole 3622. A side wall of the limiting rod 363 is provided with a clamping block. Under a condition that the clamping block corresponds to the clamping hole 3622, the limiting rod 363 is inserted into the limiting hole 3621, rotating the limiting rod 363 enables the clamping block and the clamping hole 3622 to be dislocated, which prevents the limiting rod 363 from separating from the limiting hole 3621 and causing the cutting deck assembly 300 to suddenly fall.

The limiting rod 363 is connected to the limiting hole 3621 by plugging and unplugging. When the limiting rod 363 is pulled out, it is easy to be lost when it is placed at will. In an embodiment of the disclosure, the limiting rod 363 is flexibly connected with the frame 100 or other parts of the mower through a rope to avoid a loss of the limiting rod 363 after pulling it out.

The height adjustment device 350 is rotatably connected with the cutting deck 310, and the cutting deck 310 is easy to shake in a working process. In an embodiment, a top surface of the cutting deck 310 is rotatably connected with a first connecting plate 357. One end of the first connecting plate 357 is away from the cutting deck 310 and is rotatably connected with the frame 100, and the first connecting plate 357 limits a moving trajectory of the cutting deck 310, so that a shaking of the cutting deck 310 in a process of moving or working may be reduced. It should be noted that, when the frame 100 includes the front frame 110 and the rear frame 120 that may be detachably connected with each other, the first connecting plate 357 is preferably rotatably connected with a bottom of the front frame 110. When disassembling, the front frame 110 and the cutting deck assembly 300 are kept in a connecting state, so that a matching may be more convenient, an assembly process is reduced simultaneously, and a speed of replacing the cutting deck assembly 300 is improved.

In an embodiment, the cutting deck assembly 300 further includes a shock absorbing device 370. In some embodiments, the shock absorbing device 370 is a shock absorbing spring. A first end of the shock absorbing spring is fixed with frame 100, and a second end of the shock absorbing spring is connected with the height adjustment device 350 at a side without the locking device 360. In some embodiments, the second end of the shock absorbing spring is connected with adjusting rod 358, and a force of shock absorbing device 370 acting on adjusting rod 358 is opposite to a force of cutting deck assembly 300 acting on adjusting rod 358. When the cutting deck assembly 300 shakes in a bumpy area, the cutting deck assembly 300 may be buffered by the shock absorbing device 370, and a shaking amplitude of the cutting deck assembly 300 is reduced. On the other hand, the shock absorbing device 370 may further reduce a force required by the staff when lifting the cutting deck assembly 300. In other embodiments, the shock absorbing device 370 may include a plurality of shock absorbing springs, which are connected between the frame 100 and the cutting deck 310, and a connection position is not limited.

In an embodiment, the lawn discharging port 340 of the cutting deck 310 is provided with a lawn discharging cover 341, and two sides of the lawn discharging cover 341 are provided with a flange that bends downward. A function of the lawn discharging cover 341 is to drain crushed lawn clippings at a lawn outlet, and the flange on both sides of the lawn discharging cover 341 can effectively prevent the crushed lawn clippings from flying during a discharging process.

In an embodiment of the disclosure, the lawn discharging cover 341 is rotatably installed on the frame 100, and a torsion spring is arranged between the frame 100 and the lawn discharging cover 341. The crushed lawn clippings carry moisture and may easily stick to an inside of the lawn discharging cover 341, so when it is necessary to clean the inside of the lawn discharging cover 341, the lawn discharging cover 341 needs to be turned over and cleaned. After cleaning, the lawn discharging cover 341 is reset under an action of the torsion spring.

In an embodiment of the disclosure, the lawn discharging cover 341 is installed on the frame 100 by two installation plates. A plurality of bolts is arranged between the two installation plates, the lawn discharging cover 341 is located between the two installation plates, the two installation plates are rotatably installed on the frame 100, and the lawn discharging cover 341 are fixed between the two installation plates.

In an embodiment, the frame 100 is provided with a first placing area 123. The first placing area 123 is arranged above the cutting deck assembly 300 and extends backwards above a standing area. The battery 800 is installed in the first placing area 123, this structure is used more reasonably, and a center of the mower is lowered. In an embodiment of the disclosure, the first placing area 123 is provided with a plurality of first installation holes 1231, and different batteries 800 are installed in different first installation holes 1231 through the bolts or the screws to meet different use needs. In an embodiment of the frame 100 including the front frame 110 and the rear frame 120, a front end of the first placing area 123 extends to a connection between the front frame 110 and the rear frame 120 to obtain a larger installation space for the battery 800.

In an embodiment, the control assembly 810 is installed above a tail part of the battery 800, so that the control assembly 810 has sufficient installation space, and the control assembly 810 is more convenient to be maintained under a premise of improving heat dissipation effect.

In an embodiment, the mower is provided with a placing platform 900. The placing platform 900 is arranged in a middle part of the frame 100 and above the battery 800, the placing platform 900 is provided with a reinforcing connecting plate 910, and the reinforcing connecting plate 910 is connected with the frame 100. The reinforcing connecting plate 910 can effectively increase a firmness of the placing platform 900, and increase a load capacity of the placing platform 900. In an embodiment, a load of the placing platform 900 is from 120 kg to 160 kg, and a preferred load is 140 kg.

In an embodiment of the disclosure, three flanges are arranged on the placing platform 900. The three flanges enclose the placing platform 900 to define a frame body with one side opening, which enables it to be easy to store things and increase a strength of the placing platform 900. The placing platform 900 is provided with a friction protrusion, the friction protrusion protrudes upward, and a through hole is arranged in the friction protrusion. The through holes can reduce a weight of the entire placing platform 900 and facilitate a heat dissipation for electrical equipment (e.g., motors, control boards, batteries, etc.) below the placing platform 900.

In an embodiment, a side of the mower is further provided with a placing frame 540, and the placing frame 540 is provided with different placing spaces such as cup frame, a placing groove, etc., so as to meet placing needs of the staff's personal belongings.

In an embodiment, the mower is provided with a storage bin 550 with a first flip cover 551, electronic devices such as mobile phones, mower remote controls and other electronic devices may be placed in the storage bin 550, and personal items such as keys may also be placed, so that it is convenient for the staff to use. In an embodiment, the storage bin 550 is arranged near the display screen 530 to facilitate a storage of the staff. The staff checks the display screen 530 very frequently, and the storage bin 550 is arranged near the display screen 530, which may also reduce a situation that the staff forgets the items in the storage bin 550. A smart phone is used very frequently in life. Once the smart phone runs out of battery, life becomes very inconvenient. In the embodiment of the disclosure, the storage bin 550 is provided with a second charging port 552. The second charging port 552 may be a USB, a Type-c, a lightning port, etc., to facilitate the staff to charge and use. In some embodiments, the second charging port 552 may also be provided with a wireless charging module to meet needs of part of wireless charging. It should be noted that, the second charging port 552 may charge intelligent devices such as mobile phones and pads, and may also charge devices such as mower remote controls, and the disclosure does not limit a main body of an energy storage. The second charging port 552 is provided with a waterproof protrusion 553 on a top surface of the storage bin 550 in order to avoid rainwater and the like from entering the storage bin 550. The waterproof protrusion 553 is arranged in a non-edge area of the top surface of the storage bin 550. The first flip cover 551 is provided with a groove matched with the waterproof protrusion 553, and the rainwater may be avoided from entering the storage bin 550 by the flip cover. It should be noted that the waterproof protrusion 553 may not only reduce an entry of the rainwater, but also may increase a scaling performance of the first flip cover 551 and the storage bin 550, and reduce an entry of dust into the storage bin 550. In order to facilitate use, the first flip cover 551 and the storage bin 550 are adsorbed by a magnet, and it is convenient for the first flip cover 551 to be automatically closed after the item is taken, which improves a scaling between the first flip cover 551 and the storage bin 550.

In an embodiment, the frame 100 is provided with the standing area, and above the standing area is an operating area. The operating area is provided with the operating device 230 and the display screen 530 to facilitate the user to control the mower, such as a speed control, a direction control, etc. In an embodiment of the disclosure, the mower may further be remotely controlled. A walking, a mowing and the like of the mower may be remotely controlled by the remote control device. The remote control device may be a mobile phone, a computer, a pad, a remote control, etc., and a control connecting may be through a communication network, a Bluetooth and other communication methods, which is not limited in the disclosure. In addition, the mower can further set parameters, specify a mowing plan, etc. through an APP.

In an embodiment, the mower is provided with two driving motors 222, and the two driving motors 222 are respectively installed on the two rear wheels 221 to drive the two rear wheels 211 to rotate respectively. The driving motor 222 is provided with an electromagnetic brake. The electromagnetic brake includes a braking plate 223. When the mower is powered off or parked, the electromagnetic brake limits a rotation of the driving motor 222, thereby realizing a parking function. When encountering special circumstances that require the staff to manually push the mower, the electromagnetic brake may limit a rotation of the rear wheel 221, which causes the staff to be unable to push the mower. In an embodiment, the mower further includes a brake releasing mechanism. The brake releasing mechanism includes a connecting base 224, a pulling rod 225 and a pulling component 226. In an embodiment, the connecting base 224 is installed on the frame 100, the pulling rod 225 is rotatably connected on the connecting base 224, and there are two pulling components 226. Two ends of the two pulling components 226 are respectively connected with the pulling rod 225 and the braking plate 223. When the pulling rod 225 rotates, the pulling component 226 is driven to pull the two braking plates 223 away from or close to the motor, so that a release opening or a reset closing of the electromagnetic brake on the two driving motors 222 are controlled simultaneously. In an embodiment, the pulling component 226 is an elastic reset component. For example, the pulling component 226 is a spring.

In an embodiment, the mower may automatically perform a mowing work without a driver. For a planning of an unmanned path, the mower may first move along the edge area through a manual control or a manual driving, and plan the mowing area, and the mower automatically plans or manually plans a walking route in the mowing area to realize an automatic mowing. It is also possible to directly manually plan the mowing area, and the mower will automatically walk and mow in the planned mowing area. For obstacles in the mowing area, the obstacle may be identified and avoided by arranging corresponding sensors such as a visual sensor, an infrared sensor, and a radar sensor on the mower, and obstacles may also be manually marked in the mowing area in advance, so as to realize an avoidance of obstacles by the mower. The disclosure does not list specific implementation methods one by one, and selects them according to needs, which is not limited here.

In an embodiment, the standing area includes a pedal device 510 and a cushion 520. The pedal device 510 is used for pedaling, the cushion 520 provides a support for the user, and the user may lean on the cushion 520 for operating and controlling. A conventional cushion 520 is vertically arranged, and the user leaning on the cushion 520 is inconvenient to operate and has a risk of falling. In an embodiment of the disclosure, the cushion 520 is inclined forward. When the staff leans on the cushion 520 during operating, they may get more support, which facilitates the operation, reduces the risk of falling, and improves operating comfort. In an embodiment, an inclination angle of the cushion 520 is from 100 degrees to 110 degrees, which means that an angle between the cushion 520 and the horizontal plane is from 100 degrees to 110 degrees, and 108.5 degrees is preferred. This means that the staff leans on the cushion 520, and leans forward 108.5 degrees, and an angle with a vertical plane is 18.5 degrees.

In an embodiment, the control assembly 810 is arranged above the battery 800, in front of the cushion 520, and below the control area. On one hand, the control assembly 810 is ensured to have sufficient installation space, which is convenient for arrangement and heat dissipation. On the other hand, when the control assembly 810 is faulty and needs to be troubled or maintained, the control assembly 810 may be repaired and maintained by removing the cushion 520, which improves a convenience of maintenance.

The display screen 530 in the conventional operating area is arranged horizontally. When the staff views relevant display content, they need to lower their heads to view. On one hand, frequent lowering and raising of heads will cause fatigue for the staff. On the other hand, if the staff lowers their head downwards, they cannot see a situation in front of the mower, which may lead to collisions. In an embodiment of the disclosure, the display screen 530 is tilted and face towards the user. An angle between the display screen 530 and the horizontal direction is from 150 degrees to 160 degrees, and 155 degrees is preferred. The user may view the display screen 530 information with a residual light, improve the safety of work, and avoid the fatigue caused by frequent lowering and raising of the head.

The conventional mower charging port is usually arranged horizontally. Because of a height limitation of the mower, it is inconvenient for the staff to plug and unplug a charging gun horizontally, so that it is difficult to plug and unplug. In an embodiment of the disclosure, a tail part of the mower is provided with a first charging port 711, and the first charging port 711 forms an angle of 60 degrees to 75 degrees with the horizontal plane, and 71.5 degrees is preferred. The first charging port 711 is inclined upwards obliquely, and it is more convenient for the staff to exert force when plugging and unplugging the charging gun, which is convenient to plug and unplug.

In an embodiment, the first charging port 711 is provided with a reversible charging port cover 710, and the charging port cover 710 is opened for charging when charging. The charging port cover 710 is automatically closed after the charging is completed, and rainwater, debris, etc. fall into the first charging port 711, which reduces an incidence of failure. It should be noted that, an implementation mode of automatic closing of the charging port cover 710 is selected in the prior art according to an actual situation, and the disclosure does not limit this.

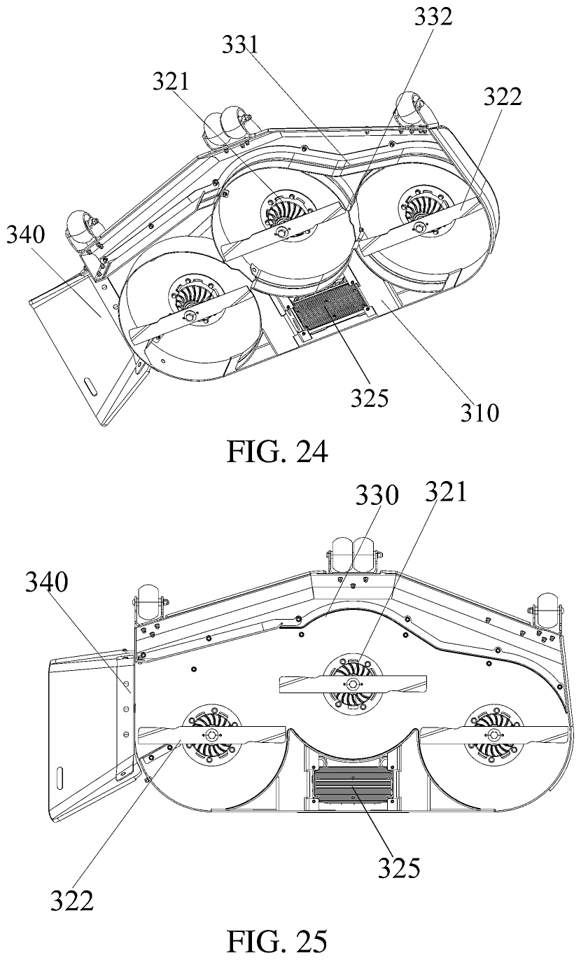

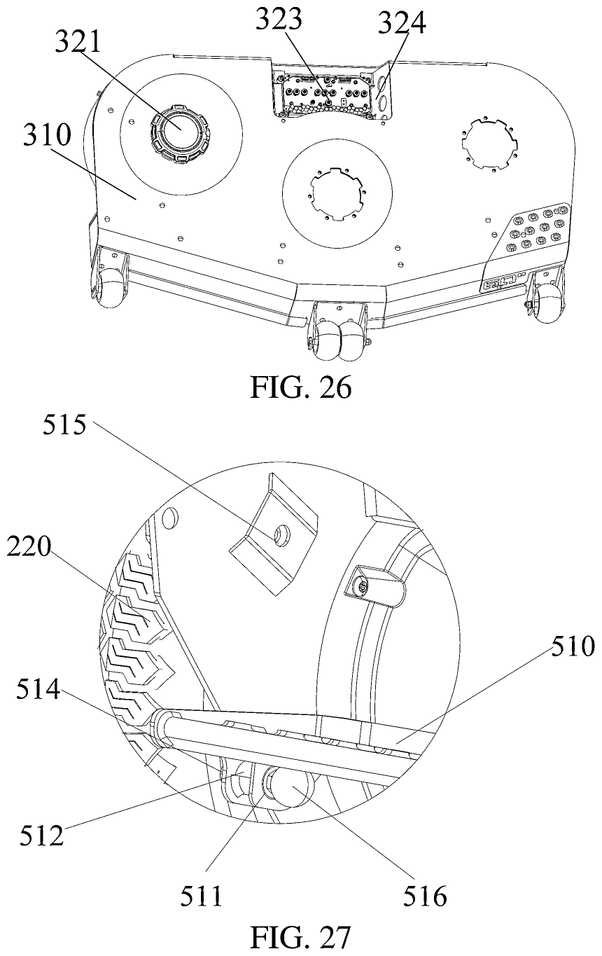

Please refer to FIG. 24. In an embodiment of the disclosure, the pedal device 510 is rotatably connected with the frame 100. When the pedal device 510 is in a lower state, the staff stands on the pedal device 510 to perform the operation of the mower. When the pedal device 510 is in a folded state, the standing mower may be used as a hand-propelled mower to meet needs of use in different scenes. In an embodiment, a detection device of the user in-place is a pressure switch 2318. When the staff operates and controls a handle, the pressure switch 2318 may send a signal, and the control assembly 810 controls the walking assembly and the cutting motor 321 in the cutting deck assembly 300 to be powered on. Further, when the operating lever 2312 leaves the pressure switch 2318, if a cutter switch that controls the cutting motor 321 is in a turning on state, the cutting motor 321 does not act at this time. The cutter switch needs to be restarted, and the cutting motor 321 can act at this time which means that the pressure switch 2318 needs to respond first, then the cutter switch is turned on, and the cutting motor 321 may start to act. In another embodiment, the detection device of the user in-place may be a separate switch, sensor, etc., to detect whether the operator is in place.

In an embodiment, a bottom surface of a side wall of the pedal device 510 is provided with a fixing through hole 511, a fixing tube 512 is fixed in the fixed through hole 511, and an end of the fixing tube 512 close to the pedal device 510 is provided with a third limiting part 5121. An inner diameter of the third limiting part 5121 is smaller than an inner diameter of the fixing tube 512. A plug-in rod 513 is arranged in the fixing tube 512. An end of the plug-in rod 513 penetrates through the fixing tube 512 from a side of the third limiting part 5121. A third clamping block 518 is arranged on one side of the plug-in rod 513 extending out of the fixing tube 512, and a diameter of the third clamping block 518 is greater than the inner diameter of the third limiting part 5121. A plug-in block 514 is arranged on a side of the plug-in rod 513 away from the third limiting part 5121. A third clastic component 517 is sleeved and arranged on the plug-in rod 513. The third clastic component 517 is preferably selected as a spring, and an outer diameter of the spring is smaller than a diameter of the plug-in block 514 and is greater than the inner diameter of the third limiting part 5121.

The frame 100 is provided with a plug-in hole 515. The plug-in hole 515 is arranged at a position corresponding to the plug-in block 514 when the pedal device 510 is folded, and the plug-in block 514 is matched with the plug-in hole 515 to limit a rotation of the pedal device 510. When the pedal device 510 is folded, the plug-in block 514 is inserted into the plug-in hole 515, and when it needs to be put down, the plug-in block 514 is manually pulled out, and the pedal device 510 falls naturally. Through a matching between the plug-in hole 515 and the plug-in block 514, two states of pedal device 510 are realized, which meets use requirements of different scenes, such as a situation that under a special harsh terrain, the mower is difficult to pass, and the staff gets off and pushes the lawn mower, so it is more convenient for the mower to pass through a terrain that is difficult to pass under normal circumstances. In an embodiment, a hand-held area 516 is arranged at one end of the plug-in rod 513 away from the plug-in hole 515, the hand-held area 516 may be a hand-held ball, a hand-held block and other parts that are convenient to hold. A surface of the hand-held area 516 may further be treated with anti-slip, such as surface anti-skip lines, setting anti-slip rubber, etc. When the pedal device 510 needs to be folded, the pedal device 510 is rotated to a given position, the hand-held area 516 is held to pull the plug-in rod 513, and the plug-in block 514 is enabled to enter the plug-in hole 515. At this time, the hand-held area 516 is loosened, and the plug-in rod 513 may be kept in the plug-in hole 515 under an effect of the third elastic component 517. The mower of the disclosure has a reasonable layout, an appearance ratio of a whole vehicle is wider, a front end is shorter, and a center of gravity is lower. A casing is arranged on the frame 100 of the mower. On one hand, an appearance of the mower is neater, and is improved. On the other hand, some parts of the mower, such as control assemblies, may be protected. A width of the casing is from 1000 mm to 1300 mm, a length of the casing is from 1600 mm to 2000 mm, a preferred width is 1136 mm, and a preferred length is 1834 mm. A height of a main casing from the ground is from 700 mm to 900 mm, and a preferred height 814 mm, for better passability in harsh terrain. A layout of the battery 800 is low, a distance of the battery 800 to the ground in an example is from 630 mm to 670 mm, and 656.51 mm is preferred. The control assembly 810 is installed in a sufficient space above the battery 800, a heat dissipation performance is good, and it is convenient for maintenance.

In an embodiment of the disclosure, there are lights in many places on the casing, such as a tail light and a turn signal at a tail part, and a front light at a front part, etc. On one hand, the lights may play a role of lighting, which is convenient for the staff to mow in a case of poor lighting to meet the needs of different use scenarios. On the other hand, different flashing frequencies and different colors of lights may transmit different signals, which is convenient for the staff to communicate with each other and transmit instruction content.

The front fork of the disclosure may effectively protect the tire. The placing platform 900 may carry more than 140 kg of heavy objects, which meets needs of placing other tools and other articles. The cushion 520 and the display screen 530 are arranged and tilted, which avoids the staff to be easily tired for a long-term use. The plugging and unplugging of the charging gun is convenient for exertion, and is more convenient to use.

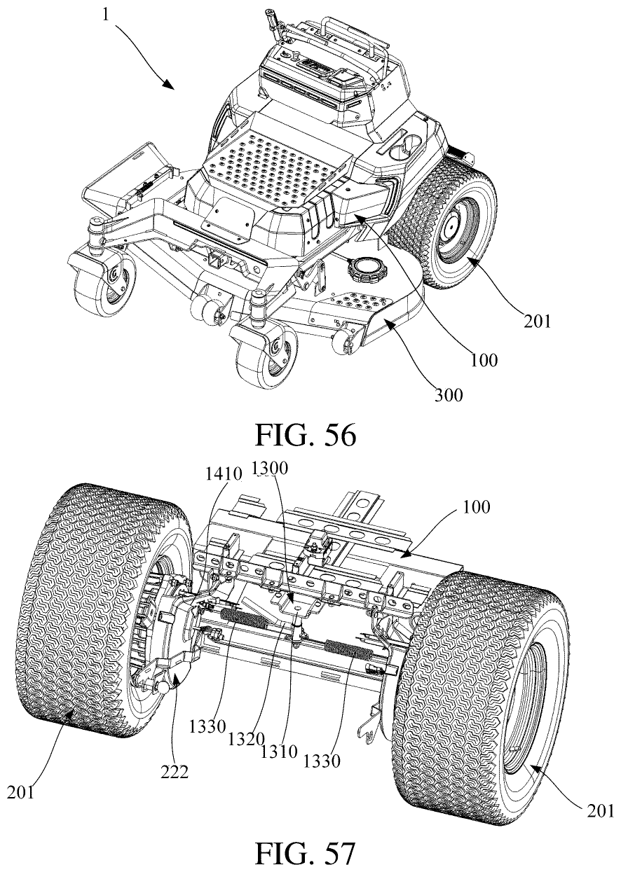

In an embodiment, please refer to FIG. 56 and FIG. 57. FIG. 56 and FIG. 57 show a structure of the mower. The mower includes the frame 100, the walking mechanism 200, the battery and the cutting deck 310.

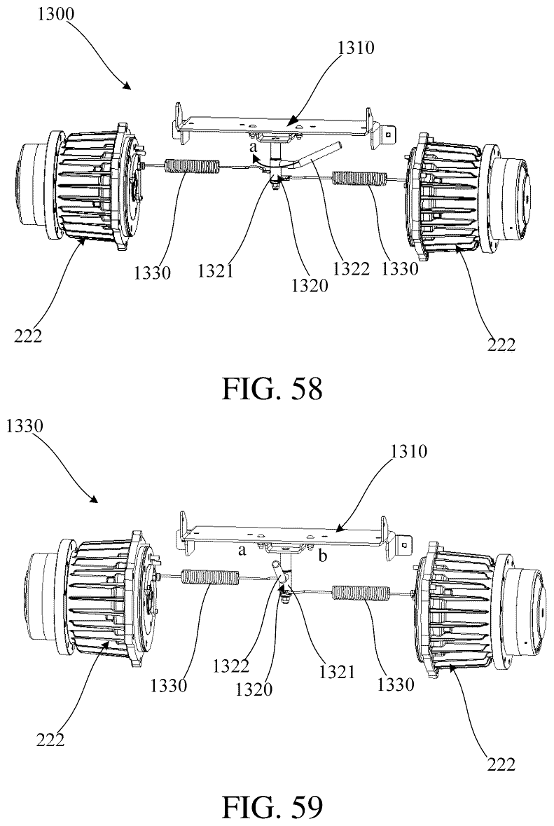

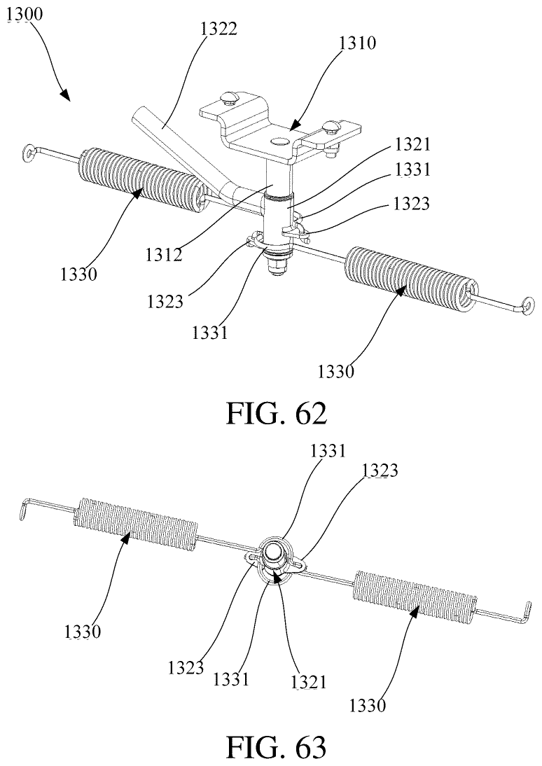

Please refer to FIG. 58 and FIG. 62. FIG. 58 and FIG. 62 show a structure of the frame 100. The frame 100 includes the front frame 110 and the rear frame 120. The front frame 110 is detachably connected with the rear frame 120. The walking mechanism 200 includes a front wheel assembly 210. In an embodiment, the front wheel assembly 210 is installed on the front frame 110, and the rear wheel assembly 220 is installed on the rear frame 120. In some embodiments, the front frame 110 and the rear frame 120 are installed and fixed through the connecting bolts 122. The front wheel assembly 210 is separately assembled on the front frame 110, and the battery, the control assembly, etc. are assembled on the rear frame 120. When the cutting deck 310 of different specifications needs to be replaced, such as 48 inches, 52 inches, 60 inches, etc., the mower changes a wheelbase of the mower by replacing an adapted front frame 110, so that the cutting deck 310 may be assembled.

In an embodiment, after the cutting deck 310 is assembled on the mower, the cutting deck 310 is located between the front wheel and the rear wheel. A closest distance between the cutting deck 310 and the front wheel is from 10 mm to 60 mm, and a closest distance between the cutting deck 310 and the rear wheel is from 10 mm to 60 mm. The cutting deck 310 keeps a suitable distance with both of the front wheel and the rear wheel. On one hand, it is convenient for the cutting deck 310 to adjust the height. On the other hand, in a harsh working environment such as bumps, the cutting deck 310 will shake slightly back and forth and keep a certain distance from the front wheel and rear wheel to prevent the cutting deck 310 from colliding with the front wheel and rear wheel and reduce a risk of damage to the mower.

Please refer to FIG. 59. FIG. 59 is a structure of the front frame 110 according to an embodiment of the disclosure. In an embodiment, the front frame 110 of the mower is U-shaped and includes the first cross beam 111. The two ends of the first cross beam 111 are provided with the first connecting part 112 extending forward, and the two first connecting parts 112 are respectively provided with the front wheel assembly 210. The front wheel preferably selects universal wheels as steering wheels. In an embodiment, a front end of the first connecting part 112 is provided with the assembling tube 113, and the assembling pipe 113 is provided with the first bearing. The first bearing is provided with the first rotating shaft with an interference fit inside the first bearing. The lower end of the first rotating shaft extends out from the assembling pipe 113 and is connected with a front wheel fork, and the front wheel is rotatably connected with the front wheel fork. When steering, the front wheels rotate around the first rotating shaft to change direction. In an embodiment, a front end of the front wheel fork is further provided with a protective inclined plate, and a front edge of the protective inclined plate exceeds a front edge of the front wheel. When encountering an obstacle, the protective inclined plate touches the obstacle earlier than the front wheel, and avoids the front wheel bumping and damage.

In an embodiment, the first cross beam 111 of the front frame 110 is provided with the front light. In some embodiments, the first cross beam 111 is provided with a penetrating groove 117, the front light is assembled on a back of the first cross beam 111, part of the front light is clamped in the penetrating groove 117, and the front light illuminates or transmits a signal. In an embodiment, a front side of the first cross beam 111 is provided with a concavity, and the penetrating groove 117 is arranged in the concavity. The front light is arranged in the penetrating groove 117 in the concavity. When encountering an obstacle or a collision, the first cross beam 111 may protect the front light and avoid a direct collision damage of the front light.

Please refer to FIG. 63. FIG. 63 shows a structure of the front frame 110 in an embodiment. In an embodiment, a rear end of the front frame 110 is provided with the two first clamping boards 114 on both sides, and the front end of the rear frame 120 are two square tubes 121. The square tubes 121 are inserted between the two first clamping boards 114, the corresponding positions of the square tubes 121 and the first clamping boards 114 are provided with the first through hole 116, and the first clamping boards 114 and the square tubes 121 are fastened through a connecting bolts 122 penetrating through the first through hole 116. In some embodiments, no less than four bolts on each side are used for installing, so that the front frame 110 and the rear frame 120 are fastened. In an embodiment, the first clamping boards 114 are vertically arranged, bottom surfaces of the two first clamping boards 114 on the same side are provided with the second clamping board 115 arranged in a transverse direction, and the first clamping boards 114 and the second clamping board 115 form a U-shape. The U-shaped groove is convenient for the square tube 121 of the rear frame 120 to be inserted and fixed, and the second clamping board 115 at the bottom supports the square tube 121. Affected by a gravity of each part of the mower, a force between the front frame 110 and the rear frame 120 is mainly concentrated at a connection, which is indicated in a relative rotating tendency of the front frame 110 and the rear frame 120. A rotation direction is respectively around the front wheel and the rear wheel downward from the connection. Through adding the second clamping board 115, a supporting area of the connection of the front frame 110 and the rear frame 120 is increased, a shear force that the connecting bolt 122 receives is reduced, a connection firmness is improved, and a duration life of the connecting bolt 122 is prolonged.

When the cutting deck 310 of different specifications needs to be replaced, the front frame 110 needs to be replaced in advance. If the parts of the mower that do not need to be replaced are installed on the front frame 110, a workload of disassembly and assembly is inevitably increased. In an embodiment of the disclosure, most parts of the mower are installed on the rear frame 120, such as the battery, the control system, a driving seat 500 or the standing area, etc.

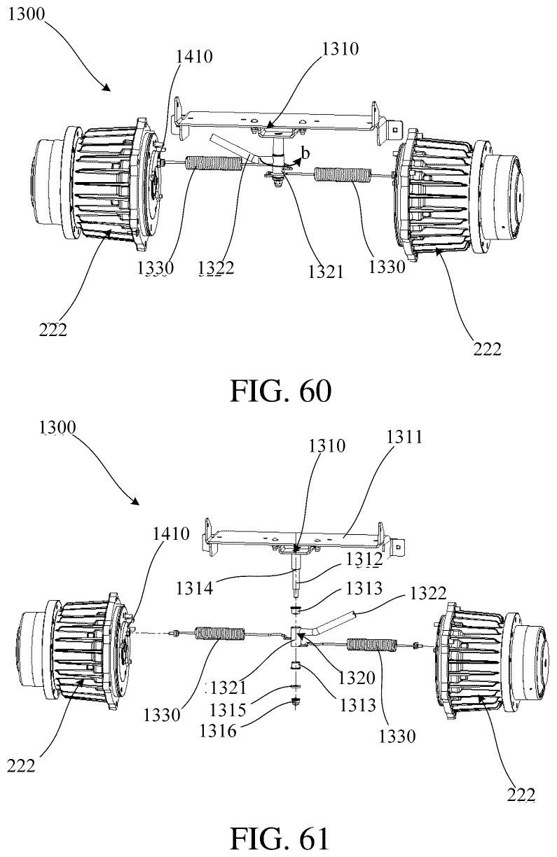

Please refer to FIG. 60. FIG. 60 shows the structure of the rear frame 120 in an embodiment. The rear frame 120 is provided with the first placing area 123, and the battery is fixed in the first placing area 123. The battery provides electrical energy for the mower, and mowers with different specifications and different requirements need to install suitable batteries as needed. In some embodiments, a bottom plate of the first placing area 123 is provided with the plurality of first installation holes 1231, and batteries of different specifications are matched with the first installation holes 1231 at different positions, so that the installation and fixation of batteries of different specifications are realized, and different uses are satisfied. It should be noted that, positions of the first placing areas 123 of the mowers of different forms are different, such as the standing mower, the first placing area 123 is arranged at a position of the rear frame 120 close to the front frame 110, a weight of the battery is larger, and it is placed in the front position, so that a force brought by a personnel standing at a rear end of the mower may be balanced, a stability of the mower is improved, and the mower is avoided from overturning when the staff stands back. An arrangement position of the first placing area 123 is selected according to the actual situation. As long as it may meet the placement needs of the battery, the disclosure does not limit this. It should be noted that, the first placing area 123 may only place one battery, or may place a plurality of batteries. The plurality of batteries may be connected in parallel or in series. The batteries may supply energy at the same time, or a second battery may be used after one battery is exhausted. This disclosure does not limit this, and the selection may be made according to actual needs.

Please refer to FIG. 60. In an embodiment, a front end and a bottom surface of the first placing area 123 are provided with a battery protective board 1232, and the battery protective board 1232 is arranged on the frame 100. On one hand, the battery protective board 1232 may limit the battery, which ensures that the battery will not be displaced in a process of use. On the other hand, the battery may be protected, the conventional battery generally selects a lithium battery or a lead-acid battery. The lithium battery is preferred in a field of mower. The lithium battery has a certain risk of spontaneous combustion under a condition of short circuit, the battery is protected by the battery protective board 1232, and the battery is prevented from being damaged and short-circuited. It should be noted that, a specific installation mode of the battery protective board 1232 may be welded, bolted, riveted, etc., and selected according to actual needs, which is not limited in the disclosure.

The walking mechanism 200 includes the front wheel assembly 210, the rear wheel assembly 220, the driving mechanism, the operating system 230 and the like. In an embodiment, the front wheel assembly 210 is the universal wheel for convenient steering, the driving mechanism is connected with the rear wheel assembly 220, and the driving assembly is controlled by the operating system 230 to drive the rear wheel to rotate, so that a movement of the mower is realized. When need to steer, a speed of the two rear wheels is adjusted by the operating system 230, and the two rear wheels have a certain speed difference, thereby driving the mower to steer. The driving mechanism is connected with the rear wheel assembly 220, which improves a walking performance of the mower and meets needs of multi-working conditions. It should be noted that, the operating lever of the operating system 230 is installed at different positions according to different vehicle models, such as the standing mower, the operating lever is installed above the standing area to facilitate a hand-held control by users. A specific installation mode, position, etc. are selected according to the need, and the disclosure does not limit this.

Please refer to FIG. 57. The cutting deck 310 is arranged at the bottom of the frame 100. In an embodiment, the driving motor is installed on the cutting deck 310, the driving motor is connected with the cutting blade to drive the cutting blade to rotate, and the cutting blade is arranged at a position below the cutting deck to perform the mowing. In an embodiment, the cutting deck 310 is connected with the frame 100 through the height adjustment device 350, and the height adjustment device 350 may adjust a distance between the cutting deck 310 and the bottom of the frame 100. It should be noted that, the height adjustment device 350 may be connected with the rear frame 120, and may also be partially connected with the front frame 110, which is selected according to actual needs, and is not limited in the disclosure. In an embodiment, the height adjustment device 350 includes the first connecting rod 351 and the second connecting rod 352. Middle parts of the first connecting rod 351 and the second connecting rod 352 are rotatably connected on the frame 100, and lower ends of the first connecting rod 351 and the second connecting rod 352 are respectively rotatably connected with the fourth connecting rod 355 and the fifth connecting rod 356. The fourth connecting rod 355 and the fifth connecting rod 356 are rotatably connected with the cutting deck respectively. The first connecting rod 351 and the second connecting rod 352 are far away from the fourth connecting rod 355. One side of the fifth connecting rod 356 is connected through the third connecting rod 353, and the third connecting rod 353 is rotatably connected with the first connecting rod 351 and the second connecting rod 352 respectively. When height adjustment is required, a height of the cutting deck may be lifted by rotating the first connecting rod 351 or the second connecting rod 352. The rear frame 120 is provided with a second rotation connecting hole 124. A second rotation connecting shaft penetrates through the second rotation connecting hole 124, and the second connecting rod 352 is rotatably connected with the rear frame 120 through the second rotation connecting shaft. The front frame 110 is provided with a first rotation connecting hole 118. A first rotation connecting shaft penetrates through the first rotation connecting hole 118, and the first connecting rod 351 is rotatably connected with the front frame 110 through the first rotating shaft. Installation dimensions of different specifications of cutting deck 310 are different. A rear part of the cutting deck 310 is installed on the rear frame 120, a front part of the cutting deck 310 is installed on the front frame 110, and the rear frame 120 only needs to be provided with two rotation installation holes on left and right sides, so as to avoid arranging more rotation installation holes on the rear frame 120, and affect a strength of the frame 100. When replacing the cutting deck 310, the front frame 110 needs to be replaced synchronously. A connection between the cutting deck 310 and the front frame 110 may not be dissolved in a disassembly process. When the cutting deck 310 and the front frame 110 need to be replaced, assembly operations are effectively reduced, and a replacement speed is effectively improved. Keeping a connection between the cutting deck 310 and the front frame 110 may also effectively improve a speed of finding components, and prevent an installation mismatch between the cutting deck 310 and the front frame 110.

In an embodiment, a rear end of the rear frame 120 is further provided with an anti-collision device, such as a rubber anti-collision strip and the like. When the mower collides with an obstacle in a reversing process, the anti-collision device is used for buffering to avoid collision damage to the rear frame 120 and reducing a collision vibration of the mower.

In an embodiment, the frame 100 may further be used for other garden tools, and the garden tools may be mowers as shown in FIG. 63 through FIG. 70. The garden tool includes the frame 100, the walking mechanism 200, the battery and the working part and so on. The frame 100 provides a support and an assembly space for the entire garden tool. The frame 100 includes the front frame 110 and the rear frame 120. The front frame 110 is detachably connected and fixed with the rear frame 120. Bolting is preferred for fixing. The front wheel assembly 210 is installed on the front frame 110, and the rear wheel assembly 220 is installed on the rear frame 120. When different garden tools need to be replaced with different working parts or other needs, a wheelbase of garden tools may be adjusted by replacing the front frame 110, which obtains different installation space and meets different use requirements. It should be noted that, a connection between the front frame 110 and the rear frame 120 may be the connection between the front frame 110 and the rear frame 120 in the mower. The walking mechanism 200 includes the front wheel assembly 210, the rear wheel assembly 220, and the driving mechanism, etc. In some embodiments, the driving mechanism is connected with the rear wheel assembly 220, so that the garden tool is rear-wheel driven, and a walking ability of different terrain of the garden tool is improved. The battery is installed in the first placing area 123 arranged on the frame 100, and different threaded holes are arranged in the first placing area 123 to correspond to installation of batteries of different specifications. It should be noted that, a part and a relative connection relationship that are not described in detail in the above-mentioned garden tools may refer to the conventional corresponding garden tools, and the disclosure will not be repeated here.

The disclosure provides the mower and the garden tools, the wheelbase of the mower or other garden tools may be adjusted by replacing the front frame 110, so that different installation spaces are obtained, and beneficial effects of different installation requirements of the working parts are satisfied.

In an embodiment, the mower includes the frame 100, the walking mechanism 200, the battery, the cutting deck assembly 300 and the control system. The walking mechanism 200 is arranged on the frame 100 and includes the front wheel, the rear wheel, and the driving mechanism, etc. In an embodiment, the front wheel is the universal wheel, the driving mechanism is connected with the rear wheel, and the driving mechanism drives the rear wheel to rotate. The battery provides electrical energy for the mower, including but not limited to providing electrical energy for the driving mechanism, the operating mechanism, the cutting motor 321 of the cutting deck assembly 300, etc. The cutting deck assembly 300 solves a problem that the conventional cutting blocking plate 330 is inconvenient to be maintained and replaced.

The control system includes speed regulation, steering and other controls. The standing mower is provided with a necessary standing position, and a specific structure is selected according to the need, and the disclosure does not limit this.

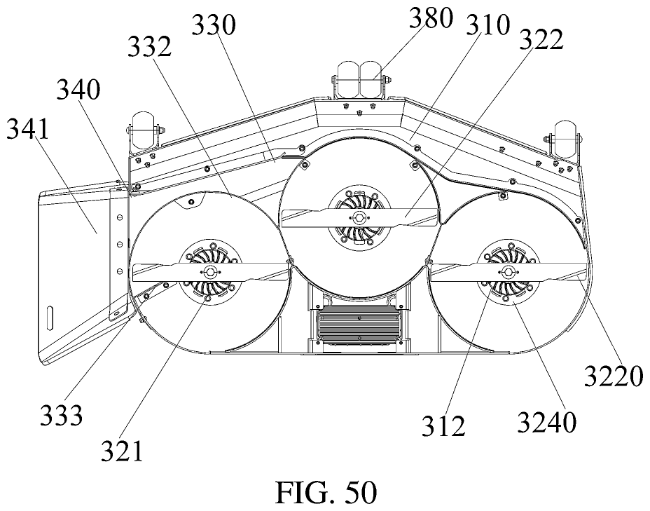

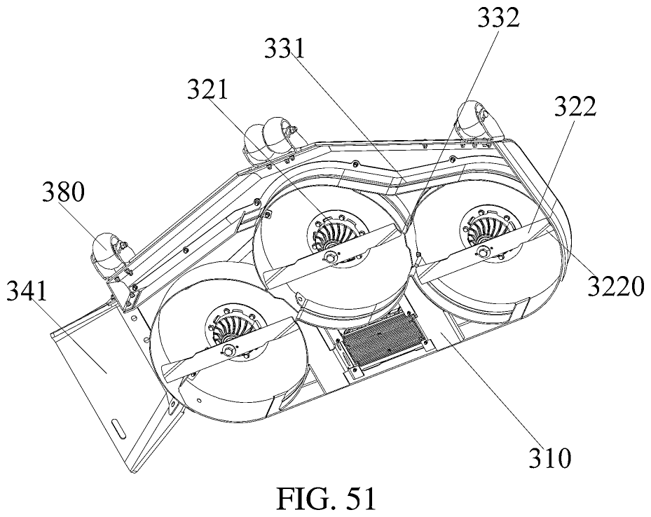

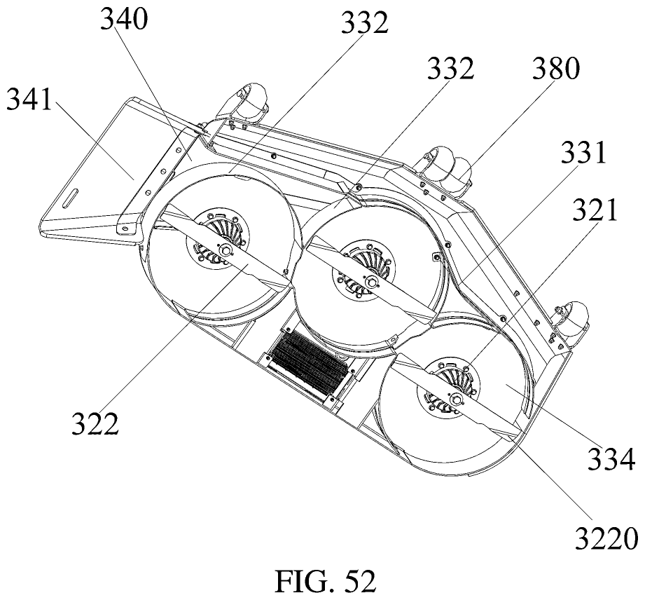

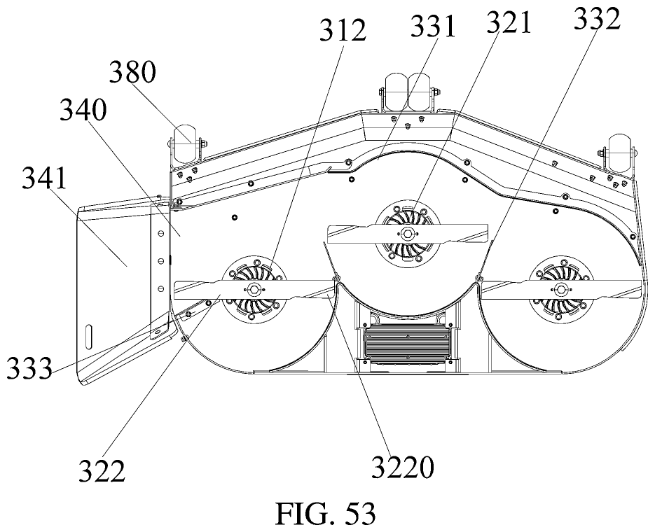

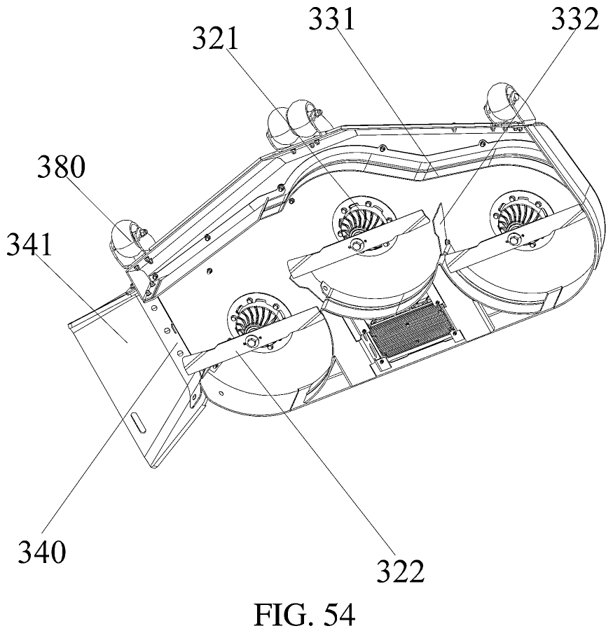

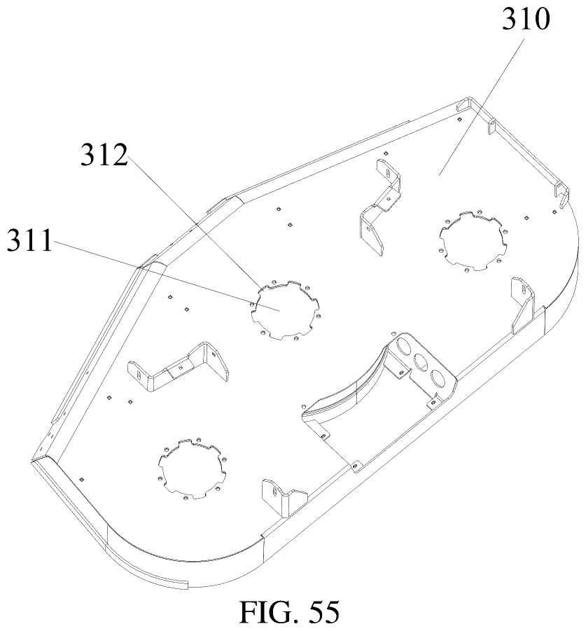

In an embodiment, please refer to FIG. 49 through FIG. 54. FIG. 49 through FIG. 54 shows the cutting deck assembly 300 in an embodiment of the disclosure. The cutting deck assembly 300 includes the cutting deck 310, the cutting part 320 and the cutting blocking plate 330. In an embodiment, the cutting deck 310 is installed on the frame 100 of the mower, and the cutting deck 310 provides an integral support and assembly position for the cutting deck assembly 300.

The cutting part 320 includes the cutting motor 321, and the cutting blade 322 driven by the cutting motor 321. In an embodiment, the cutting motor 321 is installed on the cutting deck 310. In an embodiments, the cutting deck 310 is provided with a plurality of penetrating holes 311 that penetrate a top plate of the cutting deck 310 from top to bottom. The cutting motor 321 penetrates through the cutting deck 310 through the penetrating holes 311, and partially extends into a below of the top plate of the cutting deck 310. A top of the penetrating hole 311 is an installation part of the cutting motor 321. A flange disc 324 is arranged below the penetrating hole 311, and the top plate of the cutting deck 310 at an edge of the penetrating hole 311 is further provided with a motor installation hole. An installation bolt is configured to penetrate the flange disc 324 and the motor installation hole sequentially and is fixed with the installation part of the cutting motor 321, so that an installation of the cutting motor 321 is realized. The cutting motor 321 partially extends into the below of the top plate of the cutting deck 310, which is conducive to increase a distance between the cutting blade 322 and the top plate of the cutting deck 310 and a space for lawn weeding and discharging, and reduce a number and frequencies of cleaning.

The cutting motor 321 will generate heat during use, and heat accumulation after long-term use may easily cause a failure of the cutting motor 321. In order to improve a heat dissipation effect of the cutting motor 321, in an embodiment, there are a plurality of ventilation holes 312 in an edge circumferential array of the penetrating hole 311. When air flow passes in the ventilation hole 312, heat around the cutting motor 321 will be taken away, so as to avoid a problem of a heat accumulation caused by a sealed contact position between the cutting motor 321 and the cutting deck 310, and improve a heat dissipation effect of the cutting motor 321.

The cutting blade 322 is installed on a driving shaft of the cutting motor 321, and the cutting motor 321 drives the cutting blade 322 to rotate to perform the mowing and repairing. In an embodiment, a front end of the cutting blade 322 rotation is a cutting edge, and a rear side of a rotation is provided with a lawn pushing part 3220. In some embodiments, a rear edge of a rotation the cutting blade 322 is bent downward to form the lawn pushing part 3220, thereby forming the front end of the cutting blade 322 to cut the lawn. The lawn pushing part 3220 at a rear side takes away the lawn after cutting, realizes a directional discharging of the lawn after cutting, such as side discharging, rear discharging or collection into a lawn collection box, etc., so as to avoid the lawn after cutting directly falling in place, and avoid a problem that it needs to be cleaned up separately.

The cutting blocking plate 330 is detachably fixed on the cutting deck 310, and encloses the cutter accommodating cavity, and the cutting blade 322 is arranged in the cutter accommodating cavity. In an embodiment, the cutting blocking plate 330 is detachably connected with the cutting deck 310 through the bolts, including but not limited to an installation plate with holes arranged on the cutting blocking plate 330, such as a cutting blocking plate 330 connected with a top plate of the cutting deck 310 and an installation plate perpendicular to a main body of the cutting blocking plate 330. The installation plate is parallel to the top plate of the cutting deck 310, which facilitates a detachable connection between the cutting blocking plate 330 and the top plate of the cutting deck 310 through the bolts. With different specifications of the cutting deck assemblies 300, the cutting blocking plates 330 that needs are also different. For the larger cutting deck assembly 300, the larger cutting blocking plate 330 is required. If the cutting blocking plate 330 is a whole, neither convenient for transportation, nor convenient for maintenance and replacement. In an embodiment, the cutting blocking plate 330 is made up of a plurality of single-section cutting blocking plates 330, and the cutting blocking plates 330 of different single sections are connected with each other by the bolts or directly fixed on the cutting deck 310. Compared with a whole integrated cutting blocking plate 330, a processing difficulty and a transportation difficulty of the single-section cutting blocking plate 330 are greatly reduced, an overall replacement is also not needed when replacing, and only the single-section cutting blocking plate 330 is needed to be replaced, so that the transportation and maintenance are convenient.

In an embodiment, a bottom edge of a front end of the cutting blocking plate 330 of the cutting deck assembly 300 in the forward direction is higher than a bottom edge of a rear end of the cutting blocking plate 330, which means that a height to the ground of the front end of the cutting blocking plate 330 is greater than a height to the ground of the rear end of the cutting blocking plate 330. The front end of the cutting blocking plate 330 is located at a front side of the rear end of the cutting blocking plate 330. The front end of the cutting blocking plate 330 is the cutting blocking plate 330 close to a front wheel side of the mower, and the rear end of the cutting blocking plate 330 is the cutting blocking plate close to a rear wheel side of the mower. When performing a mowing, the mower moves forward according to a predetermined trajectory, and the front end of the cutting blocking plate 330 first passes through the lawn to be mowed, then the cutting blade 332 cuts the lawn to be mowed, and the rear end of the cutting blocking plate 330 moves through this area. The bottom edge of the front end of the cutting blocking plate 330 is higher than the bottom edge of the rear end of the cutting blocking plate 330, so that the lawn is convenient to enter the cutting area, and the crushed lawn after cutting is avoided from being thrown back from the rear end of the cutting blocking plate 330. In some embodiments, a cutting height of the cutting blade 322 is flush with the front end of the cutting blocking plate 330 or slightly lower than the front end of the cutting blocking plate 330, which effectively ensures a height after cutting to be the same as an expected cutting height.

In an embodiment, the cutting blocking plate 330 includes the edge blocking plate 331 and the middle blocking plate 332. The edge blocking plate 331 is a peripheral cutting blocking plate 330, and the edge blocking plate 331 is connected into an accommodating cavity that is provided with the lawn discharging port 340. The accommodating cavity enclosed by the edge blocking plate 331 is larger, and spaces between a plurality of cutting blades 322 are not closed, which forms a lawn discharge passage. The lawn after cutting passes through the lawn discharge passage from one side far away from the lawn discharging port 340, and is finally discharged from the lawn discharging port 340. In some embodiments, the lawn discharging port 340 is arranged on a side surface of a forward direction of the cutting deck 310, and discharged lawn is avoided from splashing on a staff through a way of side discharging, which may affect the staff. The middle blocking plate 332 is detachably arranged in the accommodating cavity enclosed by the edge blocking plate 331, the accommodating cavity enclosed by the edge blocking plate 331 is separated into a plurality of smaller accommodating cavities 334, and cutting blades 332 are arranged in all of the accommodating cavities 334.

In an embodiment, there are three cutting blades 322, and the three cutting blades 322 are arranged in the triangular pattern. The middle blocking plate 332 and the edge blocking plate 331 are matched with each other to enclose and form three accommodating cavities 334. The cutting blade 322 is arranged in the accommodating cavity. In some embodiments 334, the middle blocking plate 332 may be disassembled according to needs to meet use requirements of a lawn crushing mode and a lawn discharging mode of the mower. When the mower crushes the lawn, working areas of the three cutting blades 322 are closed to each other, and the cut lawn is continuously cut and broken in the accommodating cavity 334 until it fall to the ground. In an embodiment, the middle blocking plate 332 at the connection of the accommodating cavities 334 is provided with the notch. In some embodiments, the height of the notch is set at half of the height of the middle blocking plate 332. In the lawn discharging mode, part of the middle blocking plate 332 is removed, and the accommodating cavities 334 are communicated with each other. The cut lawn moves from one side away from the lawn discharging port 340 to the lawn discharging port 340 until it is discharged from the lawn discharging port 340. In order to facilitate a discharge of crushed lawn, in an embodiment, a lawn discharging blocking plate 333 is arranged in the accommodating cavity 334 closest to the lawn discharging port 340, and the lawn discharging blocking plate 333 prevents the crushed lawn from re-entering the accommodating cavity 334 closest to the lawn discharging port 340.

In an embodiment, a lawn discharging cover 341 is arranged at the lawn discharging port 340, the lawn discharging cover 341 is detachably connected with the cutting deck 310, and the lawn discharging cover 341 enables the crushed lawn discharged from the lawn discharging port 340 moves along an established trajectory to avoid a lawn splashing. An opening of the lawn discharging cover 341 becomes larger from an inside of the cutting deck assembly 300 to an outside of the cutting deck assembly 300, which is convenient for a discharging of crushed lawn and avoids an accumulation of the crushed lawn. In some embodiments, the lawn discharging blocking plate 333 is obliquely arranged. A first end of the lawn discharging blocking plate 333 is close to the lawn discharging port 340, and a second end of the lawn discharging blocking plate 333 is arranged along an extension line of a side edge of the lawn discharging cover 341, which means that a length direction of the lawn discharging blocking plate 333 overlaps with a side edge of the lawn discharging cover 341, so that the crushed lawn is convenient for being discharged. The lawn discharging cover 341 is rotatably connected with the cutting deck 310, and in a natural state, the lawn discharging cover 341 is in a working position through an elastic component.

In an embodiment, a front end of the cutting deck assembly 300 is provided with a roller 380. In some embodiments, the roller 380 is arranged at three positions, which are respectively arranged at two ends of a front end of the cutting deck 310 and a middle of the cutting deck 310. In a process of walking, the roller 380 is in contact with the ground, and the cutting deck assembly 300 moves forward more stably in the working process, reduces a shaking, and ensures that a mowing height is consistent.

In an embodiment, a top surface of the cutting deck 310 is provided with a pedal pad 313, and the pedal pad 313 is arranged on one side of the cutting deck 310 away from the lawn discharging cover 341. When sitting on the mower, the staff may first step on the pedal pad 313 and then sit on the mower, so as to facilitate the staff to sit on the mower. In some embodiments, the pedal pad 313 is arranged on an outside of the frame 100, which means a vertical direction projection, and at least part of the pedal pad 313 is not blocked by the frame 100, so that the staff is convenient to step on. In an embodiment, a surface of the pedal pad 313 is provided with an anti-slip device, and the anti-slip device avoids a situation that the staff slips and falls when stepping on it. The anti-slip device may be an anti-skid layer covered with such as rubber on the surface, and may also anti-skid lines provided on a surface of the pedal pad, and a specific embodiment is selected according to an actual situation, which is not limited in the disclosure.

The cutting deck assembly of the mower of the disclosure has a beneficial effect of the cutting blocking plate 330 being convenient to be disassembled and replaced, which reduces maintenance cost.

In the mower of an embodiment of the disclosure, through the pulling component, the brake releasing mechanism is connected with the braking mechanism on at least two driving motors simultaneously, so as to operate the braking mechanism on different driving motors simultaneously, solve a technical problem that the brake releasing mechanism on the mower in the prior art cannot operate a plurality of braking mechanisms on the driving motor simultaneously.

Please refer to FIG. 56 through FIG. 58. The mower 1 includes the frame 100, the brake releasing mechanism 1300, a power supply device, the cutting deck assembly 300, at least the two driving motors 222 and the walking wheel 201. In an embodiment, the frame 100 of the mower 1 is provided with the brake releasing mechanism 1300, the power supply device, the cutting deck assembly 300, at least the two driving motors 222 and the walking wheel 201. The power supply device mentioned above is electrically connected with the cutting deck assembly 300 and at least two driving motors 222 respectively. In this embodiment, the driving motor 222 is used for driving the walking wheel 201 to rotate in the mower 1, and each driving motor 222 on the mower 1 is arranged on the frame 100 and is connected with the walking wheel 201 of the mower 1. The power supply device in the mower 1 supplies power for the at least two driving motors 222 to drive the walking wheel 201 to rotate through the driving motor 222 to drive the mower 1 to walk. In an embodiment, each driving motor 222 used for driving the walking wheel 201 in the mower 1 is provided with the braking mechanism 1410, and the braking mechanism 1410 can lock or release the walking wheel 201 connected with the corresponding driving motor 222 under a condition that the mower 1 is powered off. For example, when mower 1 is powered on, the user may control the driving motor 222 through the operating lever on the mower 1 to operate the mower 1 to walk forward or backward. When the mower 1 is powered off, each driving motor 222 in the mower 1 is locked under an effect of the corresponding braking mechanism 1410, so that the walking wheel 201 connected with the driving motor 222 cannot rotate, and the mower 1 is driven to maintain a stationary state. And when the user wants to move the mower 1 that is in a power-off state, the braking mechanism 1410 on each driving motor 222 on the frame 100 needs to be operated respectively, and the braking mechanisms 1410 on all the driving motors 222 on the frame 100 are released to unlock all the walking wheels 201 arranged on the mower 1, so that the mower 1 may be moved by the user.

Therefore, as shown in FIG. 57, in order to uniformly operate the braking mechanisms 1410 located on different driving motors 222, the mower 1 of the disclosure is provided with the brake releasing mechanism 1300 on the frame 100. The brake releasing mechanism 1300 is located between at least two driving motors 222 on the frame 100, and is connected with the braking mechanism 1410 on at least two driving motors 222 respectively through the pulling component 1330. In the above-mentioned arrangement mode, the brake releasing mechanism 1300 can simultaneously operate the braking mechanisms 1410 that are respectively located on at least two driving motors 222, and uniformly control the release opening or reset closing of the braking mechanisms 1410 on all driving motors 222, so that the stationary state or a movable state of the mower 1 may be switched through a single operation when the mower 1 is powered off, the user does not need to operate the brake mechanisms 1410 located on different driving motors 222 respectively when fixing or moving the mower 1, and the braking mechanisms 1410 on the different driving motors 222 can be operated uniformly through the brake releasing mechanism 1300. In an embodiment, in the stationary state, the braking mechanisms 1410 on the driving motors 222 in the mower 1 are all in a reset closing state, and all the driving motors 222 in the mower 1 are locked. The mower 1 cannot be pushed under a user's external force. In the movable state, the braking mechanisms 1410 on the driving motors 222 in the mower 1 are all in the release opening state, all the driving motors 222 in the mower 1 are unlocked, and the mower 1 can move under the user's external force drive.

Specifically, please refer to FIG. 57 through FIG. 61. The brake releasing mechanism 1300 mentioned above includes a connecting base 1310 and a pulling rod 1320. The connecting base 1310 is arranged on the frame 100 of the mower 1, and the connecting base 1310 is provided with a sleeving shaft 1312. The pulling rod 1320 includes a connecting sleeve 1321 and a rod body 1322. The pulling rod 1320 is sleeved on the sleeving shaft 1312 of the connecting base 1310 through the connecting sleeve 1321, and the rod body 1322 is arranged on the connecting sleeve 1321 and extends towards a side facing the user so that the user may easily manipulate. In an embodiment, the connecting sleeve 1321 is located between the at least two driving motors 222 on the frame 100, and the connecting sleeve 1321 is connected with the braking mechanisms 1410 on at least two driving motors 222 through the pulling component 1330 respectively. When the user operates the brake releasing mechanism 1300 of the mower 1, the connecting sleeve 1321 may be driven to rotate on the sleeving shaft 1312 by rotating the pulling rod 1320, and then the pulling component 1330 connected with the connecting sleeve 1321 is driven to move to a direction away from or close to the corresponding driving motor 222 simultaneously, so that the braking mechanisms 1410 on the at least two driving motors 222 are pulled to be release opened and reset closed at the same time.

Please refer to FIG. 57 and FIG. 61, the braking mechanism 1410 is the electromagnetic brake. The electromagnetic brake is located at a tail part of the driving motor 222 and provided with a brake releasing plate, and the brake releasing plate is connected with the pulling component 1330. In the braking mechanism 1410 of the embodiment, when the brake releasing plate is pulled away by a traction of the pulling component 1330, the electromagnetic brake is released and opened, thereby unlocking the driving motor 222, so that the walking wheel 201 connected with the driving motor 222 may rotate freely. The brake releasing plate closes the electromagnetic brake when being pulled back by the pulling component 1330 to lock the driving motor 222 and block a rotation of the walking wheel 201 connected with the driving motor 222.

Therefore, when the user rotates the pulling rod 1320 to guide the plurality of pulling components 1330 with a first end connected with the connecting sleeve 1321 to move in a direction away from the corresponding driving motor 222, the plurality of pulling components 1330 may be driven to pull the brake releasing plate at a second end simultaneously to unlock all the walking wheels 201 on the mower 1, so that the mower 1 is switched from the stationary state to the movable state. When the user rotates the pulling rod 1320 to guide the plurality of pulling components 1330 with the first end connected with the connecting sleeve 1321 to move in a direction close to the corresponding driving motor 222, the plurality of pulling components 1330 may be driven to pull the brake releasing plate at the second end to reset simultaneously to lock all the walking wheels 201 on the mower 1, so that the mower 1 is switched from the movable state to the stationary state.

Please refer to FIG. 57 through FIG. 60. In an embodiment of the disclosure, the connecting sleeve 1321 sleeved on the connecting base 1310 is located at a center position of at least two driving motors 222, and the above-mentioned at least two driving motors 222 are symmetrically arranged on a circumferential outward side of the connecting sleeve 1321.

Please refer to FIG. 57 through FIG. 59. In an embodiment, the pulling component 1330 is the clastic reset component. For example, the pulling component 1330 may be the tension spring. One end of the pulling component 1330 close to the connecting sleeve 1321 is provided with a first limiting structure 1331 matched with a shape of the connecting sleeve 1321, and the pulling component 1330 is driven by a rotation with the connecting sleeve 1321. When it moves from a relative position with the connecting sleeve 1321 to a tangent position with the connecting sleeve 1321, the first limiting structure 1331 at an end part of the pulling component 1330 may be fitted and clamped on a circumferential outer wall of the connecting sleeve 1321 to lock a relative rotation of the connecting sleeve 1321 and the pulling component 1330, so that a relative position of the connecting sleeve 1321 and the pulling component 1330 may be fixed.

Please refer to FIG. 58 through FIG. 60. In this embodiment, the pulling component 1330 connected between the connecting sleeve 1321 and the braking mechanism 1410 is always in a stretched state. When the pulling rod 1320 rotates past the releasing position, the connecting sleeve 1321 is stressed and balanced under an effect of each pulling component 1330 that is connected with the at least two driving motors 222, so that the pulling rod 1320 is maintained at the releasing position when there is no external force. While the at least two pulling components 1320 connected with the connecting sleeve 1321 are maintained in the stretched state, and the braking mechanisms 1410 on the at least two driving motors 222 are driven to be released and opened at the same time, so that the braking mechanisms 1410 on the mower 1 are all maintained in a release opening state. When the pulling rod 1320 rotates past the releasing position in an opposite direction, the connecting sleeve 1321 is contracted and reset under an effect of the pulling components 1330 connected with the at least two driving motors 222, so that the braking mechanisms 1410 on the at least two driving motors 222 are reset and closed at the same time.

Specifically, when the user rotates the pulling rod 1320 along a direction a and the pulling rod 1320 rotates past the releasing position (the direction a is a rotation direction that the connecting sleeve 1321 drives the pulling component 1330 to deviate from the corresponding driving motor 222), the plurality of pulling components 1330 connected with the connecting sleeve 1321 are attached to a circumferential outer edge of the connecting sleeve 1321 through the first limiting structure 1331. The connecting sleeve 1321 is maintained at the releasing position under a joint action of the plurality of pulling components 1330, and the plurality of pulling components 1330 connected with the connecting sleeve 1321 can continuously pull away the brake releasing plate on the driving motor 222, so that all the braking mechanisms 1410 on the mower 1 are kept in the release opening state. While when the user rotates the pulling rod 1320 along a direction b and the pulling rod 1320 rotates past the releasing position (the direction b is a rotation direction that the connecting sleeve 1321 drives the pulling component 1330 to be close to the corresponding driving motor 222), the connecting sleeve 1321 on the pulling rod 1320 resets and rotates from the releasing position to a pre-tightened position under a shrinkage traction of the plurality of pulling components 1330, and the brake releasing plates all connected with the pulling components 1330 on the mower 1 may be automatically reset when it is not subjected to a sufficient traction force of the pulling components 1330. And the brake releasing plates of the braking mechanisms 1410 are reset and close the corresponding electromagnetic brake because of a pre-tightened force of the pulling components 1330 when the connecting sleeve 1321 rotates to the pre-tightened position, thereby locking the walking wheel 201 connected with the driving motor 222.

For example, in this embodiment of the disclosure, there are two driving motors 222 arranged on the mower 1, and the two driving motors 222 are symmetrically arranged on both sides of the connecting sleeve 1321. Please refer to FIG. 58. When the mower 1 that is powered off is in the stationary state, the pulling rod 1320 of the brake releasing mechanism 1300 is in the pre-tightened position, and the pulling component 1330 connecting the connecting sleeve 1321 and the two braking mechanisms 1410 is in a tensile pre-tightened state. A pre-tightened torque of the pulling component 1330 on the brake releasing plate on the electromagnetic brake is from 150N to 100 N, and the pre-tightened torque of the pulling component 1330 to the brake releasing plate does not pull the brake releasing plate, but may tighten and fix the brake releasing plate. Please refer to FIG. 59 and FIG. 60. When the user wants to move the mower 1 in the power-off state, the pulling rod 1320 is rotated along the direction a. When the pulling rod 1320 rotates to a middle position between the pre-tightened position and the releasing position, a torque of the pulling component 1330 connected with the connecting sleeve 1321 to the brake releasing plate on the electromagnetic brake is from 220N to 250N, the brake releasing plate is still not pulled at this time, the electromagnetic brake still cannot be released, and the mower 1 is still in the stationary state. The pulling rod 1320 continues to be rotated along the direction a, when the pulling rod 1320 turns past the releasing position, the two pulling components 1330 on the connecting sleeve 1321 are clamped on the circumferential outer wall of the connecting sleeve 1321 through their respective first limiting structures 1331 relatively. The connecting sleeve 1321 is balanced under a relative force of the two pulling components 1330 and remains in the stationary state, so that the pulling rod 1320 is spontaneously maintained at the releasing position without user's operation. While at the releasing position, the two pulling components 1330 connected with the connecting sleeve 1321 on the pulling rod 1320 are in the stretched state, and a torque of the two pulling components 1330 to the brake releasing plate that is respectively connected with the two pulling components 1330 is from 390N to 420N. The brake releasing plate of two driving motors 222 on the mower 1 is pulled away by the stretched pull components 1330, the electromagnetic brakes of two driving motors 222 on the mower 1 are all released, and the mower 1 is switched to the movable state from the stationary state, so that it can be moved by the user.

In addition, when the user needs the mower 1 to continue to maintain the stationary state, the pulling rod 1320 may be rotated along the direction b past the releasing position. The connecting sleeve 1321 on the pulling rod 1320 is automatically rotated back to the pre-tightened position by a contraction traction force of the two pulling components 1330, and the brake releasing plate connected with the pulling component 1330 is also automatically resets because it is not subjected to the sufficient traction force of the pulling component 1330, and the corresponding electromagnetic brake is locked and closed, which realizes a switching of the mower 1 from the movable state to the stationary state.

Please refer to FIG. 61. In an embodiment of the disclosure, the brake releasing mechanism 1300 is arranged at the bottom of the frame 100 of the mower 1. In an embodiment, the connecting base 1310 is arranged at the bottom of the frame 100 of the mower 1 through an installation base 1311, a top of the connecting base 1310 is connected with the installation base 1311 through the bolts, and the installation base 1311 is bolted to a bottom surface of the frame 100.

Please refer to FIG. 61 and FIG. 60. In an embodiment of the disclosure, a fixing end 1323 is arranged on an outer side of the connecting sleeve 1321, a number of the fixing ends 1323 is the same as a number of the driving motors 222, and the fixing end 1323 extends outward along a radial direction of the connecting sleeve 1321. When the connecting sleeve 1321 is in a reset position, each fixing end 1323 of the connecting sleeve 1321 is opposite to the respective corresponding driving motor 222.

Please refer to FIG. 61 and FIG. 62. In this disclosure, a first end of the pulling component 1330 is connected with the fixing end 1323 fixed on the connecting sleeve 1321, and fixed in a fixing hole of the fixing end 1323, and a second end of the pulling component 1330 is provided with a thread, and connected with the braking mechanism 1410 through threading.

Please refer to FIG. 61. In an embodiment of the disclosure, the connecting sleeve 1321 is sleeved on the sleeving shaft 1312 of the connecting base 1310 by a separating sleeve 1313, and the separating sleeve 1313 is clamped on a second limiting structure of the sleeving shaft 1312. Specifically, the separating sleeve 1313 is arranged at two ends of the connecting sleeve 1321, and the separating sleeve 1313 at two ends of the connecting sleeve 1321 is sleeved on the sleeve shaft 1312 and clamped on the second limiting structure of the sleeving shaft 1312. In an embodiment, the separating sleeve 1313 at a top of the connecting sleeve 1321 is against the clamping groove 1314 of the sleeving shaft 1312, and the separating sleeve 1313 at a bottom of the connecting sleeve 1321 is against a nut 1316 that is tightly connected with the sleeving shaft 1312. The nut 1316 and the clamping groove 1314 on the sleeve shaft 1312 are matched and clamped with the separating sleeve 1313 at both ends of the connecting sleeve 1321 as the second limiting structure and clamp to limit and fix the connecting sleeve 1321 on the sleeving shaft 1312. In addition, in this embodiment, a gasket 1315 is further arranged between the separating sleeve 1313 at the bottom of the connecting sleeve 1321 and the nut 1316.

It should be noted that, a type of the mower 1 may not be limited, for example, as shown in FIG. 56, in an embodiment of the disclosure, the mower 1 is a stand-on mower.

The brake releasing mechanism 1300 on the mower 1 may further be applied to other garden tools. The garden tool includes the frame 100, the brake releasing mechanism 1300, the power supply device, a working assembly, at least the two driving motors 222 and the walking wheel 201. In an embodiment, The frame 100 of garden tool is provided with the brake releasing mechanism 1300, the power supply device, the working assembly, the at least two driving motors 222 and the walking wheel 201, and the power supply device is electrically connected with the working assembly and the at least two driving motors 222 respectively. In this embodiment, the driving motor 222 is used for driving the walking wheel 201 to rotate in the mower 1, and each driving motor 222 on the mower 1 is arranged on the frame 100 and is connected with the walking wheel 201 of the garden tool. The power supply device in the garden tool supplies power for the at least two driving motors 222 to drive the walking wheel 201 to rotate through the driving motor 222 to drive the garden tool to walk. In an embodiment, each driving motor 222 used for driving the walking wheel 201 in the garden tool is provided with the braking mechanism 1410, and the braking mechanism 1410 can lock or release the walking wheel 201 connected with the corresponding driving motor 222 under the condition that the garden tool is powered off. For example, when garden tool is powered on, the user may control the driving motor 222 through the operating lever on the garden tool to operate the garden tool to walk forward or backward. When the garden tool is powered off, each driving motor 222 in the garden tool is locked under the effect of the corresponding braking mechanism 1410, so that the walking wheel 201 connected with the driving motor 222 cannot rotate, and the garden tool is driven to maintain the stationary state. And when the user wants to move the garden tool that is in the power-off state, the braking mechanism 1410 on each driving motor 222 on the frame 100 needs to be operated respectively, and the braking mechanisms 1410 on all the driving motors 222 on the frame 100 are released to unlock all the walking wheels 201 arranged on the garden tool, so that the garden tool may be moved by the user.

Therefore, in order to uniformly operate the braking mechanisms 1410 located on the different driving motors 222, the garden tool of the disclosure is provided with the brake releasing mechanism 1300 on the frame 100. The brake releasing mechanism 1300 is located between the at least two driving motors 222 on the frame 100, and is connected with the braking mechanism 1410 on the at least two driving motors 222 respectively through the pulling component 1330. In the above-mentioned arrangement mode, the brake releasing mechanism 1300 can simultaneously operate the braking mechanisms 1410 that are respectively located on the at least two driving motors 222, and uniformly control the release opening or reset closing of the braking mechanisms 1410 on all driving motors 222, so that the stationary state or the movable state of the garden tool may be switched through the single operation when the garden tool is powered off, the user does not need to operate the brake mechanisms 1410 located on different driving motors 222 respectively when fixing or moving the garden tool, and the braking mechanisms 1410 on the different driving motors 222 can be operated uniformly through the brake releasing mechanism 1300. In an embodiment, in the stationary state, the braking mechanisms 1410 on the driving motors 222 in the garden tool are all in the reset closing state, and all the driving motors 222 in the garden tool are locked. The garden tool cannot be pushed under the user's external force. In the movable state, the braking mechanisms 1410 on the driving motors 222 in the garden tool are all in the release opening state, all the driving motors 222 in the garden tool are unlocked, and the garden tool can move under the user's external force drive.

It should be noted that, a type of working assembly used in the above-mentioned garden tool may be unlimited, and the above-mentioned working assembly may be the cutting deck assembly, a snow throwing assembly, a blower and a sowing assembly and other working components.

In the mower and garden tools of the disclosure, the pulling rod for user operation is sleeved on the connecting base, and the connecting sleeve on the pulling rod is connected with the braking mechanism on the at least two driving motors simultaneously through the pulling component, so as to ensure that the user can simultaneously operate and pull the braking mechanism on the at least two driving motors to release open or reset close when rotating the pulling rod. The brake releasing mechanism adopted by the mower is simple and clear in structure, which is convenient and fast to operate. The braking mechanisms located on the at least two driving motors can be operated at the same time during use, so as to realize simultaneous release opening and reset closing of the braking mechanisms on different driving motors, which effectively improves user's experience.

In an embodiment, the mower 1 includes the placing platform 900, and the placing platform 900 is arranged on the frame 100.

The mower 1 of the disclosure is provided with the placing platform 900 on the mower 1, which increases a load capacity of the mower in an operation process and is convenient for the staff to randomly configure auxiliary tools or other articles, so that the staff has reduced labor effort in the mowing process, and increased a convenience of the mower when using.

In an embodiment of the disclosure, the placing platform 900 is provided with a flange 912, and the flange 912 is located on a rear edge of the placing platform 900. The flange 912 prevents objects from slipping and is easy to hold to lift the placing platform 900. At the same time, the flange 912 can effectively increase a strength of the placing platform 900 and the load-bearing capacity of the placing platform 900.

In an embodiment of the disclosure, a plurality of friction protrusions 913 is arranged on the placing platform 900. A middle part of each friction protrusion 913 is provided with a through hole, and the through hole is mainly set up for two purposes: firstly, it can effectively reduce a weight of a storage board, and secondly, the through hole can play a role of ventilation in order to maintain a dryness of a storage cavity 920.

In an embodiment of the disclosure, the mower 1 further includes a casing 101 installed on the frame 100, and a cup groove 521 is arranged on the casing 101. The casing 101 is further provided with a storage space, and the storage space is located at a side of the driving seat. A port is arranged in the storage space, a dust-proof cover 522 covers above the port, and the dust-proof cover 522 may be rotatably installed on the casing 101. The dust-proof cover 522 van effectively protect the port. The port may be a USB port, a type-c port and a micro port and so on. There is further a wireless charging base in the storage space for wireless charging of a hand-held terminals (such as a mobile phone).

In an embodiment of the disclosure, the casing 101 is provided with an operating deck 162, the operating deck 162 is provided with an operating key, and the operating key is configured to realize an operation of the mower 1, such as a speed or a light of the mower 1, etc. The operating deck is further provided with the display screen 530. The display screen 530 is tilted and arranged.

In an embodiment of the disclosure, the casing 101 is further provided with a tail light (not labeled), and the tail light is oriented towards a rear part of the mower 1 and is located at a position below the placing platform 900 to play a role of indication, warning and the like.

In an embodiment of the disclosure, the walking wheel 201 includes the front wheel assembly 210 and the rear wheel assembly 220. The front wheel assembly 210 is the universal wheel, and the rear wheel assembly 220 is driven by the walking motor. A radius of the front wheel assembly 210 is less than a radius of the rear wheel assembly 220. The large radius of the rear wheel assembly 220 ensures that the mower 1 has enough horsepower.

In an embodiment of the disclosure, a lawn outlet of the cutting deck assembly 300 is provided with the lawn discharging cover 341, and two sides of the lawn discharging cover 341 are provided with a flange that bends downward. A function of the lawn discharging cover 341 is to drain crushed lawn clippings at the lawn outlet, and the flange on both sides of the lawn discharging cover 341 can effectively prevent the crushed lawn clippings from flying during a discharging process.

In an embodiment of the disclosure, the lawn discharging cover 341 is rotatably installed on the frame 100, and a torsion spring 343 is arranged between the frame 100 and the lawn discharging cover 341. The crushed lawn clippings carry moisture and may easily stick to an inside of the lawn discharging cover 341, so when it is necessary to clean the inside of the lawn discharging cover 341, the lawn discharging cover 341 needs to be turned over and cleaned. After cleaning, the lawn discharging cover 341 is reset under an action of the torsion spring 343.

In an embodiment of the disclosure, the lawn discharging cover 341 is installed on the frame 100 by two installation plates 342. A plurality of bolts are arranged between the two installation plates 342, the lawn discharging cover 341 is installed between the two installation plates 342 through the plurality of bolts, and the two installation plates 342 are rotatably installed on the frame 100.

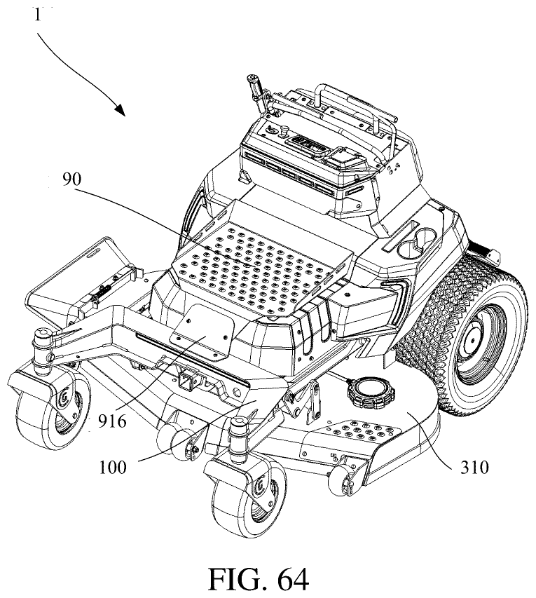

Please refer to FIG. 64. In an embodiment of the disclosure, the placing platform 900 is arranged in a middle part of the frame 100, the placing platform 900 is provided with the connecting plate 916, and the connecting plate 916 is connected with the frame 100. The connecting plate 916 can effectively increase a firmness of the placing platform 900. The tail part of the frame 100 of the standing mower is provided with a standing board.

Please refer to FIG. 64. In an embodiment of the disclosure, three flanges are arranged on the placing platform 900. The three flanges enclose the placing platform 900 into a frame body with one side opening, which enables it to be easy to store things and increase a strength of the placing platform 900. The placing platform 900 is provided with a friction protrusion, the friction protrusion protrudes upward, and a through hole is arranged in the friction protrusion. The through holes can reduce the weight of the entire placing platform 900 and facilitate a heat dissipation for electrical equipment (e.g., motors, control boards, batteries, etc.) below the placing platform 900. The mower 1 of the disclosure is provided with the placing platform 900 on the mower 1. The placing platform 900 is configured to place auxiliary equipment or personal belongings of the staff. When the mower 1 is a riding mower 1, the placing platform 900 is placed at a tail part of a machine body, and the storage cavity 920 is arranged below it, so that upper and lower layers of a storage system are formed. In an embodiment, the storage cavity 920 is used for placing small items, such as mobile phones, etc., and the placing platform 900 is used for placing large items, such as the auxiliary equipment, etc. When the mower 1 is the standing mower 1, the placing platform 900 is arranged in the middle part of the frame 100, an opening-shaped frame body is formed by arranging the flanges 912 at three edges, and the frame body is used for placing items.

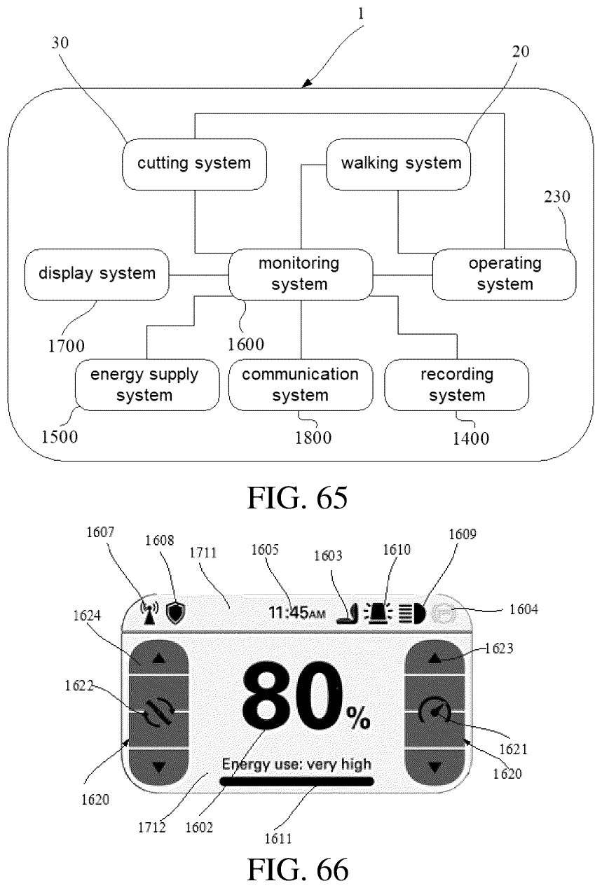

Please refer to FIG. 65. The mower in an embodiment of the disclosure includes the machine body 10 and a cutting system 30, a walking system 20, an operating system 230, a recording system 1400, an energy supply system 1500, a monitoring system 1600 and a display system 1700 installed on the machine body 10. In an embodiment, the cutting system 30 includes at least one cutter and one cutter driving device for mowing. The walking system 20 includes the walking wheel 201 for a movement of the mower 1 and a driving device of the walking wheel 201. The operating system 230 includes an operation device for operating and controlling the mower 1, and the operation device is provided with a speed regulation key. A regulation of the speed regulation key according to a setting method can set a walking speed or a cutting speed of a cutting machine, such as setting a gear of the walking speed or the cutting speed. In an embodiment of the disclosure, the recording system 1400 includes a memory that is used for recording fault information of the mower 1 and corresponding fault handling measures, warning information and stage mowing information. The energy supply system 1500 includes at least one battery pack. The monitoring system 1600 is used for monitoring states about the cutting system 30, the walking system 20, the operating system 230, the recording system 1400 and the energy supply system 1500. The display system 1700 includes the display screen 530 for displaying monitoring results and parameter settings of the monitoring system 1600. The display screen 530 is tilted on the machine body, and an inclination angle range is from 30 degrees to 60 degrees, for example, 45 degrees.

The monitoring results include state information as well as working information. The monitoring results may all be displayed by the display screen 530. The monitoring results may be displayed through text, icons, etc. The working information includes identification information of the walking speed and the cutting speed, and the identification information includes a speed identification and a speed regulation identification. The speed identification includes a walking speed identification and a cutting speed identification, and the speed regulation identification includes a walking speed regulation identification and a cutting speed regulation identification. The display screen 530 can display the identification information of the walking speed and the cutting speed, and a regulation of the speed regulation identification can set the gear of the walking speed or the cutting speed.

In an embodiment of the disclosure, the state information includes at least one of an operator in-position state 1603, a closing state and releasing state 1604 of an electromagnetic brake, time 1605 in a current time zone, a cellular signal state 1607, a remote control state 1608, a lighting device state 1609, an alarm light state 1610, and a project name. The project name may be a name of an item in working information. For example, the project name may be light, setting, stage working information, and so on.

In the embodiment of the disclosure, the working information includes states of battery power 1602, a charging remaining time, an estimated time of a full charging, an external tool state 1601, a device energy consumption state 1611, a device use time 1612, a fault reminding 1613 and other states. The device use time 1612 includes a total use time of the device, a use time of the cutting system 30, and a use time of a knife blade. The working information may all be displayed by the display screen 530.

In an embodiment, the fault reminding 1613 includes the fault information 1614 and the corresponding fault handling measures 1615, and the fault information includes a fault code and corresponding fault details. The working information further includes the stage working information, which includes: an operating area, a working time, and an average speed. The working information further includes pause reminding information, and the pause reminding information includes a pause time period.

In an embodiment of the disclosure, the mower 1 further includes a lighting device and an alarm light, the lighting device and the alarm light are arranged on the machine body of the mower 1. The lighting device is configured to provide lighting or light display, and alarm lights are configured to alarm. The monitoring system 1600 is configured to monitor a working state of the lighting device.

Please refer to FIG. 65. In an embodiment of the disclosure, the operating system further includes a communication system 1800. The monitoring system 1600 further monitor the communication system 1800. The monitoring system 1600 further monitors the communication system 1800. The device is located by a GPS positioning of the communication system 1800. Device information is collected and sent to a cloud through a cellular network, and a remote user may check a device state through a mobile phone or a computer.

Please refer to FIG. 66. In an embodiment of the disclosure, the working information includes the external tool state 1601. The external tool state 1601 includes whether there is an external tool and whether the external tool is turned on or off. The mower 1 further includes a port to connect the external tool, and the monitoring system 1600 is further configured to control whether to start the external tool when it is detected.

In an embodiment of the disclosure, the operating system 230 further includes the operating lever 2312 for operating and controlling the walking system 20. The operating lever 2312 is rotatably installed on the machine body, and a rotation angle of the operating lever 2312 is positively correlated with the walking speed. The rotation angle refers to an angle between an initial position of the operating lever 2312 and a current position. When the operating lever 2312 is at the initial position, the walking speed of the mower is zero. When a position of the operating lever 2312 is in an extreme position (the rotation angle is largest at this time), the walking speed of the mower is a maximum value corresponding to a gear of a current walking speed. A number of the operating levers 2312 is two, the two operating levers 2312 control driving wheels at corresponding sides of the walking system respectively, and a walking direction of the mower is adjusted by enabling a rotation angle difference of the two operating levers 2312. The walking speed and the rotation angle of the walking system 20 can be operated and controlled by the operating lever 2312.

Each operating lever 2312 is respectively provided with the speed regulation key, one of operating lever 2312 is provided with the walking speed regulation key, and a cutting speed regulation key is arranged on the other operating lever 2312. The speed regulation key is located at an end of the operating lever 2312, and a moving direction of the speed regulation key is along a direction of a holding part of the operating lever 2312. When the operator holds the operating lever tightly, a thumb is naturally located at the end of the operating lever 2312, the operator only needs to move and press with the thumb to a palm direction at this time, and then a regulation of the speed is completed, which is ergonomic.

In an embodiment, the speed regulation key is divided into three gears of a high gear, a medium gear and a low gear, which can regulate a maximum value of walking speed or cutting rotating speed. When the speed is regulated by using the speed regulation key, a regulation result is displayed synchronously on the display system. At the same time, the speed regulation identification on the display screen can also regulate a rotating speed of the blade and the cutting machine.

Please refer to FIG. 66. In an embodiment of the disclosure, the operating system further includes a plurality of operating buttons. Through the operating buttons, it can be realized a turning on and off of the lighting device, a turning on and off of the alarm light, a start and stop of the external tool, a reset of a knife blade use time, a selection of language, a conversion of a unit, a brightness regulation of the display screen 530, and a statistics of a staged mowing area, a mowing time and an average speed. A side of the display screen 530 is further provided with a cutting switch 231. When the operator is in position, a starting cutting switch may start the cutting system to mow. It should be noted that, when the operator is not in position, even if the cutting switch is started, the cutting system cannot be started. The cutting system can only be started after the operator is in position and starts the cutting switch, and this starting mode avoids the cutting system being started by mistake, which increases a safety of the mower.

In an embodiment of the disclosure, the speed regulation key may be a separating type structure. The speed regulation key includes the cutting speed regulation key and the walking speed regulation key. In an embodiment, the cutting speed regulation key includes the speed regulation key of a cutting acceleration key and a cutting deceleration key. The walking speed regulation key includes a walking acceleration key and a walking deceleration key. When pressing the speed regulation key, a corresponding speed regulation identification on the display screen 530 will be lit. For example, when the walking acceleration key is configured to accelerate the walking system 20 of the cutting machine, an acceleration identification corresponding to the walking speed identification is lit. In addition, the speed regulation key may also be an integrated structure, and the above functions may be realized through a touch screen or a swing mode.

Please refer to FIG. 65. The mower of an embodiment of the disclosure includes the display system 1700. The display system 1700 includes the display screen 530. The display screen 530 is arranged on the machine body. The display screen is configured to display identification information 1620 of the walking speed and a working speed, and the identification information includes: the speed identification and the speed regulation identification, and the walking speed or the working speed of the machine body can be set through the speed regulation identification.

In an embodiment of the disclosure, the display screen 530 includes a state display area 1711 and a working display area 1712, the state display area 1711 is used for displaying state information, the working display area 1712 is used for displaying working information, and the working information includes the identification information. In an embodiment, the state display area is located in an upper area of the display screen in a form of a horizontal bar, and a rest area of the display screen is the working display area.

In an embodiment of the disclosure, the state information includes at least one of an operator in-position state 1603, the closing state and releasing state 1604 of the electromagnetic brake, time 1605 in the current time zone, the cellular signal state 1607, the remote control state 1608, the lighting device state 1609, the alarm light state 1610, and the project name. The project name may be the name of the item in the working information. For example, the project name may be light, setting, stage working information, and so on.

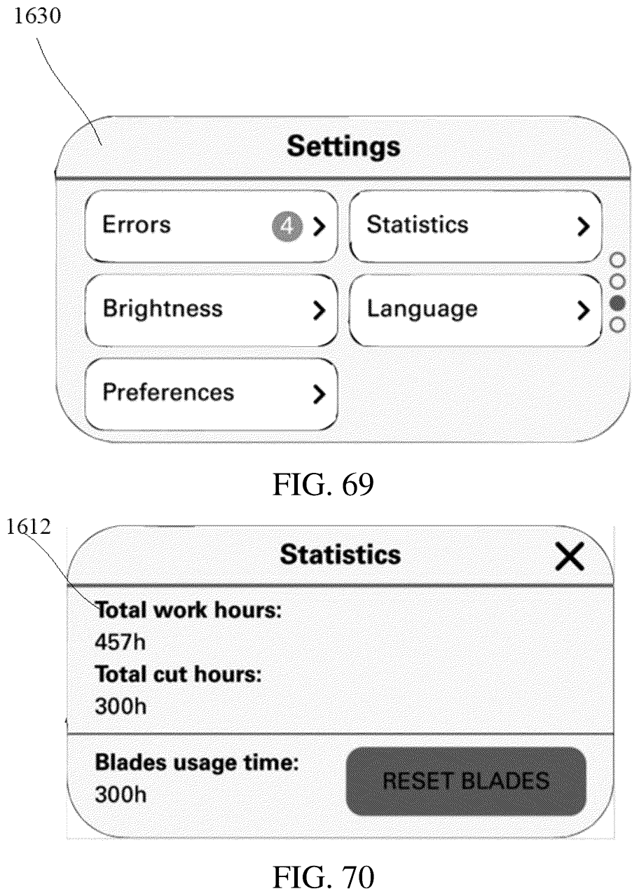

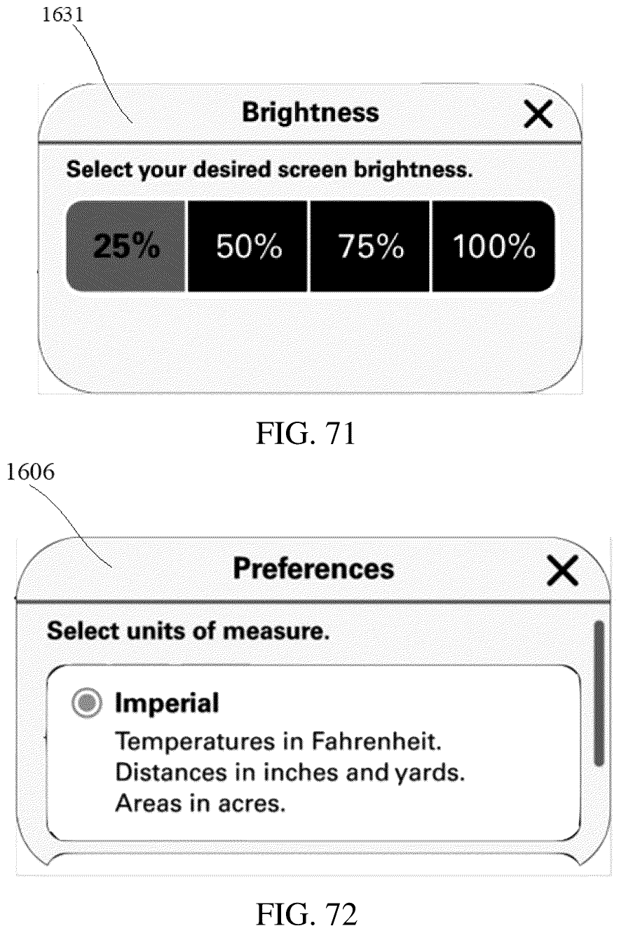

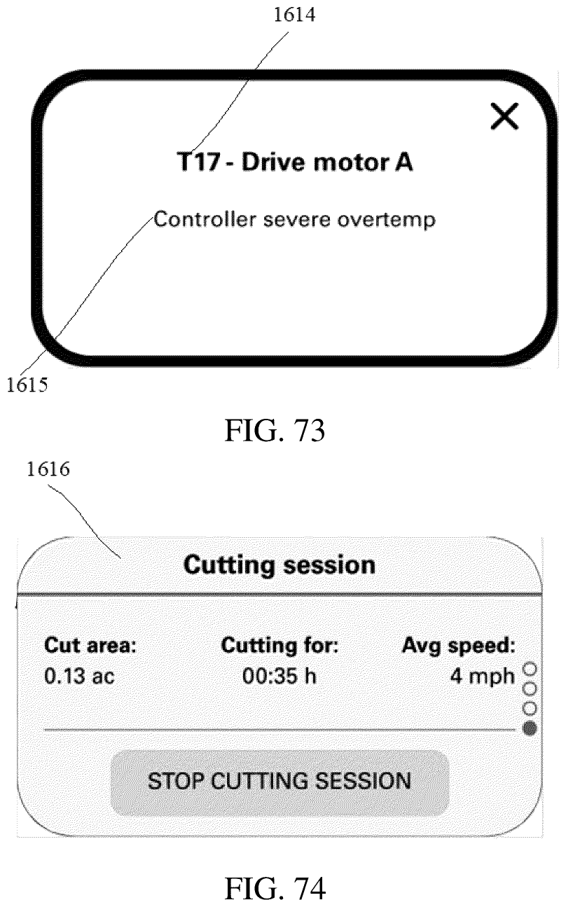

Please refer to FIG. 65 and FIG. 69. In an embodiment of the disclosure, the display screen 530 may be a touch screen, and a device parameter 1630 can be set through the display screen 530. The device parameter 1630 includes language, screen brightness 1631, unit conversion 1606 and statistical parameter etc. The statistical parameter includes a cumulative use time of a blade strip, a cumulative use time of the device, and a cumulative use time of the cutting system 30. The display screen 530 is further provided with a blade strip reset key. The blade strip reset key is configured to reset the use time of the blade strip. When replacing the blade strip, the accumulated usage time of the previous blade strip may be reset to zero through the blade strip reset key. The screen brightness 1631 increases in steps of 25%.

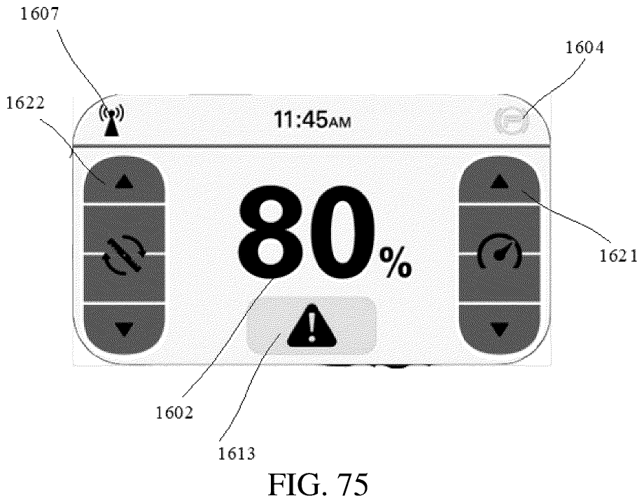

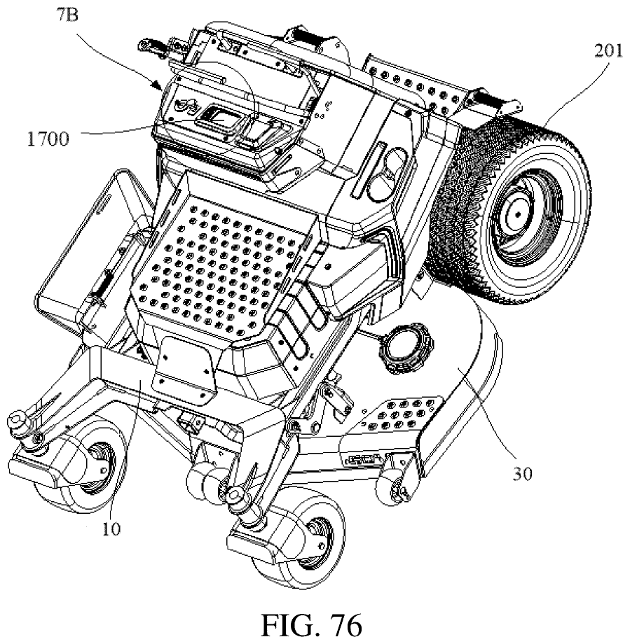

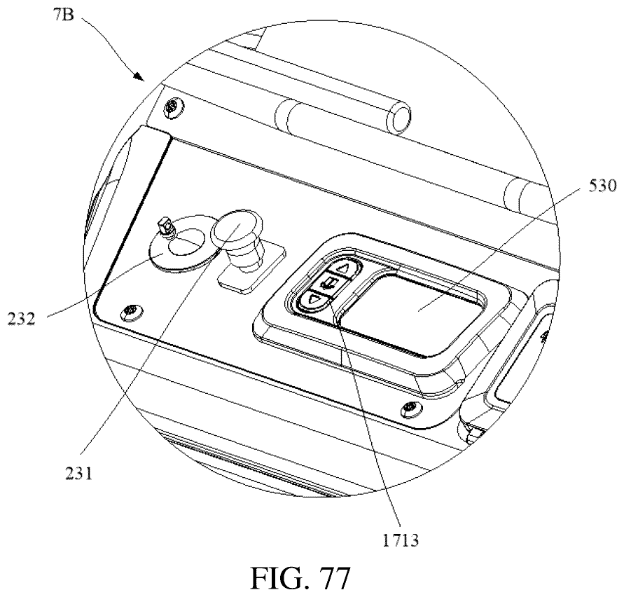

Please refer to FIG. 75 through FIG. 77. In an embodiment of the disclosure, the display screen 530 can display power information, and different states will be displayed below the power information. For example, when a fault occurs, the fault reminding is displayed, and a fault detail interface may be viewed through directly clicking the fault reminding. The side of the display screen 530 is further provided with an interface switching key 1713 and a main switch 232, and a switching of a display interface can be realized through the interface switching key. The interface switching key 1713 may be a touch key. The main switch 232 is provided with a safety key. A lower part of the safety key is a magnet, and a sensor is arranged at a key base to sense the magnet. If the safety key is not inserted, the main switch cannot be activated.

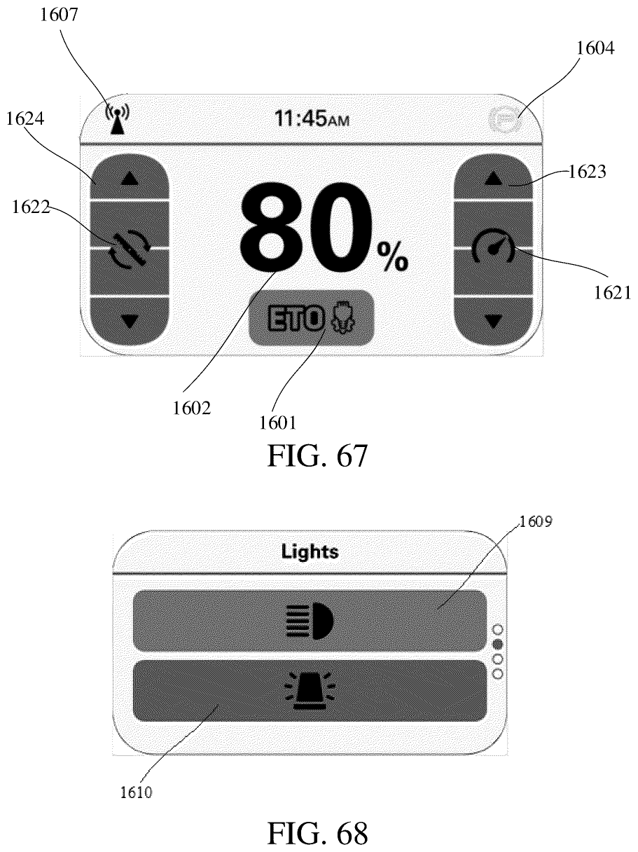

Please refer to FIG. 65 and FIG. 67. The external tool state 1601 includes whether there is the external tool and whether the external tool is turned on or off. The mower 1 further includes the port to connect the external tool, and the monitoring system 1600 is further configured to control whether to start the external tool when it is detected.

In an embodiment of the disclosure, the working information further includes the stage working information 1616, which includes: the operating area, the working time, and the average speed. The monitoring result further includes the pause reminding information, and the pause reminding information includes the pause time period.

The system of the mower may also be applied to other garden tools. The garden tool includes the machine body, a working system, the walking system, the operating system, the recording system, the energy supply system, the monitoring system and the display system installed on the machine body. In an embodiment, the working system includes at least one tool for use in the work and a tool driving device. The walking system includes the walking wheel and the walking wheel driving device that are used for enable the garden tool to move. The operating system includes the operation device for controlling the garden tool, and the operation device is provided with the speed regulation key. The walking speed or the working speed can be set by the speed regulation key. The recording system includes a memory that is used for recording fault information of the garden tool and corresponding fault handling measures, warning information and stage working information. The energy supply system includes at least one energy pack. The monitoring system is used for monitoring states about the working system, the walking system, the operating system, the recording system and the energy supply system. The display system includes the display screen for displaying monitoring results and parameter settings of the monitoring system. The display screen is tilted on the machine body. The inclination angle range is from 30 degrees to 60 degrees, for example, 45 degrees.

The monitoring results include state information as well as working information. The monitoring results may all be displayed by the display screen 530. The monitoring results may be displayed through the text, the icons, etc. The working information includes the identification information of the walking speed and the cutting speed, and the identification information includes the speed identification and the speed regulation identification. The speed identification includes the walking speed identification and an operation speed identification, and the speed regulation identification includes the walking speed regulation identification and a working speed regulation identification. The display screen can display the identification information of the walking speed and the cutting speed, and a regulation of the speed regulation identification can set the walking speed or the cutting speed.

The display system 1700 of the disclosure can display states of the battery power 1602, the operator in-position state 1603, the closing state and the releasing state of the electromagnetic brake 1604, the time in current time zone 1605, the cellular signal state 1607 (2/3/4G and so on), the remote control state 1608, the charging remaining time, the estimated time of the full charging, the lighting device state 1609, the alarm light state 1610, the external tool state 1601, a speed gear of the walking system 1621, a speed gear of the cutting system 1622, the device energy consumption state 1611, the device use time 1612, the fault reminding 1613, a detail fault code 1614, an advice of fault handling measure 1615 and other states. The device use time 1612 includes the total use time of the device, the use time of the cutting system 30, and the use time of the knife blade. Therefore, the disclosure realizes a centralized management of functions of the garden tool, and improves a visualization degree of the functions.

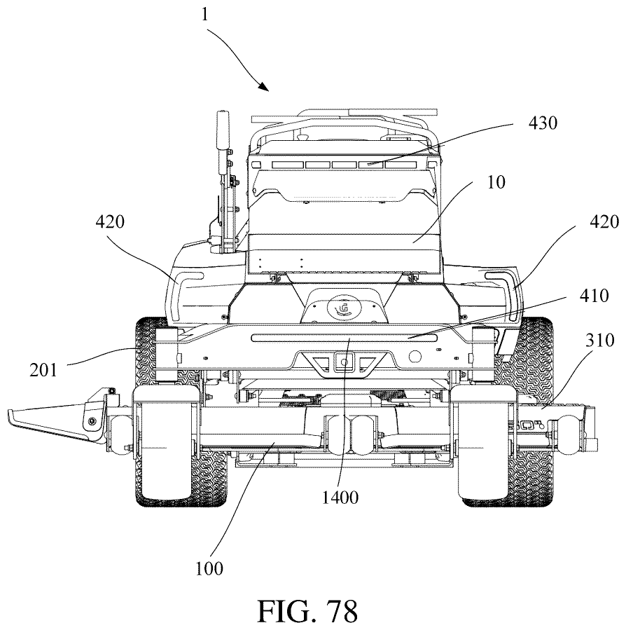

Please refer to FIG. 78. In an embodiment, the mower 1 further includes a light group 400. In an embodiment, the light group 400 is arranged on the machine body and is electrically connected with the controller. And it will be lit up according to a preset lighting method under a control of the controller. The light group 400 is provided with at least one lighting method, and the lighting method of the light group 400 corresponds to the state of the mower. For example, the state of the mower corresponding to the different lighting method of the light group 400 is different, and in a certain embodiment, the lighting method of the light group 400 corresponds to the state of the mower 1 one-to-one.

The mower 1 further includes a functional assembly and the operating assembly. In an embodiment, an energy supply assembly includes the battery pack to supply energy to the mower 1. The operating assembly includes an operating panel and the operating keys arranged on the operating panel to realize an operating and controlling of the mower 1. The mower 1 further includes the walking motor. The walking motor drives the walking wheels 201 to roll to enable the mower 1 to move as it operates.

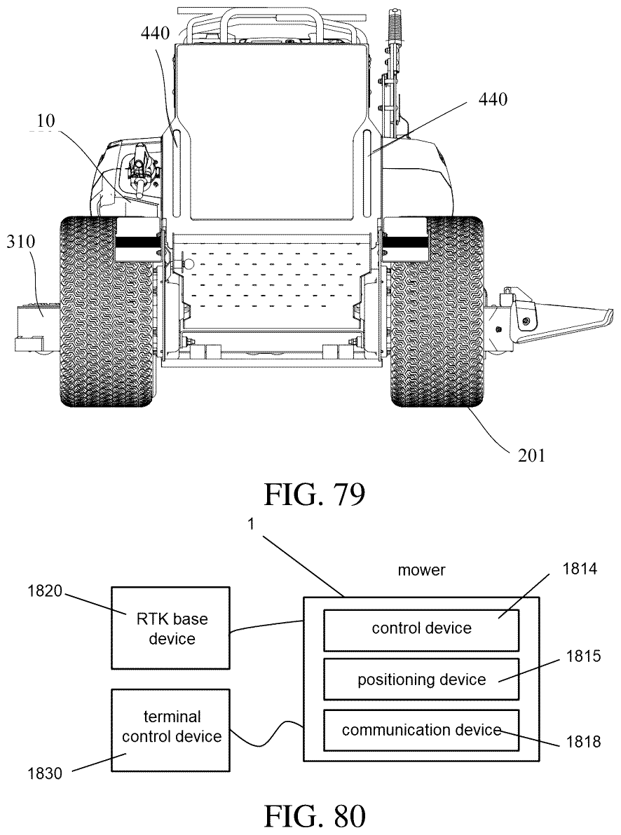

Please refer to FIG. 78 through FIG. 79. In an embodiment of the disclosure, the light group 400 includes at least one of a headlight 410, a side light 420, a dome light 430 or a tail light 440.

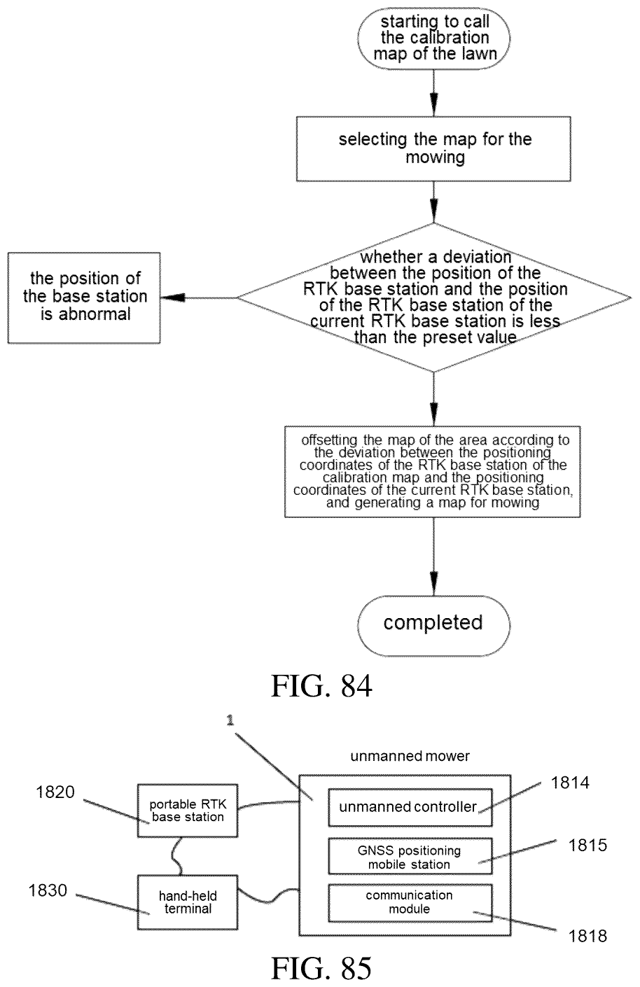

Please refer to FIG. 84. In an embodiment of the disclosure, the headlight 410, the side light 420 or the dome light 430 is a white light. The headlight 410, the side light 420 or the dome light 430 includes a light cover and a light bead arranged inside the light cover, and the light cover of the headlight 410, the side light 420 or the dome light 430 emits a white light with the light beads. For example, the light bead is white, and the light cover is transparent.

Please refer to FIG. 78. In an embodiment of the disclosure, a green light bead is further arranged in the light cover of the headlight 410, the light cover of the side light 420 or the light cover of the dome light 430, and the green light bead can emit a green light. Therefore, the headlight 410, the side light 420 or the dome light 430 may emit the green light according to a control command of the controller.

Please refer to FIG. 79. In an embodiment of the disclosure, the tail light 440 is a red light, the tail light 440 includes a tail light cover and a tail light bead arranged inside the tail light cover, and the tail light cover and the light bead of the tail light cooperate with each other to emit a red light externally. For example, the tail light cover is red, and the tail light bead is white or red.

Please refer to FIG. 78 and FIG. 79. In an embodiment of the disclosure, the headlight 410 of mower 1 is arranged on a front side of machine body 10 and is located at a front of the frame, and the headlight 410 faces forward. The side light 420 is arranged at left and right directions of the front side of machine body 10. The dome light 430 is arranged at a top of machine body 10 and faces forward. The tail light 440 is arranged at left and right directions of a tail part of the casing, and the tail light includes two light bars parallel to each other. Each light bar is arranged from top to bottom, and the two light bars are respectively located at the left and right directions of the tail part respectively.

In the mower, the side light 420 may be a long strip of light bar, and the two side lights 420 are arranged in parallel on the left and right directions of the front side of the machine body 10 at this time. In another embodiment, the side light 420 may be similar to the side light 420 of the riding mower 1. The two side lights are symmetrical, each side light 1420 includes a first light bar and a second light bar, and the first light bar and the second light bar intersect with each other and are smoothly transitioned.

In an embodiment of the disclosure, the state of the mower 1 include a charging state, a charging completion state, a low power state, a light on state, or a light off state.

In an embodiment of the disclosure, the state of the mower 1 further includes a plurality of fault states. The fault state may include a fault device and a number of faults. For example, a right driving controller has two faults, a left blade controller has two faults, etc.

The mower 1 of the disclosure is provided with the light group 400 and the controller. The light group 400 will be lit up according to a preset lighting method under a control of the controller. The lighting method of the light group 400 corresponds to the state of the mower one-to-one. The light group 400 is arranged on the machine body 10, so a lighting of the light group 400 may be viewed from a long distance. And the lighting method of the light group 400 corresponds to the state of the mower 1 one-to-one, so a current state of the mower 1 may be known by viewing a light form of the light group 400 from the long distance.

The mower 1 of an embodiment of the disclosure includes a light indication system. The light indication system includes the controller and the light group 400. In an embodiment, the light group 400 is electrically connected with the controller, and lit according to the preset lighting method under the control of the controller. The light group 400 has at least one lighting method, and the lighting method of the light group 400 corresponds to the state of the mower. The light indication system is installed on the device.

The light indication system of the mower of the disclosure may further be applied to other garden tools. The garden tool includes the machine body 10, the walking wheel 201, the working assembly, a working motor, the controller and the light group 400. In an embodiment, the machine body 10 includes the frame 100. The walking wheel 201 is rotatably installed on the frame 100. The working assembly is arranged on the frame 100. The working motor is arranged on the frame 100 and is connected with the working assembly. The controller is arranged inside the machine body 10 and is electrically connected with the working motor. The light group 400 is arranged on the machine body 10, electrically connected with the controller, and lit according to the preset lighting method under the control of the controller. The light group 400 has at least one lighting method, and the lighting method of the light group 400 corresponds to a state of the garden tool.

The garden tool further includes the functional assembly and the operating assembly. In an embodiment, an energy supply assembly includes the battery pack to supply energy to the garden tool. The operating assembly includes an operating panel and the operating keys arranged on the operating panel to realize the operating and controlling of the garden tool. The garden tool further includes the walking motor. The walking motor drives the walking wheels 201 to roll to enable the garden tool to move as it operates.

A specific correspondence between the lighting method of the light group 400 and a state of the garden tool may be as follows:
when battery pack of the tool is in a process of discharging:
after powering on, it is lit sequentially according to a predefined order, for example, taking a standing cutting machine as an example, the white light is lit in turn, its lighting sequence may be a dome light, the headlight, the side light. In an embodiment, the dome light flashes first, and then lights up together with the headlight, the dome light and the headlight may start from a middle and are synchronously lit towards both ends, the side lights on both sides may be lit synchronously, and each side light is lit from one end to the other end. Red light, two tail lights emit light synchronously, an upper part of each tail light is always on, and a lower part of each tail light is flashing. Taking the riding mower as an example, the white light is lit in turn, and the lighting sequence may be the dome light and the headlight, the side light. In an embodiment, the dome light and the headlight may be lit at the same time, and the lighting method may be from the middle to the two ends synchronously. A middle part of the red light (which means a part located directly behind the casing) is always on, and the two ends (which means a part located on the left and right sides of the tail part of the machine body) flashes.

When the predefined lighting process is completed:
if a signal received by the switch or a communication is a command to turn off the lights, both the white and red lights will be turned off.
if a signal received by the switch or a communication is a command to turn on the lights, the white light works normally, and the red light is partly on and partly flashing.

If there is a device failure in a vehicle, the white light and red light will flash according to a predetermined frequency, for example: a number of red light flashes represents the fault device, and the number of white light flashes represents a number of faults. For example, if the red light flashes one time, and the white light flashes two times, it means that a right driving controller has two faults. If the red light flashes three times, and the white light flashes two times, it means that a left blade controller has two faults. In an embodiment, after a flashing sequence is that the red light flashing one time, the red light enters an off state, then the white light flashes two times, then enters the off state, and after a period of time, for example 5 seconds, it loops again. The light flashes at an interval of one second.

It may also possible that as long as there is a malfunction of the device, the white light and the red light will flash together.

If a power drops to a warning threshold, the white or red light flashes according to the predetermined frequency, reminds the user to go back to charge as soon as possible, and the flashing mode may be that the lower the battery, the faster the flashing frequency.

When the vehicle is in a process of charging:
during a normal charging, the white light flashes according to the predetermined frequency and a brightness. For example, it flashes in a breathing manner at 30% brightness, and the red light is turned off.

During the normal charging, the flashing frequency of the white light may be adjusted according to a charging current. For example, the greater the charging current, the faster the flashing frequency.

When fully charged, the battery pack is 100% charged, and the white light remains on or turns green to indicate the user that it is fully charged.

When there is a malfunction during charging, the white and red lights flash according to the predetermined frequency and the brightness, just like when a fault occurs during the discharging.

The disclosure realizes a state display of different garden tools through different light control logics. The light group 400 is arranged on the machine body 10, and a brightness range is wide, so that a long distance view of the state of the garden tool at the present moment may be realized. For example, if the garden tool needs to be charged, but the staff does not remember whether they have been charged or not, the staff only need to observe a flashing state of the lights from a long distance to find out whether the garden tool is in the charging state.

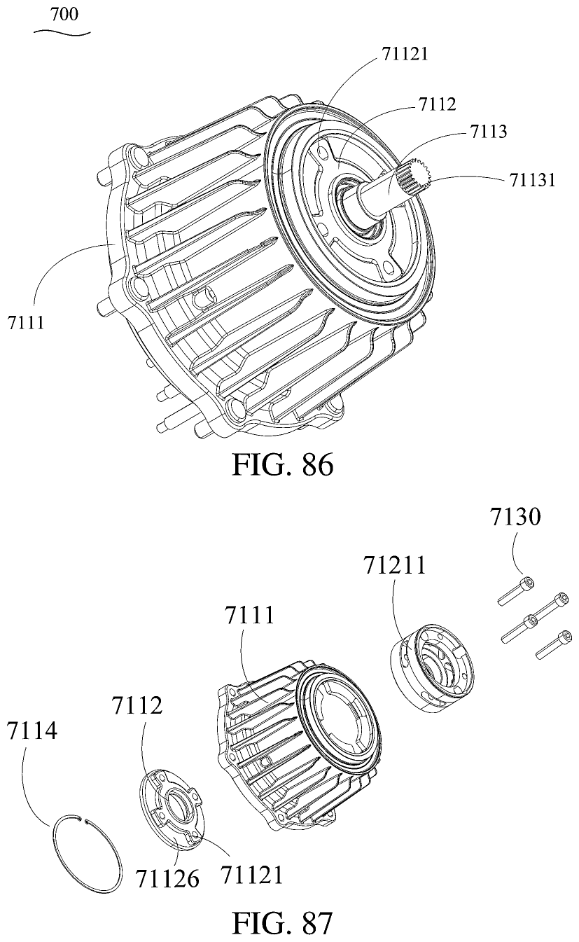

Please refer to FIG. 86 and FIG. 87. The mower 1 of an embodiment of the disclosure includes a driving motor 7110. The driving motor 7110 includes a motor casing 7111 and a driving motor winding installed in the motor casing 7111. The driving motor winding includes a stator winding (not labeled) and a rotor winding (not labeled). A structure and an installation mode of the stator winding and the rotor winding may be found in all conventional stator windings or rotor winding types. In this embodiment, the stator winding is fixedly installed in the motor casing 7111, and the rotor winding is rotatably installed in the motor casing 7111, and can be matched with the stator winding to convert electrical energy into rotating mechanical energy of the rotor winding. One end of the rotor winding is provided with a first torque output end 7113. At least one reinforcing connecting body 7112 is arranged on the motor casing 7111. The motor casing 7111 and the reinforcing connecting body 7112 are made of different materials respectively, and a material strength of the reinforcing connecting body 7112 is greater than that of the motor casing 7111. The reinforcing connecting body 7112 is provided with a threaded hole 71121 for a threaded connection with the reducer 120. When the driving motor 7110 needs to be connected with the reducer 120, a small end of a connecting bolt 7130 may pass through a bolt through hole on the fixing base 71121 of the reducer 120 after an installation of the driving motor 7110 assembly is completed, and then be threaded with the threaded hole 71121 on the reinforcing connecting body 7112, so that the fixing base 71121 is connected and fixed with the motor casing 7111. Since the bolt in the disclosure may be threaded with the connecting body from an outside of the motor casing 7111, it may be connected with the fixing base 71121 of the reducer 120 after the installation of the entire driving motor 7110 is completed, so that an assembly process of the driving motor 7110 and an assembly process of the reducer 120 may be completed independently. Moreover, there is no threaded connection between the connecting bolt 7130 and the fixing base 71121 of the reducer 120 in the disclosure, so a material of the fixing base 71121 of the reducer 120 may be flexibly selected according to the design needs without a material of relatively high connection strength. For example, it may be a plastic material such as PA6 and POM with a weak connection strength.

An installation mode of the reinforcing connecting body 7112 on the motor casing 7111 in the disclosure may not be limited, including but not limited to modes such as embedded casting, detachable fixing, bonding, welding, etc. There is also no limit to a number of reinforcing connecting bodies 7112, which may be one, two, or more, and following examples of various forms and quantities of reinforcing connecting bodies 7112 are illustrated.

Please refer to FIG. 86 through FIG. 89. In an embodiment of the driving motor 7110 of the disclosure, only one reinforcing connecting body 7112 is arranged on the motor casing 7111. The reinforcing connecting body 7112 is a stopping disc, and the motor casing 7111 is provided with a stopping disc installation hole 71112 matched with an outer diameter of the stopping disc. A blocking edge 71126 is arranged on the stopping disc, and a shaft hole 71124 for a core shaft of the first torque output end 7113 to pass through is arranged in a middle of the stopping disc. The stopping disc is clamped in the stopping disc installation hole 71112. A first side of the blocking edge 71126 is in contact with a block 71114 in the motor casing 7111 and is positioned, and a second side of the blocking edge 71126 is detachably fixed along an axial direction through an clastic blocking ring 114 that is clamped on the motor casing 7111. The reinforcing connecting body 7112 is provided with at least two threaded holes 71121 for the threaded connection with a connecting component of the reducer 120. A number of threaded holes 71121 is determined according to a number of the connecting bolts 7130 between the reducer 120 and the motor casing 7111. For example, when there are two connecting bolts 7130, the number of threaded holes 71121 corresponds to two. In this embodiment, there are four connecting bolts 7130. An outer contour of the fixing base 71121 is approximately cylindrical. The fixing base 71121 is provided with four bolt through holes matched with the connecting bolts 7130. Four threaded holes 71121 are arranged on the stopping disc, positions of the four threaded holes 71121 correspond to positions of the four bolt through holes, and small ends of the four connecting bolts 7130 are threaded with the four threaded holes 71121 by passing through the four bolt through holes respectively. As long as a stable connection between the fixing base 71121 and the motor casing 7111 can be realized, the position and an arrangement of connecting through holes are not limited. In this embodiment, the four bolt through holes are evenly distributed along a same circumference, so that a stress of the four connecting bolts 7130 will be more uniform.

Please refer to FIG. 86 through FIG. 89. In an embodiment of the disclosure, a first circumferential stopping structure (not labeled) is arranged between the stopping disc and the motor casing 7111. Although a circumferential stop of the stopping disc relative to the motor casing 7111 may also be realized through a matching of an outer contour of the stopping disc and a contour of the stopping disc installation hole 71112, such as setting a non-rotary profile that cannot rotate relatively, in some embodiments, the first circumferential stopping structure includes a plurality of first protruding parts 71122 and a plurality of first concave parts 71111 corresponding to the plurality of first protruding parts 71122. The plurality of first protruding parts 71122 are arranged on one of the reinforcing connecting body 7112 and/or the motor casing 7111, and the plurality of first concave parts 71111 are correspondingly arranged on the other one of the reinforcing connecting body 7112 and/or the motor casing 7111. In this embodiment, the first protruding part 71122 is arranged on the stopping disc, and the first concave part 71111 is arranged on the motor casing 7111. A shape and a position of the first protruding part 71122 on the stopping disc correspond to a shape and a position of the first concave part 71111 on the motor casing 7111. The first protruding part 71122 is clamped into the first concave part 71111 to stop it in the circumferential direction, and a shearing force may be evenly distributed to the motor casing 7111 by arranging the first protruding part 71122 and the first concave part 71111 with a larger contact area, which may avoid a damage to a weaker motor casing 7111. In another embodiment of the driving motor of the disclosure, the first concave part 71111 may also be arranged on the stopping disc, and the first protruding part 71122 is arranged on the motor casing 7111. The shape and the position of the first concave part 71111 on the stopping disc correspond to the shape and the position of the first protruding part 71122 on the motor casing 7111, and the first protruding part 71122 is clamped into the first concave part 71111. In a third embodiment of the driving motor of the disclosure, the plurality of the first concave parts 71111 may also be arranged on the stopping disc and the motor casing 7111 respectively, and the plurality of first protruding parts 71122 is correspondingly arranged on the motor casing 7111 and the stopping disc 7111 respectively. The first concave parts 71111 and the first protruding part 71122 on the stopping disc respectively correspond to each other and are clamped with the first protruding parts 71122 and a second concave part on the motor casing 7111.

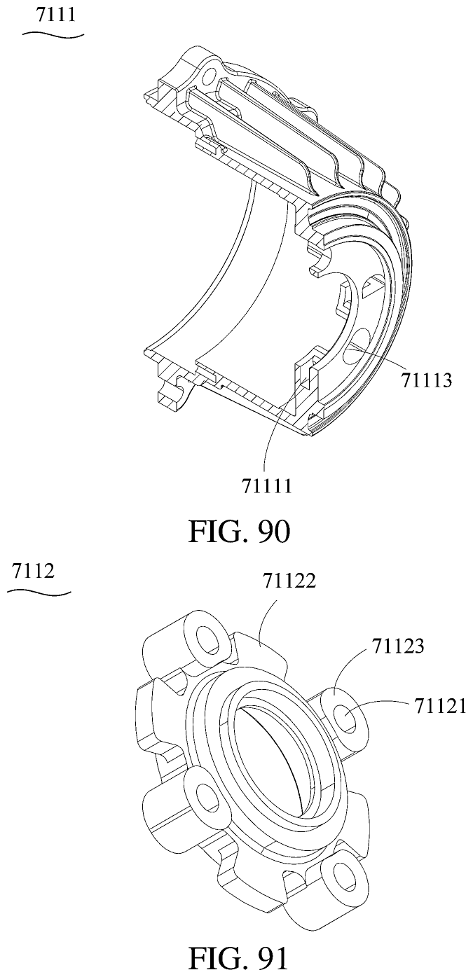

Please refer to FIG. 90 through FIG. 91. In another embodiment of the driving motor 7110 of the disclosure, there are also only one reinforcing connecting body 7112 arranged on the motor casing 7111. The reinforcing connecting body 7112 is embedded and cast in the motor casing 7111. A periphery of the reinforcing connecting body 7112 is fixedly connected with four connecting sleeves 71123, the four connecting sleeves 71123 are respectively provided with the threaded holes 71121, and the threaded holes 71121 on the four connecting sleeves 71123 are used for threaded connections with the corresponding connecting bolts 7130. It should be noted that, the number of threaded holes 71121 is equal to the number of the connecting bolts 7130 between the reducer 120 and the motor casing 7111, but should be at least two according to connection needs. The fixing base 71121 is provided with four bolt through holes matched with the connecting bolts 7130. The small ends of the four connecting bolts 7130 are threaded with the four threaded holes 71121 by passing through the four bolt through holes respectively.

Please continue to refer to FIG. 90 through FIG. 91. Although the circumferential stop between the reinforcing connecting body 7112 and the motor casing 7111 may also be realized through an embedded casting, the first circumferential stopping structure is also arranged between the reinforcing connecting body 7112 and the motor casing 7111 considering a stability of an embedded fixation. As long as a circumferential relative stopping can be realized, a specific structure of the first circumferential stopping structure is not limited. For example, the reinforcing connecting body 7112 is set into a non-rotating outer contour, so that a corresponding matching concave part and filling protrusions are formed on the subsequently motor casing 7111 when embedded casting, and the more stable and reliable circumferential stopping and fixed connection of the reinforcing connecting body 7112 relative to the motor casing 7111 are realized. In an embodiment of the driving device of the disclosure, the first circumferential stopping structure includes the plurality of first protruding parts 71122 and the plurality of first concave parts 71111 corresponding to the plurality of first protruding parts 71122. The first protruding parts 71122 are arranged on one of the reinforcing connecting body 7112 and/or the motor casing 7111, and the plurality of first concave parts 71111 is correspondingly arranged on the other one of the reinforcing connecting body 7112 and/or the motor casing 7111. In this embodiment, the first protruding part 71122 is arranged on the reinforcing connecting body 7112, and the first concave part 71111 is arranged on the motor casing 7111. The shape and the position of the first protruding part 71122 on the reinforcing connecting body 7112 correspond to the shape and the position of the first concave part 71111 on the motor casing 7111. When casting, a formed reinforcing connecting body 7112 is put into a mold of the motor casing 7111, and when the motor casing 7111 is cast, metal melt of the motor casing 7111 fills other cavities around the reinforcing connecting body 7112, so as to form the concave parts matched with the first protruding parts 71122 and the connecting sleeves 71123.

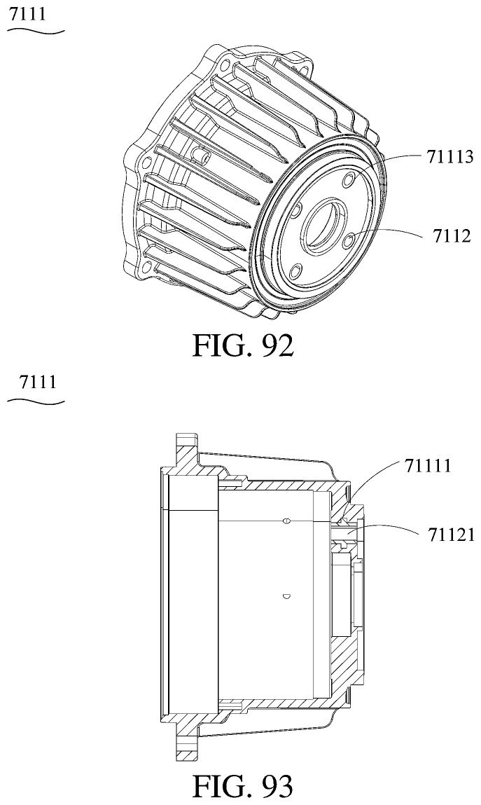

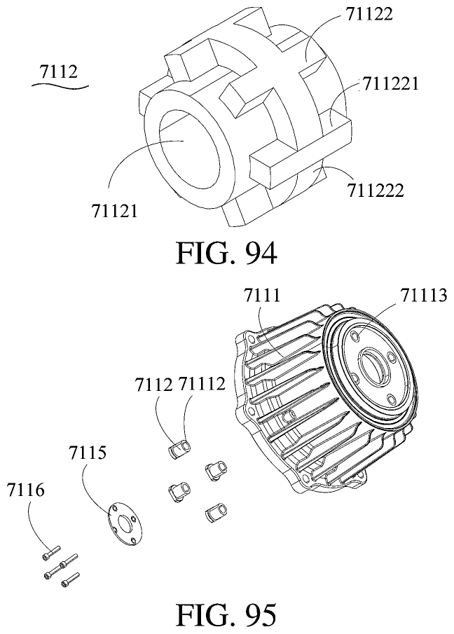

Please refer to FIG. 92 through FIG. 94. In an embodiment of the driving motor 7110 of the disclosure, the motor casing 7111 is provided with at least two reinforcing connecting bodies 7112, each reinforcing connecting body 7112 is an independent connecting sleeve, and each reinforcing connecting body 7112 is provided with the threaded holes for the threaded connection with the connecting components of the reducer 120. All the reinforcing connecting bodies 7112 are embedded and cast at corresponding positions in the motor casing 7111 and are used for the threaded connection with the connecting bolt 7130 of the reducer 120. It should be noted that, the number of reinforcing connecting bodies 7112 is equal to the number of the connecting bolts 7130 between the reducer 120 and the motor casing 7111, and should be at least two according to connection needs. Considering a stability of a connection, in this embodiment, the motor casing 7111 includes four independent reinforcing connecting bodies 7112. The fixing base 71121 is provided with four bolt through holes matched with the connecting bolts 7130. The small ends of the four connecting bolts 7130 are threaded with the threaded holes 71121 of the reinforcing connecting bodies 7112 by passing through the four bolt through holes respectively.

Please continue to refer to FIG. 92 through FIG. 94. Although the circumferential stop between the reinforcing connecting body 7112 and the motor casing 7111 may also be realized through the embedded casting, the first circumferential stopping structure is also arranged between the reinforcing connecting body 7112 and the motor casing 7111 considering the stability of the embedded fixation. As long as the circumferential relative stopping can be realized, the specific structure of the first circumferential stopping structure is not limited. For example, the reinforcing connecting body 7112 is set into the non-rotating outer contour, so that the corresponding matching concave part and filling protrusions are formed on the subsequently motor casing 7111 when embedded casting, and the more stable and reliable circumferential stopping and fixed connection of the reinforcing connecting body 7112 relative to the motor casing 7111 are realized. In an embodiment of the driving device of the disclosure, the first circumferential stopping structure includes the plurality of first protruding parts 71122 and the plurality of first concave parts 71111 corresponding to the plurality of first protruding parts 71122. The first protruding parts 71122 are arranged on one of the reinforcing connecting body 7112 and/or the motor casing 7111, and the plurality of first concave parts 71111 is correspondingly arranged on the other one of the reinforcing connecting body 7112 and/or the motor casing 7111. In this embodiment, the first protruding part 71122 is arranged on the reinforcing connecting body 7112. The first protruding part 71122 includes an annular protrusion 7171222 and a plurality of axial protrusions 7171221, the plurality of the axial protrusions 7171221 is parallel to each other and extends along an axial direction of the reinforcing connecting body 7112. The plurality of axial protrusions 7171221 is uniformly distributed on a circumference of the reinforcing connecting body 7112. The annular protrusions 7171222 is arranged in a middle part of the reinforcing connecting body 7112, surrounds an outer circle of the reinforcing connecting body 7112 and connects each axial protrusions. When casting, the formed reinforcing connecting body 7112 is put into the mold of the motor casing 7111. When the motor casing 7111 is cast, the metal melt of the motor casing 7111 fills cavities around the axial protrusion and the annular protrusion 7171222, so as to form the concave parts that matches the axial protrusion and the annular protrusion 7171222. Of course, those skilled in the art may understand that if a volume and a strength of the reinforcing connecting body 7112 are not considered, a concave part may also be arranged on the reinforcing connecting body 7112 so that the metal melt of the motor casing 7111 fills the concave part, thereby forming a protruding part of the motor casing. Alternatively, concave parts and protruding parts are respectively arranged on the reinforcing connecting body 7112, so that the metal melt of the motor casing 7111 fills the cavities around the concave parts and the protruding parts, so as to form the corresponding the protruding parts and the concave parts of the motor casing.

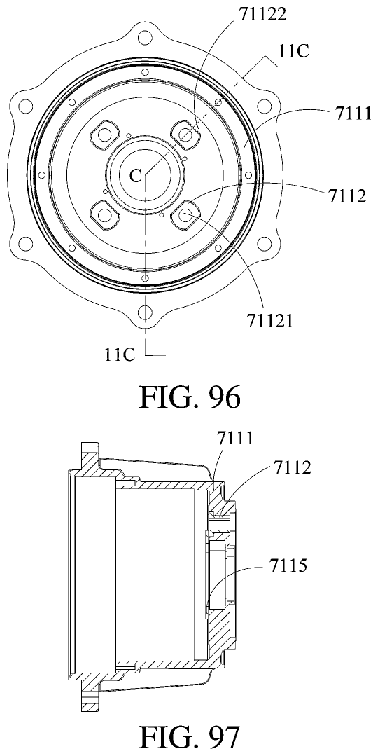

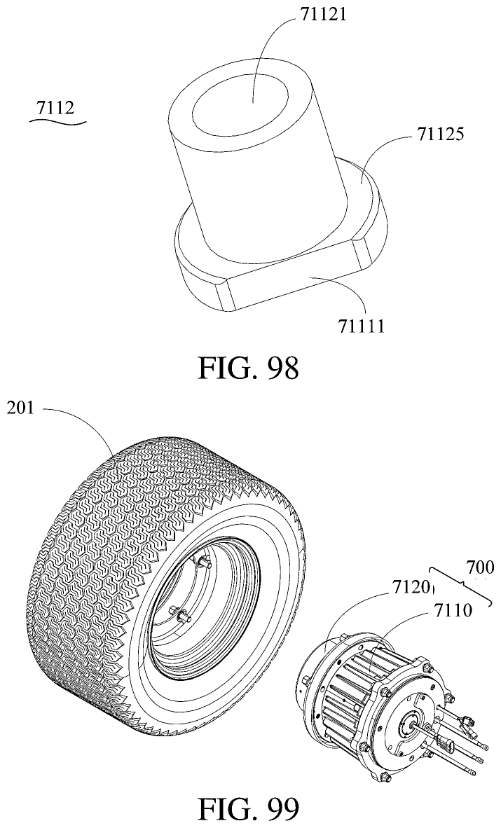

Please refer to FIG. 85 through FIG. 98. In another embodiment of the driving motor 7110 of the disclosure, the motor casing 7111 is provided with the at least two reinforcing connecting bodies 7112, the reinforcing connecting body 7112 is the independent connecting sleeve, and each reinforcing connecting body 7112 is provided with the threaded holes 71121 for the threaded connection with the connecting components of the reducer 120. One end of the reinforcing connecting body 7112 deviating from the reducer 120 is provided with a positioning boss 71125, and a connecting sleeve installation through hole 71113 is arranged on the motor casing 7111. The reinforcing connecting body 7112 is installed in the connecting sleeve installation through hole 7113 from an inner cavity of the motor casing 7111, and the positioning boss 71125 is abutted against an inner wall of the motor casing 7111 towards one side of the reducer 120 to be positioned along the axial direction. A compressing plate 115 is arranged on one side of the positioning boss 71125 of all the reinforcing connecting body 7112 that deviates from the reducer 120, and the compressing plate 115 is connected with the motor casing 7111 through a compressing bolt 116, so that all the reinforcing connecting bodies 7112 are detachably press-installed at corresponding positions in the motor casing 7111 and are respectively used for the threaded connection with different connecting bolts 7130. It should be noted that, the number of reinforcing connecting bodies 7112 is equal to the number of the connecting bolts 7130 between the reducer 120 and the motor casing 7111, and should be at least two according to connection needs. Considering a stability of a connection, in this embodiment, the motor casing 7111 includes four independent reinforcing connecting bodies 7112. The fixing base 71121 is provided with four bolt through holes matched with the connecting bolts 7130. The small ends of the four connecting bolts 7130 are threaded with the threaded holes 71121 of the reinforcing connecting bodies 7112 by passing through the four bolt through holes respectively.

Please refer to FIG. 95 through FIG. 98. In order to prevent the reinforcing connecting body 7112 from rotating, causing the connecting bolt 7130 to loosen, in an embodiment of the disclosure, the first circumferential stopping structure is arranged between the reinforcing connecting body 7112 and the motor casing 7111. The first circumferential stopping structure includes the plurality of first protruding parts 71122 and the plurality of first concave parts 71111 corresponding to the plurality of first protruding parts 71122. The first protruding parts 71122 are arranged on one of the reinforcing connecting body 7112 and/or the motor casing 7111, and the plurality of first concave parts 71111 is correspondingly arranged on the other one of the reinforcing connecting body 7112 and/or the motor casing 7111. In this embodiment, the first concave part 71111 is arranged on one side edge of the positioning boss 71125, and the first protruding part 71122 is arranged on the motor casing 7111. The connecting sleeve installation through hole 71113 is provided with the first protruding part 71122 that matches a shape of the first concave part 71111. The first protruding part 71122 is matched with the first concave part 71111 to stop in the circumferential direction. In another embodiment of the driving motor 7110 of the disclosure, the first protruding part 71122 may also be arranged on the reinforcing connecting body 7112, and the first concave part 71111 may be arranged on the motor casing 7111. In a fourth embodiment of the driving motor 7110 of the disclosure, the plurality of the first concave parts 71111 may also be arranged on the reinforcing connecting body 7112 and the motor casing 7111 respectively, and the plurality of first protruding parts 71122 is correspondingly arranged on the motor casing 7111 and the reinforcing connecting body 7112 respectively. The first concave part 71111 and the first protruding part 71122 on the reinforcing connecting body 7112 correspond to and are clamped with the first protruding part 71122 and the second concave part on the motor casing 7111, respectively.

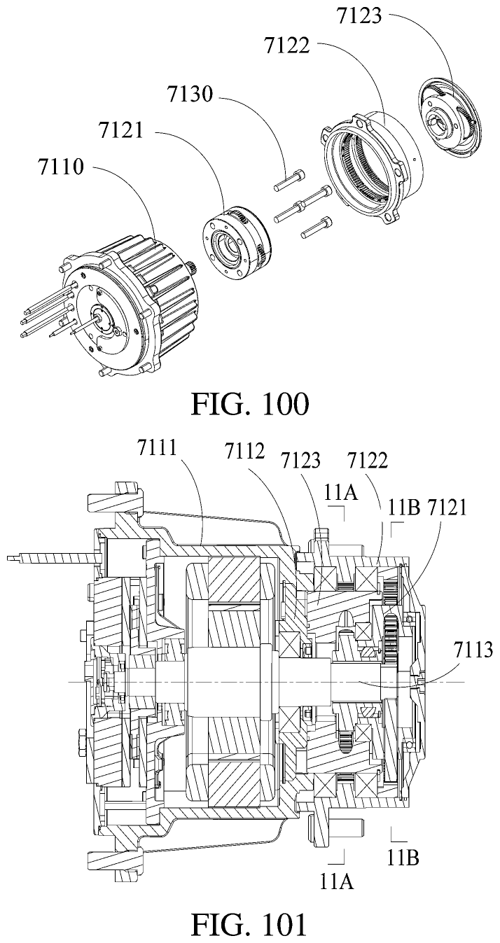

Please refer to FIG. 99 through FIG. 101. The mower 1 of the disclosure provides a driving device 700. The driving device 700 is configured to drive the walking wheel 201 to walk. The driving device 700 includes the driving motor 7110 and the reducer 120. The driving motor 7110 may be the driving motor 7110 as described in any of the above embodiments. In an embodiment of the driving device 700 of the disclosure, the driving motor 7110 includes the motor casing 7111 and the first torque output end 7113. The reducer 120 includes the fixing base 71121, a torque input end and a second torque output end 7122. In an embodiment, at least one reinforcing connecting body 7112 for connection is fixedly arranged on the motor casing 7111. The motor casing 7111 and the reinforcing connecting body 7112 are made of different materials respectively, and the material strength of the reinforcing connecting body 7112 is greater than that of the motor casing 7111. The reinforcing connecting body 7112 is provided with the threaded hole 71121. The fixing base 71121 of the reducer 120 is in a threaded connection with the threaded hole 71121 on a same or different reinforcing connecting bodies 7112 through a plurality of connecting components. The first torque output end 7113 drives the torque input end (which means at least one first planetary gear 71232 in a first gear system 7121) to rotate. The torque input end drives the second torque output end 7122 to rotate, and the second torque output end 7122 is connected with the walking wheel 201, and drives the walking wheel 201 to rotate.

In an embodiment of the driving device 700 of the disclosure, a second circumferential stopping structure is arranged between the fixing base 71121 and the reinforcing connecting body 7112 to prevent the fixing base 71121 and the reinforcing connecting body 71121 from rotating. The second circumferential stopping structure includes a plurality of second protrusions and a plurality of second grooves matched with the plurality of second protrusions. The plurality of the second protrusions is arranged on one of the reinforcing connecting body 7112 and/or the fixing base 71121, and the plurality of second grooves is correspondingly arranged on the other one of the reinforcing connecting body 7112 and/or the fixing base 71121. In this embodiment of the driving device 700 of the disclosure, a second protruding part is arranged on the reinforcing connecting body 7112, and the second concave part is arranged on the fixing base 71121. A shape and a position of the second protruding part on the reinforcing connecting body 7112 correspond to a shape and a position of the second concave part on the fixing base 71121. The second protruding part is clamped into the second concave part 71111 to stop it in the circumferential direction, and a shearing force may be evenly distributed to the fixing base 71121 by arranging the second protruding part and the second concave part with a larger contact area. In another embodiment of the driving device 700 of the disclosure, the second concave part may also be arranged on the reinforcing connecting body 7112, and the second protruding part is arranged on the fixing base 71121. The shape and the position of the second concave part on the reinforcing connecting body correspond to the shape and the position of the second protruding part on the fixing base 71121, and the second protruding part is clamped into the second concave part. In a fifth embodiment of the driving device 700 of the disclosure, the plurality of the second concave parts may also be arranged on the reinforcing connecting body 7112 and the fixing base 71121 respectively, and the plurality of second protruding parts is correspondingly arranged on the fixing base 71121 and the reinforcing connecting body 7112 respectively. The second concave parts and the first second part on the reinforcing connecting body respectively correspond to each other and are clamped with the second protruding part and the second concave part on the fixing base 71121.

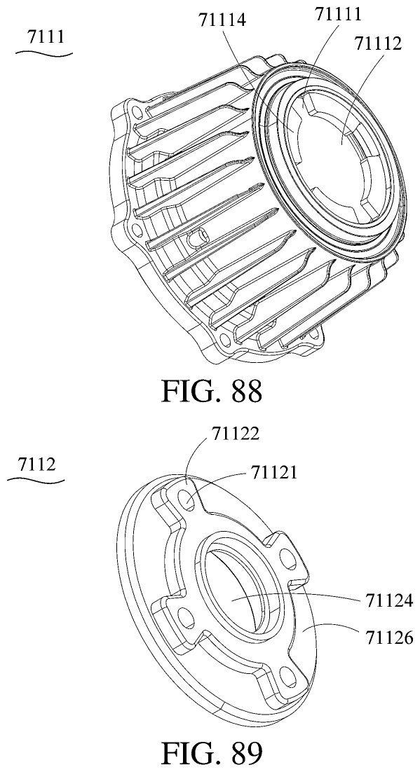

Please refer to FIG. 87 and FIG. 88. In another embodiment of the disclosure, the second protrusion and the first protrusion are a same protrusion. The fixing base 71121 is provided with the second concave part matched with the first protrusion, and the first protrusion extends to the second concave part by passing through the first concave part on the motor casing 7111. A bolt through hole is arranged in the second concave part, and a small end of the connecting bolt 7130 penetrates through the through hole and is threaded with the threaded hole 71121 on the first protruding part 71122 extending into the second concave part. In this arrangement mode, when a torsional reaction force on the reducer 120 acts on the fixing base 71121, the second concave part on the fixing base 71121 corresponds and is matched with the first protruding part 71122 to realize a transmission of force, which may reduce a damage to the connecting bolt 7130. At the same time, due to a shear force between the fixing base 71121 and the first protruding part 71122, and between the first protruding part 71122 and the first concave part, a protruding part and a concave part with a larger cross-sectional area than the connecting bolt 7130 may be selected for transmission, thereby reducing a damage to the motor casing 7111 and the fixing base 71121 and improving a durability of the product.

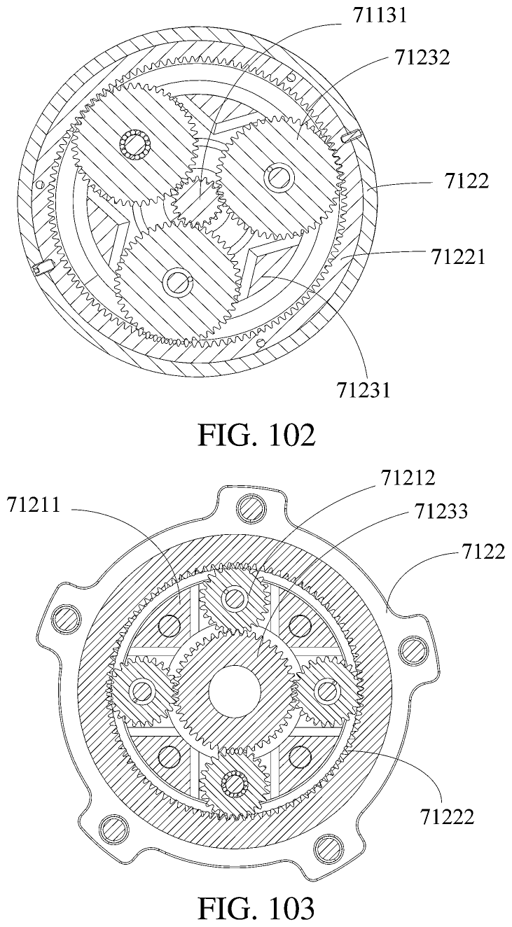

Please refer to FIG. 101 through FIG. 103. In the disclosure, as long as a set reduction ratio can be reached, and the driving motor 7110 can be fixed to realize an output of an external rotor, a type of the reducer 120 is not limited. In an the embodiment of the driving device 700 in the disclosure, the reducer 120 is a planetary gear reducer 120. The reducer 120 includes the first gear system 7121, a second gear system 7123 and a rotating bracket (second torque output end 7122). The first gear system 7121 includes a first sun gear 71131, a plurality of first planetary gears 71232, a first planetary gear bracket 71231 and a first inner tooth ring 71221. The second gear system 7123 includes a second sun gear 71233, a plurality of second planetary gear 71212, a second planetary gear bracket (which means the fixing base 71121) and a second inner tooth ring 71222. The core shaft of the first torque output end 7113 is arranged at a center of the walking wheel 201 along the axial direction of the walking wheel 201, the core shaft is provided with the first sun gear 71131, and the first sun gear 71131 is coaxially fixed with the core shaft. The first planetary gear bracket 71231 is rotatably connected with the first torque output end 7113, and the first planetary gear bracket 71231 is provided with the first planetary gear 71232 and the second sun gear 71233. There is a plurality of first planetary gears 71232, and the first planetary gears 71232 are rotatably connected with the first planetary gear bracket 71231. The first planetary gear 71232 is meshed with the first sun gear 71131, and the second sun gear 71233 is coaxially connected with the first planetary gear bracket 71231. The second planetary gear bracket (which means the fixing base 71121) is fixed with the reinforcing connecting body 7112 on the motor casing 7111 through the connecting bolt 7130, a plurality of second planet gears 71212 is rotatably arranged on the bracket of the second planetary gear 71212, and the second planetary gear 71212 is meshed with the second sun gear 71233. The rotating bracket (the second torque output end 7122) is fixedly connected with a wheel hub of the walking wheel 201, and the first inner tooth ring 71221 and the second inner tooth ring 71222 are coaxially arranged inside the rotating bracket at intervals. The first inner tooth ring 71221 and the second inner tooth ring 71222 may be fitted with the rotating bracket by interference or fixing pins, bolts and so on, so that the rotating bracket is driven to rotate, the first inner tooth ring 71221 is meshed with the first planetary gear 71232, and the second inner tooth ring 71222 is meshed with the second planetary gear 71212. The disclosure is provided with two groups of planetary gear mechanisms. The inner tooth rings of the two groups of planetary gear mechanisms (which means the first inner tooth ring 71221 and the second inner tooth ring 71222) are all fixed with the rotating bracket, so that they can be driven from two ends of the rotating bracket, and a power distribution is more uniform. In addition, a differential matching between the two groups of planetary gears realizes a two-stage deceleration from the driving motor 7110 to the walking wheel 201, a transmission ratio is larger, and a torque is increased more significantly.

The disclosure further provides a garden walking device. The garden walking device may be, for example, a riding cleaning machine, a riding snow thrower or a riding mower. Taking the mower as an example, the garden walking device includes the frame 100, the cutting deck assembly 300, the driving device 700 and a power part. The power part provides electrical energy for the driving device 700, and the driving device 700 provides power for the rotation of the walking wheel 201. A rear side of the frame 100 is provided with the walking wheel 201, a front side of the frame 100 is provided with a steering wheel 2100, and the steering wheel 2100 controls a walking direction of the frame 100 under an effect of the operating device 230. Other structural forms of the frame 100 are not limited, which may refer to the structure of the frame 100 of the conventional garden walking device. The cutting deck assembly 300 is installed on the bottom of the frame 100 to perform corresponding garden operation.

The walking wheel 201 may be an inflatable wheel that is made up of a tire and a wheel hub, for example, or may be an integrated wheel made of polymer. A structure of the wheel is not limited to a certain form, but a premise is that a wheel center needs to have a cavity that can accommodate the reducer 120 or even the driving motor 7110. The motor casing 7111 in the driving device 700 is fixedly connected with the frame 100, and a gearbox in the driving device 700 is coaxially connected with the wheel hub of the walking wheel 201. It is understood that the driving device 700 in the disclosure is not only used as a driving element, but also as a supporting structure connecting the walking wheel 201 and the frame 100, so connecting parts of the driving motor 7110 and the reducer 120 in the driving device 700 should have sufficient structural strength. For example, materials such as cast iron and cast aluminum may be used.

The driving device 700 in the garden walking device in the disclosure may be the driving device 700 in any of the above embodiments. In an embodiment of the garden walking device in the disclosure, the driving device 700 includes the driving motor 7110 and the reducer 120. The driving motor 7110 includes the motor casing 7111 and the first torque output end 7113. The reducer 120 includes the fixing base 71121, the torque input end and the second torque output end 7122. In an embodiment, at least one reinforcing connecting body 7112 for connection is fixedly arranged on the motor casing 7111. The motor casing 7111 and the reinforcing connecting body 7112 are made of different materials respectively, and the material strength of the reinforcing connecting body 7112 is greater than that of the motor casing 7111. The reinforcing connecting body 7112 is provided with the threaded hole 71121. The fixing base 71121 of the reducer 120 is in the threaded connection with the threaded hole 71121 on the same or different reinforcing connecting bodies 7112 through the plurality of connecting components. The first torque output end 7113 drives the torque input end (which means at least one first planetary gear 71232 in the first gear system 7121) to rotate. The torque input end drives the second torque output end 7122 to rotate, and the second torque output end 7122 is coaxially connected with the walking wheel 201. It should be noted that, a part and a relative connection relationship that are not described in detail in the above-mentioned garden walking devices may refer to the conventional corresponding garden walking devices, and the details will not be repeated here.

In the driving motor, the driving device and the garden walking device of the disclosure, the motor housing and the reinforcing connecting body are made of different materials respectively, and a material strength of the reinforcing connecting body is greater than a material strength of the motor casing. Therefore, the reinforcing connecting body is provided with a threaded hole for a threaded connection with a reducer. With this arrangement method, after an driving motor assembly is installed, a fixing base of the reducer may be threadedly connected with the threaded hole on the reinforcing connecting body from a reducer side, so that a driving motor assembly process and a reducer assembly process may be completed independently, and a material of the fixing seat of the reducer using this structure is no longer limited and may be flexibly selected according to design needs.

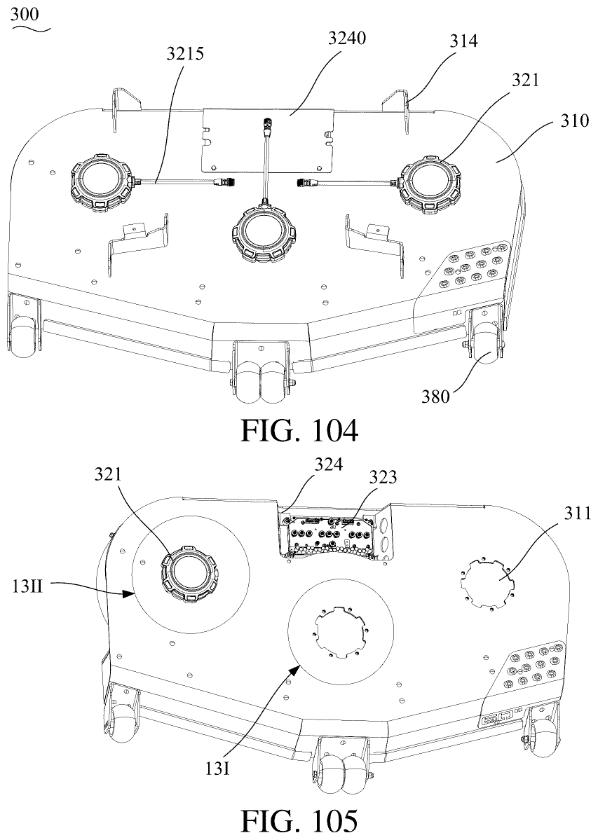

Please refer to FIG. 104 and FIG. 105. In an embodiment of the mower of the disclosure, the mower includes the cutting deck assembly 300. The cutting deck assembly 300 includes the cutting deck 310, the motor controller 323 and a plurality of cutting motors 321. In an embodiment, the motor controller 323 and the cutting motor 321 are both installed on the cutting deck 310, each of the cutting motors 321 is electrically connected with the motor controller 323, and the motor controller 130 centrally controls a rotation of each cutting motor 321. A structure of the cutting deck assembly 300 of the disclosure may save an installation space of the whole machine, improve heat dissipation efficiency of motor and motor controller, and reduce cost of the whole vehicle.

Please refer to FIG. 104 through FIG. 106. In an embodiment, the cutting deck 310 is provided with the controller accommodating cavity 324 for installing the motor controller 323. A structural form of the controller accommodating cavity 324 is not limited, and it may be an independent structure or integrally formed with the cutting deck 310. For example, a middle part of one side of the cutting deck 310 is concave downward to form the controller accommodating cavity 324, and the motor controller 323 is fixed in the controller accommodating cavity 324 through fasteners, such as screws. The motor controller 323 is arranged in the controller accommodating cavity 324, and an upper surface of the motor controller 323 is not higher than an upper surface of the cutting deck 310 to facilitate an installation of the cutting deck 310. Of course, in other embodiments, the upper surface of the motor controller 323 may also extend beyond the upper surface of the cutting deck 310, but a lower surface of the motor controller 323 is lower than an upper surface of the cutting deck (which means that the motor controller 323 is at least partially located in the cutting deck). In some embodiments, the bottom of the controller accommodating cavity 324 is the opening hole structure, and the bottom of the motor controller 323 is at least partially arranged at the open hole to facilitate heat dissipation of the controller. Further, the bottom of the controller accommodating cavity 324 is a completely opening hole structure, which means that the bottom of the motor controller 323 is completely open, so that the motor controller 323 may better dissipate heat.

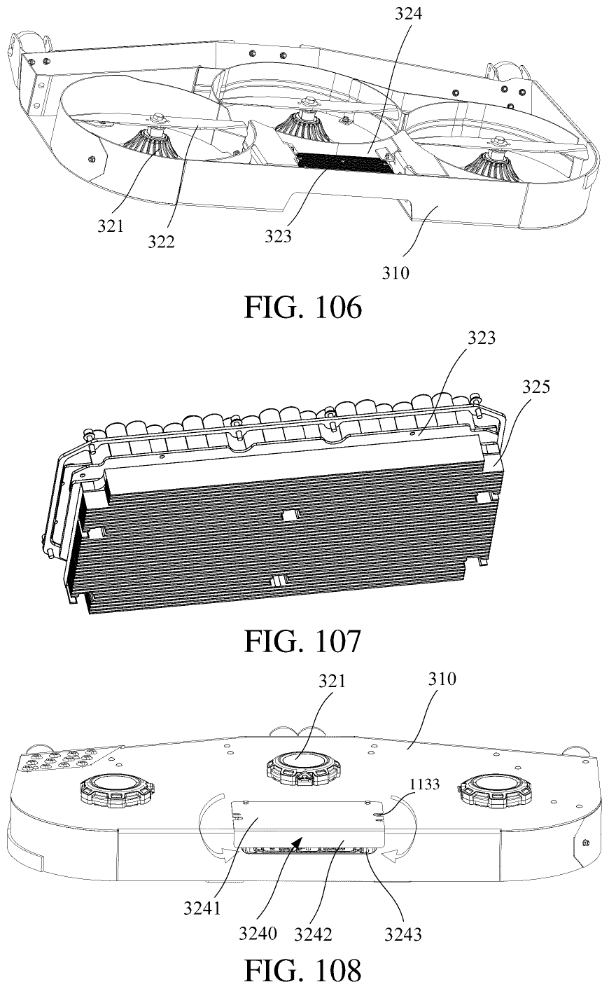

Please refer to FIG. 104, FIG. 106 and FIG. 107. In an embodiment, the bottom of the motor controller 323 is provided with the plurality of heat sinks 325, and the plurality of heat sinks 325 are arranged at intervals along a lower surface of the motor controller 323. The heat sinks 325 extend downward along a direction perpendicular to the lower surface of the motor controller 323. A height of the heat sink 325 extending downwards does not exceed a lower edge of the cutting deck 310, which means that the heat sinks 325 are completely accommodated in the controller accommodating cavity 324. Air at the bottom of the cutting deck 310 flows through the heat sinks 325, and heat generated by the motor controller 323 is taken away, which is conducive to an effective heat dissipation of the controller.

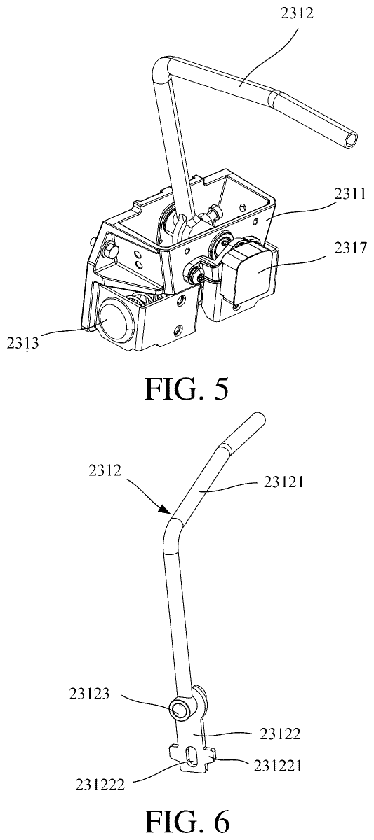

Please refer to FIG. 104, FIG. 105 and FIG. 108. In some embodiments, a controller protective cover 3240 is arranged above the motor controller 323, and an air inlet 3243 is arranged at a connection of the controller protective cover 3240 and the controller accommodating cavity 324. In this embodiment, one side wall of the controller accommodating cavity 324 is lower than the upper surface of the cutting deck 310. The controller protective cover 3240 includes a cover board 3241 and a connecting plate 3242 fixedly connected with the cover board 3241, the cover board 3241 is matched with an upper opening of the controller accommodating cavity 324, and the cover board 3241 covers above the controller accommodating cavity 324 and is fixed on the cutting deck 310 through the fasteners. The connecting plate 3242 is matched with the side wall of the controller accommodating cavity 324 lower than the upper surface of the cutting deck 310, and the connecting plate 3242 extends downward along a direction perpendicular to the cover board 3241. A gap is left between the connecting plate 3242 and the side wall of the controller accommodating cavity 324, and this gap forms the air inlet 3243. Cold air above the cutting deck 310 enters the controller accommodating cavity 324 from the air inlet 1131 (an arrow direction in FIG. 5 is a flow direction of the cold air), and flows to a bottom of the controlling accommodating cavity 324 along the gap between the controller accommodating cavity 324 and the controller 120, and heat generated by the controller 120 flows out from the bottom of the controlling accommodating cavity 324 with the cold air. Of course, the air inlet 3243 may also be arranged at a connection of the cover board 3241 and cutting deck 310. In other embodiments, the controller protective cover 3240 may also be a cover body structure, and a side wall of a cover body is provided with the air inlet that is matched with the controller accommodating cavity 324. There is no limitation on a shape of the controller protective cover 3240, as long as it can cover the upper opening of the controller accommodation cavity 324. The controller protective cover 3240 may be fixed on the cutting deck 310 through the fasteners, and may also be hinged with the cutting deck 310. After the motor controller 323 is installed in the controller accommodating cavity 324, the motor controller 323 is enclosed in the controller accommodating cavity 324 through the controller protective cover 324, and the motor controller 323 is protected from an external damage.

Please refer to FIG. 104 and FIG. 105. In an embodiment, the cutting deck 310 is provided with a motor installation hole 311 longitudinally penetrating the cutting deck, and the cutting motor 321 is fixed on the cutting deck 310 through the motor installation hole 311 and passing through a flange part at an end part. The cutting deck assembly 300 may include one or more cutting motors 321, and an installation mode of each cutting motor 321 is the same. For example, the cutting deck assembly 300 includes three cutting motors 321, and three motor installation holes 311 are correspondingly arranged on the cutting deck 310. In some embodiments, the three motor installation holes 311 are triangularly distributed on the cutting deck 310, which means that one motor installation hole 311 is arranged in the middle part of one side of the cutting deck 310 that deviates from the controller accommodating cavity 324, and the other two motor installation holes 311 are respectively arranged on the two sides of the controller accommodating cavity 324. This installation mode enables a force of the cutting deck 310 to be more uniform.

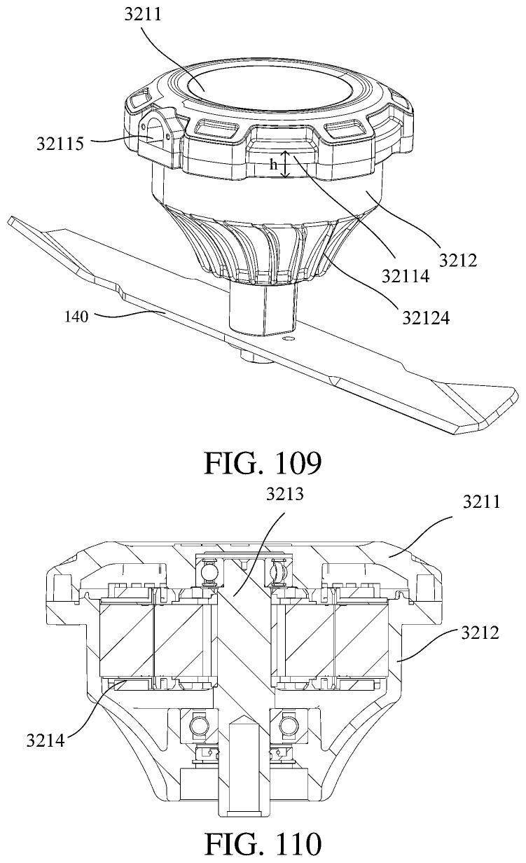

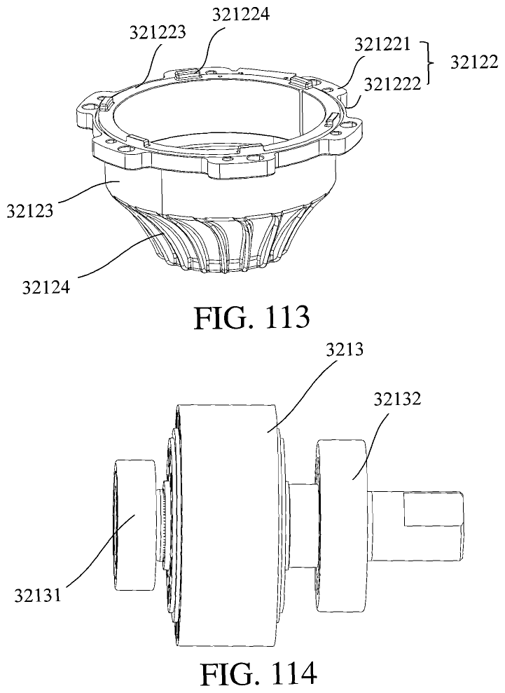

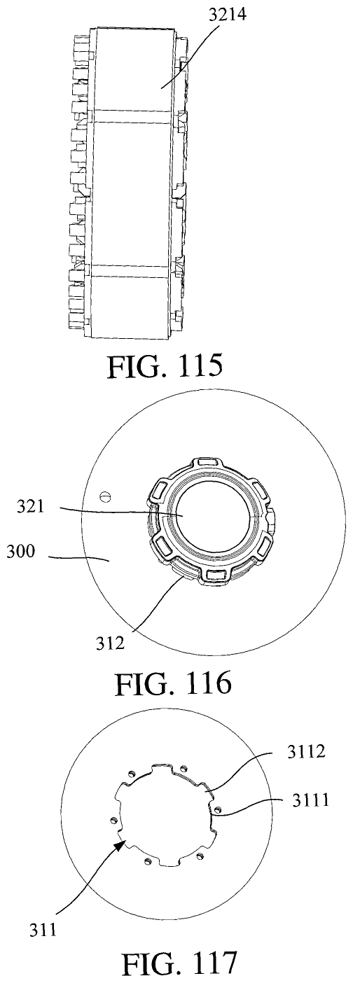

Please refer to FIG. 109 through FIG. 115. In an embodiment, the cutting motor 321 includes a motor end cover 131, a motor housing 3212, a motor rotor 3213 and a motor stator 3214. The motor end cover 131 is buckled with the motor housing 3212 to form a motor cavity, and the motor rotor 3213 and the motor stator 3214 are installed in the motor cavity. Two ends of the motor rotor 3213 are respectively provided with a first bearing 32131 and a second bearing 32132, and the motor rotor 3213 is rotatably installed on the motor end cover 131 and the motor housing 3212 through the first bearing 32131 and the second bearing 32132 respectively. In some embodiments, a middle part of motor end cover 131 is provided with a first bearing installation base 32111, and a shape and size of the first bearing installation base 32111 are matched with the first bearing 32131. A middle of a bottom of the motor housing 3212 is provided with a second bearing installation base 32121, and a shape and size of the second bearing installation base 32121 are matched with the second bearing 32132. The motor stator 3214 is sleeved and installed in a periphery of the motor rotor 3213, and when the motor stator 3214 receives current, the motor rotor 3213 will rotate along a magnetic field direction of the motor stator 3214 according to a principle of electromagnetism. In some embodiments, a position of an inner wall of the motor housing 3212 corresponding to the motor stator 3214 radially protrudes inward to form a stator supporting step 32141, and the motor stator 3214 is fixed in the motor cavity through the stator supporting step 32141.

Please refer to FIG. 105, FIG. 112 and FIG. 113. In an embodiment, the motor housing 3212 includes a connecting flange 32122, a first housing 32123 and a second housing 1324 that are communicated sequentially. The first housing 32123 is a cylindrical empty cavity structure. A first end of the first housing 32123 is connected with the connecting flange 32122, and a second end of the first housing 32123 is connected with the second housing 1324. An outer diameter of the connecting flange 32122 is greater than a diameter of the motor installation hole 311, and an outer diameter of the first housing 32123 is less than or equal to the diameter of the motor installation hole 311. The connecting flange 32122 extends outward along a radial direction of the first housing 32123 and protrudes beyond the first housing 32123. The second housing 1324 is a conical empty cavity structure. The first housing 32123 is used for installing the motor rotor 3213 and the motor stator 3214, and the second housing 1324 is used for installing the second bearing 32132 of the motor rotor 3213. A connection of the first housing 32123 and the second housing 1324 is provided with the stator supporting step 32141, and the second housing 1324 is provided with the second bearing installation base 32121 matched with the second bearing 32132. In some embodiments, a surface of the second housing 1324 is provided with a plurality of reinforcing ribs 321241, which may thin the motor housing while ensuring a strength of a motor assembly, thereby greatly reducing a weight of the motor, and an arrangement of the reinforcing ribs 321241 may further increase a heat dissipation area and improve heat dissipation efficiency.

Please refer to FIG. 105, FIG. 112, FIG. 113, FIG. 116 and FIG. 117. The connecting flange 32122 of the motor housing 3212 includes a plurality of first connecting parts 321221 and a plurality of second connecting parts 321222. In an embodiment, the first connecting part 321221 is used for connecting with the motor end cover 131 and the cutting deck 310, and the second connecting part 321222 is used for connecting the first connecting part 321221. The plurality of first connecting parts 321221 and the plurality of second connecting parts 321222 are arranged at intervals and enclose in a circle along a circumferential direction of the first housing 32123 to form the connecting flange 32122. The first connecting part 321221 protrudes outwards from the second connecting part 321222 along a radial direction of the first housing 32123. When the cutting motor 321 is installed in the motor installation hole 311 of the cutting deck 310, it is fixed on the cutting deck 310 through the first connecting part 321221. At this time, a position of the motor installation hole 311 corresponding to the second connecting part 321222 is left with a ventilation hole 312, so that an air circulation of upper and lower surfaces of the cutting deck 310 is convenient. In some embodiments, the motor installation hole 311 includes a first hole 3111 and a second hole 3112, a diameter of the first hole 3111 matches the outer diameter of the first housing 32123, and a diameter of the second hole 3112 is greater than the diameter of the first hole 3111. The first hole 3111 corresponds to the first connecting part 321221 of the connecting flange 32122, and the second hole 3112 corresponds to the second connecting part 321222 of the connecting flange 32122. The motor housing 3212 fixes the first connecting part 321221 to the cutting deck 310 outside the first hole 3111 through the fasteners such as bolts. Since the diameter of the second connecting part 321222 is smaller than the diameter of the first connecting part, the diameter of the second hole 3112 is larger than the diameter of first hole 3111. Therefore, after the motor is installed, a larger ventilation hole 312 (a gap between the second connection part 321222 and the second hole 3112) is left at a position of the second connection part 321222 corresponding to the cutting deck 310. A hole shape of the ventilation hole 312 corresponds to a hole shape of the second hole 3112, and is an arc-shaped strip hole, which may realize the air circulation on the upper and lower surfaces of the cutting deck 310.

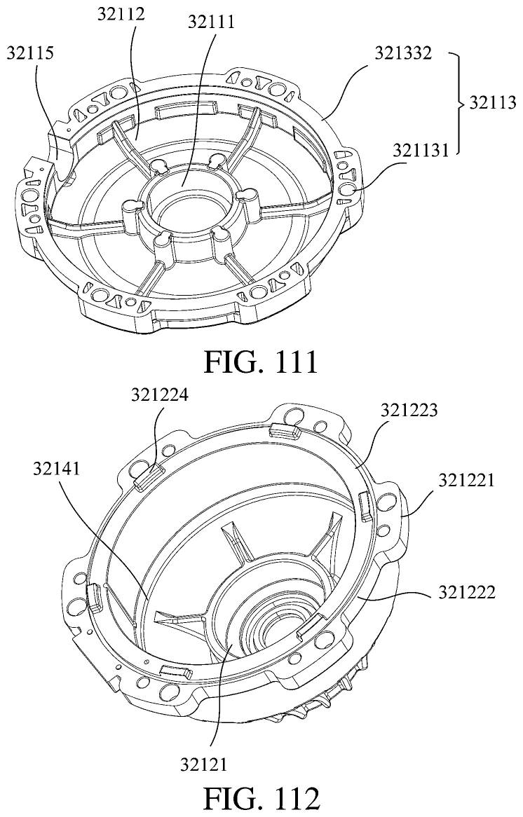

Please refer to FIG. 109, FIG. 111, FIG. 112, FIG. 113 and FIG. 116. The motor end cover 131 is matched and connected with the motor housing 3212. In an embodiment, the motor end cover 131 includes an end cover body 32112 and an end cover flange 32113 located at a periphery of the end cover body 32112. In order to facilitate a matching of the motor end cover 131 and the motor housing 3212, a circumferential protrusion 321223 is arranged on one side of the connecting flange 32122 towards the motor end cover 131, and an outer diameter of the circumferential protrusion 321223 matches an inner diameter of the end cover body 32112. In some embodiments, a plurality of arc-shaped protrusions 321241 are further arranged at intervals above the circumferential protrusion 321223, and the arc-shaped protruding 321241 is used for guiding the end cover body 32112 to be nested on an outer side of the circumferential protrusion 321223. A shape of the end cover flange 32113 matches the connecting flange 32122, which means that the end cover flange 32113 includes a first flange part 321131 and a second flange part 321132. The first flange part 321131 is matched with the first connecting part 321221, and the second flange part 321132 is matched with the second connecting part 321222. The second flange part 321132 is concave downward compared with the first flange part 321131, so as to reduce a weight of the motor end cover 131. When the motor end cover 131 is matched and connected with the motor housing 3212, the first flange part 321131 and the first connecting part 321221 are fixed on the cutting deck 310 through the fasteners such as bolts, and the second flange part 321132 is fitted with the second connecting part 321222 to form a step 32114. A height h of the step 32114 may be from 10 mm to 12 mm, for example, it may be 10 mm, 11 mm, 11.5 mm, 12 mm and so on. The motor housing 3212 and the motor end cover 131 adopt a stepped design, which may reduce an overall weight of the motor assembly and is convenient for disassembly, maintenance and installation. In addition, after the cutting motor 321 and the cutting deck 310 are installed, an arc-shaped strip hole left at a position of the cutting deck 310 corresponding to the step 32114 is convenient for the air circulation when the cutting deck 310 is in a lowest position.

Please refer to FIG. 104, FIG. 105, FIG. 109 and FIG. 111. The cutting motor 321 is electrically connected with the motor controller 323 by a connecting wiring 3215, which means that a wiring outlet 32115 is left on one side of the motor end cover 131. A first end of the connecting wiring 3215 is electrically connected with the cutting motor 321 through the wiring outlet 32115, and a second end of the connecting wiring 3215 is electrically connected with the motor controller 323. An energy storage device supplies power to the motor controller 323, and the motor controller 323 distributes a direction of a rotating speed and controls a current according to a rotating speed signal required by the cutting motor 321. In some embodiments, the connecting wiring 3215 adopts a protective connector, and after a wiring connection is completed, the controller protective cover 3240 is installed above the motor controller 323, so that a protection level reaches IP65, and a water ingress is avoided at a terminal connection, which may result in the motor being unable to operate.

The cutting deck assembly of the disclosure integrates the mowing motor and the motor controller on the cutting deck of the mower, which utilizes one motor controller to control an operation of the plurality of mowing motors simultaneously, saves a layout space of the whole machine, reduces a cost of the whole vehicle and its own weight, facilitates the heat dissipation of the motor controller, and enables it to be able to maintain a long-term efficient operation. In addition, a stator coil of the motor is installed in a sinking way, so that a main component of the motor is located below the cutting deck. On one hand, a volume of the motor is reduced, a center of gravity of the motor is reduced, and the motor runs more smoothly. On the other hand, the heating components of the motor are concentrated below the cutting deck, the heat generated during a running of the motor is concentrated below the cutting deck, and the cutting blade may be used as a heat dissipation fan to accelerate the heat dissipation.

Please refer to FIG. 104, FIG. 105, FIG. 109 and FIG. 108. The disclosure further provides the mower. The mower includes the frame 100, the walking assembly, the battery 800, the cutting deck assembly and the cutting blade assembly. The frame 100 is used for installing other parts as a vehicle support, the walking assembly is connected with the frame 100 and is used for driving the mower to walk, and the battery 800 is installed on the frame 100 to provide power to the driving assembly of the mower and the cutting deck assembly. The cutting deck assembly is installed at the bottom of the frame 100. In an embodiment, the cutting deck assembly 300 includes the cutting deck 310, the motor controller 323 and a plurality of cutting motors 321. The motor controller 323 and the cutting motor 321 are both installed on the cutting deck 310, the plurality of the cutting motors 321 is installed on the cutting deck 310 and all electrically connected with the motor controller 323, and the motor controller 323 centrally controls the rotation of each cutting motor 321. The cutting blade assembly includes the plurality of cutting blades 322, and a number of cutting blades 322 corresponds to a number of cutting motors 321. The cutting blades 322 are correspondingly arranged on an output shaft of the cutting motor 321 through a cutter base one by one. A structure of each component in the cutting deck assembly 300 may be described in detail above and will not be repeated here.

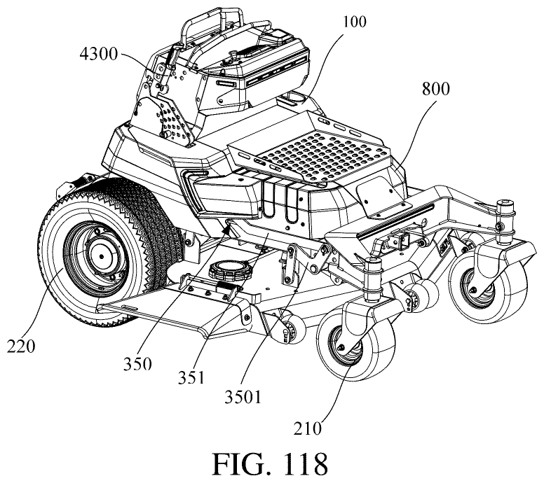

Please refer to FIG. 118. In an embodiment, the walking assembly includes a driving wheel 2200 and a power device (not shown in the figure) that drives the driving wheel to walk. The power device may, for example, be a walking motor, and the walking motor is electrically connected with the battery 800. The battery 800 provides power to the walking motor to drive the driving wheel 2200 to walk. In some embodiments, the mower further includes the steering wheel 2100, the driving wheel 2200 is installed at the rear end of the frame 100, the steering wheel 2100 is installed at the front end of the frame 100, and the steering wheel 2100 is the universal wheel, which may realize the steering of the mower.

Please refer to FIG. 104 and FIG. 118. In an embodiment, the cutting deck 310 is provided with a plurality of connecting bases 314 and rollers 380, the rollers 380 are arranged at the front end of the cutting deck 310, and the cutting deck 310 is arranged at a bottom of the frame 100 through the connecting bases 314. For example, the cutting deck 310 is provided with four connecting bases 314, the four connecting bases 314 are symmetrically distributed on front and rear sides of the cutting deck 310, and the cutting deck 310 is connected with the frame 100 through the four connecting bases 314. In some embodiments, the mower further includes the height adjustment device 350 for adjusting the height of the cutting deck. The height adjustment device 350 may be any structure that can adjust the height of the cutting deck 310. In an embodiment, the height adjustment device 350 includes a front height adjustment component 3501, a rear height adjustment component (not shown in the figure), a first connection rod 420, a second connection rod and a height adjustment handle 440. Structures and connection modes of the front height adjustment component 3501 and the rear height adjustment component are the same. The front height adjustment component 3501 is hinged with the connecting base 314 at a front side of the cutting deck 310, and the rear height adjustment component 3501 is hinged with the connecting base 314 at a rear side of the cutting deck 310. A first end of the first connection rod 420 is hinged with the front height adjustment component 3501, and a second end of the first connection rod 420 is hinged with the post-height-adjusting piece. The front height adjustment component 3501 and the rear height adjustment component are connected to form a parallelogram structure through the first connection rod 420, and the rear height adjustment component is hinged with the height adjustment handle 430 through the second connection rod. The height adjustment handle 430 rotates through a linkage of the rear height adjustment component and the second connection rod with the front height adjustment component 3501 to adjust the height of the cutting deck 310. A rotation shaft (not shown in the figure) is arranged between the front height adjustment components 3501, a rotation shaft is arranged between the rear height adjustment components, and the front height adjustment components 3501 and the rear height adjustment components 420 rotate around the rotation shafts. When the height adjustment handle 430 rotates, the rear height adjustment component and the second connection rod are driven to rotate. The rear height adjustment component drives the front height adjustment component 3501 to rotate simultaneously through the first connection rod 420, and a hinge chain on the front height adjustment component 3501 and the rear height adjustment component drives a lifting and lowering of the cutting deck 310.

Other structures of the mower of the disclosure that are not described in detail may be realized by the conventional structure of the art, and are not described in detail here.

The cutting deck assembly of the disclosure integrates the mowing motor and the motor controller on the cutting deck, which utilizes one motor controller to control an operation of the plurality of mowing motors simultaneously, saves a layout space of the whole machine, reduces the cost of the whole vehicle and its own weight, facilitates the heat dissipation of the motor and the controller, and enables it to maintain the long-term efficient operation.

The mower of en embodiment of the disclosure includes the walking mechanism. A walking driving mechanism is provided with a sealing structure at a connection of the driving motor and the reducer to realize a sealing along a circumferential surface and/or a radial surface of the connection, so as to solve a technical problem that in the walking driving mechanism of the prior art, there is a gap between the motor and the reducer, and foreign matter and impurities are easy to enter in a harsh environment, which may cause the reducer to fail.

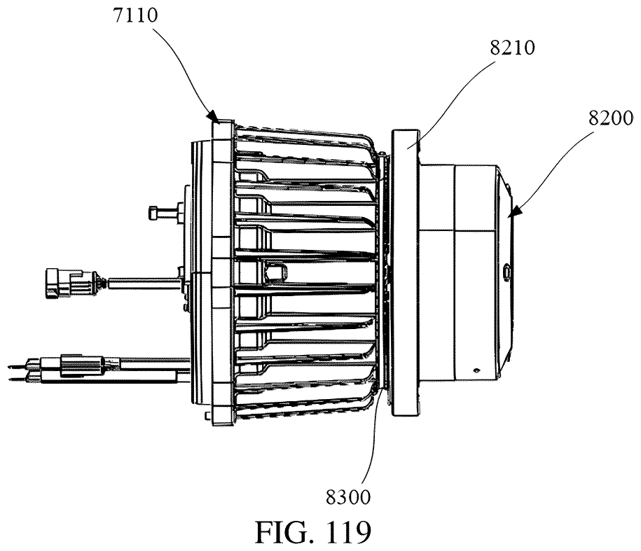

Please refer to FIG. 119 through FIG. 132. The walking driving mechanism mentioned above includes the driving motor 7110, the reducer 200 and the scaling structure. In an embodiment, the reducer 200 is coaxially connected with the driving motor 7110, the walking wheel 600 is coaxially connected with the reducer 200, and the driving motor 7110 drives the walking wheel 600 to rotate through the reducer 200. The sealing structure is arranged at a coaxial connection of the driving motor 7110 and the reducer 200, and a scaling fit is formed between the driving motor 7110 and the reducer 200. In an embodiment, in order to increase a circumferential sealing area of the sealing structure, the sealing structure extends radially or circumferentially from an axial overlapping position of the driving motor 7110 and the reducer 200, and the scaling fit is formed on the circumferential surface and/or the radial surface at an axial overlapping position, so as to realize that foreign matters are prevented from entering a rotating gap between the reducer 200 and the driving motor 7110.

Please refer to FIG. 119. In an embodiment of the disclosure, the driving motor 7110 is coaxially arranged with the reducer 200, and is fixed and connected with the reducer 200 through the bolt. A first scaling component 8300 is coaxially sleeved on the driving motor 7110 and/or the reducer 200, so that it is matched with the driving motor 7110 and/or the reducer 200 at a connection between the driving motor 7110 and/or the reducer 200 to form a sealing. For example, in an embodiment, the first sealing component 8300 is coaxially sleeved along the circumferential direction at the connection of the driving motor 7110 and the reducer 200, and at the same time matched with the driving motor 7110 and the reducer 200 at an inner ring and/or an outer ring of the first sealing component 8300 to form a seal between the driving motor 7110 and the reducer 8200. In another embodiment, The first sealing component 8300 is coaxial sleeved on one side of a housing of the reducer 8200 towards the driving motor 7110, and the first scaling component 8300 is fixedly arranged on an outer gear ring 8210 of the reducer 200, and is relatively matched with an end surface of the housing of the driving motor 7110 on one side towards the driving motor 7110 to form the scaling. In a third embodiment, the first sealing component 8300 is coaxial sleeved is on the housing of the driving motor 7110 towards the reducer 200, and the first scaling component 8300 is fixedly arranged on a circumferential periphery of the housing of the driving motor 7110, and is arranged relative to an outer tooth ring end surface 8211 of the reducer 8200 on one side towards the reducer 200. There is a gap between the first sealing component 8300 and the outer tooth ring end surface 8211, and one surface of the first scaling component 8300 towards the reducer 8200 is matched with the outer tooth ring end surface 8211 on a radial plane to form the sealing structure to realize a sealing protection function of an internal structure of the reducer 200 and the driving motor 7110 without affecting a relative rotation of the reducer 200 and the driving motor 7110.

In an embodiment, the reducer 200 mentioned above is a planetary reducer 200, and a characteristic of planetary reducer 200 is that it can generate a larger reduction transmission ratio with a smaller axial size, and its axial length may even be less than a width of the walking wheel 600, so the reducer 200 can be completely hidden in the walking wheel 600, which then increases a utilization rate of a lateral space.

In an embodiment, a gap distance between the first sealing component 8300 and the outer tooth ring end surface 8211 is from 1 mm to 3 mm, and this gap distance may be 1 mm, 2 mm or 3 mm for example.

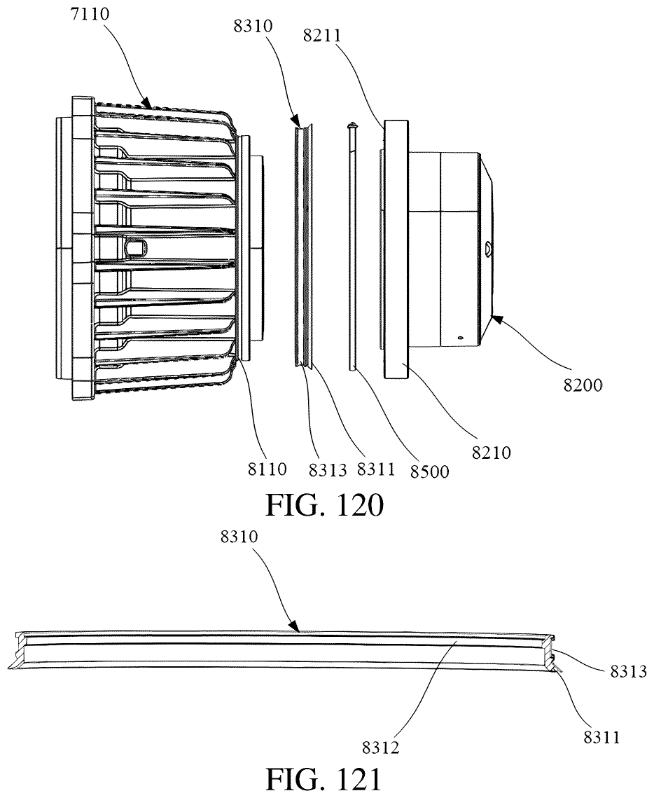

Please refer to FIG. 120 through FIG. 122. In an embodiment of the disclosure, the driving motor 7110 is coaxially arranged with the reducer 200, and is fixed and connected with the reducer 200 through the bolt. The first sealing component 8300 is coaxially sleeved on the housing of one side of the driving motor 7110 towards the reducer 200, and the first scaling component 8300 is fixedly arranged on the circumferential periphery of the housing of the driving motor 7110. The first sealing component 8300 does not rotate axially on the housing of the driving motor 7110, and the first sealing component 8300 is arranged relative to the outer tooth ring end surface 8211 of the reducer 200 on a plane facing one side of the reducer 200.

Please refer to FIG. 120 through FIG. 122. In this embodiment, the first scaling component 8300 is a first sealing ring 310. The first sealing ring 310 is sleeved and fixed on a periphery of the housing of the driving motor 7110, and the first scaling ring 310 is provided with a first elastic structure 8311. The first elastic structure 8311 protrudes and is arranged on a surface of the first sealing component 8300 towards the reducer 200, and the first elastic structure 8311 extends in a closed loop along the circumferential direction on an end surface of the first scaling component 8300. When the reducer 200 is coaxially assembled to the driving motor 7110. A first end of the first sealing ring 310 is fixed by a sleeve to achieve the sealing structure with the driving motor 7110, and the first clastic structure 8311 protruding at a second end of the first scaling ring 310 is interference abutted on the outer tooth ring end surface 8211 of the reducer 200 (the outer tooth ring end surface 8211 is a radial plane that is axially connected with the reducer 200 relative to the driving motor 7110). An end of the first clastic structure 8311 abuts and fits on the outer tooth ring end surface 8211 along the radial direction, and prevent the external foreign matter from entering from an abutting position through a friction matching with the outer tooth ring end surface 8211 when the outer ring gear 210 rotates, so as to form the sealing structure that does not affect an axial rotation of the reducer 200.

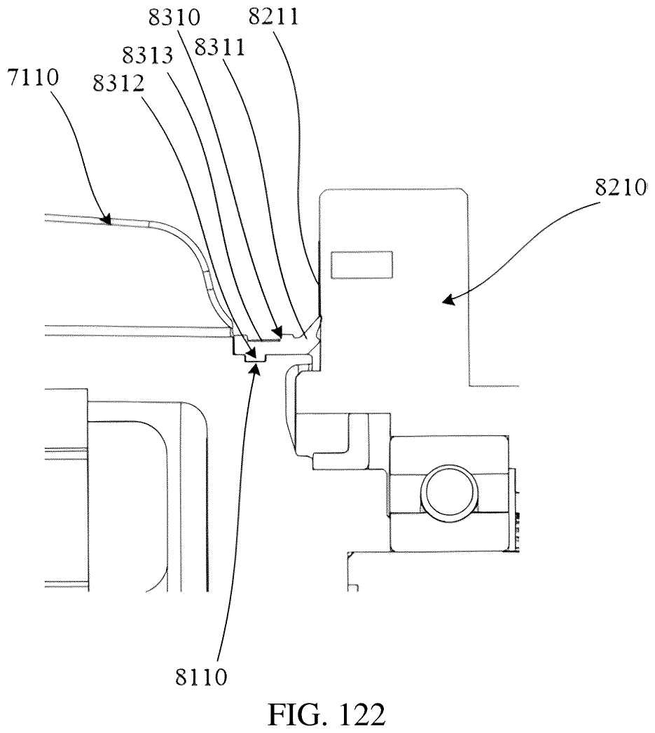

Please refer to FIG. 121 and FIG. 122. In this embodiment of the disclosure, the end of the first elastic structure 8311 is set to a double-lip structure. When the double-lip structure at the end of the first clastic structure 8311 is interference abutted on the outer tooth ring end surface 8211 of the reducer 200, the double-lip structure may form two rings of scaling structures at different radial positions on the outer tooth ring end surface 8211, whereby the two rings of the scaling structure can form two block parts at a connection position of the driving motor 7110 and the reducer 200, so as to enhance a sealing effect between the first sealing ring 310 and the reducer 200.

Please refer to FIG. 121 and FIG. 122. In an embodiment of the disclosure, an inner ring of the first sealing ring 310 is provided with a first protrusion 8312. The first protrusion 8312 is arranged along a circumferential inner edge of the first sealing ring 310, and the driving motor 7110 is provided with a first groove 8110 matched with the first protrusion 8312 on a circumferential outer edge of a housing at a side of the reducer 200. When the first sealing ring 310 is sleeved on the housing of the driving motor 7110, the first protrusion 8312 on the inner ring of the first sealing ring 310 is clamped and fixed in the first groove 8110 around a circumferential outer edge of the driving motor 7110. The housing of the driving motor 7110 clamps the first protrusion 8312 with elastic deformation characteristics in the first groove 8110, so that the first scaling ring 310 is fixed on the housing of the driving motor 7110.

Please refer to FIG. 120. In an embodiment of the disclosure, an outer ring of the first scaling ring 310 is further provided with a clamping hood 8500. The clamping hood 8500 is sleeved on the outer ring of the first sealing ring 310, and the clamping hood 8500 limits the first scaling ring 310 in the circumferential direction, so that the first sealing ring 310 is sleeved on the housing of the driving motor 7110. In an embodiment, a circumferential surface of the outer ring of the first sealing ring 310 is provided with a second groove 8313 concave inward. A shape of the second groove 8313 is matched with the clamping hood 8500, and a flange extending inward is arranged at two ends at a top of a groove body. The clamping hood 8500 is embedded in the second groove 8313 along the circumferential direction of the first scaling ring 310, and is blocked and fixed in the groove body by the top flange of the second groove 8313.

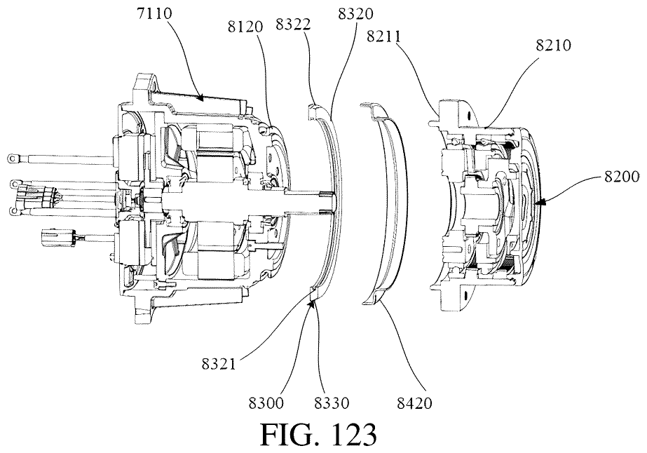

Please refer to FIG. 123 through FIG. 126. In some embodiments, the driving motor 7110 is coaxially arranged with the reducer 200, and is fixed and connected with the reducer 200 through the bolt. The sealing structure between the driving motor 7110 and the reducer 200 is provided with the first sealing component 8300 and a second sealing component 8400 matched with each other. In an embodiment, the first sealing component 8300 is coaxially sleeved on the housing of one side of the driving motor 7110 towards the reducer 200, and the first scaling component 8300 is fixedly arranged on the circumferential periphery of the housing of the driving motor 7110. The first sealing component 8300 does not rotate axially on the housing of the driving motor 7110. The second sealing component 8400 is coaxially arranged on one side of the reducer 200 towards the driving motor 7110, and the first sealing component 8300 and the second scaling component 8400 are arranged relative to each other at a radial plane at the connection position between the driving motor 7110 and the reducer 200, and matched with each other to form the scaling.

Please refer to FIG. 123 through FIG. 126. In an embodiment of the disclosure, the first scaling component 8300 is a second sealing ring 8320. The second sealing ring 8320 is sleeved and fixed on the periphery of the housing of the driving motor 7110, and an outer ring of the second scaling ring 8320 is provided with a second elastic structure 8322 along a circumferential outer edge. The second elastic structure 8322 extends in a ring along the circumferential direction of the outer ring of the second sealing ring 8320. The second sealing component 8400 is an oil scaling 8410. The oil scaling 8410 is provided with a plane, and this plane extends along the radial direction. The oil sealing 8410 is coaxially connected with the outer tooth ring 210 of the reducer 200 on a first side of the radial plane, and the oil sealing 8410 is provided with a lip edge 8412 on a second side of the radial plane. The lip edge 8412 is arranged along a circumferential outer edge of the radial plane of the oil sealing 8410, and the lip edge 8412 extends to a side of the driving motor 7110 at a circumferential outer edge of the oil sealing 8410. When the reducer 200 is coaxially assembled to the driving motor 7110, the second sealing ring 8320 is sleeved on the housing of the driving motor 7110 towards one side of the reducer 200. One end of the oil scaling 8410 is coaxially connected with the outer tooth ring 210 of the reducer 200, the radial plane on the oil sealing 8410 is arranged opposite to one side of the second sealing ring 8320 towards the reducer 200, and the lip edge 8412 arranged along the circumferential outer edge of the oil scaling 8410 is located on a circumferential outward side of the second sealing ring 8320. The second clastic structure 8322 protruding on the outer ring of the second sealing ring 8320 is interference abutted with an inner wall of the lip edge 8412 of the oil sealing 8410. An end of the second clastic structure 8322 conflicts and fits with the inner wall of the lip edge 8412 along a circumferential plane. And when the outer tooth ring 210 rotates along the axial direction, the external foreign matter is prevented from entering from a conflicting position by a friction and matching with the inner wall of the lip edge 8412 of the oil sealing 8410 along the circumferential direction, so as to form the sealing structure that does not affect the axial rotation of the reducer 200.

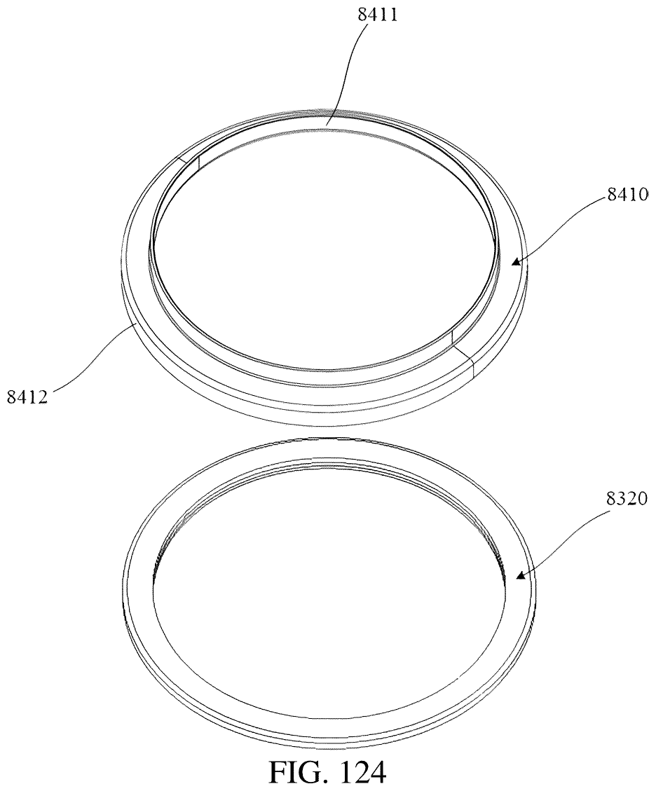

Please refer to FIG. 124 through FIG. 126. In this embodiment, the sealing structure utilizes the matching between the second sealing ring 8320 and the oil scaling 8410 in the radial plane and the circumferential plane, and effectively utilizes a sealing area of a matching between the first sealing component 8300 and the second sealing component 8400 increased by a small gap distance at the connection position of the driving motor 7110 and the reducer 200, so that the scaling effect of the sealing structure is improved.

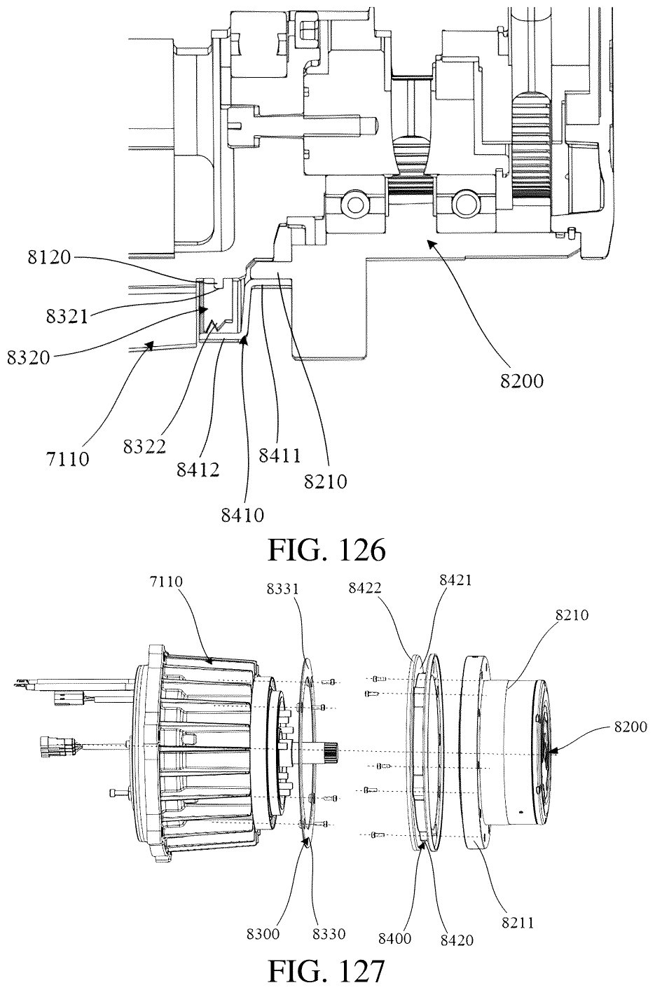

Please refer to FIG. 123 and FIG. 126. In an embodiment of the disclosure, one end of the oil scaling 8410 connected with the reducer 200 is provided with a tightening steel ring 8411. The tightening steel ring 8411 is arranged along a circumferential inner edge of the radial plane of the oil sealing 8410, the tightening steel ring 8411 extends outward along the axial direction, and a size of the tightening steel ring 8411 matches the outer tooth ring 210 of the reducer 200. The tightening steel ring 8411 of the oil sealing 8410 is sleeved on the outer tooth ring 210 of the reducer 200, for example, sleeved on an outer side of the outer tooth ring 210. The oil scaling 8410 is firmly connected with the reducer 200 through an interference fit between the tightening steel ring 8411 and the outer tooth ring 210.

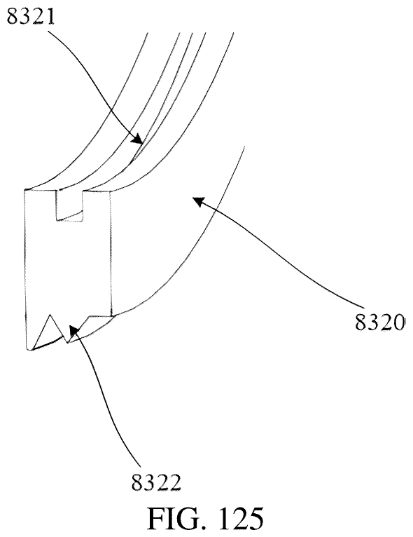

Please refer to FIG. 125 and FIG. 126. In this embodiment of the disclosure, the end of the second elastic structure 311 is set to the double-lip structure. When the double-lip structure at the end of the second clastic structure 8322 is interference abutted on the inner wall of the lip edge 8412 of the oil scaling 8410, the double-lip structure may form two rings of sealing structures at different axial positions on the inner wall of the lip edge 8412. The two rings of the scaling structure can form two block parts at a circumferential surface of the second sealing ring 8320 opposite to the oil scaling 8410, so as to enhance a sealing effect between the second sealing ring 8320 and the oil sealing 8410.

Please refer to FIG. 125 and FIG. 126. In an embodiment of the disclosure, an inner ring of the second sealing ring 8320 is provided with a third groove 8321. The third groove 8321 is arranged along a circumferential inner edge of the second sealing ring 8320, and the driving motor 7110 is provided with a second protrusion 120 matched with the third groove 8321 on the circumferential outer edge of the housing at the side of the reducer 200. When the second scaling ring 8320 is sleeved on the housing of the driving motor 7110, the second protrusion 120 on the circumferential outer edge of the housing of the driving motor is clamped and fixed in the third groove 8321 on the inner ring of the second sealing ring 8320. The driving motor 7110 utilizes an interference fit between the second protrusion 120 and the third groove 8321 to fix the second scaling ring 8320 on the housing of the driving motor 7110.

Please refer to FIG. 127 through FIG. 130. In some embodiments, the first scaling component 8300 is provided with a first deck surface 8331, and the second sealing component 8400 is provided with a second deck surface 8421. The first deck surface 8331 of the first sealing component 8300 and the second deck surface 8421 of the second sealing component 8400 are relatively arranged along the radial plane. A gap is maintained between the first deck surface 8331 and the second deck surface 8421, and the first sealing component 8300 and the second scaling component 8400 utilize the gap between the first deck surface 8331 and the second deck surface 8421 to prevent an entry of external foreign matters, so as to form the sealing structure that does not affect the axial rotation of the reducer 200.

In an embodiment, a gap distance between the first deck surface 8331 and the second deck surface 8421 is from 1 mm to 3 mm, and this gap distance may be 1 mm, 2 mm or 3 mm for example.

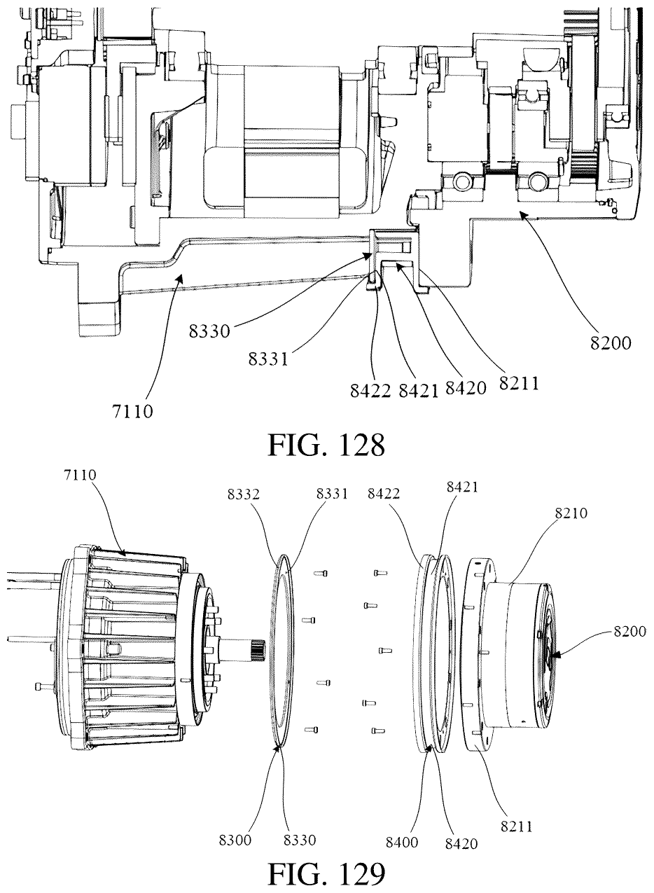

Please refer to FIG. 127 and FIG. 128. In an embodiment of the disclosure, the first scaling component 8300 is an end surface pressing plate 8330. One surface of the end surface pressing plate 8330 towards the reducer 200 is set to the first deck surface 8331. The end surface pressing plate 8330 is sleeved on one side of the housing of the driving motor 7110 towards the reducer 200, and the end surface pressing plate 8330 is sleeved in a circumferential periphery of the housing of the driving motor 7110, and is fixedly connected with the housing of the driving motor 7110 by bolts. The second scaling component 8400 is a rotating frame 8420, and the rotating frame 8420 is fixedly connected with the outer tooth ring end surface 8211 of the reducer 200 through the bolts. The second deck surface 8421 of the rotating frame 8420 and the first deck surface 8331 of the first sealing component 8300 are arranged relative to each other along the radial plane, and are matched with each other to form the scaling.

Please refer to FIG. 127 and FIG. 128. In an embodiment of the disclosure, the rotating frame 8420 is provided with a first flange 8422 on the second deck surface 8421, and the first flange 8422 on the second deck surface 8421 is arranged along the circumferential outer edge of the first deck surface 8331 and extends to one side of the driving motor 7110. When the driving motor 7110 and the reducer 200 are axially connected, the first deck surface 8331 of the end surface pressing plate 8330 is arranged opposite to the second deck surface 8421 of the rotating frame 8420. The first flange 8422 arranged on the second deck surface 8421 surrounds a periphery of the end surface pressing plate 8330 along the circumferential direction, and the circumferential outer edge of the end surface pressing plate 8330 is relatively matched with the first flange 8422 on the circumferential plane to form the sealing. In an embodiment, between the end surface pressing plate 8330 and the rotating frame 8420, in addition to utilizing the relative matching of the first deck surface 8331 and the second deck surface 8421 to form the sealing structure on the radial surface, the sealing structure on the circumferential surface is also formed through a relative matching of an outer edge of the end surface pressing plate 8330 and the first flange 8422 on the rotating frame 8420. The sealing structure of the circumferential surface can produce an outward centrifugal force at a gap between the end surface pressing plate 8330 and the first flange 8422 to throw out the foreign matter entering the gap when the rotating frame 8420 rotates relative to the end surface pressing plate 8330 with the reducer 200, so as to achieve an efficient scaling.

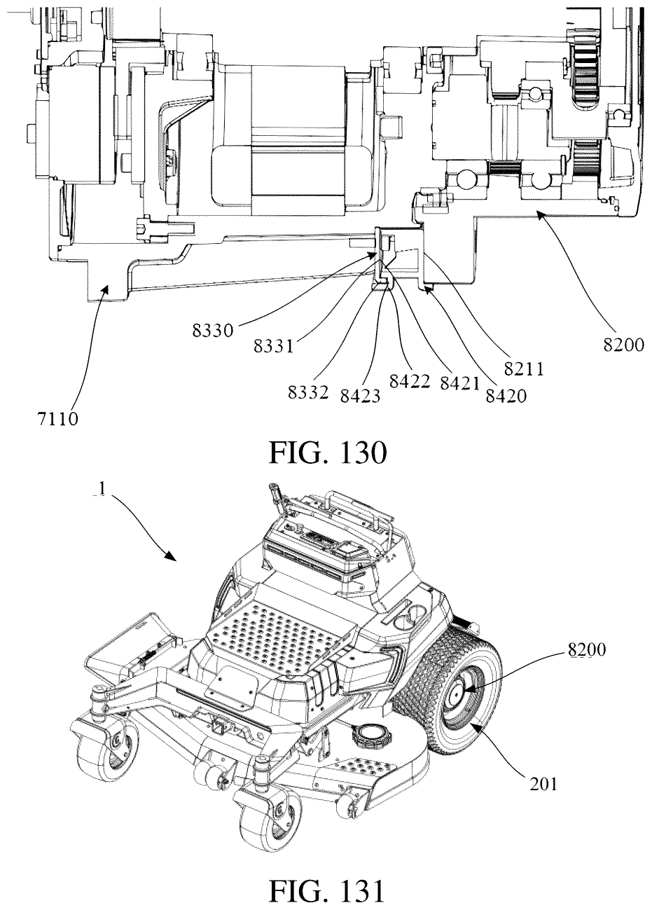

Further, please refer to FIG. 129 and FIG. 130. In an embodiment of the disclosure, the end surface pressing plate 8330 is provided with a second flange 8332 on the first deck surface 8331, and the second flange 8332 on the first deck surface 8331 is arranged along an inner edge of the circumferential direction of the second deck surface 8421 and extends to one side of the reducer 200. The second deck surface 8421 of the rotating frame 8420 is provided with a scaling groove 8423 at a position corresponding to the second flange 8332. The scaling groove 8423 is arranged along the inner edge of the circumferential direction of the second deck surface 8421, and a shape of the sealing groove 8423 matches the second flange 8332. In an embodiment, an outer ring of the sealing groove 8423 is arranged at the first flange 8422 located at an outer edge of the second deck surface 8421, and an inner ring of the sealing groove 8423 is arranged at an inner edge of the second deck surface 8421.

Please refer to FIG. 130. When the driving motor 7110 and the reducer 200 are axially connected, the first deck surface 8331 of the end surface pressing plate 8330 is arranged opposite to the second deck surface 8421 of the rotating frame 8420. The second flange 8332 arranged on the first deck surface 8331 is embedded in the sealing groove 8423 arranged on the second deck surface 8421, and in the scaling groove 8423, the second flange 8332 is respectively matched with inner walls of both sides of the scaling groove 8423 and a bottom of the groove to form the scaling. Under a premise of not affecting the relative rotation of the reducer 200, the scaling structure increases a sealing length between the end surface pressing plate 8330 and the rotating frame 8420 on a plurality of radial and circumferential surfaces, which effectively improves the sealing effect of the scaling structure.

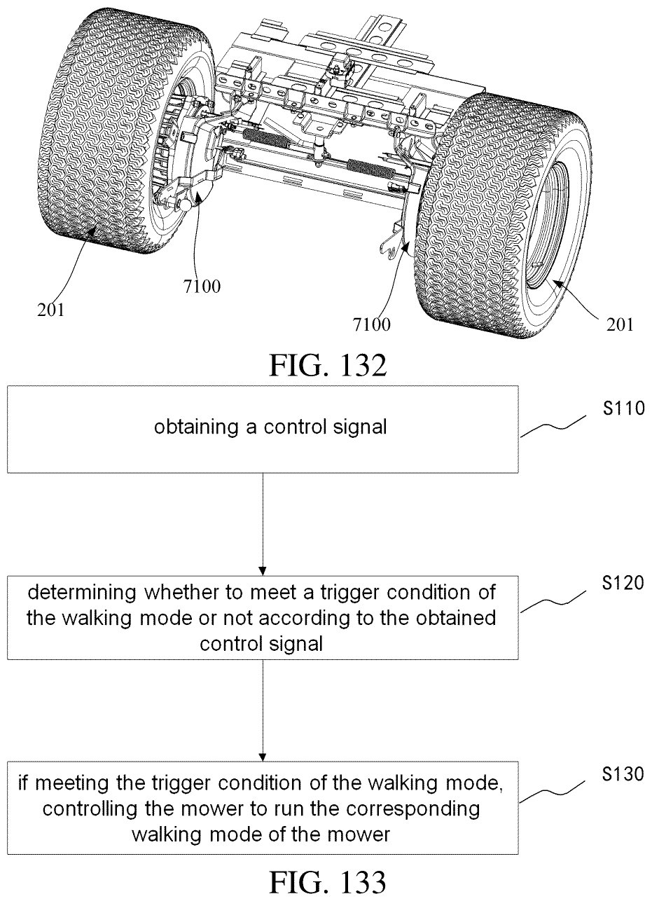

Please refer to FIG. 131 and FIG. 132. The mower 1 of the disclosure includes the machine body, the power battery, the driving motor 7110, the reducer 200, the walking wheel 600, the sealing structure, as well as the necessary working assembly, the operating assembly, the control module and so on.

In an embodiment, the walking wheel 600 is arranged at two sides of the machine body. The walking wheel 600 may be the inflatable wheel that is made up of the tire and the wheel hub, for example, or may be the integrated wheel made of polymer. The structure of the wheel is not limited to the certain form, but the premise is that the wheel center needs to have the cavity that can accommodate the reducer 200 or even the driving motor 7110. The power battery is fixed on the machine body and is electrically connected with the driving motor 7110 to provide power to the driving motor 7110. The driving motor 7110 is fixedly arranged on the machine body, and may be used as a supporting structure connecting the walking wheel 600 and the machine body. An output end of the driving motor 7110 is provided with the reducer 200, a power input end of the reducer 200 is coaxially connected with the output shaft of the driving motor 7110, and the power output end of the reducer 200 is coaxially connected with the walking wheel 600. For example, the reducer 200 is the planetary reducer 200, the reducer 200 is arranged in a cavity of the walking wheel 600, and the outer tooth ring 210 as the power output end of the reducer 200 is connected with the cavity of the walking wheel 600.

Please refer to FIG. 119. The sealing structure is arranged at the coaxial connection of the driving motor 7110 and the reducer 200, and the sealing fit is formed between the driving motor 7110 and the reducer 200. In an embodiment, in order to increase the circumferential sealing area of the sealing structure, the sealing structure extends radially or circumferentially from the axial overlapping position of the driving motor 7110 and the reducer 200, and the scaling fit is formed on the circumferential surface and/or the radial surface at the axial overlapping position, so as to realize that foreign matters are prevented from entering the rotating gap between the reducer 200 and the driving motor 7110.

In the walking driving mechanism and the mower provided by the disclosure, the scaling structure is arranged at the connection of the driving motor and the reducer, and the scaling structure is formed by the radial surface or the circumferential surface of a connection position of the driving motor and the reducer to form a sealing fit, so that a sealing length of the scaling structure is effectively increased by utilizing a small gap at the connection position of the driving motor and the reducer, and then the foreign body impurities are prevented from entering the rotating gap between the reducer and the driving motor while not affecting the axial rotation of the reducer, so as to achieve an effective sealing effect.

Embodiment 2: please refer to FIG. 133. This embodiment provides the mower, the mower is provided with a control method, which includes:

S110: obtaining a control signal.

After the mower is powered on, the mower enters a standby state and obtains the control signal. The control signal may be sent by sensors, switches, etc. on the mower, or by the operator when selecting an operating mode, or by a remote control. In an embodiment, the mower is provided with a first sensor. The first sensor is configured to detect whether the operator is on the mower. When the operator is on the mower and is not on the mower, a different signal is emitted. For example, when the operator is on the mower, the first sensor sends a first signal, and when the operator is not on the mower, the first sensor sends a second signal. In an embodiment, the first sensor is a pedal signal switch. The pedal signal switch is arranged on a pedal device. When the operator stands on the pedal, the pedal signal switch is in a connecting state, and the first signal is sent. When the operator is not standing on the pedal, the pedal signal switch is in a separating state, and the second signal is sent. It should be noted that when the pedal signal switch is in the separating state, there is a situation that the pedal signal switch cannot send a signal. At this time, the pedal signal switch does not send the signal. Then by default, when the pedal signal switch does not send the signal, it is also the second signal. In other words, when the first sensor sends the first signal, it is determined that the operator stands on the pedal of the mower, and when the first sensor sends the second signal, it is determined that the operator does not stand on the pedal of the mower. In another embodiment, when the operator stands on the pedal, the pedal signal switch is in the separating state, and the first signal is sent. It should be noted that there is a situation that the pedal signal switch cannot send the signal at this time, then by default, when the signal that the pedal signal switch is not obtained, and the first signal is also sent out for the pedal signal switch. When the operator does not stand on the pedal, the pedal signal switch is in the connecting state, and the second signal is sent. In another embodiment, the first sensor may monitor a position of the pedal to determine whether there is an operator on the pedal. For example, when the operator stands on the pedal, the pedal is rotated to a first position by a gravitational action of the operator. When the person does not stand on the pedal, the pedal is reset to an initial position by a force of a reset mechanism, and the first sensor determines whether there is an operator standing by monitoring the position of the pedal. In other embodiments, the first sensor determines whether there is an operator on the pedal by monitoring whether there is a block on the pedal and other means, and a method that the first sensor determines whether there is an operator on the pedal may be selected according to the actual needs.

In an embodiment, the mower is provided with a second sensor, and the second sensor is used for detecting whether the operating mechanism is in a parking position. When the operating mechanism is in the parking position and a non-parking position, the second sensor sends out different signals. For example, when the operating mechanism is in the non-parking position, the second sensor sends a third signal, and when the operating mechanism is in the parking position, the second sensor sends a fourth signal. In an embodiment, the second sensor detects position information of the operating lever of the mower, thereby determining an operating intention of the operator. When the second sensor sends the fourth signal, the operating lever is in the parking position, and the mower enters or maintains a parking state. When the second sensor sends the third signal, the operating lever is in the non-parking position, and the mower enters or maintains a walking mode. In an embodiment, after the mower enters the walking mode, it makes forward or backward movements according to a control of the operator or a preset program. Only when it enters the walking mode and the operator does not further control or does not preset the program, the mower does not make forward or backward movements. In an embodiment, in an initial state of an operating handle, the second sensor sends the fourth signal. When the operator controls the operating handle to get out of the initial position, the second sensor sends the third signal. In an embodiment, the second sensor is an operating signal switch of the mower. In the initial state, the operating signal switch is in a combined state, the second sensor signal at this time is the fourth signal. When the operating handle is wrenched, the operating signal switch is in the separating state, the second sensor signal at this time is the third signal, and a control part of the mower enters the walking mode after receiving a walking signal. After the operating handle further acts, the mower is controlled to move forward or backward.

S120: determining whether to meet a trigger condition of the walking mode or not according to the obtained control signal.

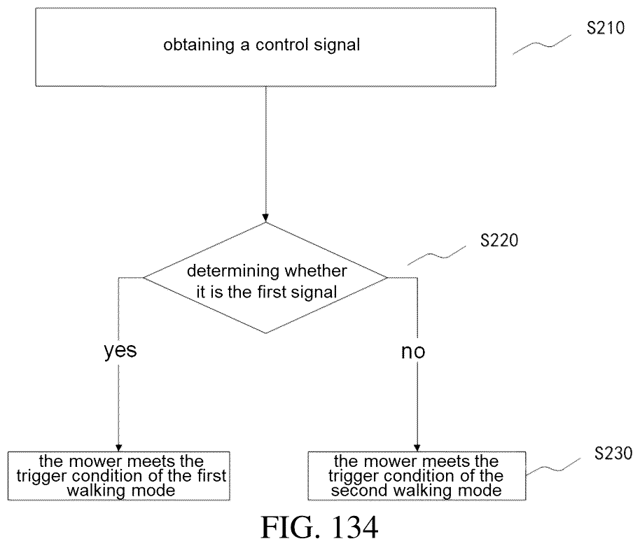

It is further determined whether to meet the trigger condition of the walking mode or not according to the obtained control signal. In an embodiment, the control signal includes the first signal. The first signal is configured to be generated when the operator arrives at a driving position and/or when a mode selection is performed. In an embodiment, the first signal is generated when the operator arrives at the driving position, and in another embodiment, the first signal is generated when the operator performs mode selection in a first walking mode. In other embodiments, the first signal may be generated when the operator arrives at the driving position and selects the first walking mode. In some embodiments, the first signal is generated when the operator arrives at the driving position. If obtaining the first signal, it is determined that it meets the trigger condition of the first walking mode. In an embodiment, the control signal further includes the second signal. The second signal is configured to be generated when the operator arrives at a pushing position and/or when the mode selection is performed. In an embodiment, the second signal is generated when the operator arrives at the pushing position. The pushing position may be a fixing position, or it may be the pushing position when the operator is not in the driving position. In an embodiment, the second signal is generated when the operator performs mode selection. For example, if a second walking mode is selected, the second signal is generated. In an embodiment, the second signal may be generated when the operator arrives at the pushing position and selects the second walking mode. In some embodiments, the second signal is generated when the operator arrives at the pushing position. Determining whether to meet a trigger condition of a walking mode or not according to the obtained control signal includes: determining to meet the trigger condition of the second walking mode if the second signal is obtained. In an embodiment, if not obtaining the first signal, it is also determined that it meets the trigger condition of the second walking mode. Please refer to FIG. 134. When there are two walking modes in the mower, the first signal corresponds to meet the trigger condition of the first walking mode, then it is determined whether a received signal is the first signal. When it is the first signal, then it is determined that the trigger condition of the first walking mode is met. When it is not the first signal, then it is determined that the trigger condition of the second walking mode is met.

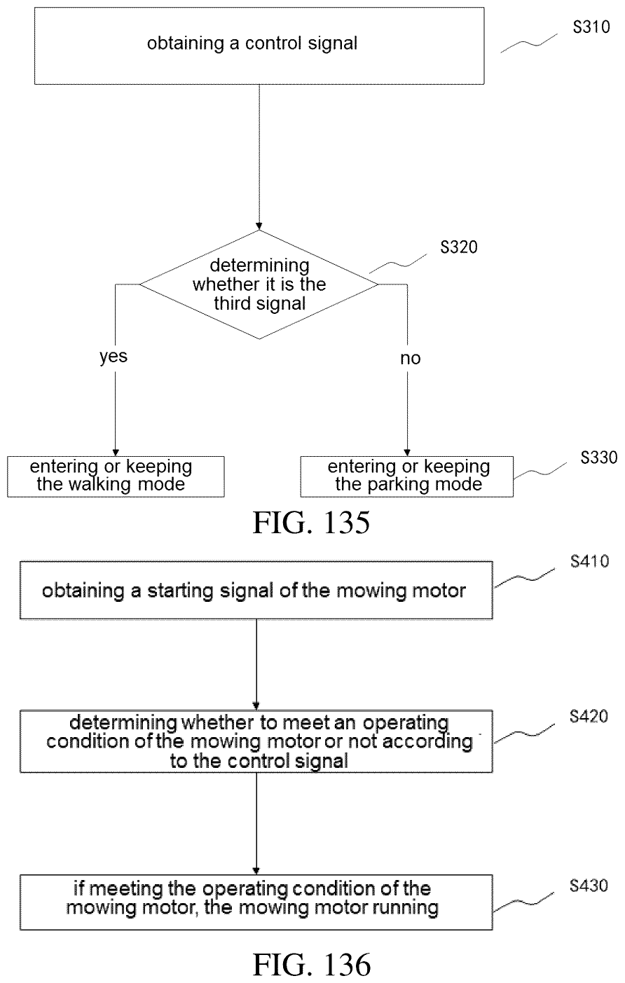

In an embodiment, the control signal includes the third signal, which is configured to be sent when the operating mechanism is in the non-parking state and/or when the mode selection is performed. In an embodiment, the third signal is sent when the operating mechanism is in the non-parking state. In another embodiment, the third signal is sent when the walking mode is selected in the parking mode and the walking mode. In other embodiments, the third signal is sent when the operating mechanism is in the non-parking state and when the mode selection is performed. In some embodiments, the third signal is sent when the operating mechanism is in the non-parking state. Determining whether to meet the trigger condition of the walking mode or not according to the obtained control signal includes: determining to meet the trigger condition of entering or maintaining the walking mode if the third signal is obtained. In an embodiment, the control signal includes the fourth signal, which is configured to be sent when the operating mechanism is in the parking state and/or when the mode selection is performed. In an embodiment, the fourth signal is sent when the operating mechanism is in the parking state. In another embodiment, the fourth signal is sent when the parking mode is selected during the mode selection. In another embodiment, the fourth signal is sent when the operating mechanism is in the parking state and when the mode selection is performed. In some embodiments, the fourth signal is sent when the operating mechanism is in the parking state. Determining whether to meet the trigger condition of the walking mode or not according to the obtained control signal includes: determining not to meet the trigger condition of entering or maintaining the walking mode if the fourth signal is obtained. Please refer to FIG. 135. In an embodiment, the third signal corresponds to meet the trigger condition of the walking mode, then it is determined whether a received signal is the third signal. When it is the third signal, then it is determined that the trigger condition of the walking mode is met. When it is not the third signal, then it is determined that the trigger condition of the parking mode is met.

S130: if meeting the trigger condition of the walking mode, controlling the mower to run the corresponding walking mode of the mower.

When meeting the trigger condition of the walking mode, the mower is controlled to run the corresponding walking mode of the mower. It should be noted that, when meeting the trigger condition of a certain walking mode, the mower directly corresponds to the corresponding walking mode when it enters the walking mode. In an embodiment, when the mower meets the trigger condition of the first walking mode, the first walking mode is directly run when the mower enters the walking mode. When the mower meets the second walking mode, the mower enters the walking mode and directly runs the second walking mode.

In an embodiment, a signal of a first sensor includes the first signal and the second signal, a signal of the second sensor includes the third signal and the fourth signal. In an embodiment, the signal of the first sensor and the signal of the second sensor are obtained simultaneously and are determined simultaneously, so that an operation state of the mower is determined. In another embodiment, the controller first determines the signal of the first sensor, determines that it is the first walking mode or the second walking mode of the mower, and then determines the signal of the second sensor, thereby determining that the mower is in the parking state or is running the corresponding walking mode. In other embodiments, the controller first determines the signal of the second sensor, if the mower runs or enters the walking mode, then determines the signal of the first sensor, thereby controlling the mower to run the .specific first walking mode or the second walking mode. In an embodiment, the signals of the first sensor and the second sensor may be obtained in real time, or they may be obtained when signal states of the first sensor and the second sensor changes, which may be selected according to the actual needs.

In an embodiment, according to the signal of the first sensor, the mower runs different modes. In different modes, forward and backward speeds of the mower are different, so as to facilitate a use of the mower in different situations. If the operator is in the driving position, the mower runs the first walking mode, and the first walking mode may also be called an ordinary mode, which means that the staff is moving forward synchronously on the mower. When special terrain or parts of the area need to be mowed repeatedly, the operator is in the pushing position, the mower runs the second walking mode, and the second walking mode may also be called an accompanying mode, which means that the staff is not on the mower to control the mower to move forward, and the staff follows the mower to move. When the state of the operator changes, the signal of the first sensor changes, and the operating mode of the mower also changes. If the operator moves from the driving position to the pushing position, the mower switches from the first walking mode of running to the second walking mode. If the operator moves from the pushing position to the driving position, then the mower switches from the second walking mode to the first walking mode. The walking mode of the mower follows an action of the operator to switch, which is more convenient to control the mower, and meets diverse use needs.

In an embodiment, in the first walking mode, a maximum forward speed of the mower is a first forward speed, and a maximum backward speed is a first backward speed. In order to ensure a safety and facilitate operation, the first forward speed is not less than the first backward speed. In the second walking mode, the maximum forward speed of the mower in the second walking mode is a second forward speed, the maximum backward speed is a second backward speed, and the second forward speed is not less than the second backward speed, so that the staff may better operate the mower to move.

In an embodiment, in a same gear, the first forward speed is greater than the second forward speed, and the first backward speed is greater than the second backward speed. When in the second walking mode, the operator is not on the mower, there is a situation that the operator and the mower cannot move synchronously. The second forward speed is less than the first forward speed, and the second backward speed is less than the second backward speed, so that the staff may follow the mower to move forward or backward. When working in a special environment, a driving speed of the mower is reduced, a reaction time of the staff is improved, a personal safety is guaranteed, and a safety of the mower is improved.

In the first walking mode, the forward speed of the mower is provided with a plurality of gears. In an embodiment, the forward speed of the mower in the first walking mode is provided with four gears. In an embodiment, in a first gear, the first forward speed is from 3 mph to 5 mph, and the first forward speed may be any value between 3 mph to 5 mph, such as 3 mph, 4 mph, 5 mph, etc. In an embodiment, when the first forward speed is 3 mph, the forward speed of the mower is 0 mph to 3 mph, and when the first forward speed is 5 mph, the forward speed of the mower is 0 mph to 5 mph. In an embodiment, an allowable error of the first forward speed is +0.3 mph, if the first forward speed is 4 mph, an actual first forward speed may be between 3.7 mph to 4.3 mph, so as to meet the actual use requirements. In other words, when the mower is in the first gear of the first walking mode, if the first forward speed is 4 mph, a forward speed range of the operator operating the mower is from 0 mph to 4 mph, and s specific speed is determined according to the control of the operator. For example, for the mower with the operating handle, the specific speed is determined according to an amplitude and a speed range of the operator pulling the operating handle. In a second gear, the first forward speed is from 5 mph to 8 mph, and any value between 5 mph and 8 mph may be selected, such as 5 mph, 6 mph, 7 mph. An allowable error between a designed first forward speed and an actual first forward speed is +0.3 mph. In a third gear, the first forward speed is from 9 mph to 11 mph, and it may be any value between 9 mph and 11 mph, such as 9 mph, 10 mph, 11 mph, etc. The allowable error between the designed first forward speed and the actual first forward speed is +0.3 mph. In a fourth gear, the first forward speed is from 13 mph to 15 mph, the first forward speed may be any value between 13 mph and 15 mph, such as 13 mph, 14 mph, 15 mph, etc. The allowable error between the designed first forward speed and the actual first forward speed is +0.3 mph. In an embodiment, the first forward speed of the fourth gear is 14 mph, then the forward speed range of the mower is from 0 mph to 14 mph, and the actual forward speed matches the operator's operation, such as determined according to a rotating amplitude of the operating lever, a pedaling amplitude of an accelerator pedal, etc. Different first forward speeds in different gears meet different walking requirements, mowing requirements, and use requirements of different staff. When the mower runs the first walking mode, the first backward speed is from 3 mph to 5 mph, and the first backward speed may be any value between 3 mph and 5 mph, such as 3 mph, 4 mph, 5 mph, etc. In an embodiment, an allowable error of the first backward speed is +0.3 mph, if the design first backward speed is 4 mph, the actual first retreat speed may be between 3.7 mph and 4.3 mph. In other embodiments, the first backward speed under different gears may also be different, and the first backward speed is preferably the same to prevent a backward speed from being too fast, which results in improper operation of the mower.

In the second walking mode, the mower forward speed is provided with three gears. In an embodiment, in a first gear, the second forward speed is from 1.75 mph to 2.75 mph, and the second forward speed may be any value between 1.75 mph and 2.75 mph, such as 1.75 mph, 2 mph, 2.25 mph, 2.75 mph, etc. In a second gear, the second forward speed is from 2.75 mph to 3.25 mph, which may be any value between 2.75 mph and 3.25 mph, such as 2.75 mph, 3 mph, 3.25 mph, etc. In a third gear, the second forward speed is 3.5 mph to 4.5 mph, which may be any value between 3.5 mph and 4.5 mp, such as 3.5 mph, 4 mph, 4.5 mph, etc. In an embodiment, an allowable error between the designed second forward speed and the actual second forward speed is +0.3 mph. In an embodiment, when the mower runs the second walking mode, the second backward speed is from 1.75 mph to 2.75 mph, which may be any value between 1.75 mph and 2.75 mph, such as 1.75 mph, 2 mph, 2.25 mph, 2.75 mph, etc. In an embodiment, the allowable error between the designed second backward speed and the actual second backward speed is +0.3 mph. In other embodiments, the second backward speed may be different under different gears, and the second backward speed is preferably the same under different gears. Different second forward speeds meet the use requirements of different staff, and a difference between the second forward speeds between adjacent gears is less than a difference between the first forward speeds between adjacent gears, which may avoid that when a difference of the second forward speed between different gears is too large, the speed is suddenly increased or reduced, a center of gravity of the staff is unstable, so an occurrence of accidents such as staff falling is prevented.

When the mower is working, the mowing motor needs to start to drive the blade to rotate to mow. However, in the conventional mower, only when the operator is in the driving position, the mowing motor can start in order to be convenient to meet different use needs. Please refer to FIG. 136. The control method of the mower of the disclosure further includes:

S410: obtaining a starting signal of the mowing motor.

The starting signal of the mowing motor is usually sent by a mowing motor switch. After the mower is powered on, when the mowing motor switch is connected, the starting signal of the mowing motor is sent after a mower power is turned on.

S420: determining whether to meet an operating condition of the mowing motor or not according to the control signal.

It is determined whether to meet the operating condition of the mowing motor or not according to the control signal mentioned above. In an embodiment, if the control signal is the first signal and/or the third signal, it is determined that the operating conditions of the mowing motor are met. In an embodiment, when the operator is in the driving position and/or the operating mechanism is in the non-parking position, it is determined that the operating conditions of the mowing motor are met, which means that when either the operator is in the driving position or the operating mechanism is in the non-parking position, it is determined that the operating conditions of the mowing motor are met. If the operator is not in the driving position and the operating mechanism is in the parking position, then it is determined that the operating conditions of the mowing motor are not met.

It should be noted that, when any of the control signals change, a starting state of the mowing motor is determined to remain or change according to a new signal state. In an embodiment, if the signal of the second sensor that detects whether the operating mechanism is in the parking position keeps the third signal, and the signal of the first sensor that detects whether the operator is in the driving position changes from the first signal to the second signal, the mowing motor keeps the starting state. If the signal of the second sensor changes from the third signal to the fourth signal, and the signal of the first sensor changes from the first signal to the second signal, the mowing motor interrupts the starting state and is in the stopping state. In other words, only when the operator is not on a board of the driving position and the operating handle is not pulled, the mowing motor is in the stopping state.

S430: if meeting the operating condition of the mowing motor, the mowing motor running.

When meeting the operating condition of the mowing motor, the mowing motor runs and drive the cutting blade to rotate and work.

In an embodiment, the disclosure further provides the control method of the mower. The control method is configured to control a start of the mowing motor and is independent of the walking mode of the mower. The control method specifically include:
obtaining the starting signal of the mowing motor;
obtaining the signal of the second sensor and the signal of the first sensor;
If the second sensor sends the third signal and/or the first sensor sends the first signal, the mowing motor starts. If the second sensor sends the fourth signal and the first sensor sends the second signal, the mowing motor does not start.

It should be noted that, there is no sequence between obtaining the starting signal of the mowing motor and obtaining the signal of the second sensor and the signal of the first sensor, the starting signal of the mowing motor may be obtained first, and the signal of the second sensor and the signal of the first sensor may also be obtained first.

The control method of the mower of the disclosure may allow people to follow the mower to work when encountering uneven ground or obstacles and other environments. It may perform the mowing work in various working environments, which has a simple structure, is easy to operate, reduce usage costs and improves user's experience.

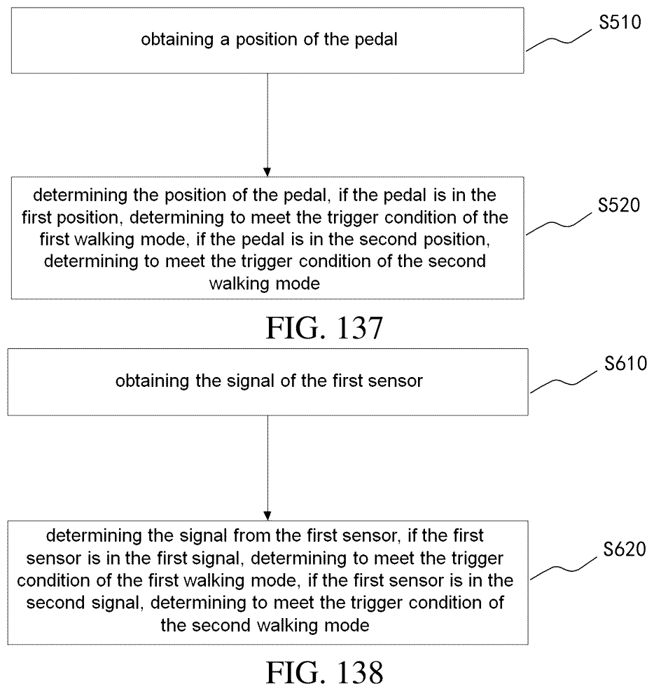

Please refer to FIG. 137. The disclosure further provides the control method of the mower. The mower is provided with the pedal, and the pedal is provided with at least a first position and the second position. In an embodiment, when the operator is standing on the pedal, the pedal is in the first position, and when the operator is not standing on the pedal, the pedal is out of the first position and is in the second position. The control method specifically include:

S510: obtaining a position of the pedal.

In an embodiment, obtaining the position of the pedal may be specifically obtaining that the pedal is in the first position or the second position, or it may only determine whether the pedal is in the first position. Specifically, when the pedal is not in the first position, the pedal is determined to be in the second position.

S520, determining the position of the pedal, if the pedal is in the first position, determining to meet the trigger condition of the first walking mode, if the pedal is in the second position, determining to meet the trigger condition of the second walking mode.

According to the position of the pedal, it is determined whether the operator is on the pedal, so as to determine whether the trigger condition of the corresponding walking mode is met. When the pedal is in the first position, it is determined that the operator is on the pedal, so as to determine the trigger condition of meeting the first walking mode. The mower directly the first walking mode when it enters the walking mode. When the pedal is in the second position, it is determined that the operator is not on the pedal, so as to determine the trigger condition of meeting the first walking mode. The mower directly the second walking mode when it enters the walking mode.

Please refer to FIG. 138. The disclosure provides the control method of the mower. The mower is provided with the first sensor. The first sensor is configured to detect whether the operator is on the pedal of the mower. The control method specifically includes:

S610: obtaining the signal of the first sensor.

S620: determining the signal from the first sensor, if the first sensor sends in the first signal, determining to meet the trigger condition of the first walking mode, if the first sensor sends in the second signal, determining to meet the trigger condition of the second walking mode. In an embodiment, when the operator is on the mower, the first sensor sends the first signal, and when the operator is not on the mower, the first sensor sends the second signal. The first sensor may be an inductive sensor, such as an infrared sensor, to detect whether there is a person in the driving position (including the standing position), and may also be a triggering sensor, such as a pressure switch, a contact switch, etc. When there is a person in the driving position, a corresponding signal is sent. When the mower enters the walking mode, the corresponding walking mode is run directly.

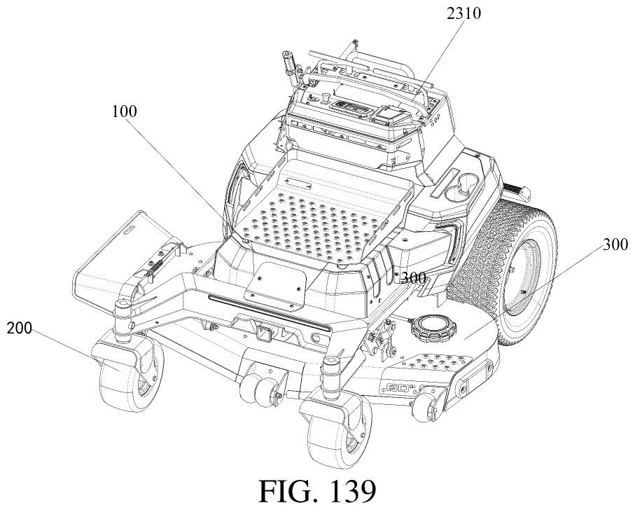

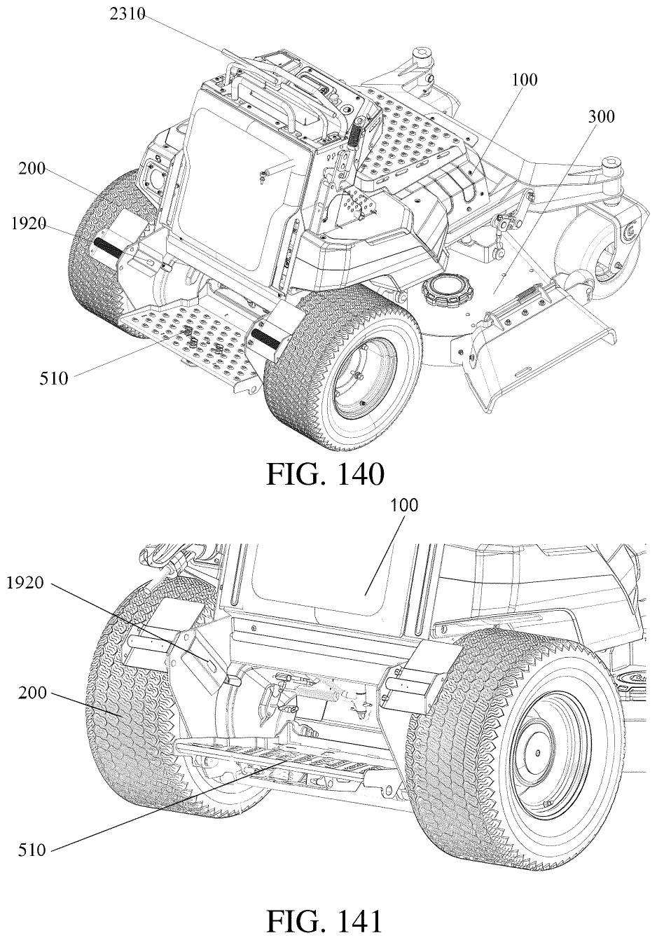

Please refer to FIG. 139 through FIG. 140. The disclosure further provides the mower. The mower includes the frame 100, the cutting deck assembly 300, the operating mechanism 2310, the walking mechanism 200, the pedal device 510 and the control part.

In an embodiment, the cutting deck assembly 2310 is installed at the bottom of the frame 100, the cutting deck assembly 2310 includes the mowing motor and the blade, and the mowing motor drives the blade to rotate for mowing.

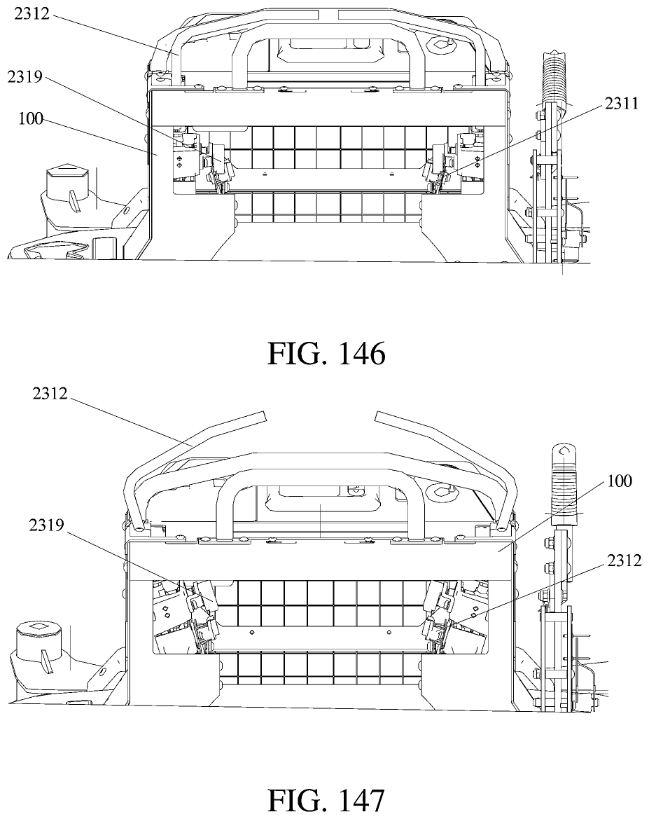

Please refer to FIG. 146 through FIG. 149. The operating mechanism 2310 includes the operating lever 2312, the operating lever mounting base 2311 and the second sensor. The operating lever 2312 is rotatably installed on the operating lever mounting base 2311, and the operating lever mounting base 2311 is rotatably installed on the frame 100. In an embodiment, the second sensor is fixed on the operating lever mounting base 2311, and the operating lever mounting base 2311 rotates with the frame 100 to realize a change of the signal of the second sensor. In another embodiment, the second sensor is fixed on the frame 100, and the operating lever mounting base 2311 rotates with the frame 100 to realize the change of the signal of the second sensor. When the operating lever mounting base 2311 is in an initial state, the second sensor sends the second signal, and when the operating lever 2312 drives the operating lever mounting base 2311 to rotate around the frame, the second sensor sends the first signal. In an embodiment, an axis of the operating lever 2312 rotating around the operating lever mounting base 2311 is perpendicular to an axis of the operating lever mounting base 2311 rotating around the frame 100, so that the operating lever 2312 drives the operating lever mounting base 2311 to rotate around the frame. In an embodiment, the operating lever 2312 includes a left operating lever and a right operating lever. The operating lever mounting base includes a left operating lever mounting base and a right operating lever mounting base, and the second sensor is arranged on each operating lever mounting base 2311 to better operate the mower. In an embodiment, the second sensor may be the inductive sensor, such as an infrared inductive sensor, and may also be a contact switch, such as the operating signal switch 2319. When in the initial state, the operating signal switch 2319 is in the connecting state, and it is the fourth signal at this time. When the operating lever 2312 drives the operating lever mounting base 2311 to rotate around the frame, the operating signal switch 2319 changes to a disconnecting state, and it is a walking signal at this time. The second sensor is preferably the contact switch, which has low cost, high recognition rate, and is easy to use in complex environments.

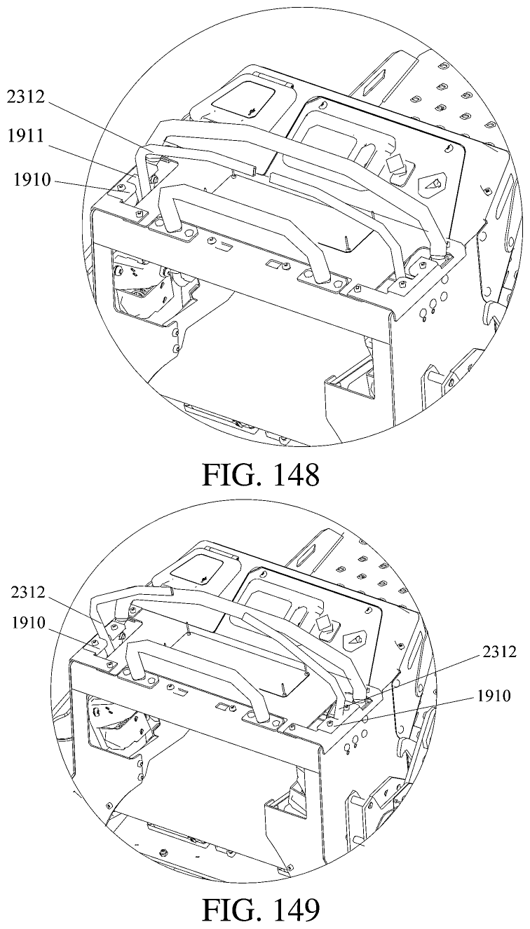

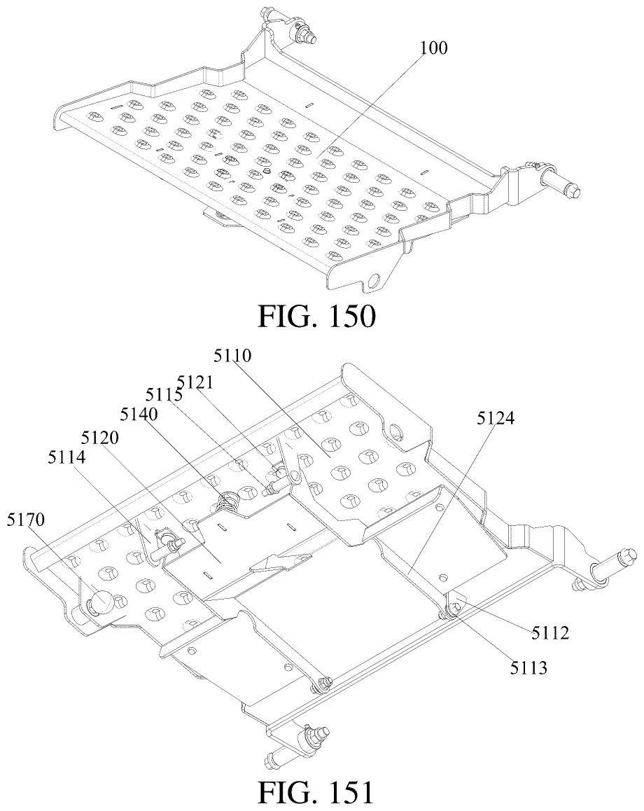

Please refer to FIG. 148 through FIG. 149. In an embodiment, a limiting plate 1910 is arranged on the frame 100, and a limiting groove 1911 is arranged on the limiting plate 1910. When the operating lever 2312 is located in the limiting groove 1911, the limiting groove 1911 limits the operating lever 2312 to rotate relative to the operating lever mounting base 2311. When the operating lever 2312 is rotated towards outside the limiting groove 1911, the operating lever mounting base 2311 rotates synchronously with the operating lever 2312, so that the operating lever mounting base 2311 rotates relative to the frame 100, and the signal of the second sensor is switched from the second signal to the first signal.

In an embodiment. the operating mechanism 2310 further includes a reset device. After an external force of the reset device on the operating lever mounting base 2311 disappears, the operating lever mounting base 2311 automatically returns to the initial state, so that after the staff releases the operating lever 2312, the operating lever mounting base 2311 automatically returns to the initial state, which avoids the mower from continuing to run, reduces the danger, and prevents accidents such as staff injury.

The walking mechanism 200 includes the driving motor and a traveling wheel. The operating mechanism 2310 controls the driving motor, and the driving motor drives the traveling wheel to rotate to control the mower forward, backward and steering.

Please refer to FIG. 143 through FIG. 145. The pedal device 510 includes a pedal 5110 and the first sensor. In an embodiment, the first sensor detects whether the operator is on the pedal. When the operator is on the pedal, the first sensor sends the first signal, and when the operator is not on the pedal, the first sensor sends the second signal. In an embodiment, the pedal is rotatably installed on the frame 100. When the pedal 5110 is in the initial state, the first sensor sends the second signal. After the pedal 5110 rotates to the ground to a preset angle, the first sensor sends switched to the first signal. In an embodiment, the first sensor is a pedal signal switch 5130. When the pedal 5110 is in the initial state, the pedal signal switch 5130 is in the separating state. When the pedal 5110 is subjected to an external force that exceeds a preset threshold and rotates to the ground to the preset angle, the pedal signal switch 5130 is switched to the connecting state. In an embodiment, the pedal device 510 further includes a reset bracket 5120 and a reset mechanism 5140. The pedal 5110 is rotatably installed on the frame 100, the reset bracket 5120 is rotatably installed on the pedal 5110, and the pedal signal switch 5130 is arranged on the reset bracket 5120 and/or the pedal 5110 to be connected when the pedal 5110 rotates to a set position relative to the reset bracket 5120. The reset mechanism 5140 is arranged between the reset bracket 5120 and the pedal 5110 to enable the pedal 5110 to rotate back after the external force acting on the pedal 5110 is removed, so that the pedal signal switch 5130 is disconnected. When the operator stands on the pedal 5110, the pedal 5110 is subjected to the external force that exceeds the preset threshold, and rotates to the set position relative to the reset bracket 5120, which means that after the pedal 5110 rotates to the ground to the preset angle, the pedal signal switch 5130 is connected, and the second signal is switched to the first signal. When the operator leaves by the pedal 5110, the pedal 5110 rotates back under an effect of the reset mechanism 5140, the pedal signal switch 5130 is separated, and it is switched to the second signal to monitor whether the operator stands on the pedal 5110, so that the garden tool may develop different operating modes according to whether the operator stands on the pedal 5110.

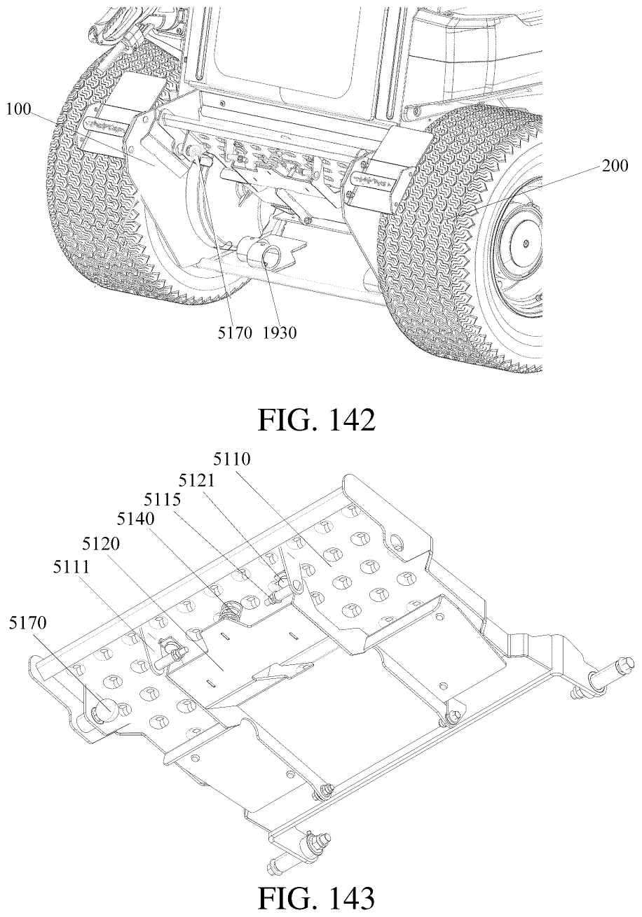

Please refer to FIG. 141 through FIG. 142. In an embodiment, the frame 100 is provided with a supporting shock absorbing component 1930, and the supporting shock absorbing component 1930 is arranged below the reset bracket 5120. The supporting shock absorbing component 1930 provides support to the pedal device 510, thereby facilitating the operator to step on the pedal 5110. In an embodiment, the supporting shock absorbing component 1930 is a transverse hollow cylindrical structure. When the operator stands on the pedal 5110 and the pedal device 510 contacts the supporting shock absorbing component 1930, the supporting shock absorbing component 1930 provides a shock absorbing effect to reduce an impact on the operator when the pedal device 510 contacts the supporting shock absorbing component 1930.

In an embodiment, the pedal signal switch 5130 may be an inductive switch, such as an infrared inductive switch, or the contact switch, preferably a contact switch, with low cost, high recognition rate, and convenient for use in complex environments. In an embodiment, the pedal signal switch 5130 includes two parts, one part is a main body part, and the other part is a contact point part, which is respectively arranged on the pedal 5110 and the reset bracket 5120. When the reset bracket 5120 is installed below the pedal 5110 and the contact point part is in contact with the main body part, the pedal signal switch 5130 is connected. When the contact point part is separated from the main body part, the pedal signal switch 5130 is disconnected. When the reset bracket 5120 is installed above the pedal 5110 and the contact point part is in contact with the main body part, the pedal signal switch 5130 is disconnected. When the contact point part is separated from the main body part, the pedal signal switch 5130 is connected. In an embodiment, the pedal signal switch 5130 is a whole, and the pedal signal switch 5130 is arranged on the pedal 5110. In another embodiment, the pedal signal switch 5130 is arranged on the reset bracket 5120.

Please refer to FIG. 143. In an embodiment, the reset bracket 5120 is provided with a first limiting part 51211, and the pedal is provided with a second limiting part 5111. The first limiting part 51211 is matched with the second limiting part 5111, and a maximum angle between the pedal 5110 and the reset bracket 5120 is limited. When the external force on the pedal 5110 disappears, which means that after the operator leaves the pedal 5110, the reset mechanism 5140 enables the pedal 5110 to rotate back. Through a matching between the first limiting part 51211 and the second limiting part 5111, the pedal 5110 may be avoided to be too far away from the reset bracket 5120, a use of the pedal device 510 is convenient, and the personnel are convenient to go up and down. In an embodiment, the second limiting part 5111 includes a limiting installation part 5114 arranged downward at a bottom of the pedal 5110 and a limiting sleeving rod 5115. The limiting sleeving rod 5115 extends to a direction of the reset bracket 5120. When the pedal 5110 rotates back to an initial position, a top of the limiting sleeve rod 5115 is in contact with a bottom of the first limiting part 51211. The first limiting part 51211 limits a further rotation of the limiting sleeve rod 5115, which means that when the first limiting part 51211 contacts with the limiting sleeving rod 5115, an angle between the reset bracket 5120 and the pedal 5110 is an maximum angle, so as to prevent the angle between the pedal 5110 and the reset bracket 5120 from being too large, which enables it to be inconvenient for the operator to step on the pedal 5110.

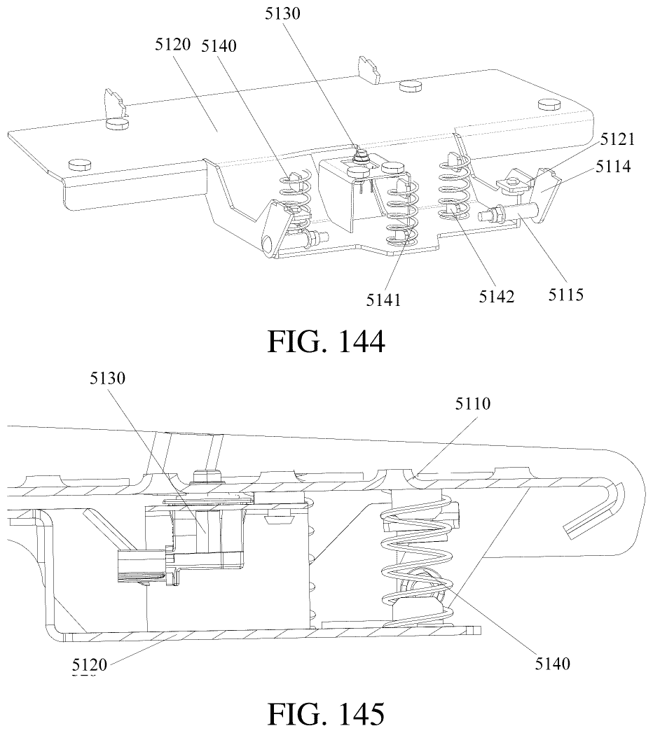

Please refer to FIG. 144. In an embodiment, the reset mechanism 5140 includes a compression spring 5141. A first end of the compression spring 5141 is fixed at a bottom of the pedal 5110, and a second end of the compression spring 5141 is fixed at a top of the reset bracket 5120. When the external force of the pedal 5110 disappears, the compression spring 5141 enables the pedal 5110 rotate back under its own elastic action. The compression spring 5141 has a stable action, stable backward rotation and low cost. In an embodiment, the pedal 5110 and the reset bracket 5120 are both provided with a fixing block 5142, and the fixing block 5142 is correspondingly arranged on the pedal 5110 and the reset bracket 5120. Two ends of the compression spring 5141 are sleeved on the fixing block 5142. When the pedal 5110 and the reset bracket 5120 are at the maximum angle, a distance between the two fixing blocks 5142 that is correspondingly arranged is less than a natural length of the compression spring 5141. In other words, when the pedal 5110 and the reset bracket 5120 are at the maximum angle, the compression spring 5141 cannot be removed from the fixing block 5142 in an uncompressed state. During installation, the compression spring 5141 is directly sleeved on the fixing block 5142 after compression, and no additional fixing is required, so that an installation and use of the compression spring 5141 are convenient.

In an embodiment, the frame 100 is provided with a limiting hole 1920, and a latch 5170 is arranged on the pedal device 510. When the pedal device 510 is folded, the latch 5170 is inserted into the limiting hole 1920 to limit a rotation of the pedal device 510. By arranging the latch 5170 and the limiting hole 1920, the pedal device 510 and the frame 100 may be prevented from rotating relative to each other during transportation, and a transportation safety is effectively guaranteed. In an embodiment, when the latch 5170 is inserted into the limiting hole 1920, the pedal signal switch 5130 is not connected. When the pedal device 510 is folded, under an effect of the reset mechanism 5140, the signal switch 5130 is in the separating state.

In an embodiment, when the second sensor sends a driving signal, if the first sensor sends the first signal, the mower starts the first walking mode. If the first sensor sends the second signal, the mower starts the second walking mode. The first sensor sends the first signal, which indicates that the operator stands on the pedal 5110 at this time, and controls the mower to start the first walking mode. The first sensor sends the second signal, which indicates that the operator does not stand on the pedal 5110 at this time, and controls the mower to start the second walking mode. Depending on where the staff stands, the mower starts different operating modes of operation, which is convenient for the staff to operate the mower better and more conveniently. Further, in an operation process of the mower, after the signal of the first sensor is changed, an operating mode of the control part controlling the mower is changed accordingly. For example, the signal of the first sensor is switched from the first signal to the second signal, then the mower is switched from the first walking mode to the second walking mode. Further, the second sensor includes two second sensors on left and right. When the signal of the two second sensors is a walking signal, the control part will obtain the walking signal, so as to reduce a problem of mower operation when the operator touches by mistake, which improves a use safety of the mower.

In an embodiment, in the same gear, an operating speed of the mower in the second walking mode is lower than an operating speed of the mower in the first walking mode. Further, in the first walking mode, a forward speed of the mower is the first forward speed, and a backward speed is the first backward speed. In order to ensure a safety and facilitate operation, in the same gear, the first forward speed is greater than the first backward speed. In the second walking mode, the forward speed of the mower in the second walking mode is a second forward speed, the backward speed is a second backward speed. In the same gear, the second forward speed is greater than the second backward speed, so that the operator may better operate the mower to move.

Further, in the same gear, the first forward speed is greater than the second forward speed, and the first backward speed is greater than the second backward speed. When in the second walking mode, the operator stands behind the mower rather than on the pedals and does not move with the mower synchronously. The second forward speed is less than the first forward speed, and the second backward speed is less than the second backward speed, so that the operator may follow the mower to move forward or backward. When working in a special environment, the driving speed of the mower is reduced, and the personal safety is guaranteed.

In an embodiment, in the first walking mode, the mower is set with multiple gears, and a maximum rotating speed of the driving motor in different gears is different. In an embodiment, in a first gear, when moving forward, the maximum rotating speed of the driving motor is from 1150 rpm to 1350 rpm, and the maximum rotating speed may be any value between 1150 rpm and 1350 rpm, such as 1150 rpm, 1250 rpm, 1251 rpm, 1350 rpm, etc. In a second gear, the maximum rotating speed is from 2050 rpm to 2250 rpm. In a third gear, the maximum rotating speed is from 2950 rpm to 3150 rpm, which may be any value between 2950 rpm and 3150 rpm, such as 2950 rpm, 3050 rpm, 3150 rpm, etc. In a fourth gear, the maximum rotating speed is from 4150 rpm to 4350 rpm, which may be any value between 4150 rpm and 4350 rpm, such as 4150 rpm, 4250 rpm, 4350 rpm, etc. In an embodiment, an allowable error between the maximum rotating speed of the above design and the actual maximum rotating speed is ±40, such as the maximum rotating speed of the design of a four-gear forward is 4250 rpm, and the actual rotating speed may be 4250±→0 rpm. In an embodiment, in the first walking mode, the maximum rotating speed of the mower when walking backward is from 1100 rpm to 1300 rpm, which may be any value between 1100 rpm and 1300 rpm, such as 1100 rpm, 1200 rpm, 1255 rpm, 1300 rpm, etc. An allowable error between the maximum rotating speed and the actual rotating speed when walking backward is ±40 rpm. For example, the maximum rotating speed when walking backward is 1200 rpm, and the actual rotating speed may be 1200±40 rpm. In other embodiments, in the different gears, the maximum rotating speed of the driving motor when the mower walks backward may be different. In some embodiments, when in the different gears, the maximum rotating speed of the driving motor when the mowing motor walks backward is the same.

In an embodiment, in the second walking mode, the mower is set with multiple gears, and the maximum rotating speed of the driving motor in the different gears is different. In an embodiment, in a first gear, when moving forward, the maximum rotating speed of the driving motor is from 550 rpm to 750, which may be any value between 550 rpm and 750 rpm, such as 550 rpm, 650 rpm, 685 rpm, 750 rpm, etc. In a second gear, the maximum rotating speed when moving forward is from 800 rpm to 1000 rpm, which may be any value between 800 rpm and 1000 rpm, such as 800 rpm, 900 rpm, 1000 rpm, etc. In a third gear, the maximum rotating speed when moving forward is from 1150 rpm to 1350 rpm, which may be any value between 1150 rpm and 1350 rpm, such as 1150 rpm, 1250 rpm, 1350 rpm, etc. In an embodiment, in the second walking mode, when the mower walks backward, the maximum rotating speed of the driving motor is from 550 rpm to 750 rpm, which may be any value between 550 rpm and 750 rpm, such as 550 rpm, 625 rpm, 650 rpm, 750 rpm, etc. In other embodiments, when the mower walks backward in the different gears, the maximum rotating speeds of the driving motor are different. In some embodiments, the maximum rotating speeds of the driving motor are the same. In an embodiment, in the second walking mode, the allowable errors between the design value and the actual value of the maximum forward and backward rotating speed are ±40. For example, the maximum rotating speed of the design of a three-gear forward is 1250 rpm, and the actual rotating speed may be 1210±1290 rpm.

In an embodiment of the disclosure, after the switch of the mowing motor is turned on, when any one of the two conditions that the second sensor sends the walking signal and the first sensor sends the first signal is satisfied, the mowing motor starts. If the second sensor sends the fourth signal and the first sensor sends the second signal, the mowing motor does not start. In order to meet the requirements of mowing under different circumstances, a start of the mowing motor may be before the mower walks, and may also be after the mower walks. For example, when the operator needs to mow locally, the operator stands on the pedal 5110, and the first sensor sends the first signal. At this time, the switch of the mowing motor is turned on, and the mowing motor may be started. For example, when the mowing motor needs to be turned off, it may be turned off by directly turning off the switch of the mowing motor, or when the first sensor sends the second signal and the second sensor sends the fourth signal, the mowing motor is also directly turned off. Further, the second sensor includes two second sensors on the left and right, when the signal of any one of the two second sensors is in the driving signal, the switch of the mowing motor is turned on, and the mowing motor may also be started, so that the mowing motor is more conveniently controlled, and the mowing needs under different conditions are satisfied.

The control method of the mower of the disclosure has the beneficial effect of switching the operating mode of the mower conveniently according to the standing position of the operator.

Please refer to FIG. 151 through FIG. 153. The mower in an embodiment includes the pedal device 510. The pedal device 510 includes the pedal 5110, the reset bracket 5120, the first sensor and the reset mechanism 5140. In an embodiment, the reset mechanism 5120 is rotatably installed on the pedal 5110. The first sensor is configured to detect whether the operator is standing on the pedal, and the first sensor is arranged on the reset mechanism 5120 and/or the pedal 5110 to send an in-position signal when the pedal 5110 rotates to the set position relative to the reset bracket 5120. The reset mechanism 5140 is arranged between the reset bracket 5120 and the pedal 5110 to enable the pedal 5110 to rotate back after the external force acting on the pedal 5110 is removed, so that the first sensor releases the in-position signal. Through the first sensor, it may be detected whether the operator stands on the pedal 5110. When the operator stands on the pedal 5110, the first sensor sends out the in-position signal, and when the operator does not stand on the pedal 5110, the first sensor releases the in-position signal. In an embodiment, the first sensor is a signal switch 5130. When the operator stands on the pedal 5110, the pedal 5110 rotates to the set position relative to the reset bracket 5120, so as to enable the signal switch 5130 to be connected. When the operator leaves by the pedal 5110, the pedal 5110 rotates back under the effect of the reset mechanism 5140, the signal switch 5130 is disconnected, which realize monitoring whether the operator stands on the pedal 5110, so that the garden tool may develop different operating modes according to whether the operator stands on the pedal 5110. In other embodiments, the first sensor may be a pressure sensor, an infrared induction sensor, etc.

In an embodiment, the reset bracket 5120 may be rotatably installed above the pedal 5110 or rotatably installed below the pedal 5110. When the reset bracket 5120 is rotatably installed above the pedal 5110, the operator stands on the pedal 5110, and the pedal 5110 rotates in the direction far away from the reset bracket 5120. When the set position is reached, the signal switch 5130 is connected. After the operator leaves from the pedal 5110, the reset mechanism 5140 enables the pedal 5110 to rotate back in a direction close to the reset bracket 5120. When the reset bracket 5120 is rotatably installed below the pedal 5110, the operator stands on the pedal 5110, and the pedal 5110 rotates in the direction close from the reset bracket 5120. After the operator leaves from the pedal 5110, the reset mechanism 5140 enables the pedal 5110 to rotate back in the direction far away to the reset bracket 5120. In some embodiments, the reset bracket 5120 is rotatably installed below the pedal 5110. When the pedal device 510 is installed on a tool, only the reset bracket 5120 needs to be relatively fixed with the tool, or the tool provides support to a bottom of the reset bracket 5120. When the person stands to the pedal 5110, the reset bracket 5120 may provide support to the pedal 5110, and a structure of an additional support for the pedal 5110 does not need to be added to the tool, so that an installation of the pedal device 510 is convenient.

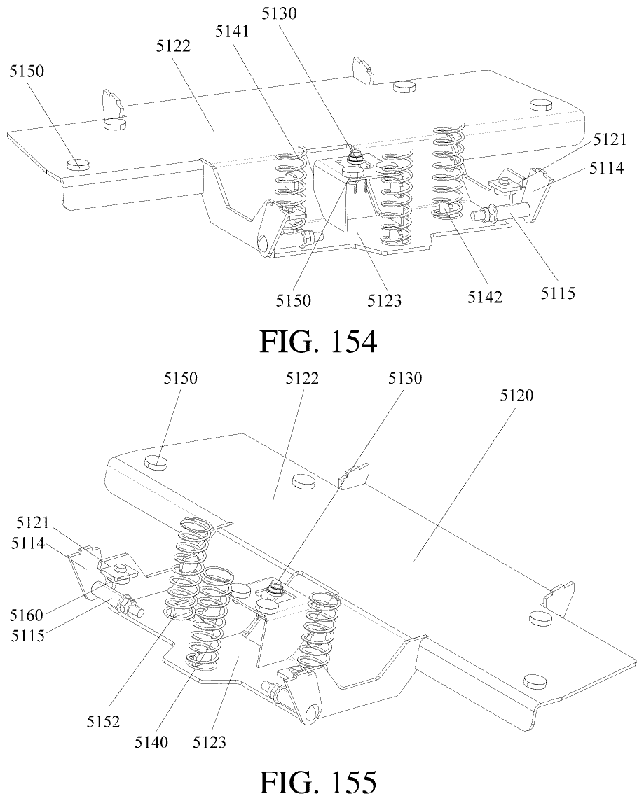

Please refer to FIG. 154 and FIG. 155. In an embodiment, the reset bracket 5120 includes a first zone 5122 and a second zone 5123. When the pedal 5110 is rotated to the set position, a distance between the second zone 5123 and the pedal 5110 is greater than a distance between the first zone 5122 and the pedal 5110. The first zone 5122 provides support for the pedal 5110, so as to ensure that the staff stands stably on the pedal 5110, and there is a certain space between the second zone 5123 and the pedal 5110 for installing the signal switch 5130 and the reset mechanism 5140. In some embodiments, when the pedal 5110 is rotated to the set position, the first zone 5122 is parallel to the pedal 5110 to ensure that the pedal 5110 is provided with a stable support. In an embodiment, the first area 5122 and the second area 5123 and a connecting area between the first zone 5122 and the second zone 5123 are all provided with reinforcing ribs 5124, which may improve a load-bearing capacity of the reset bracket 5120.

Please refer to FIG. 151. In an embodiment, the bottom of the pedal 5110 is provided with a rotating installation base 5112, a rotating shaft 5113 is arranged on the rotating installation base 5112, and the reset bracket 5120 is rotatably installed on the rotating installation base 5112 through the rotating shaft 5113. An installation space between the reset bracket 5120 and the pedal 5110 is increased by arranging the rotating installation base 5112, so as to facilitate the installation of the reset bracket 5120 and the pedal 5110. In an embodiment, the reinforcing rib 5124 of the reset bracket 5120 is rotatably connected with the rotating installation base 5112 to ensure that a rotating connection between the reset bracket 5120 and the pedal 5110 is stable, which improves a duration life of the pedal device 510.

In an embodiment, the signal switch 5130 may be the inductive switch, such as the infrared inductive switch, or the contact switch, preferably a contact switch, with low purchasing cost, high recognition rate, and convenient for use in complex environments. In an embodiment, the signal switch 5130 includes two parts, one part is the main body part, and the other part is the contact point part, which is respectively arranged on the pedal 5110 and the reset bracket 5120. When the reset bracket 5120 is installed below the pedal 5110 and the contact point part is in contact with the main body part, the signal switch 5130 is connected. When the contact point part is separated from the main body part, the signal switch 5130 is disconnected. When the reset bracket 5120 is installed above the pedal 5110 and the contact point part is in contact with the main body part, the signal switch 5130 is disconnected. When the contact point part is separated from the main body part, the signal switch 5130 is connected. In an embodiment, the signal switch 5130 is a whole, and the signal switch 5130 is arranged on the pedal 5110. In another embodiment, the signal switch 5130 is arranged on the reset bracket 5120.

Please refer to FIG. 154 through FIG. 155. In an embodiment, a shock absorbing pad 5150 is arranged between the reset bracket 5120 and the pedal 5110, and the shock absorbing pad 5150 is arranged at an abutting position between the pedal 5110 and the reset bracket 5120 when the pedal 5110 rotates to the set position relative to the reset bracket 5120. By adding the shock absorbing pad 5150, a rigid contact between the pedal 5110 and the reset bracket 5120 is avoided. On one hand, a wear and tear between the pedal 5110 and the reset bracket 5120 may be reduced, and the duration life of the pedal 5110 and the reset bracket 5120 is prolonged. On the other hand, when the staff steps on the pedal 5110, it plays a role of shock absorption and avoids causing damage to the staff. In an embodiment, the shock absorbing pad 5150 is made of rubber, and one end of the shock absorbing pad 5150 is fixed in the first zone 5122 of the reset bracket 5120. When the pedal 5110 rotates to the set position, one end of the shock absorbing pad 5150 away from the reset bracket 5120 is connected with the pedal 5110. In an embodiment, there is a plurality of the shock absorbing pad 5150, so that each area of the pedal 5110 may have a good support, which may provide better shock absorption effect at the same time. A number of shock absorbing pads 5150 may be two, three, four, five, six, etc.

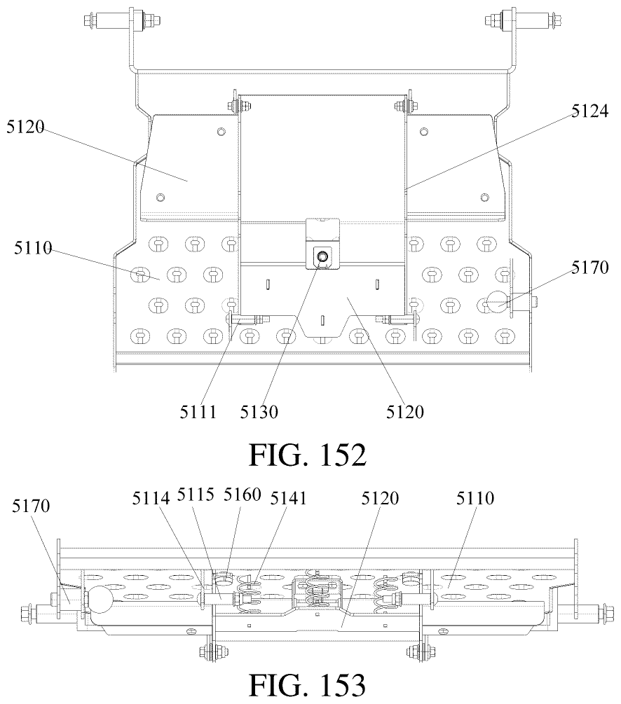

Please refer to FIG. 151, FIG. 152 and FIG. 155. In an embodiment, the reset bracket 5120 is provided with the first limiting part 51211, and the pedal is provided with the second limiting part 5111. The first limiting part 51211 is matched with the second limiting part 5111, and the maximum angle between the pedal 5110 and the reset bracket 5120 is limited. When the external force on the pedal 5110 disappears, which means that after the operator leaves the pedal 5110, the reset mechanism 5140 enables the pedal 5110 to rotate back. Through the matching between the first limiting part 51211 and the second limiting part 5111, the pedal 5110 may be avoided to be too far away from the reset bracket 5120, the use of the pedal device 510 is convenient, and the personnel are convenient to go up and down. In an embodiment, the second limiting part 5111 includes the limiting installation part 5114 arranged downward at a bottom of the pedal 5110 and the limiting sleeving rod 5115 fixed with the limiting installation part 5114. The limiting sleeving rod 5115 is arranged perpendicular to the limiting installation part 5114. When the pedal 5110 rotates back to the initial position, the top of the limiting sleeve rod 5115 is in contact with the bottom of the first limiting part 51211. The first limiting part 51211 limits the further rotation of the limiting sleeve rod 5115, which means that when the first limiting part 51211 contacts with the limiting sleeving rod 5115, the angle between the reset bracket 5120 and the pedal 5110 is the maximum angle, so as to prevent the angle between the pedal 5110 and the reset bracket 5120 from being too large, which enables it to be inconvenient for the operator to step on the pedal 5110.

Please refer to FIG. 155. In an embodiment, a cushion pad 5160 is provided between the first limiting part 51211 and the second limiting part 5111. By adding the cushion pad 5160 between the first limiting part 51211 and the second limiting part 5111, when the pedal 5110 rotates, a rigid contact between the first limiting part 51211 and the second limiting part 5111 may be avoided. On one hand, a wear and tear between the first limiting part 51211 and the second limiting part 5111 may be reduced. On the other hand, a sound when the first limiting part 51211 and the second limiting part 5111 are in contact may be reduced, which may also play a role of shock absorbing simultaneously, avoid multiple collisions between the first limiting part 51211 and the second limiting part 5111 under the effect of the reset mechanism 5140.

Please refer to FIG. 154 through FIG. 155. In an embodiment, the reset mechanism 5140 includes a compression spring 5141. The first end of the compression spring 5141 is fixed at the bottom of the pedal 5110, and the second end of the compression spring 5141 is fixed at the top of the reset bracket 5120. When the external force of the pedal 5110 disappears, the compression spring 5141 enables the pedal 5110 rotate back under its own clastic action. The compression spring 5141 has the stable action, stable backward rotation and low cost. In an embodiment, the pedal 5110 and the reset bracket 5120 are both provided with the fixing block 5142, and the fixing block 5142 is correspondingly arranged on the pedal 5110 and the reset bracket 5120. The two ends of the compression spring 5141 are sleeved on the fixing block 5142. When the pedal 5110 and the reset bracket 5120 are at the maximum angle, the distance between the two fixing blocks 5142 that is correspondingly arranged is less than the natural length of the compression spring 5141. In other words, when the pedal 5110 and the reset bracket 5120 are at the maximum angle, the compression spring 5141 cannot be removed from the fixing block 5142 in the uncompressed state. During installation, the compression spring 5141 is directly sleeved on the fixing block 5142 after compression, and no additional fixing is required, so that the installation and use of the compression spring 5141 are convenient.

Please refer to FIG. 155. In an embodiment, there are three compression springs 5141, and the three cutting blades are arranged in an isosceles triangle. By arranging three compression springs 5141, a force on the pedal 5110 may be evenly distributed and a rotation of the pedal 5110 may be ensured to be stable.

In an embodiment of the disclosure, an oil filling nozzle is arranged at a rotating connection between the reset bracket 5120 and the pedal 5110, and the oil filling nozzle is communicated with a contact point between the reset bracket 5120 and the pedal 5110. A rotation connection between the reset bracket 5120 and the pedal 5110 is easy to wear, tear and rust for a long-term use. On one hand, it can cause an abnormal sound when the reset bracket 5120 and the pedal 5110 rotate. On the other hand, it can enable the pedal 5110 to be difficult to rotate, which causes the reset mechanism 5140 to be stressed too much, and affects the duration life. By arranging the oil filling nozzle, lubricating oil may be injected into a connection between the reset bracket 5120 and the pedal 5110, so as to ensure a smooth rotation between the reset bracket 5120 and the pedal 5110, and reduce abnormal noise and noise. In an embodiment, the oil filling nozzle may further be arranged at a part where the pedal device is connected with the frame to reduce wear and corrosion of a connection between the pedal device and the frame.

The disclosure further provides the garden tool, which includes the machine body 10, a working part 3000, the control part and any one of the pedal device 510 mentioned above. In an embodiment, the machine body 10 is provided with the supporting shock absorbing component 1930. The working part 3000 is arranged on the machine body 10, and the control part controls the working part 3000 to work. The pedal device 510 includes the pedal 5110, the reset bracket 5120, the first sensor and the reset mechanism 5140. The pedal 5110 is rotatably installed on the machine body 10, the reset bracket 5120 is rotatably installed on the pedal 5110, and the supporting shock absorbing component 1930 limits the reset bracket 5120 to rotate in a direction away from the pedal 5110. In an embodiment, when the operator steps on the pedal 5110, the supporting shock absorbing component 1930 may perform a limiting support to the return bracket 5120 on one hand, so that the pedal 5110 abuts against the reset bracket 5120. On the other hand, a shock absorption effect may be provided, a vibration that the operator stands on the pedal 5110 may be reduced, and a use comfort of the operator is improved. In an embodiment, the first sensor is the signal switch 5130, and the signal switch 5130 is arranged on the reset bracket 5120 and/or the pedal 5110 to be connected when the pedal 5110 rotates to the set position relative to the reset bracket 5120. The reset mechanism 5140 is arranged between the reset bracket 5120 and the pedal 5110 to enable the pedal 5110 to rotate back after the external force acting on the pedal 5110 is removed, so that the signal switch 5130 is disconnected. The control part of the garden tool of the disclosure obtains the connecting and disconnecting state of the signal switch 5130, so that different working modes of the garden tool may be started.

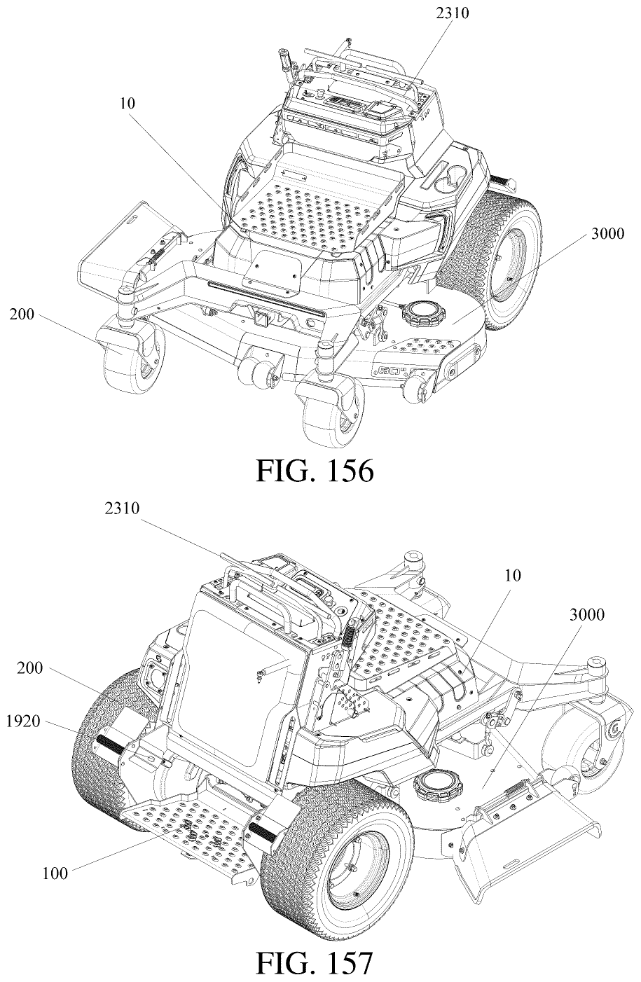

Please refer to FIG. 156 through FIG. 158. In an embodiment, the mower is also known as weeder, lawn cutter, lawn trimmer, etc. The mower is a mechanical tool configured to mow lawn, vegetation, etc. Generally, the mower can only run normally in a normal mode. When encountering obstacles or ground irregularities, the mower cannot clearly mow the lawn, which needs to cycle many times, reduces running time of the mower, and increases cost of use. The mower further includes the walking mechanism 200 and the second sensor, the control part of the mower receives the signal of the second sensor and the signal of the first sensor, and the modes of the mower are controlled according to the signal of the second sensor and the signal of the first sensor. The second sensor detects position information of the operating lever of the mower, thereby determining an operating intention of the operator. The signal sent by the second sensor includes two types, one is the fourth signal. When the second sensor sends the fourth signal, the operating lever is in the parking state. The other one is the third signal. When the second sensor sends the third signal, the mower enters the walking mode. In an embodiment, after the mower enters the walking mode, it makes forward or backward movements according to a control of the operator or a preset program. Only when it enters the walking mode and the operator does not further control or does not preset the program, the mower does not make forward or backward movements. In an embodiment, in the initial state of the operating handle, the second sensor sends the fourth signal. When the operator controls the operating handle to get out of the initial position, the second sensor sends the third signal. In an embodiment, the second sensor is the operating signal switch of the mower. In the initial state, the operating signal switch is in the combined state, the second sensor signal at this time is the fourth signal. When the operating handle is wrenched, the operating signal switch is in the separating state, the second sensor signal at this time is the third signal, and the control part of the mower enters the walking mode after receiving the walking signal. After the operating handle further acts, the mower is controlled to move forward or backward.

In an embodiment, the first sensor monitors whether there is an operator standing on the pedal 5110. When the operator stands on the pedal, the first sensor sends the first signal, which means the in-position signal, and when the operator does not stand on the pedal, the first sensor sends the second signal, which means releasing the in-position signal. In an embodiment, the first sensor is the pedal signal switch. The pedal signal switch is arranged on the pedal device. When the operator stands on the pedal, the pedal signal switch is in the connecting state, and the first signal is sent. When the operator is not standing on the pedal, the pedal signal switch is in the separating state, and the second signal is sent. It should be noted that when the pedal signal switch is in the separating state, there is the situation that the pedal signal switch cannot send the signal. At this time, the control part detects that the pedal signal switch does not send the signal. Then by default, when the pedal signal switch does not send the signal, it is also the second signal. In other words, when the first sensor sends the first signal, it is determined that the operator stands on the pedal of the mower, and when the first sensor sends the second signal, it is determined that the operator does not stand on the pedal of the mower. In another embodiment, when the operator stands on the pedal, the pedal signal switch is in the separating state, and the first signal is sent. It should be noted that there is the situation that the pedal signal switch cannot send the signal at this time, then by default, when the control part does not monitor that the signal sent by the pedal signal switch, and the first signal is also sent out for the pedal signal switch. When the operator does not stand on the pedal, the pedal signal switch is in the connecting state, and the second signal is sent.

If a walking sensor sends a starting signal, then the mower releases parking, and enters the walking mode. If the first sensor sends the first signal, the mower runs the first walking mode. If the first sensor sends the second signal, the mower runs the second walking mode.

In the first walking mode, a maximum forward speed of the mower is the first forward speed, and a maximum backward speed is the first backward speed. In order to ensure the safety and facilitate operation, in the same gear, the first forward speed is not less than the first backward speed. In the second walking mode, the maximum forward speed of the mower in the second walking mode is the second forward speed, the maximum backward speed is the second backward speed. In the same gear, the second forward speed is not less than the second backward speed, so that the staff may better operate the mower to move.

In an embodiment, in the same gear, the first forward speed is greater than the second forward speed, and the first backward speed is greater than the second backward speed. When in the second walking mode, the operator stands behind the mower rather than on the pedals. The second forward speed is less than the first forward speed, and the second backward speed is less than the second backward speed, so that the operator may follow the mower to move forward or backward. When working in the special environment, the driving speed of the mower is reduced, the reaction time of the staff is improved the personal safety is guaranteed, and the safety of the mower is improved.

In an embodiment, the mower further includes the operating mechanism 2310 and other structures. The other structures of the mower may refer to conventional mower structures, and the disclosure is not repeated here.

Please refer to FIG. 157. In an embodiment, the machine body 10 is provided with the limiting hole 1920, and the latch 5170 is arranged on the pedal device 510. When the pedal device 510 is folded, the latch 5170 is inserted into the limiting hole 1920 to limit the rotation of the pedal device 510. By arranging the latch 5170 and the limiting hole 1920, the pedal device 510 and the machine body 10 may be prevented from rotating relative to each other during transportation, and the transportation safety is effectively guaranteed. In an embodiment, when the latch 5170 is inserted into the limiting hole 1920, the signal switch 5130 is not connected. When the pedal device 510 is folded, under the effect of the reset mechanism 5140, the signal switch 5130 is in the disconnecting state.

The disclosure may detect whether the operator stands on the pedal 5110, so that the operator is convenient to use.

Embodiment 3: the disclosure provides the mower. It may be the mower 1, which includes the cutting deck 310 and other components generally arranged in the mower. The mower 1 further includes a standing frame 1819, and the standing frame 1819 is provided with two global navigation satellite systems (GNSS) receiving antenna 12 and a wireless antenna 1813. The GNSS receiving antenna 1812 and the wireless antenna 1813 may also be arranged on other components or at other suitable positions of the mower 1. The mower 1 is further provided with a control device 1814 and a positioning device 1815. The control device 1814 and the positioning device 1815 may be arranged at any suitable position on the mower 1. It shows that the control device 1814 and the positioning device 1815 are arranged in a box (not labeled) behind a driver's seat (not labeled) of the mower 1.

An RTK base station 1820 used in the disclosure is a portable RTK base station, which may be transported to different lawns with the mower 1, and then installed on a fixed anchor point 20 (FIG. 4) next to the lawn to be used together with the mower 1, so as to be used together with the mower 1 when the mower 1 performs map calibration or mowing operations on the lawn. The portable RTK base station 1820 wirelessly transmits differential data and a converged position (positioning) coordinates of the RTK base station itself to the mower 1, and the RTK base station 1820 may include a GNSS satellite receiver (not shown), a processing unit (not shown), a battery (not shown), a wireless signal transceiver (not shown) and other components. These components are what RTK base stations should normally include to achieve their functionality.

FIG. 80 is a schematic functional module view of the mower 1, a terminal control device 1830 and the RTK base station 1820 of the disclosure. The mower 1 may be the mower 1 shown in FIG. 1. The RTK base station 1820 may be the portable RTK base station shown in FIG. 1, and the terminal control device 1830 may be a hand-held terminal, such as an APP terminal of an iPad. The mower 1 includes the control device 1814, a positioning device 1815 and a communication device 1818.

In an embodiment, the control device 1814 may control the mower 1 to perform operations or/and functions such as driving, map calibrating/calling/offset, and mowing operations, so as to realize an intelligent driving function of mower 1. The control device 1814 may further include a map generation and management module, a trajectory planning module, and a mowing operation control module etc. The control device 1814 may also be referred to as an intelligent driving controller or controller in this disclosure.

The positioning device 1815 may be the GNSS mobile station, other satellite positioning mobile, or other positioning device that may be matched with the RTK base station to realize a real-time positioning function. The positioning device 1815 further includes the GNSS receiving antenna 1812 arranged on the standing frame 1819 of the mower 1. The positioning device 1815 applies the differential data to correct the GNSS positioning coordinates (which means the positioning coordinates of the mower 1) and outputs them to the control device 1814.

Please refer to FIG. 80. The communication device 1818 includes a radio unit 1811, which receives data/signals from the portable RTK base station 1820, including the differential data and base station coordinate data. The radio unit 1811 sends the differential data from the RTK base station 1820 to the positioning device (mobile satellite positioning station) 14, and transmits the base station coordinates from the RTK base station 1820 to the control device (intelligent driving controller) 1814. The communication device 1818 may further include a remote control signal receiving unit 1817 used between the mower 1 and the hand-held terminal 1830 (e.g., an APP on the iPad), and the remote control signal receiving unit 1817 may be a Bluetooth device or other wireless communication device to receive a command signal from the hand-held terminal 1830. The communication device 1818 may further include a 4G-GPS module 1816. The mower 1 may communicate with a server (such as an AWS server) 4 through a network (such as a mobile network) through the 4G-GPS module 1816, and the server 1840 may communicate with the hand-held terminal 1830 through the network (such as the mobile network).

The hand-held terminal 1830 receives state information fed back by the mower 1, and then sends a corresponding command to the mower 1 to control it to execute the command sent. The state information fed back by the mower 1 includes a positioning state and alarm information. The positioning state of the mower 1 received by the hand-held terminal 1830 includes a high-precision positioning state and a non-high-precision positioning state. The high-precision positioning state refers to an RTK fixed solution, and the non-high-precision positioning state refers to an RTK floating-point solution. In an embodiment, the high-precision positioning state indicates that the mower 1 is in a centimeter-level positioning state. The alarm information refers to various fault states of mower 1, such as a blade current overcurrent, a walking motor overcurrent, a control temperature being too high, etc.

The commands sent by the hand-held terminal 1830 may be: a command to continue a current state, a command to calibrate the map, a command to calibrate a non-mowing area (which means a non-working area), a command to increase the non-mowing area, a command that the map boundary demarcation is completed, a command that a calibration of the non-mowing area is completed, etc. The hand-held terminal 1830 is a medium of communication between the operator and the mower 1, and it may send commands to the mower 1 through a wireless communication way such as Bluetooth, Wi-Fi, Lora, etc.

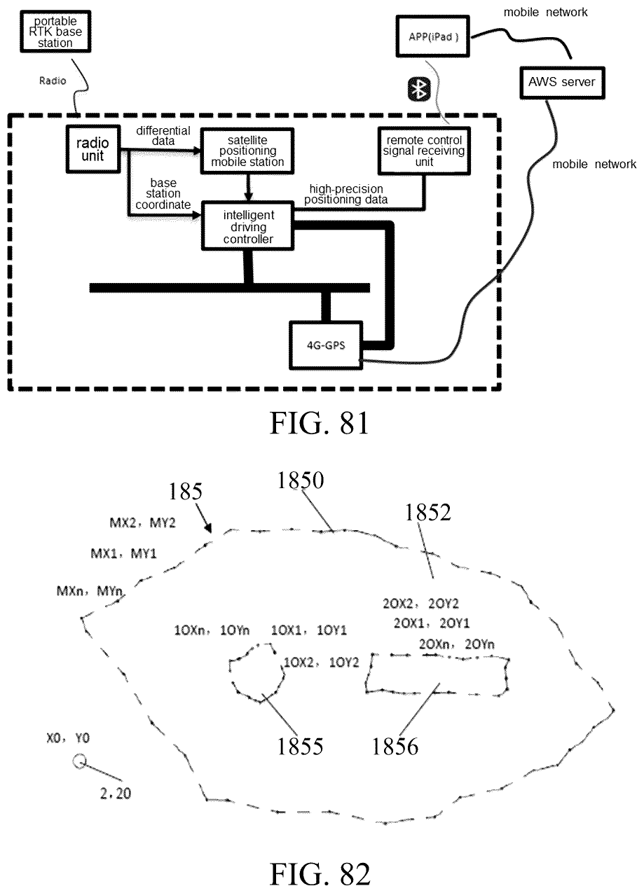

In this disclosure, please refer to FIG. 81 and FIG. 82. A GNSS positioning mobile station (which means the positioning device) 1815 collects positioning coordinates of mower 1 in real time. When the mower performs a map calibration on the lawn to be mowed (which may be a working area) 5, the positioning device 1815 applies the differential data from the RTK base station 1820 to correct positioning coordinate data of the mower 1, and sends the corrected positioning coordinate data to control device 1814. The control device 1814 applies the corrected positioning coordinate data and base station coordinate data from the RTK base station 1820 to generate a calibration map of the lawn to be mowed, and sends the calibration map to a storage device for storage. When the mower 1 mows the lawn 5 to be mowed, the control device 1814 compares RTK base station coordinates in the calibration map with the RTK base station coordinates of the current RTK base station 1820. If a deviation value obtained by the comparison is less than a preset value, then the calibration map is offset accordingly, and a new map is generated for a use of mowing operation. If the deviation value obtained by the comparison is greater than the preset value, an abnormal position of the RTK base station 1820 will be reported as an alarm. The preset value may be 1.5m.

When the positioning state information received by the hand-held terminal 1830 is high-precision positioning state information, the hand-held terminal 1830 sends a corresponding execution command to the mower 1. The execution command may be one of commands such as the command to continue a current state, the command to calibrate the map, the command to calibrate the non-mowing area, the command to increase the non-mowing area, the command that the map boundary demarcation is completed, the command that the calibration of the non-mowing area is completed, etc.

When the positioning state information received by the hand-held terminal 1830 is non-high-precision positioning state information, the hand-held terminal 1830 sends a stop command to the mower.

When the hand-held terminal 1830 receives an alarm information, the hand-held terminal 1830 displays the alarm information and notifies the operator, and the operator sends corresponding processing command to the mower 1 through the terminal control device.

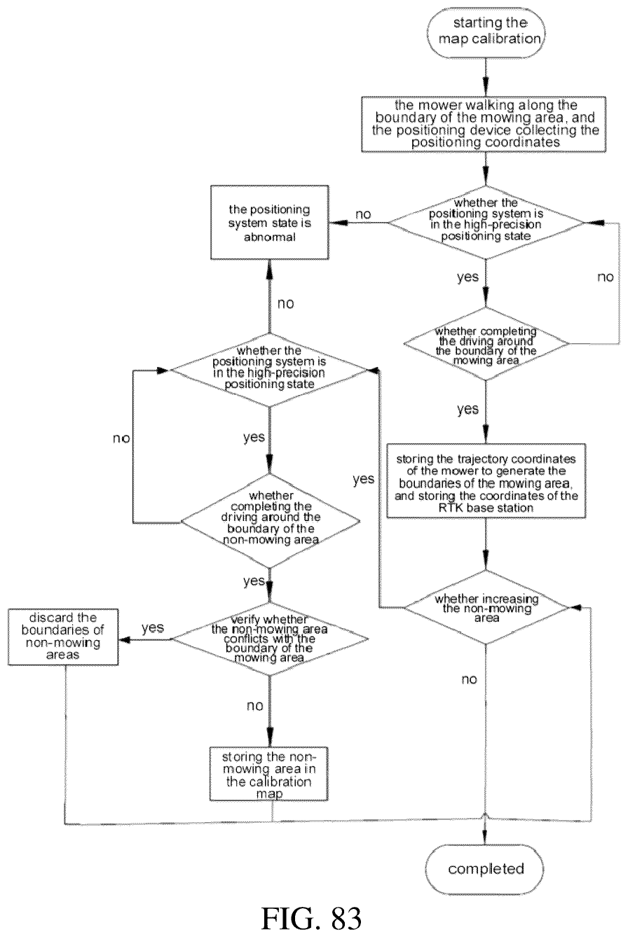

Please refer to FIG. 83 and FIG. 84. When the mower 1 is mapping to calibrate the map of a lawn 5, the mower 1 walks along a boundary 1850 of the mowing area (which means the working area) 1852 of the lawn to be calibrated, and the GNSS positioning mobile station (positioning device) 14 collects the positioning coordinates of the mower 1 in real time. The control device 1814 monitors whether the mower 1 is in the high-precision positioning state in real time. If it is not in the high-precision positioning state, then a feedback that the positioning system is abnormal is sent to the hand-held terminal 1830. If it is in the high-precision positioning state all the time, then the positioning coordinates of the mower 1 is continuously recorded until the hand-held terminal 1830 sends a map boundary calibration completion command to the control device 1814 of the mower 1. Since the positioning device 1815 is installed on the mower 1, it may be considered that the control device 1814 is actually monitoring whether the positioning system is in the high-precision positioning state in real time. The control device 1814 generates a calibration map of the mowing area 1852 according to the positioning coordinates of the mower 1 received from a start calibration command to an end calibration command, stores the calibration map to the storage device, and correspondingly stores the RTK base station coordinates sent by the RTK base station 3 simultaneously.

After completing the map of the mowing area 1852, the hand-held terminal 1830 may further send the command to calibrate the non-mowing area to the mower 1, and the non-mowing area is an obstacle 1855, 1856 and the like. The mower 1 walks along a boundary of the non-mowing area (obstacle) 1855 or 1856, the positioning device 1815 collects the positioning coordinates of the mower 1 in real time, and the control device 1814 monitors whether the mower 1 (or positioning system) is in the high-precision positioning state in real time. If it is not in the high-precision positioning state, then a feedback that the positioning system is abnormal is sent to the hand-held terminal 1830. If it is in the high-precision positioning state all the time, then the positioning coordinates of the mower 1 is continuously recorded until the hand-held terminal 1830 sends a non-mowing area calibration completion command to the mower 1. The control device 1814 generates a calibration map of the non-mowing area (obstacle, also the non-working area) 1855 or 1856 according to the positioning coordinates of the mower 1 received from the start calibration command and the end calibration command, compares it with the calibration map of the mowing area 1852 to verify whether boundaries of the non-mowing area 1855 and 1856 exceed the boundary 1850 of the mowing area 1852 (a plot to be calibrated) (or verify whether the boundaries of the non-mowing area 1855 and 1856 conflict with the boundary 1850 of the mowing area 1852 (the plot to be calibrated), and correspondingly store a boundary calibration map of the non-mowing areas 1855 and 1856 and the RTK base station coordinates sent by the RTK base station 1820.

The calibration map of the mowing area 1852 and the calibration map of the non-mowing area 1855 or 1856 may be stored on the control device 1814, the hand-held terminal 1830, or the server 1840 that may communicate with the mower and the hand-held terminal 1830.

In the disclosure, when the calibration map of a mowing area 1852 is offset accordingly, the calibration map is first called by the storage device and sent to the map generation and management module of the control device 1814. The map generation and management module calculates a difference between the RTK base station coordinates in the calibration map and the RTK base station coordinates of the current RTK base station 1820, and then adds coordinates of all points in the calibration map to the calculated difference, thereby generating a new map after the offset. The mower 1 may perform a mowing operation according to this new map.

Further, the disclosure provides a map calibration and a calling method for the mower 1, which includes:

S1: calibrating the map and generating processes/operations, which may be referred to FIG. 84. When starting the map calibration, the mower 1 walks along the boundary 1850 of the mowing area 1852 to be calibrated, and the positioning device 1815 collects (monitors and records) the positioning coordinates of the mower 1 in real time. The positioning device 1815 applies the differential data from the RTK base station 1820 to correct the positioning coordinate data of the mower 1, and sends the corrected positioning coordinate data to the control device 1814 of the mower 1. The control device 1814 applies the corrected positioning coordinate data and base station coordinate data from the RTK base station 1820 to generate a calibration map of the mowing area 1852, and sends the calibration map to the corresponding storage device for storage.

The control device 1814 monitors whether the mower 1 is in the high-precision positioning state in real time. If it is not in the high-precision positioning state, then a feedback that the positioning system is abnormal is sent to the hand-held terminal 1830. If it is in the high-precision positioning state all the time, then the positioning coordinates of the mower 1 is continuously recorded until the hand-held terminal 1830 sends the map boundary calibration completion command. The control device 1814 generates and stores the calibration map of the mowing area 1852 according to the positioning coordinates of the mower 1 received from the start calibration command and the end calibration command, and correspondingly stores the RTK base station coordinates sent by the RTK base station 1820 simultaneously.

After completing the calibration of the map mentioned above, the hand-held terminal 1830 may further send the command to calibrate the non-mowing area to the mower 1. The mower 1 walks along a boundary of the non-mowing area (for example the obstacle) 1855 or 1856, the map generation and management module of the mower 1 monitors whether the positioning device 1815/the mower 1 (or a monitoring the positioning system) is in the high-precision positioning state in real time. If it is not in the high-precision positioning state, then a feedback that the positioning system is abnormal is sent to the hand-held terminal 1830. If it is in the high-precision positioning state all the time, then the positioning coordinates of the mower 1 is continuously recorded until the hand-held terminal 1830 sends a non-mowing area calibration completion command to the mower 1. The control device 1814 generates the calibration map of the non-mowing area 1855 of 1856 according to the positioning coordinates of the mower 1 received from the start calibration command to an end calibration command, verifies whether the non-mowing area 1855 or 1856 conflicts with the boundary 1850 of the mowing area (which means whether it exceeds the boundary 1850 of the mowing area), and correspondingly stores the RTK base station coordinates sent by the RTK base station 1820 simultaneously.

S1 further includes comparing the calibration map of the non-mowing area 1855 or 1856 with the calibration map of the mowing area 1852 to verify whether the non-mowing area 1855 or 1856 is within the boundary of the mowing area 1852.

In an embodiment of FIG. 83, the map calibration and generation process of the disclosure includes:
(1) starting the map calibration;
(2) the mower 1 walking along the boundary 1850 of the mowing area 1852, and the map generation system (such as the map generation and management module of the control device 1814) collecting the positioning coordinates of the mower 1 through the GNSS positioning mobile station 14;
(3) the control device 1814 determining whether the positioning system (positioning device 1815 and the mower 1) is in the high-precision positioning state according to the state information provided by the GNSS positioning mobile station 14, if so, then continuing to determine whether the mower 1 completes a driving around the boundary 1850, if not, then sending an alarm that the positioning system state is abnormal;
(4) if the control device 1814 determines that the mower 1 has completed the driving around the boundary 1850, the hand-held terminal sending a command to store trajectory coordinates of the mower 1 to generate the calibration map, and storing the RTK base station coordinates; if the control device 1814 determines that the mower 1 has not completed the driving around the boundary 1850, then continuing to return to operation (3);
(5) after storing the trajectory coordinates of the mower 1 to generate the calibration map and storing the RTK base station coordinates, the control device 1814 determining whether it is necessary to increase the calibration of the non-mowing area (such as the obstacles 1855 and 1856), if necessary, the hand-held terminal 1830 sending the command to calibrate the non-mowing area, and if not, the process being ended (completed);
(6) after the hand-held terminal 1830 sending the command to calibrate the non-mowing area, the control device 1814 determining whether the positioning system is in the high-precision positioning state according to the state information monitored by the control device 1814, if so, then continuing to determine whether the mower 1 completes a driving around the boundary of the non-mowing area, if not, then sending the alarm that the positioning system state is abnormal;
(7) If the control device 1814 determines that the mower 1 has completed the driving around the boundary of the non-mowing area, the control device 1814 continuing to verify whether the non-mowing area conflicts with the boundary 1850 of the mowing area (usually means that the non-mowing area has exceeded the boundary 1850 of the mowing area 1852); If so, returning to (6), if not, storing the non-mowing area in the calibration map of (4), and then returning to (5);
(8) If the control device 1814 determines that the mower 1 has not completed the driving around the boundary of the non-mowing area, returning to (6).

S2 of the map calibration and the calling method for the mower 1 of the disclosure is calibrating a calling process of the map. When the mower 1 performs the mowing operation on the mowing area 1852, the control device 1814 calls the stored calibration map from the storage device. When the map is called, the control device 1814 of the mower 1 is required to calculate a deviation (which means the difference) between the positioning (position) coordinates of the RTK base station 1820 and the corresponding position coordinates of the RTK base station in the calibration map, and the calibration map of the lawn 5 is offset correspondingly according to the deviation value (differences) of the two RTK base stations.

And a preset value of a deviation range of the RTK base station is set according to a standard deviation of a GNSS single-point positioning accuracy. When the deviation exceeds the preset value, the operator is reminded that the position of the base station is abnormal, and the operator needs to check whether the RTK base station is placed on a fixed anchor point.

An embodiment of FIG. 84 includes following operations:
(1) starting to call the calibration map of the lawn 90;
(2) selecting the calibration map for the mowing operations by the storage device containing the calibration map;
(3) the control device 1814 determining whether a deviation between the position of the RTK base station in the calibration map and the positioning (position) of the RTK base station of the current RTK base station 1820 is less than the preset value, if yes, then entering the next operation, if not, then reporting that the position of the base station is abnormal to the hand-held terminal 1830 or the server 1840;
(4) the control device 1814 offsetting the calibration map according to the deviation between the positioning coordinates of the RTK base station of the calibration map and the positioning coordinates of the current RTK base station 1820, and generating a new map for the mowing operations;
(5) the process being ended (completed).

S3 of the method of the disclosure is a process of offsetting the calibration map. The control device 1814 compares RTK base station coordinates in the calibration map with the RTK base station coordinates of the current RTK base station 1820. If a deviation value obtained by the comparison is less than the preset value (for example 1.5m), then the calibration map is offset accordingly, and the new map is generated for the use of mowing operation. If the deviation value obtained by the comparison is greater than the preset value (for example 1.5m), the abnormal position of the RTK base station 1820 will be reported as an alarm.

In this disclosure, the storage device calls and sends the calibration map to a control device. The control device calculates the difference between the RTK base station coordinates in the calibration map and the RTK base station coordinates of the current RTK base station, and then adds the coordinates of all points in the calibration map to the calculated difference, thereby generating the new map after the offset. The mower may perform the mowing operation according to this new map.

The following is an example of an offset method of the calibration map for the disclosure:
when drawing the calibration map, a latitude and longitude coordinates of the RTK base station 1 position are (X0, Y0),
boundaries of the calibration map are {(MX1, MY1), (MX2, MY2), • • •, (MXn, Myn)},
boundaries of the obstacle (non-mowing area) 1 is {(1OX1, 1OY1), (1OX2, 1OY2), • • •, (1OXn, 1Oyn)},
boundaries of the obstacle (non-mowing area) 2 is {(2OX1, 2OY1), (2OX2, 2OY2), • • •, (2OXn, 2Oyn)},
• • •
boundaries of the obstacle (non-mowing area) m is {(mOX1, mOY1), (mOX2, mOY2), • • •, (1OXn, 1Oyn)},
when mowing next time, the RTK base station coordinates are (X1, Y1), then an offset (difference) that needs to be offset is (detaX, detaY)=((X1−X0), (Y1−Y0)),
The boundaries of the new map generated by the offset while mowing are {((MX1−detaX), (MY1−detaY)), ((MX2−detaX), (MY2−detaY)), • • •, ((MXn−detaX), (MYn−detaY))},
The boundaries of an obstacle 1 of the new map are {((1OX1−detaX), (1OY1−detaY)), ((1OX2−detaX), (1OY2−detaY)), • • •, ((1OXn−detaX), (1OYn−detaY))},
The boundaries of an obstacle 2 of the new map are {((2OX1−detaX), (2OY1−detaY)), ((2OX2−detaX), (2OY2−detaY)), • • •, ((2OXn−detaX), (2OYn−detaY))},
• • •
The boundaries of an obstacle m of the new map are {((mOX1−detaX), (mOY1−detaY)), ((mOX2−detaX), (mOY2−detaY)), • • •, ((1OXn−detaX), (1OYn−detaY))},

Similarly, an example of a map offset method with elevation (altitude) information:
when drawing the calibration map, the latitude coordinate, the longitude coordinate and an altitude coordinate of the RTK base station 1820 position are (X0, X0, Y0),
boundaries of the calibration map are {(MX1, MX1, MH1), (MX2, MY2, MH2), • • •, (MXn, Myn, Mhn)},
boundaries of the obstacle (non-mowing area) 1 is {(1OX1, 1OX1, 1OH1), (1OX2, 1OX2, 1OH2), • • •, (1OXn, 1OYn, 1Ohn)},
boundaries of the obstacle (non-mowing area) 2 is {(2OX1, 2OY1, 2OH1), (2OX2, 2OY2,2OH2), • • •, (2OXn, 2OYn, 2OHn)},
• • •
boundaries of the obstacle (non-mowing area) m is {(mOX1, mOY1, mOH1), (mOX2, mOY2, mOH2), • • •, (mOXn, mOYn, mOHn)},
• • •
when mowing next time, the RTK base station coordinates are (X1, X1, H1), then an offset (difference) that needs to be offset is (detaX, detaY, detaH)=((X1−X0), (Y1−Y0), (H1−H0),
The boundaries of the new map generated after the offset while mowing are {((MX1−detaX), (MY1−detaY), (MH1−detaH)), ((MX2−detaX), (MY2−detaY), (MH2−detaH)), • • •, ((MXn−detaX), (MYn−detaY)), (MHn−detaH)},
The boundaries of an obstacle 1 of the new map are {((1OX1−detaX), (1OY1−detaY), (1OH1−detaH)), ((1OX2−detaX), (1OY2−detaY), (1OH2−detaH)), • • •, ((1OXn−detaX), (1OYn−detaY)), (1OH1−detaH)},
The boundaries of an obstacle 2 of the new map are {((2OX1−detaX), (2OY1−detaY), (2OH1−detaH)), ((2OX2−detaX), (2OY2−detaY), (2OH2−detaH)), • • •, ((2OXn−detaX), (2OYn−detaY), (2OHn−detaH))},
• • •
The boundaries of an obstacle m of the new map are {((mOX1−detaX), (mOY1−detaY), (mOH1−detaH)), ((mOX2−detaX), (mOY2−detaY), (mOH2−detaH)), • • •, ((mOXn−detaX), (mOYn−detaY)), (mOH1−detaH)},

In summary, the disclosure provides a control method for a working device system of (for example the mower 1), which includes following operations:
obtaining original RTK base station coordinates;
controlling the working device to collect positioning coordinate data along the boundary of the working area, and generating a calibration map of the working area according to the collected positioning coordinate data and the original RTK base station coordinate data;
storing the calibration map and the original RTK base station coordinates; and
when the working device works in the working area, calling the calibration map;

In an embodiment, when calling the calibration map,
obtaining current RTK base station coordinates;
comparing the original RTK base station coordinates with the current RTK base station coordinates, if a deviation value obtained by the comparison is less than a preset value, then offsetting the calibration map accordingly, and generating the new map for the operation, if the deviation value obtained by the comparison is greater than the preset value, reporting the abnormal position of the RTK base station as the alarm.

In an embodiment of the disclosure, the disclosure further provides the working device system. It may be used not only for the mower 1, but also for other working devices or cases where a map needs to be mapped on a certain area of land, and the calibrated map needs to be called later (for example, for navigation). The working device system of the disclosure includes the RTK base station 1820 and the working device 1. The working device 1 may be the mower 1, for example. The working device includes the control device 1814, the positioning device 1815 and the storage device communicating with the RTK base station 1820. The positioning device 1815 collects positioning coordinates of a map calibration and calling system 1 in real time. When the map calibration and calling system 1 performs the map calibration on an area to be calibrated 5, the positioning device 1815 applies the differential data from the RTK base station 1820 to correct positioning coordinate data of the map calibration and calling system 1, and sends the corrected positioning coordinate data to control device 1814. The control device 1814 applies the corrected positioning coordinate data and base station coordinate data from the RTK base station 1820 to generate a calibration map of the area 5 to be calibrated, and sends the calibration map to a storage device for storage. When the map calibration and calling system is configured to navigate the area 5 to be calibrated (which means the working area, or called mowing area) or when it is necessary to use a completed calibration map of the area 5 to be calibrated, the control device 1814 compares RTK base station coordinates in the calibration map with the RTK base station coordinates of the current RTK base station 1820. If a deviation value obtained by the comparison is less than a preset value, then the calibration map is offset accordingly, and a new map is generated for a use navigation or other purpose. If the deviation value obtained by the comparison is greater than the preset value, the abnormal position of the RTK base station will be reported as an alarm.

The RTK base station 1820 is the portable RTK base station 1820, which may be arranged at a fixed anchor point 20 near the area 5 to be calibrated.

The control device 1814 and the positioning device 1815 communicate with the RTK base station 1820 through the communication device 1818. The communication device 1818 receives the differential data and RTK base station coordinate data from the RTK base station 1820, and sends the differential data to the positioning device 1815 and the RTK base station coordinate data to the control device 1814.

The communication device 1818 includes a radio station device installed on the map calibration and calling system, and the positioning device 1815 may be a mobile satellite positioning station.

The map calibration and calling system of the disclosure further includes the terminal control device 1830. It may receive the state information fed back by the map calibration and calling system, and send the corresponding control command to the system. The state information includes the positioning state information and alarm information of the map calibration and calling system. The positioning state information includes the high-precision positioning state information and the non-high-precision positioning state information. The high-precision positioning state information indicates that the map calibration and calling system is in a centimeter-level positioning state. The alarm information indicates that fault state information of the map calibration and calling system.

When the positioning state information received by the terminal control device 1830 is the high-precision positioning state information, the terminal control device 1830 sends the corresponding execution command to the map calibration and calling system 1. The execution command may include the command to continue the current state and the command to calibrate the map.

When the positioning state information received by the terminal control device 1830 is non-high-precision positioning state information, the terminal control device 1830 sends the stop command to the map calibration and calling system. When the terminal control device 1830 receives the alarm information, the terminal control device 1830 displays the alarm information and notifies the operator, and the operator sends corresponding processing command to the system 1 through the terminal control device 1830.

In an embodiment of the disclosure, the communication device 1818 further includes the Bluetooth device 17 and the 4G-GPS module 1816 for wireless communication with the terminal control device 1830. The 4G-GPS module 1816 may upload information of the control device 1814 to the server 1840. Then the server 1840 may send the information of the control device 1840 to the terminal control device 3, and a command of the terminal control device 1830 may also be sent to the server 1840 through the mobile network, and further sent to the control device 1814.

When the map calibration and calling system 1 draws the calibration map of the area 5 to be calibrated, the system walks along the boundary 1850 of the area 5 to be calibrated, and the positioning device 1815 collects the positioning coordinates of the system in real time. The control device 1814 monitors whether the system 1 is in the high-precision positioning state in real time. If it is not in the high-precision positioning state, then a feedback that the positioning system is abnormal is sent to the terminal control device 1830. If it is in the high-precision positioning state all the time, then the positioning coordinates of the system 1 is continuously recorded until the terminal control device 1830 sends a map boundary calibration completion command. The control device 1814 generates a calibration map of the area 5 to be calibrated according to the positioning coordinates of the system 1 received from the start calibration command to the end calibration command, stores the calibration map to the storage device, and correspondingly stores the RTK base station coordinates sent by the RTK base station 1820 simultaneously.

When the calibration map of the area 5 to be calibrated is completed, the terminal control device 1830 may further send an obstacle calibration command to the system. The system walks along the boundary of the obstacle (which means non-working area, or non-mowing area) 1855, 1856, and the positioning device 1815 collects the positioning coordinates of the system 1 in real time. The control device 1814 monitors whether the system is in the high-precision positioning state in real time. If it is not in the high-precision positioning state, then a feedback that the positioning system is abnormal is sent to the terminal control device 1830. If it is in the high-precision positioning state all the time, then the positioning coordinates of the system is continuously recorded until the terminal control device 1830 sends an obstacle calibration completion command to the system. The control device 1814 then compares the calibration map of obstacles 1855 and 1856 with the calibration map of the area 5 to be calibrated to verify whether the obstacles 1855 and 1856 are within the boundary 1850 of the area 5 to be calibrated. Then, a calibration map of the obstacle 1855, 1856 is generated and stored according to the positioning coordinates of the system received from the start calibration command to the end calibration command, and stores the RTK base station coordinates sent by the RTK base station 1820 simultaneously.

When the calibration map of the area 5 to be calibrated is offset accordingly, the calibration map is first called by the storage device and sent to the control device 1814. The control device 1814 calculates the difference between the RTK base station coordinates in the calibration map and the RTK base station coordinates of the current RTK base station 1820, and then adds the coordinates of all points in the calibration map to the calculated difference, thereby generating the new map after the offset. The system may be used for the navigation or other purpose according to this new map.

Please refer to FIG. 91. In an embodiment of the disclosure, When the unmanned mower 1 mows the lawn 5 to be mowed, the GNSS positioning mobile station (positioning device) 14 collects the positioning coordinates of the mower 1 in real time. The unmanned communication device 1814 sends the stored RTK base station coordinates to the RTK base station 1820 through the communication device (module) 18, or the hand-held terminal 1830 sends the RTK base station coordinates to the RTK base station 1820 through wireless communication modes such as Bluetooth or Wi-Fi, and the RTK base station 1820 compares the current coordinates with the received coordinates. If the deviation value obtained by comparison is less than the preset value, the received coordinates are set to the RTK base station coordinates, and if the deviation value obtained by comparison is greater than the preset value, then the alarm will be issued that the RTK base station location is abnormal.

In summary, the disclosure provides the mower with the RTK base station and the map calibration and calling system of the mower. A problem of a position drift of the RTK base station is solved when is repositioned each time by offsetting the map of the mowed lawn, and the calibration map of the lawn (including the base station coordinates of the RTK base station) is generated and stored. The mower automatically calls and offsets the calibration map for subsequent mowing operations when the lawn is mowed next time, so that there is no need to manually input new coordinates when a lawn map deviation occurs, and an automation of the lawn mowing operation is realized, which greatly improves work efficiency.

Further, the disclosure provides the working device system mentioned above and the control method thereof. It may be used not only for a calibration and calling the map of the mower, but also for other working devices or cases where a map needs to be calibrated on a certain area of land, and the calibrated map needs to be called later (for example, for navigation).

Therefore, the disclosure effectively overcomes some practical problems in the prior art, thereby having high utilization value and use significance. The above embodiments only illustrate principles and effects of the disclosure, but are not intended to limit the disclosure. Anyone familiar with this technology may modify or change the above embodiments without departing from a scope of the disclosure. Therefore, all equivalent modifications or changes made by those with ordinary knowledge in the technical field without departing from the technical ideas disclosed in the disclosure shall still be covered by the claims of the disclosure.

What is claimed is:

1. A mower, comprising:
a frame;
a walking assembly, installed on the frame;
a cutting deck assembly, mounted to the frame, and
an operating mechanism, configured to control the walking assembly to walk, and comprising:
an operating lever mounting base, rotatably installed on the frame along a first direction;
an operating lever, rotatably installed on the operating lever mounting base along a second direction;
a reset assembly, driving the operating lever to reset to an initial position in the first direction; and
a limiting assembly, locking the operating lever in the initial position.

2. The mower according to claim 1, wherein, the operating lever comprises an operating handle and a limiting plate, and the limiting plate is connected with a bottom of the operating handle.

3. The mower according to claim 2, wherein, the operating lever further comprises a sleeving tube, the sleeving tube is arranged between a connection of the limiting plate and the operating handle, the operating lever is arranged on the operating lever mounting base through a rotation shaft, the rotation shaft penetrates through the sleeving tube and is fixed together with the sleeving tube, and two ends of the rotation shaft are respectively rotatably installed on the operating lever mounting base.

4. The mower according to claim 2, wherein, the operating mechanism further comprises an elastic assembly, the elastic assembly is installed on the operating lever mounting base and is connected with the limiting plate, the elastic assembly comprises a spring base and a compression spring arranged in the spring base, the spring base is installed at a bottom of the operating lever mounting base, a first end of the compression spring is connected with the spring base, a second end of the compression spring is connected with the limiting plate, and two sides of the limiting plate are respectively provided with a protrusion matched with the compression spring.

5. The mower according to claim 2, wherein, the limiting assembly comprises a fixing base, a limiting rod and an elastic body, a first end of the limiting rod is arranged on the fixing base, a second end of the limiting rod extends towards the operating lever, the limiting plate is provided with a limiting hole matched with the limiting rod, and the elastic body is arranged between the limiting rod and the fixing base.

6. The mower according to claim 5, wherein, the limiting rod is obliquely arranged.

7. The mower according to claim 6, wherein, an angle between the limiting rod and a horizontal plane is from 8 degrees to 10 degrees, and the limiting hole is a waist-shaped hole.

8. The mower according to claim 1, wherein, the reset assembly comprises a tension spring, and an end of the tension spring is connected with the operating lever mounting base to drive the operating lever mounting base to move along the first direction.

9. The mower according to claim 1, wherein, the operating mechanism further comprises an angle sensor, and a rotating shaft of the angle sensor is installed on the operating lever and rotates synchronously with the operating lever.

10. The mower according to claim 1, wherein, the operating mechanism further comprises a blocking plate and a limiting base, the blocking plate is fixedly installed on the frame, the limiting base is rotatably connected with the blocking plate, and the operating lever mounting base is fixedly installed on the limiting base.

11. The mower according to claim 10, wherein, the operating mechanism is arranged on the frame through a fixing plate, the fixing plate is connected with the frame, the blocking plate is arranged on the fixing plate, and the fixing plate is configured to limit the operating lever mounting base in the first direction.

12. The mower according to claim 1, wherein, the operating mechanism further comprises a first operating handle and a second operating handle fixedly installed on the frame, and the first operating handle and the second operating handle are respectively arranged on a front side and rear side of the operating lever.

13. The mower according to claim 1, wherein, the walking assembly comprises a walking wheel and a driving motor to drive the walking wheel, and the operating mechanism further comprises a switch to control the driving motor to be turned on and off, and when the operating lever returns to the initial position under an effect of the reset assembly, the switch is triggered, and the driving motor is powered off.

14. The mower according to claim 1, wherein, the frame comprises a front frame and a rear frame, the front frame is detachably connected with the rear frame, the front frame is provided with a front wheel assembly, and the rear frame is provided with a rear wheel assembly.

15. The mower according to claim 1, wherein, the mower comprises a standing area, the standing area is arranged at a tail part of the frame, a cushion is arranged on standing area, the cushion tilts forward from bottom to top, and the cushion forms an angle of 100 degrees to 110 degrees with a horizontal direction.

16. The mower according to claim 1, wherein, the mower comprises a standing area, the standing area is arranged at a tail part of the frame, an operating platform is arranged on the standing area, the operating platform is provided with a display screen, and the display screen forms an angle of 150 degrees to 160 degrees with a horizontal direction.

17. The mower according to claim 1, wherein, the frame is provided with a first placing area, batteries are installed on the first placing area, the first placing area is provided with a plurality of first installation holes, and the batteries of different specifications are matched with different first installation holes.

18. The mower according to claim 1, wherein, a tail part of the mower is provided with a first charging port, the first charging port forms an angle of 15 degrees to 30 degrees with a ground, and the first charging port is provided with a reversible charging port cover.

19. The mower according to claim 1, wherein, the mower comprises a brake releasing mechanism, the brake releasing mechanism is arranged on the frame, connected with braking mechanisms on at least two motors, and comprises:
a connecting base, arranged on the frame,
a pulling rod, comprising a connecting sleeve, sleeved and installed on the connecting base through the connecting sleeve, and
at least two pulling components, the connecting sleeve being respectively connected with the braking mechanisms on the at least two motors through the at least two pulling components.

20. The mower according to claim 19, wherein, the pulling rod is configured to rotate to drive the connecting sleeve to rotate, drive the pulling components connected with the connecting sleeve to move, and simultaneously pull the braking mechanism on the at least two motors to release and open or to reset and lock; the pulling component is an elastic reset component; when the pulling rod rotates over a releasing position, the at least two elastic reset components stretch to drive the braking mechanism on the at least two motors to release and open, and enable the connecting sleeve to bear a force balance at the releasing position; and when the pulling rod rotates over the releasing position in an opposite direction, the at least two elastic reset components shrink and reset, so as to drive the connecting sleeve to move and reset, and enable the braking mechanism on the at least two motors to reset and lock at the same time.
